(19) United States
(12) Patent Application Publication
(10) Pub. No.: US 2016/0078712 A1
(43) Pub. Date: Mar. 17, 2016

(54) GAMING MACHINE HAVING A BASE GAME MODE AND A FEATURE GAME MODE

(71) Applicants: Universal Entertainment Corporation, Tokyo (JP); Aruze Gaming America, Inc., Las Vegas, NV (US)

(72) Inventors: Takehisa ITAGAKI, Tokyo (JP); Yuuki TERADA, Tokyo (JP); Yuji MIYAGAWA, Tokyo (JP); Hiromoto YAMAUCHI, Tokyo (JP)

(21) Appl. No.: 14/847,122

(22) Filed: Sep. 8, 2015

(30) Foreign Application Priority Data
Sep. 16, 2014 (JP) 2014-188314
Sep. 16, 2014 (JP) 2014-188315
Sep. 16, 2014 (JP) 2014-188316
Sep. 16, 2014 (JP) 2014-188317
Sep. 16, 2014 (JP) 2014-188318

(51) Int. Cl. G07F 17/32; G07F 17/34

(52) U.S. Cl. CPC G07F 17/3213; G07F 17/32; G07F 17/34

(57) ABSTRACT

Provided is a gaming machine which is capable of continuously providing a player with a feeling of expectation in a feature game mode. The gaming machine includes: a display for displaying a game in a base game mode and for displaying a unit game in a feature game mode being different from the base game mode; and a controller for determining a payout in the unit game in the feature game mode, (A-1-1) displaying order in which a plurality of unit games in the feature game mode are displayed is determined, and (A-1-2) the displaying order is rearranged.

### CROSS-REFERENCE TO RELATED APPLICATION FIELD OF THE INVENTION

This application claims the benefit of Japanese Patent Application No. 2014-188314, filed on Sep. 16, 2014, Japanese Patent Application No. 2014-188315, filed on Sep. 16, 2014, Japanese Patent Application No. 2014-188316, filed on Sep. 16, 2014, Japanese Patent Application No. 2014-188317, filed on Sep. 16, 2014, Japanese Patent Application No. 2014-188318, filed on Sep. 16, 2014, which applications are incorporated herein by reference in their entirety.

### FIELD OF THE INVENTION

The present invention relates to a gaming machine in which symbols are rearranged.

### BACKGROUND OF THE INVENTION

Conventionally, there has been known a slot machine in which a plurality of kinds of symbols are displayed in a scrolling manner and thereafter, the plurality of kinds of symbols are displayed in a stopped manner, and based on a combination (winning pattern) of the symbols displayed in the stopped manner, gaming media (for example, coins) are provided (for example, refer to U.S. Pat. No. 6,960,133, U.S. Pat. No. 6,012,983, and U.S. Pat. No. 6,093,102).

Further, as such a slot machine, there is a slot machine in which on the condition that a predetermined condition is satisfied in a base game mode, the game mode shifts to a second game mode which is different from the base game mode (for example, refer to Australian Patent Application Laid-Open Publication No. 1972901, U.S. Pat. No. 6,913,532, and U.S. Pat. No. 6,491,584).

As the above-mentioned second game mode, for example, there is a feature game mode in which a game can be played on a more advantageous condition than in a game the base game mode. However, in this conventional gaming machine, an outcome of a unit game is determined each time the unit game is executed. Therefore, although a feeling of expectation can be temporarily provided for a player, thereafter, the feeling of expectation is likely to be reduced.

In view of the above-described point, the present invention was made, and an object of the present invention is to provide a gaming machine which is capable of sustaining a player's feeling of expectation in the feature game mode.

### BRIEF SUMMARY OF THE INVENTION

A first aspect of the present invention is a gaming machine which includes

a display for displaying a game in a base game mode and for displaying a unit game in a feature game mode being different from the base game mode; and

a controller for determining a payout in the unit game in the feature game mode, and

the controller is programmed to execute processes described below:

a process (A-1-1) in which displaying order in which a plurality of unit games in the feature game mode are displayed is determined; and

a process (A-1-2) in which the displaying order is rearranged.

Since the display order is previously changed, the whole development of the unit games in the feature game mode is previously determined, thereby allowing a feeling of expectation to be enhanced and enabling a player to be attracted to the feature game mode.

The process (A-1-1) may be a process (A-1-1′) in which the order in which the plurality of unit games in the feature game mode are executed is determined; and the process (A-1-2) may be a process (A-1-2′) in which the executing order is rearranged.

Since the order is not the displaying order, but the executing order, it is only required for the unit games to be internally executed and it is not required for the unit games to be displayed.

A second aspect of the present invention is configured such that

the process (A-1-1) includes:

a process (A-2-1) in which a payout in each of the plurality of unit games is determined; and

a process (A-2-2) in which winning or losing in each of the plurality of unit games is determined based on the payout, and

the process (A-1-2) includes

a process (A-2-3) in which based on the winning or losing, a pattern in which the displaying order is rearranged is determined by a drawing process.

Since the displaying order is rearranged based on the payout, the order of the plurality of unit games can be determined so as to gradually enhance a feeling of expectation, thereby allowing monotony of the feature game mode to be avoided. It is only required for the winning or losing to be determined based on the payout, and effect images for the winning or losing can be conducted so as to be different from those in each of the unit games.

A third aspect of the present invention is configured such that

the feature game mode is a game mode in which by rearranging a plurality of symbols arranged in a group of reel strips, an outcome of each of the unit games is displayed on the display,

the process (A-2-1) includes:

a process (A-3-1) in which one kind of a group of reel strips is determined from a plurality of kinds of groups of reel strips for each of the unit games by a drawing process;

a process (A-3-2) in which by rearranging a plurality of symbols arranged in the one kind of the group of reel strips determined by the process (A-3-1), a payout of the unit game is determined; and

a process (A-3-3) in which in the predetermined number-th unit game among the plurality of unit games, a predetermined group of reel strips is selected from the plurality of kinds of groups of reel strips, and

the process (A-3-1) is executed, and

the process (A-1-2) includes

a process (A-3-4) in which the displaying order is rearranged such that displaying order in which the predetermined number-th unit game is displayed is the same before and after the process (A-1-2) is executed.

In the predetermined number-th unit game, the predetermined group of reel strips is selected and the payout is determined, thereby allowing the payout in the predetermined number-th unit game to be adjusted. Since in the feature game mode, the predetermined number-th unit game is fixed, the development of the unit games in the feature game mode can be adjusted.

A fourth aspect of the present invention is a gaming machine which includes:

a display for displaying a game in a base game mode and for displaying a unit game in a feature game mode being different from the base game mode; and

a controller for determining payouts of a plurality of unit games in the feature game mode, and the controller is programmed to execute processes described below:

a process (B-1-1) in which a payout of each of the plurality of unit games is determined;

a process (B-1-2) in which a class of the payout of each of the plurality of unit games is determined; and

a process (B-1-3) in which as an outcome of the unit game, an image in accordance with the class of the payout is displayed on the display.

Since the payouts of the plurality of unit games are classified and the image in accordance with the class of the payout is displayed, the displayed image allows a player to imagine the payout of the unit game played at that time, thereby allowing a feeling of expectation regarding the development of the feature game mode to be enhanced.

A fifth aspect of the present invention is configured such that

the base game mode is a game mode in which by rearranging the plurality of symbols, an outcome of the unit game is displayed on the display, and

the feature game mode is a game mode in which an image being different from an image in which the plurality of symbols are rearranged is displayed on the display as the image in accordance with the class of the payout

The game in the base game mode is the game in which by rearranging the plurality of symbols, the outcome of the unit game is displayed on the display. On the other hand, in the game in the feature game mode, the image in which the plurality of symbols are rearranged is not displayed, and the image in accordance with the class of the payout is displayed. According to the fifth aspect thereof, in the feature game mode, the game which is clearly different from the game in the base game mode is executed, thereby allowing an interest of a player to be attracted and enabling a feeling of expectation to be enhanced. In addition, since the image in accordance with the class of the payout is displayed, a player predicts or expect a payout, thereby allowing a player to be attracted to the feature game mode.

A sixth aspect of the present invention is configured such that

the gaming machine further includes

a memory for storing a class correspondence table which defines relationship between the classes of the payouts and images in accordance with the classes of the payouts, and

the process (B-1-3) includes

a process (B-3-1) in which after executing the process (B-1-2), the class correspondence table is referenced based on the class of the payout, the image in accordance with the class of the payout is determined.

According to the sixth aspect thereof, since the gaming machine has the class correspondence table which defines the relationship between the classes of the payouts and the images in accordance with the classes of the payouts, by referencing the class correspondence table, the image in accordance with the class of the payout can be immediately determined from the classes of the payouts, thereby allowing effects to be smoothly determined. In particular, even in a case when a configuration in which a plurality of images in accordance with the classes of the payouts are to be displayed is employed, the plurality of images can be quickly determined and executed.

A seventh aspect of the present invention is configured such that

the display has a first display part and a second display part,

in the base game mode, the plurality of symbols are rearrange on the first display part, and

in the feature game mode, each of the images in accordance with the classes of the payouts is displayed on the first display part, and the plurality of symbols are rearranged on the second display part.

In the base game mode, the game in which the plurality of symbols are rearranged on the first display part is executed. On the other hand, in the feature game mode, on the first display part, each of the images in accordance with the classes of the payouts is displayed, and on the second display part, the plurality of symbols are rearranged. According to the seventh aspect thereof, since also in the feature game mode, each of the images in accordance with the classes of the payouts is displayed on the first display part, a player can play the game in the feature game mode without moving his or her line of sight. In addition, since in the feature game mode, the game which is clearly different from the game in the base game mode is executed, a feeling of expectation of a player can be enhanced. Further, since on the second display part, the plurality of symbols are rearranged, a player is notified of a basis of the image in accordance with the class of the payout, thereby allowing reliability of the game to be enhanced and enabling a player to be relieved and to play the game.

An eighth aspect of the present invention is a gaming machine which includes:

a display for displaying a game in a base game mode and for displaying a unit game in a feature game mode being different from the base game mode; and

a controller for determining a payout in the unit game in the feature game mode, and

the controller is programmed to execute processes described below:

a process (C-1-1) in which a number of times at which information pertinent to a payout is displayed is determined by a drawing process; and

a process (C-1-2) in which in the predetermined number-th unit game among the plurality of unit games, in accordance with the number of times determined by the process (C-1-1), the information pertinent to the payout is generated from the payout

In the predetermined number-th unit game, the information pertinent to the payout is displayed over divided times, thereby allowing a player to expect that a payout which is different from a payout in a normal unit game is likely to be provided and enabling the feature game mode to be prevented from becoming monotonous.

In a ninth aspect of the present invention,

the controller is configured to execute processes described below:

a process (C-2-1) in which all of payouts in the plurality of unit games in the feature game mode are determined; and

a process (C-2-2) in which as the process (C-1-1), after executing the process (C-2-1), a number of times at which the information pertinent to the payout is displayed is determined by a drawing process.

First, all of the payouts in the plurality of unit games in the feature game mode are determined and thereafter, the number of times at which the information pertinent to the payout is displayed is determined. According to the ninth aspect thereof, while all of the payouts in the plurality of unit games in the feature game mode are reflected, the predetermined number-th unit game, the number of times at which the information pertinent to the payout is displayed in the predetermined number-th unit game, and the information pertinent to the payout can be determined. In other words, effects can be executed by utilizing the information pertinent to the payout from the overall flow of the plurality of unit games. Effects which causes a player to expect can be executed.

In a 10th aspect of the present invention,

the controller is configured to execute processes described below:

a process (C-3-1) in which a payout is determined each time each of the plurality of unit games in the feature game mode is executed;

a process (C-3-2) in which it is determined whether or not a unit game is the predetermined number-th unit game among the plurality of unit games; and

a process (C-3-3) in which when the unit game is the predetermined number-th unit game, as the process (C-1-1), the number of times at which the information pertinent to the payout is displayed is determined by a drawing process.

While the payout is determined each time each of the plurality of unit games is executed, when the unit game is the predetermine unit game, for example, the predetermined game is executed and the predetermined effects are executed, and when the unit game is different from any of the other unit games, the number of times at which the unit game is displayed is determined by the drawing process. According to the 10th aspect thereof, since without being limited by all of the payouts in the feature game mode, the number of times at which the information pertinent to the payout is displayed is determined by the drawing process, effects utilizing the information pertinent to the payout can be executed in an unexpected manner, thereby allowing effects which surprise a player to be executed.

In an 11th aspect of the present invention,

the controller is configured to execute processes described below:

a process (C-4-1) in which it is determined whether or not a unit game is the predetermined number-th unit game among the plurality of unit games; and

a process (C-4-2) in which when the unit game is the predetermined number-th unit game, as the process (C-1-1), based on the payout of the predetermined number-th unit game, the number of times at which the information pertinent to the payout is displayed is determined by a drawing process.

According to the 11th aspect thereof, based on the payout of the predetermined number-th unit game, the number of times at which the information pertinent to the payout is displayed is determined, thereby allowing a player to predict or expect the payout based on the number of times at which the information pertinent to the payout is displayed.

A 12th aspect of the present invention is a gaming machine which includes:

a display for displaying a game in a base game mode and for displaying a unit game in a feature game mode being different from the base game mode; and

a controller for determining payouts of a plurality of unit games in the feature game mode, and

the controller is programmed to execute processes described below:

a process (D-1-1) in which in the predetermined number-th unit game among the plurality of unit games, it is determined whether the feature game mode is continued or finished;

a process (D-1-2) in which it is determined whether or not the payout satisfies a condition regarding a payout;

a process (D-1-3) in which it is determined whether or not the predetermined number-th time satisfies a condition regarding the number of times; and

a process (D-1-4) in which based on results of the determination processes of the process (D-1-1) to the process (D-1-3), contents of effects in the predetermined number-th unit game is determined.

The contents of effects in the predetermined number-th unit game is determined based on the predetermined number-th unit game, the payout, and whether or not the feature game mode is continued. According to the 12th aspect thereof, based on the various conditions in the unit games in the feature game mode, the contents of effects can be appropriately modified, thereby allowing diverse effects to be conducted and enabling a feeling of expectation of a player to be enhanced by the progress of the effects.

In a 13th aspect of the present invention,

the controller is configured to further execute processes described below:

a process (D-2-1) in which in the predetermined number-th unit game, when the contents of effects have not been determined in the determination process of the process (D-1-4), first effects are determined as the contents of effects; and

a process (D-2-2) in which in the predetermined number-th unit game, when the contents of effects have already been determined in the determination process of the process (D-1-4), second effects which are different from the first effects are determined as the contents of effects.

According to the 13th aspect thereof, since depending on whether or not the contents of effects have already been determined, the contents of effects are made different, repeating the same effects is prevented and the different effects are executed in accordance with the progress of the unit game, thereby allowing a player not to get bored.

In a 14th aspect of the present invention,

the controller is configured to further execute

a process in which in the process (D-1-3), when the feature game mode is continued, it is determined whether or not a condition regarding the number of times is satisfied, the condition including a number of times at which the feature game mode is continued.

According to the 14th aspect thereof, since it is determined whether or not the condition regarding the number of times is satisfied, the condition including the number of times at which the feature game mode is continued, even when the feature game mode is continued, the contents of effects can be determined while the overall flow of the feature game mode is reflected.

In a 15th aspect of the present invention,

the controller is configured to further execute processes described below:

a process (D-4-1) in which winning or losing in each of the plurality of unit games is determined based on the payout; and

a process (D-4-2) in which based on the payout and whether or not a result of the determination of the winning or losing is winning, effects are conducted.

According to the 15th aspect thereof, when the result of the determination of the winning or losing is the winning, an image being different from the image which has been so far displayed is displayed. For example, an image in which a character being different from the character which has so far appeared appears is displayed, thereby allowing a feeling of expectation to be enhanced.

A 16th aspect of the present invention is a gaming machine which includes:

a display for displaying a game in a base game mode and for displaying a unit game in a feature game mode being different from the base game mode; and

a controller for determining payouts of a plurality of unit games in the feature game mode, and the controller is programmed to execute processes described below:

a process (E-1-1) in which in the predetermined number-th unit game among the plurality of unit games, it is determined whether the feature game mode is continued or finished;

a process (E-1-2) in which when the feature game mode is continued, a payout of each of all of unit games which includes unit games to be continued is determined; and

a process (E-1-3) in which based on the payout determined in the process (E-1-2), effects are executed.

According to the 16th aspect thereof, the overall development such as the number of times, at which the unit game in the feature game mode is executed, can be previously determined, thereby allowing a player to be easily attracted to the feature game mode.

In a 17th aspect of the present invention, when the feature game mode is continued, the plurality of times is a number of times including a number of unit game to be continued, and

the controller is configured to execute processes described below:

a process (E-2-1) in which a payout of each of a plurality of unit games in the feature game mode is determined; and

a process (E-2-2) in which effects based on the payout of the unit game executed are executed each time each of the plurality of unit games is executed.

When the unit games in the feature game mode are continued, the payout of each of all of the unit games including the continued unit games is determined, and the effects based on the payout are executed each time each of the unit games is executed. According to the 17th aspect thereof, since the effects are executed based on the payout of each of all of the unit games in the feature game mode, continuity of the effects based on the payout can be ensured. For example, smooth effects such as effects having story nature are executed, thereby attracting a player and allowing a feeling of expectation to be enhanced.

In an 18th aspect of the present invention,

the controller is configured to execute processes described below:

a process (E-3-1) in which a payout of each of all of the plurality of unit games in the feature game mode is determined; and

a process (E-3-2) in which in any unit game among the plurality of unit games, effects based on the payout of each of the plurality of unit games are executed before the unit game is initiated.

The payout of each of all of the plurality of unit games in the feature game mode is determined and in any unit game, the effects based on the payout of each of all of the plurality of unit games are executed. For example, in an initial unit game in the feature game mode, the effects based on the payout of each of all of the unit games are executed. According to the 18th aspect thereof, since in any unit game, the effects based on the payout are executed, a player can know the payout provided in the feature game mode, thereby allowing a feeling of expectation of a player to be enhanced. In particular, when in the initial unit game in the feature game mode, the effects are executed, a feeling of expectation of a player can be maintained over the feature game mode.

In a 19th aspect of the present invention,

the controller is configured to execute processes described below:

a process (E-4-1) in which displaying order in which the plurality of unit games in the feature game mode are displayed is determined; and

a process (E-4-2) in which the displaying order is rearranged.

According to the 19th aspect thereof, since the displaying order is previously changed, the overall development of the unit games in the feature game mode is previously determined, thereby allowing a feeling of expectation to be enhanced and enabling a player to be attracted to the feature game mode.

In a 20th aspect of the present invention,

the controller is configured to execute

a process in which in the process (E-4-2), except for the predetermined number-th unit game among the plurality of unit games, the displaying order is rearranged.

According to the 20th aspect thereof, since the displaying order is rearranged except for the predetermined number-th unit game, the displaying order is prevented from being similarly rearranged, thereby allowing the progress of the unit games to be prevented from becoming simple.

In a 21st aspect of the present invention,

the controller is configured to execute

a process in which in the process (E-4-2), displaying order in which the another predetermined number-th unit game, which is different from said predetermined number-th unit game, among the plurality of unit games is displayed is randomly determined.

According to the 21st aspect thereof, since the displaying order in which the particular number-th unit game is displayed is randomly determined, the particular number-th unit games can be randomly dispersed, thereby allowing the progress of the unit games to be prevented from becoming simple.

In the feature game mode, a feeling of expectation can be continuously provided for a player.

### BRIEF DESCRIPTION OF THE DRAWINGS

FIG. 1 is a diagram illustrating an outline of a gaming machine;

FIG. 2 is a diagram illustrating a game system which includes slot machines;

FIG. 3 is a diagram illustrating an overall configuration of the slot machine;

FIG. 4 is a table showing a group of reel strips constituting five video reels 3a to 3e (symbol determination table);

FIG. 5 is the table showing the group of reel strips constituting the five video reels 3a to 3e (symbol determination table);

FIG. 6 is a table showing a group of reel strips constituting the five video reels 3a to 3e (symbol determination table);

FIG. 7 is a table showing a group of reel strips constituting the five video reels 3a to 3e (symbol determination table);

FIG. 8 is a table showing a group of reel strips constituting the five video reels 3a to 3e (symbol determination table);

FIG. 9 is the table showing the group of reel strips constituting the five video reels 3a to 3e (symbol determination table);

FIG. 10 is the table showing the group of reel strips constituting the five video reels 3a to 3e (symbol determination table);

FIG. 11 is a block diagram illustrating an internal configuration of the slot machine;

FIG. 12 shows an example of a payout table;

FIG. 13 is a diagram illustrating state transition in the slot machine;

FIG. 14 is a diagram illustrating an outline of knockout effects;

FIG. 15 is a diagram illustrating an outline of knockout effects;

FIG. 16 is a table showing an example of a payline definition table;

FIG. 17 is a flowchart of a main control process;

FIG. 18 is a flowchart of a coin-insertion/start-check process;

FIG. 19 is a flowchart of a symbol drawing process;

FIG. 20 is a flowchart of a symbol display control process;

FIG. 21 is a flowchart of a to-be-paid-out number determination process;

FIG. 22 is a flowchart showing an outline of a feature game mode;

FIG. 23 is a flowchart of a feature game mode process;

FIG. 24 is a flowchart of a payout drawing process;

FIG. 25 is a flowchart of a feature game mode symbol drawing process;

FIG. 26 is a flowchart of a revival drawing process;

FIG. 27 is a flowchart of a winning or losing determination and rearrangement pattern determination process;

FIG. 28 is a flowchart of a rearrangement execution process;

FIG. 29 is flowchart of a rearrangement execution process;

FIG. 30A and FIG. 30B are flowcharts of a knockout effects determination process;

FIG. 31 is a flowchart of an enemy character determination process;

FIG. 32 is a flowchart of an enemy character physical strength determination process;

FIG. 33A and FIG. 33B are flowcharts of a physical strength calculation process;

FIG. 34 is a flowchart of a physical strength determination process in a case when an ally character defeats an enemy character;

FIG. 35 is a flowchart of a physical strength determination process in a case when an ally character is defeated by an enemy character;

FIG. 36 is a flowchart of a battle effects drawing process;

FIG. 37 is a flowchart of a combo effects drawing process;

FIG. 38 shows a winning or losing drawing table;

FIG. 39 shows a rearrangement drawing table;

FIG. 40 is a reel strip drawing table;

FIG. 41 is a revival drawing table;

FIG. 42 is a table showing relationship between rounds and payouts;

FIG. 43 is a table showing rearranged payouts;

FIG. 44 is a table showing relationship between rounds and payouts;

FIG. 45 is a table showing relationship between rounds and payouts;

FIG. 46 is a table showing relationship between rounds and payouts;

FIG. 47 is a number-of-position-changed-rounds drawing table;

FIG. 48 is a table showing relationship between rounds and payouts;

FIG. 49A and FIG. 49B are tables showing relationship between rounds and payouts;

FIG. 50 is a table showing relationship between rounds and payouts;

FIG. 51 is a table showing relationship between rounds and payouts;

FIG. 52A and FIG. 52B are tables showing relationship between rounds and payouts;

FIG. 53 is a table showing relationship between rounds and payouts;

FIG. 54 is a table showing relationship between rounds and payouts;

FIG. 55 is a table showing relationship between rounds and payouts;

FIG. 56 is a table showing relationship between rounds and payouts;

FIG. 57 is a table showing relationship between rounds and payouts;

FIG. 58 is a table showing relationship between rounds and payouts;

FIG. 59 is a table showing relationship between rounds and payouts;

FIG. 60 is a table showing relationship between rounds and payouts;

FIG. 61 is a table showing relationship between rounds and payouts;

FIG. 62 is a table showing relationship between rounds and payouts;

FIG. 63A and FIG. 63B are tables showing relationship between rounds and payouts;

FIG. 64 is a table showing relationship between rounds and payouts;

FIG. 65 is a table showing relationship between rounds and payouts;

FIG. 66 is a table showing relationship between rounds and payouts;

FIG. 67A and FIG. 67B are tables showing relationship between rounds and payouts;

FIG. 68 is a table showing relationship between rounds and payouts;

FIG. 69 is a diagram illustrating kinds of branching of single attacks S1, S2, and S3;

FIG. 70 is a diagram illustrating kinds of branching of single attacks S, M, and L;

FIG. 71 is a diagram illustrating kinds of branching of combos A, B, and C;

FIG. 72 is a table showing kinds of the combos;

FIG. 73 is a table showing a battle effects drawing table;

FIG. 74 is a table showing a battle effects drawing table;

FIG. 75 is a table showing a battle effects drawing table;

FIG. 76 is a table showing a battle effects drawing table;

FIG. 77 is a table showing a battle effects drawing table;

FIG. 78 is a table showing an example of the combos and payouts;

FIG. 79 is a to-be-added-number drawing table;

FIG. 80 is a table showing an example of the combos and payouts;

FIG. 81 is a table defining relationship between payouts and ranks;

FIG. 82 is a table showing relationship of the rounds, payouts, and the ranks;

FIG. 83 is a correction value drawing table;

FIG. 84 is a table showing relationship of the rounds, payouts, the ranks, and enemy physical strengths;

FIG. 85 is correction value drawing table;

FIG. 86 is a table showing relationship of the rounds, payouts, the ranks, and own physical strengths;

FIG. 87 is a table defining relationship between payouts and ranks;

FIG. 88 is a table showing relationship of the rounds, payouts, and the ranks;

FIG. 89 is a correction value drawing table;

FIG. 90 is a table showing relationship of the rounds, payouts, the ranks, and enemy physical strengths;

FIG. 91 is a table showing relationship of the rounds, payouts, the ranks, and own physical strengths;

FIG. 92A is a diagram illustrating an example of battle effects;

FIG. 92B is a diagram illustrating the example of battle effects;

FIG. 92C is a diagram illustrating the example of battle effects;

FIG. 92D is a diagram illustrating the example of battle effects;

FIG. 93A is a diagram illustrating the example of battle effects;

FIG. 93B is a diagram illustrating the example of battle effects;

FIG. 93C is a diagram illustrating the example of battle effects;

FIG. 93D is a diagram illustrating the example of battle effects;

FIG. 94A is a diagram illustrating an example of battle effects;

FIG. 94B is a diagram illustrating the example of battle effects;

FIG. 94C is a diagram illustrating the example of battle effects;

FIG. 94D is a diagram illustrating the example of battle effects;

FIG. 95A is a diagram illustrating the example of battle effects;

FIG. 95B is a diagram illustrating the example of battle effects;

FIG. 95C is a diagram illustrating the example of battle effects;

FIG. 95D is a diagram illustrating the example of battle effects;

FIG. 96A is a diagram illustrating the example of battle effects;

FIG. 96B is a diagram illustrating the example of battle effects;

FIG. 96C is a diagram illustrating the example of battle effects;

FIG. 96D is a diagram illustrating the example of battle effects;

FIG. 97A is a diagram illustrating the example of battle effects;

FIG. 97B is a diagram illustrating the example of battle effects;

FIG. 97C is a diagram illustrating the example of battle effects;

FIG. 97D is a diagram illustrating the example of battle effects;

FIG. 98A is a diagram illustrating an example of battle effects;

FIG. 98B is a diagram illustrating the example of battle effects;

FIG. 98C is a diagram illustrating the example of battle effects;

FIG. 98D is a diagram illustrating the example of battle effects;

FIG. 99A is a diagram illustrating the example of battle effects;

FIG. 99B is a diagram illustrating the example of battle effects;

FIG. 99C is a diagram illustrating the example of battle effects;

FIG. 99D is a diagram illustrating the example of battle effects;

FIG. 100A is a diagram illustrating the example of battle effects;

FIG. 100B is a diagram illustrating the example of battle effects;

FIG. 100C is a diagram illustrating an example of battle effects;

FIG. 100D is a diagram illustrating an example of battle effects;

FIG. 101A is a diagram illustrating the example of battle effects;

FIG. 101B is a diagram illustrating the example of battle effects;

FIG. 101C is a diagram illustrating the example of battle effects;

FIG. 101D is a diagram illustrating the example of battle effects;

FIG. 102A is a diagram illustrating the example of battle effects;

FIG. 102B is a diagram illustrating the example of battle effects;

FIG. 102C is a diagram illustrating the example of battle effects;

FIG. 102D is a diagram illustrating the example of battle effects;

FIG. 103A is a diagram illustrating the example of battle effects;

FIG. 103B is a diagram illustrating the example of battle effects;

FIG. 103C is a diagram illustrating the example of battle effects;

FIG. 103D is a diagram illustrating the example of battle effects;

FIG. 104A is a diagram illustrating the example of battle effects;

FIG. 104B is a diagram illustrating the example of battle effects;

FIG. 104C is a diagram illustrating the example of battle effects;

FIG. 104D is a diagram illustrating the example of battle effects;

FIG. 105A is a diagram illustrating the example of battle effects;

FIG. 105B is a diagram illustrating an example of battle effects;

FIG. 105C is a diagram illustrating the example of battle effects;

FIG. 105D is a diagram illustrating the example of battle effects;

FIG. 106A is a diagram illustrating the example of battle effects;

FIG. 106B is a diagram illustrating the example of battle effects;

FIG. 106C is a diagram illustrating the example of battle effects;

FIG. 106D is a diagram illustrating the example of battle effects;

FIG. 107A is a diagram illustrating the example of battle effects;

FIG. 107B is a diagram illustrating the example of battle effects;

FIG. 107C is a diagram illustrating the example of battle effects;

FIG. 107D is a diagram illustrating the example of battle effects;

FIG. 108A is a diagram illustrating the example of battle effects;

FIG. 108B is a diagram illustrating the example of battle effects;

FIG. 108C is a diagram illustrating the example of battle effects;

FIG. 108D is a diagram illustrating the example of battle effects;

FIG. 109A is a diagram illustrating the example of battle effects;

FIG. 109B is a diagram illustrating the example of battle effects;

FIG. 109C is a diagram illustrating the example of battle effects;

FIG. 109D is a diagram illustrating the example of battle effects;

FIG. 110A is a diagram illustrating the example of battle effects;

FIG. 110B is a diagram illustrating the example of battle effects;

FIG. 110C is a diagram illustrating the example of battle effects;

FIG. 110D is a diagram illustrating the example of battle effects;

FIG. 111A is a diagram illustrating the example of battle effects;

FIG. 111B is a diagram illustrating the example of battle effects;

FIG. 111C is a diagram illustrating the example of battle effects;

FIG. 111D is a diagram illustrating the example of battle effects.

### DETAILED DESCRIPTION OF THE PREFERRED EMBODIMENT

### Outline of Gaming Machine of the Present Embodiment

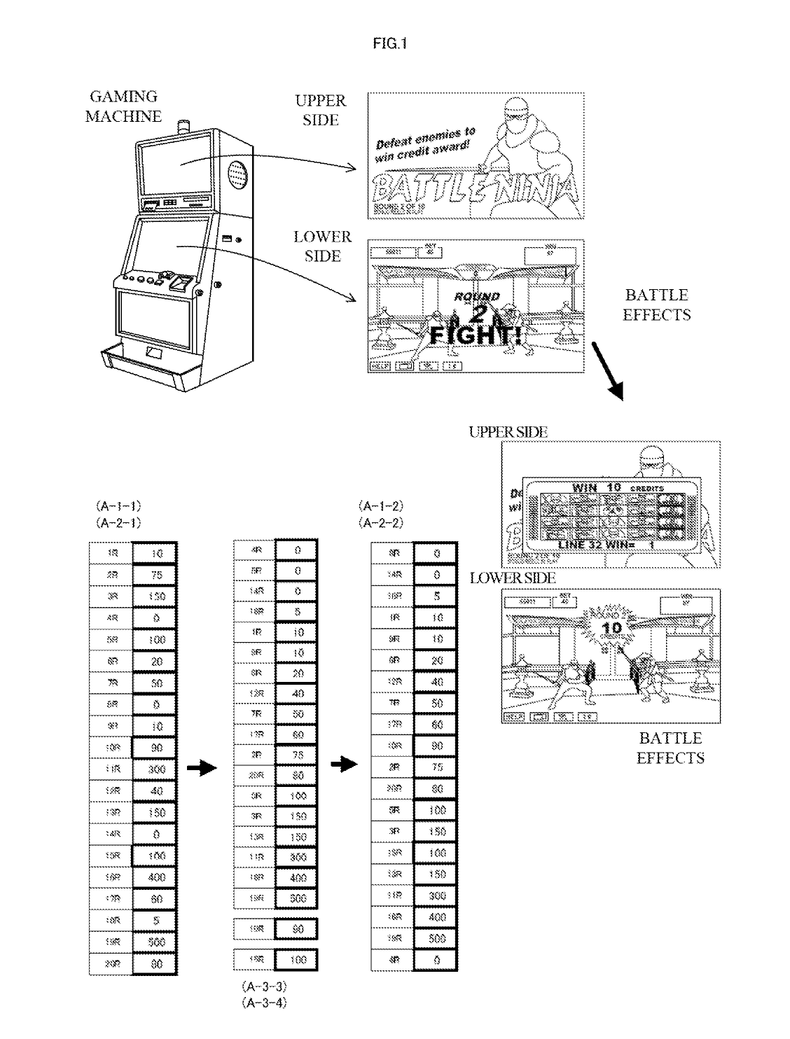

FIG. 1 is a diagram illustrating an outline of a gaming machine according to the present embodiment.

The gaming machine according to the present embodiment includes:

a display for displaying a game in a base game mode and for displaying a unit game in a feature game mode being different from the base game mode; and

a controller for determining a payout in the unit game in the feature game mode, and the controller is programmed to execute processes described below:

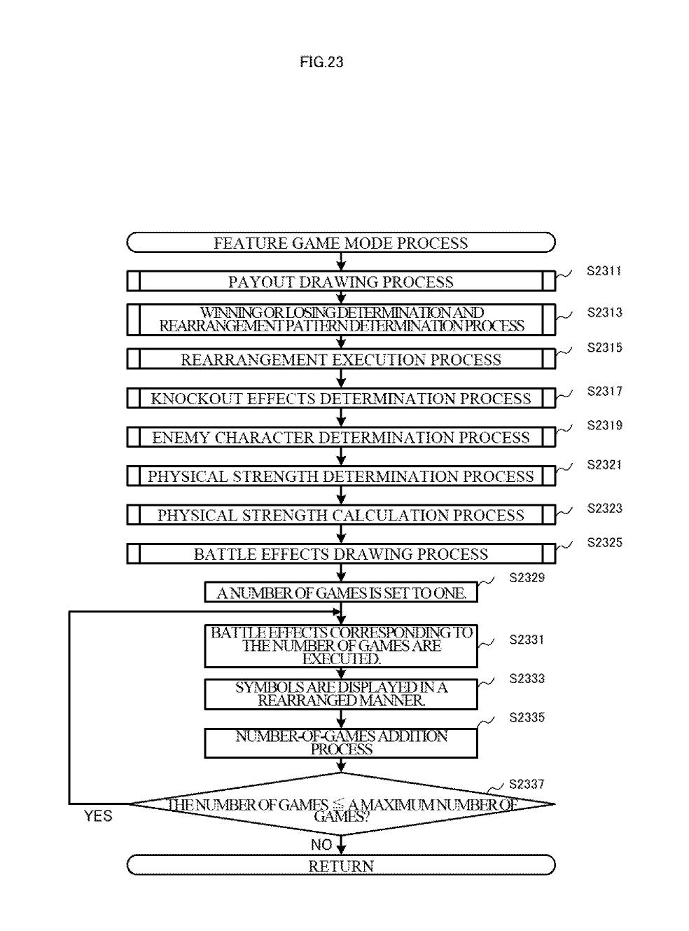

a process (A-1-1) in which displaying order in which a plurality of unit games in the feature game mode are displayed is determined (for example, the later-described step S2311 in FIG. 23 or the like); and

a process (A-1-2) in which the displaying order is rearranged (for example, the later-described step S2315 in FIG. 23 or the like).

In the feature game mode, the plurality of unit games are executed. The order in which all of the unit games in the feature game mode are displayed can be determined upon initiating the feature game mode. The displaying order which has been once determined is changed through the rearrangement.

Since the display order is previously changed, the whole development of the unit games in the feature game mode is previously determined, thereby allowing a feeling of expectation to be enhanced and enabling a player to be attracted to the feature game mode.

The process (A-1-1) may be a process (A-1-1′) in which the order in which the plurality of unit games in the feature game mode are executed is determined (for example, the later-described step S2311 in FIG. 23 or the like); and

the process (A-1-2) may be a process (A-1-2′) in which the executing order is rearranged (for example, the later-described step S2315 in FIG. 23 or the like).

Since the order is not the displaying order, but the executing order, it is only required for the unit games to be internally executed and it is not required for the unit games to be displayed. For example, even if the manners in which the unit games are displayed are the same as each other, the order is internally rearranged, whereby the process (A-1-1) and the process (A-1-2) correspond to the processes (A-1-1′) and (A-1-2′), respectively.

Further, in the gaming machine according to the present embodiment,

the (A-1-1) includes:

a process (A-2-1) in which a payout of each of the plurality of unit games is determined (for example, the later-described step S2311 in FIG. 23 or the like); and

a process (A-2-2) in which winning or losing in each of the plurality of unit games is determined based on the payout (for example, the later-described step S2313 in FIG. 23 or the like);

the (A-1-2) includes

a process (A-2-3) in which based on the winning or losing, a pattern in which the displaying order is rearranged is determined by a drawing process (for example, the later-described step S2315 in FIG. 23 or the like).

Since the displaying order is rearranged based on the payout, the order of the plurality of unit games can be determined so as to gradually enhance a feeling of expectation, thereby allowing monotony of the feature game mode to be avoided. It is only required for the winning or losing to be determined based on the payout, and effect images for the winning or losing can be conducted so as to be different from those in each of the unit games.

Further, in the gaming machine according to the present embodiment,

the feature game mode is a game mode in which by rearranging a plurality of symbols arranged in a group of reel strips, an outcome of each of the unit games is displayed on the display, and

the process (A-2-1) includes:

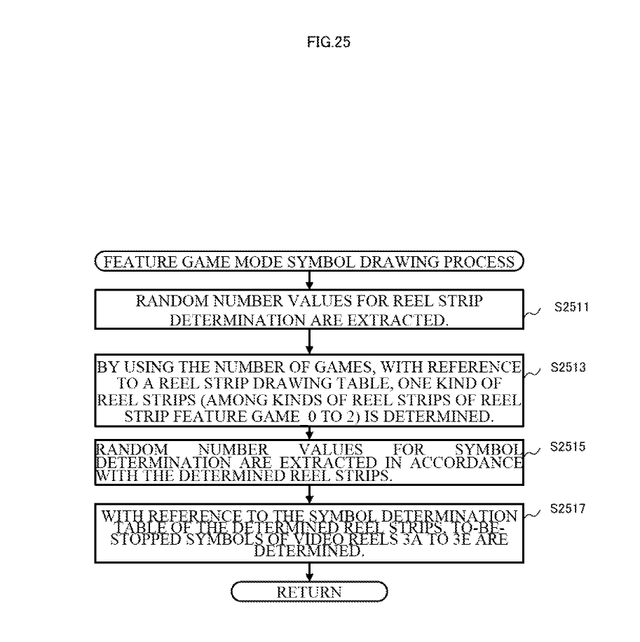

a process (A-3-1) in which one kind of a group of reel strips is determined from a plurality of kinds of groups of reel strips for each of the unit games by a drawing process (for example, the later-described step S2511 and step S2513 in FIG. 25 or the like);

a process (A-3-2) in which by rearranging a plurality of symbols arranged in the one kind of the group of reel strips determined by the process (A-3-1), a payout of each of the unit games is determined (for example, the later-described step S2515 in FIG. 25 or the like); and

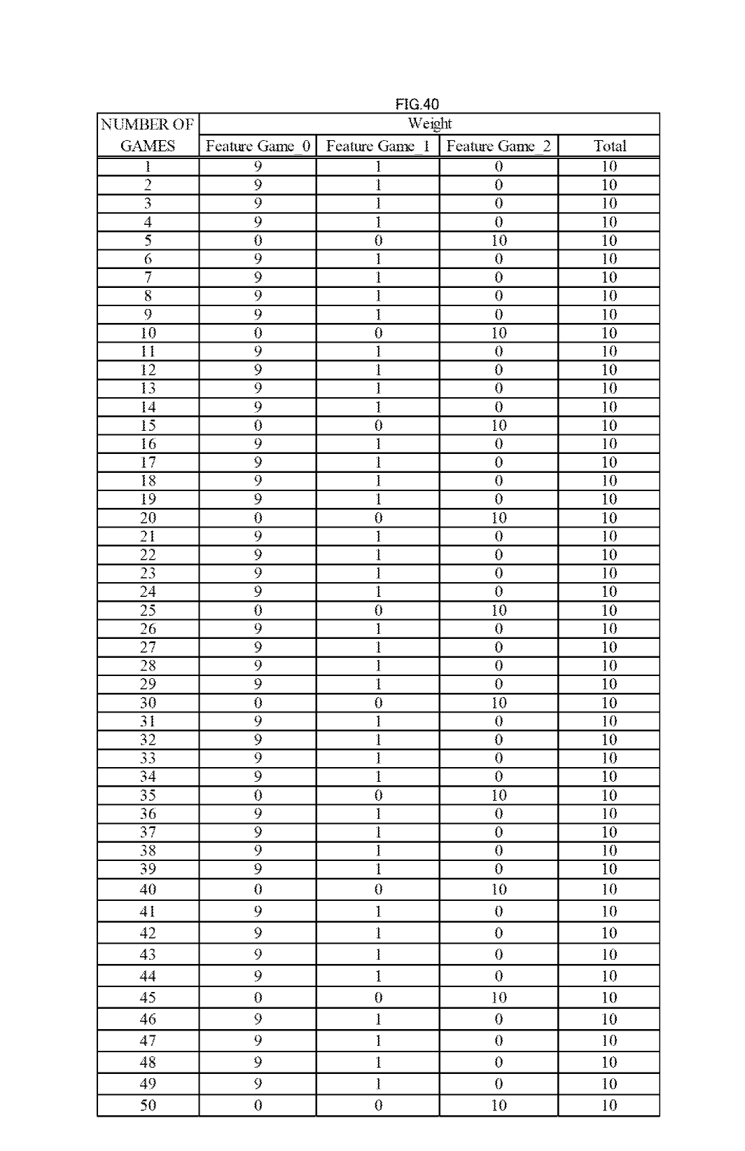

a process (A-3-3) in which in the predetermined number-th unit game among the plurality of unit games, a predetermined group of reel strips is selected from the plurality of kinds of groups of reel strips, and the process (A-3-1) is executed (for example, the later-described FIG. 40 or the like), and

the process (A-1-2) includes

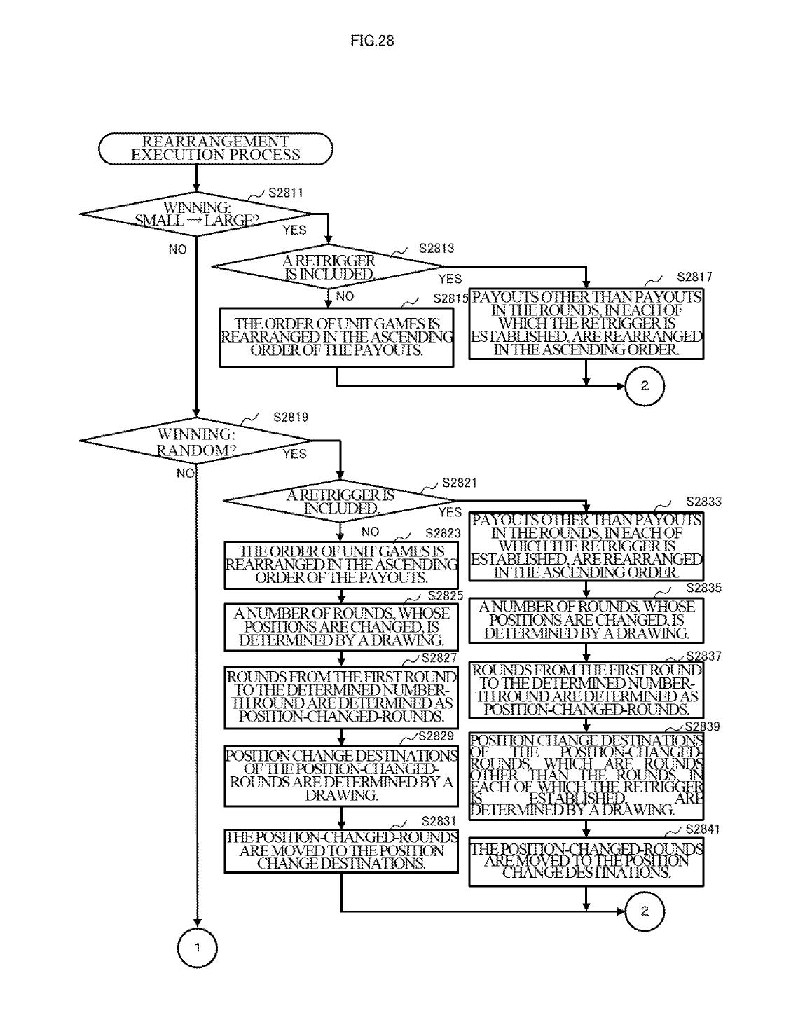

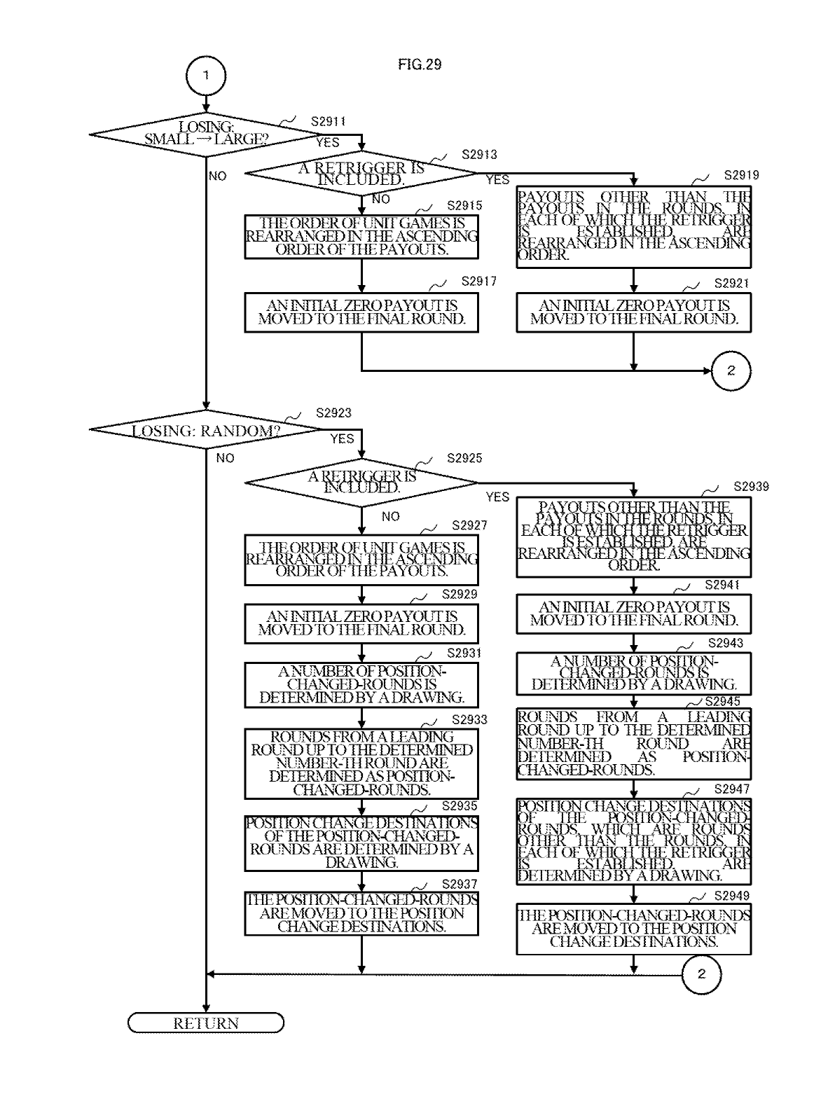

a process (A-3-4) in which the displaying order is rearranged such that displaying order in which the predetermined number-th unit game is displayed is the same before and after the process (A-1-2) is executed (for example, the later-described step S2833 in FIG. 28, step S2939 in FIG. 29, or the like).

In the predetermined number-th unit game, the predetermined group of reel strips is selected and the payout is determined, thereby allowing the payout in the predetermined number-th unit game to be adjusted. Since in the feature game mode, the predetermined number-th unit game is fixed, the development of the unit games in the feature game mode can be adjusted.

In addition, the gaming machine according to the present embodiment includes:

a display for displaying a game in a base game mode and for displaying a unit game in a feature game mode being different from the base game mode (for example, a lower display device 141 or the like); and

a controller for determining payouts of a plurality of unit games in the feature game mode, and the controller is programmed to execute processes described below:

a process (B-1-1) in which a payout of each of the plurality of unit games is determined (for example, the later-described step S2311 in FIG. 23 or the like);

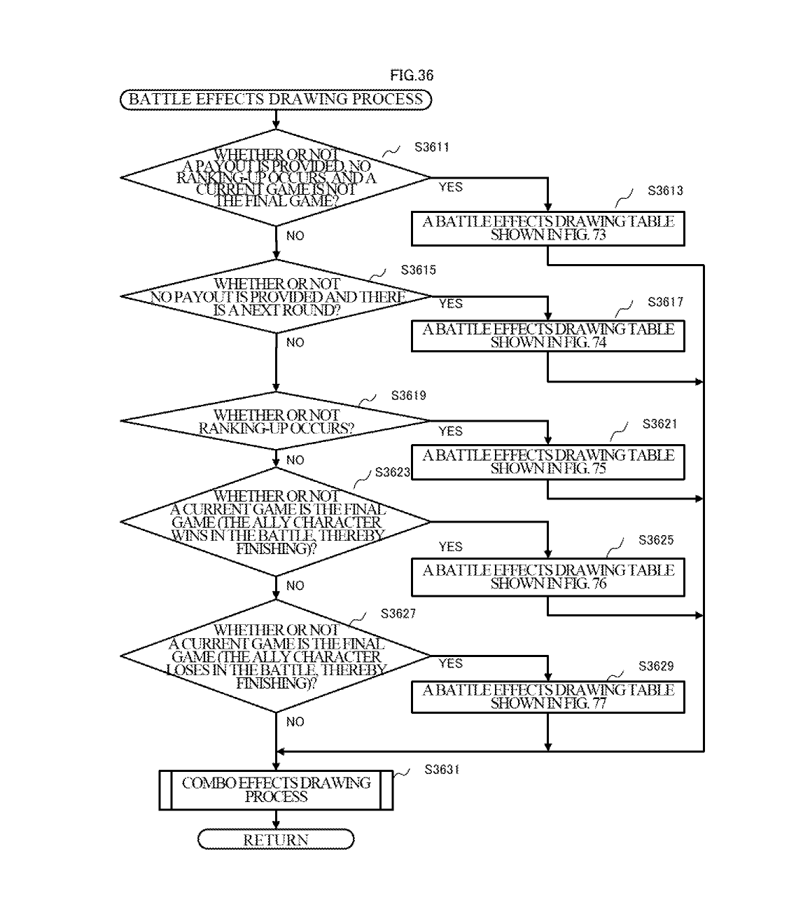

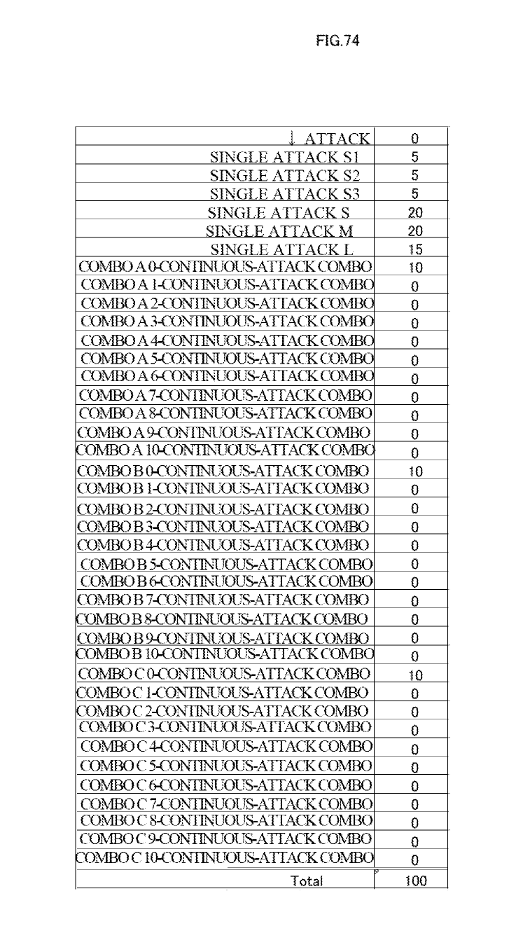

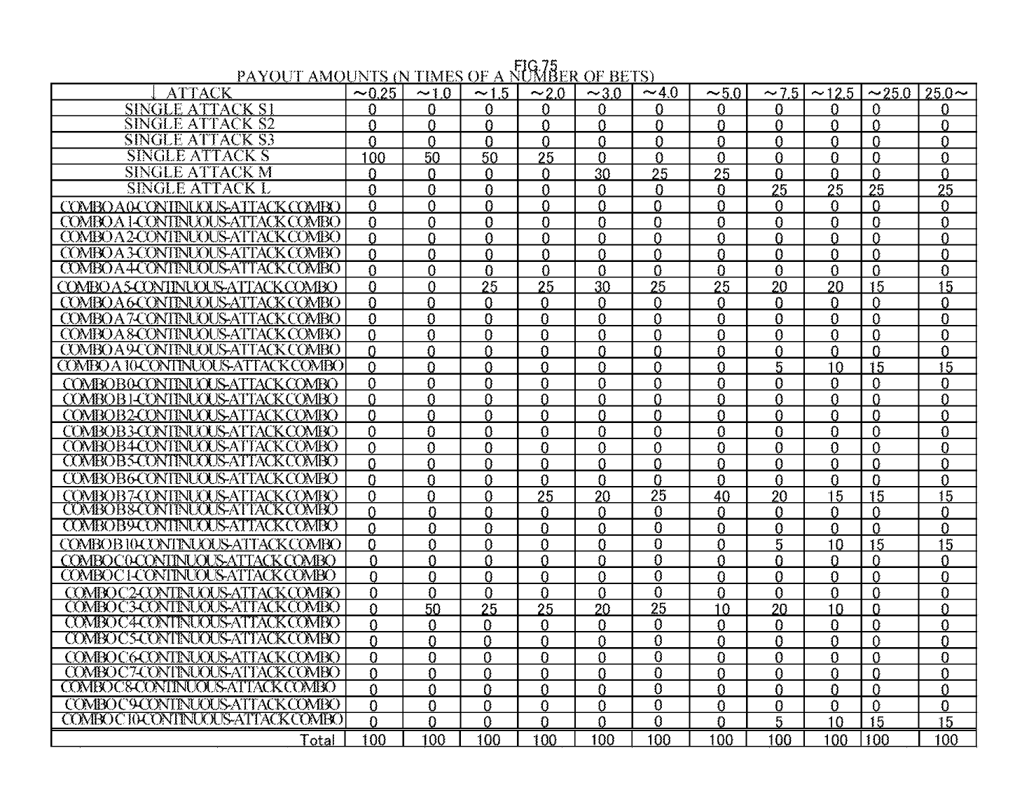

a process (B-1-2) in which a class of the payout of each of the plurality of unit games is determined (for example, the later-described step S3611 in FIG. 36, FIG. 73, step S3615 in FIG. 36, and FIG. 74, or the like); and

a process (B-1-3) in which as an outcome of the unit game, an image in accordance with the class of the payout is displayed on the display (for example, the later-described step S2331 in FIG. 23 or the like).

Since the payouts of the plurality of unit games are classified and the image in accordance with the class of the payout is displayed, the displayed image allows a player to imagine the payout of the unit game played at that time, thereby allowing a feeling of expectation regarding the development of the feature game mode to be enhanced.

Further, in the gaming machine according to the present embodiment,

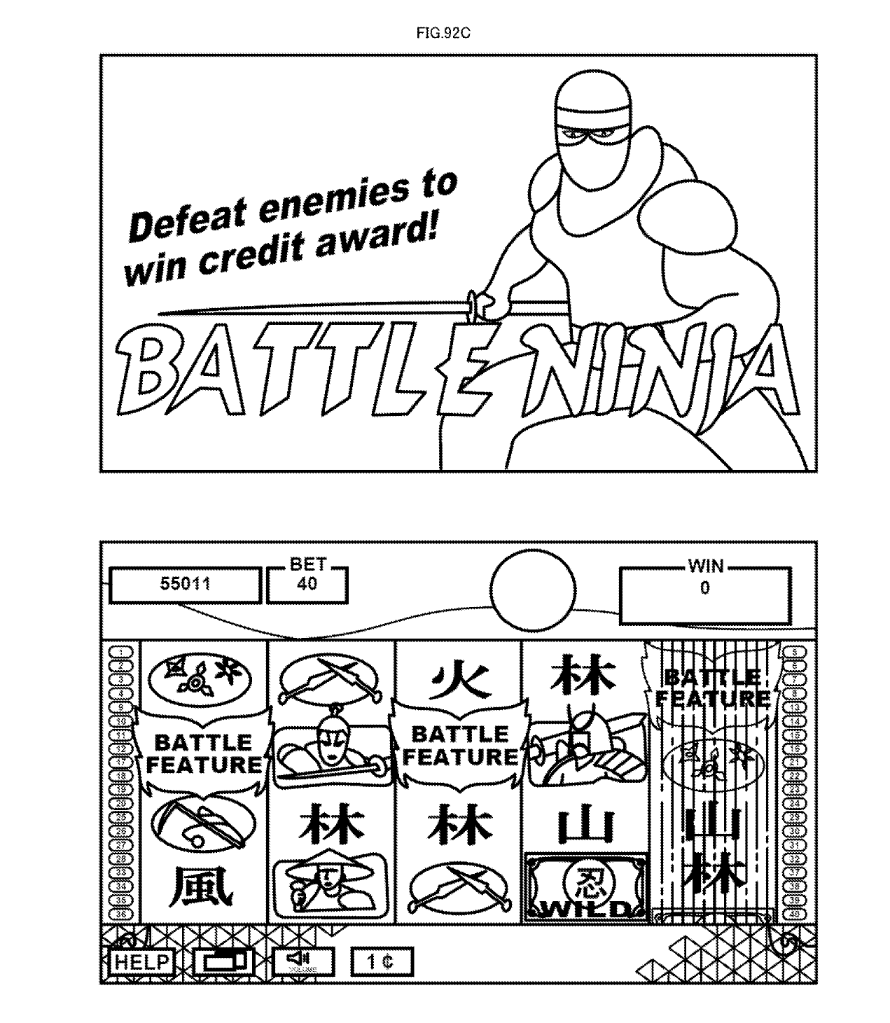

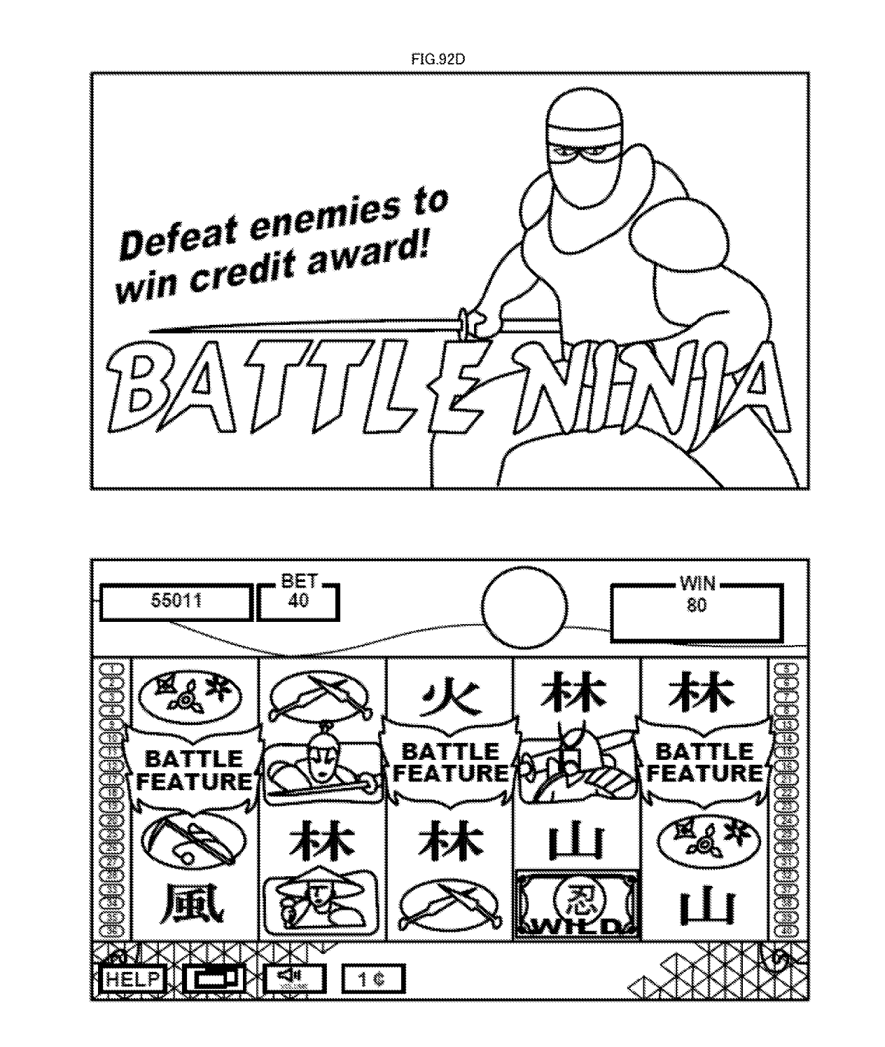

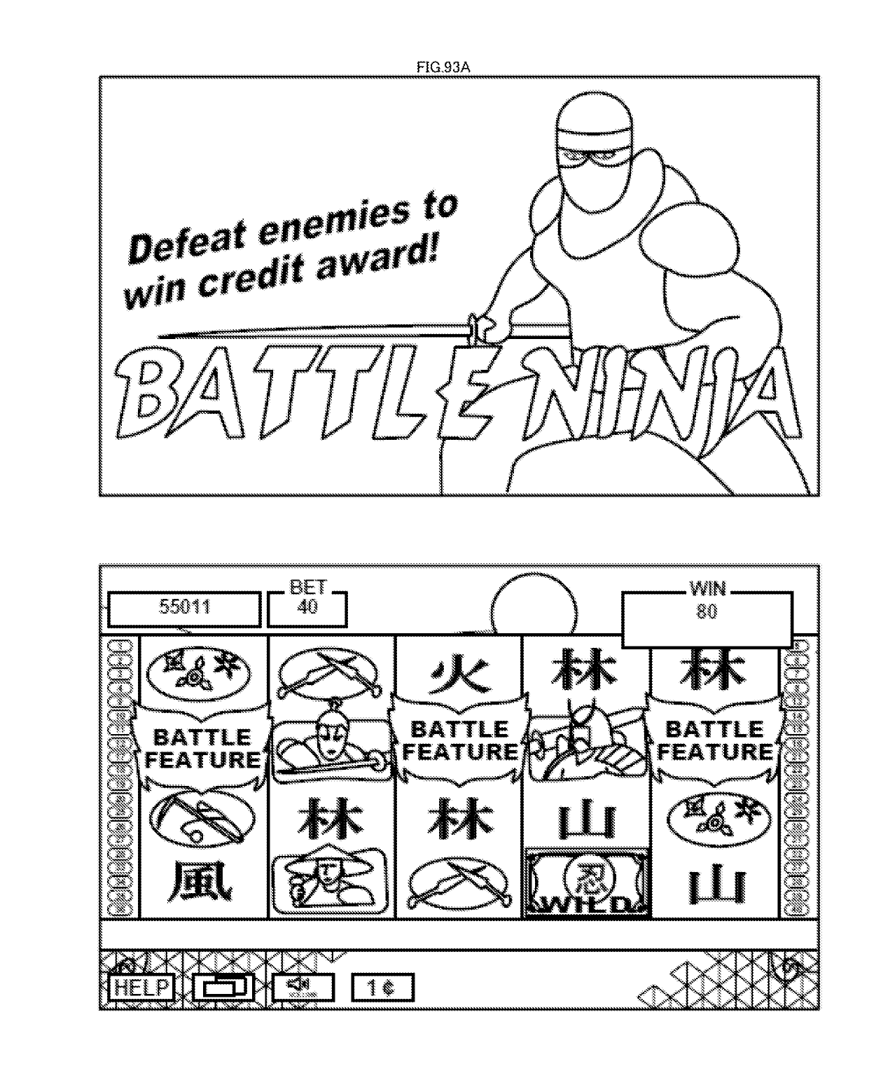

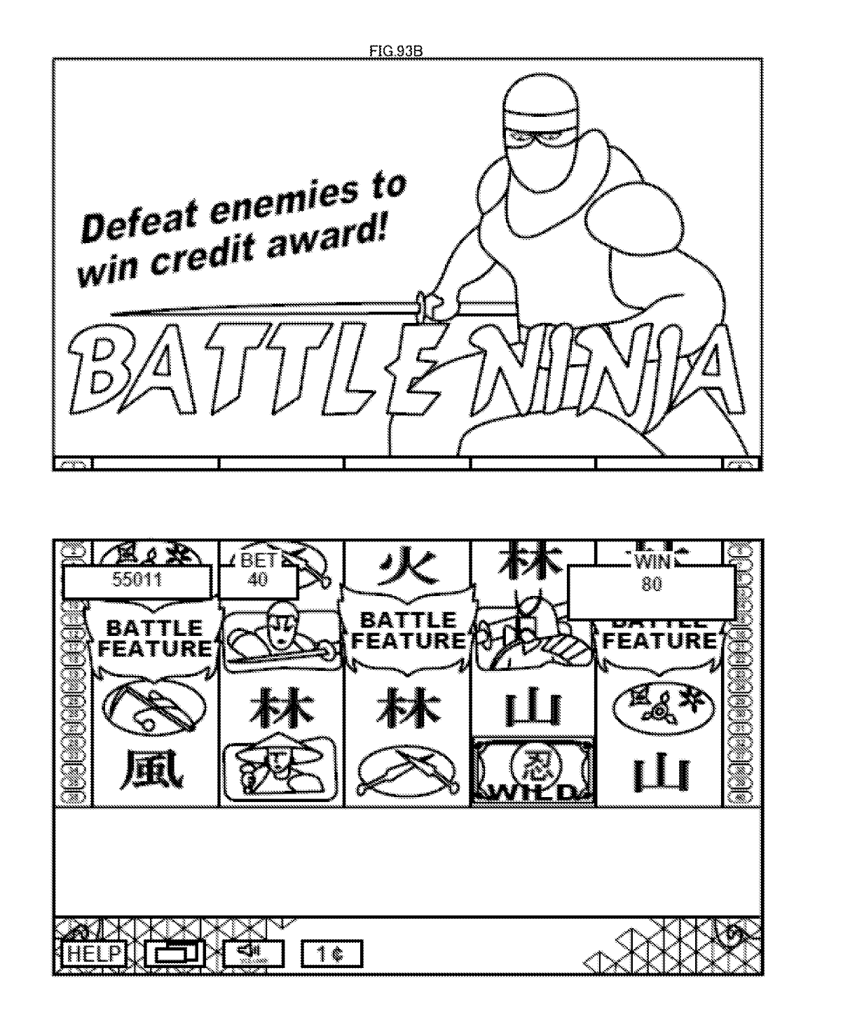

the base game mode is a game mode in which by rearranging the plurality of symbols, an outcome of the unit game is displayed on the display (for example, FIGS. 92A to 92D or the like), and

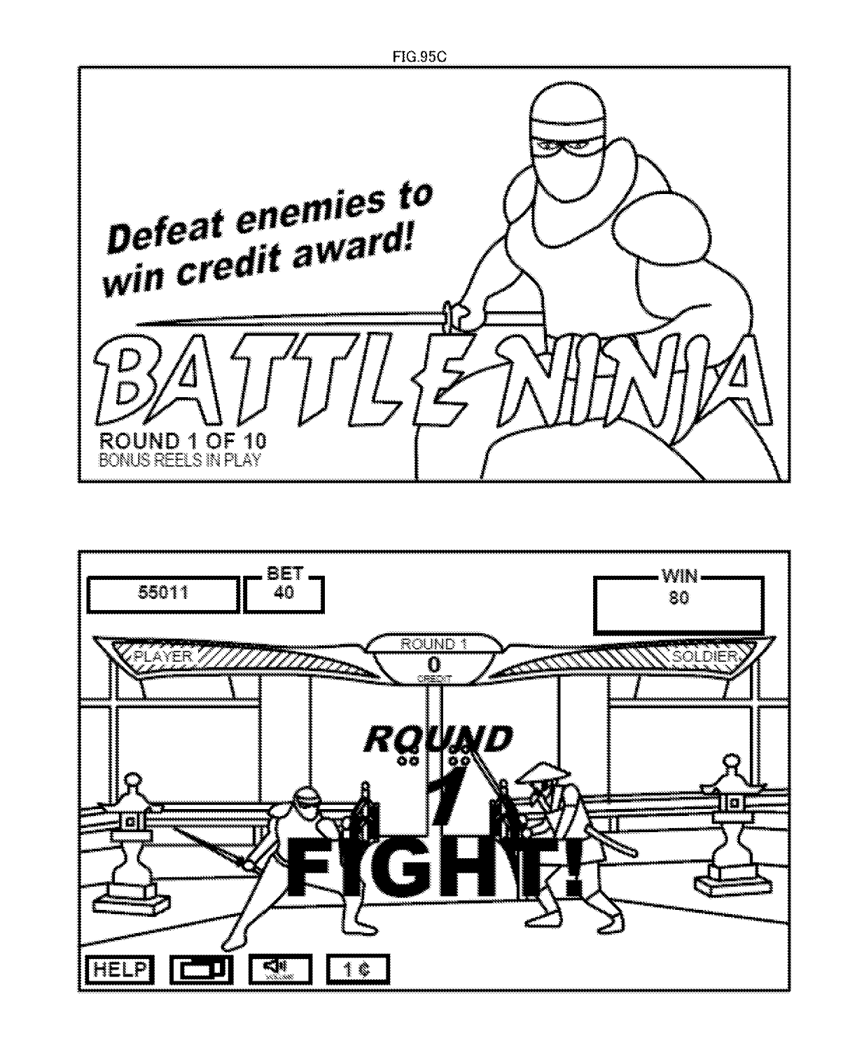

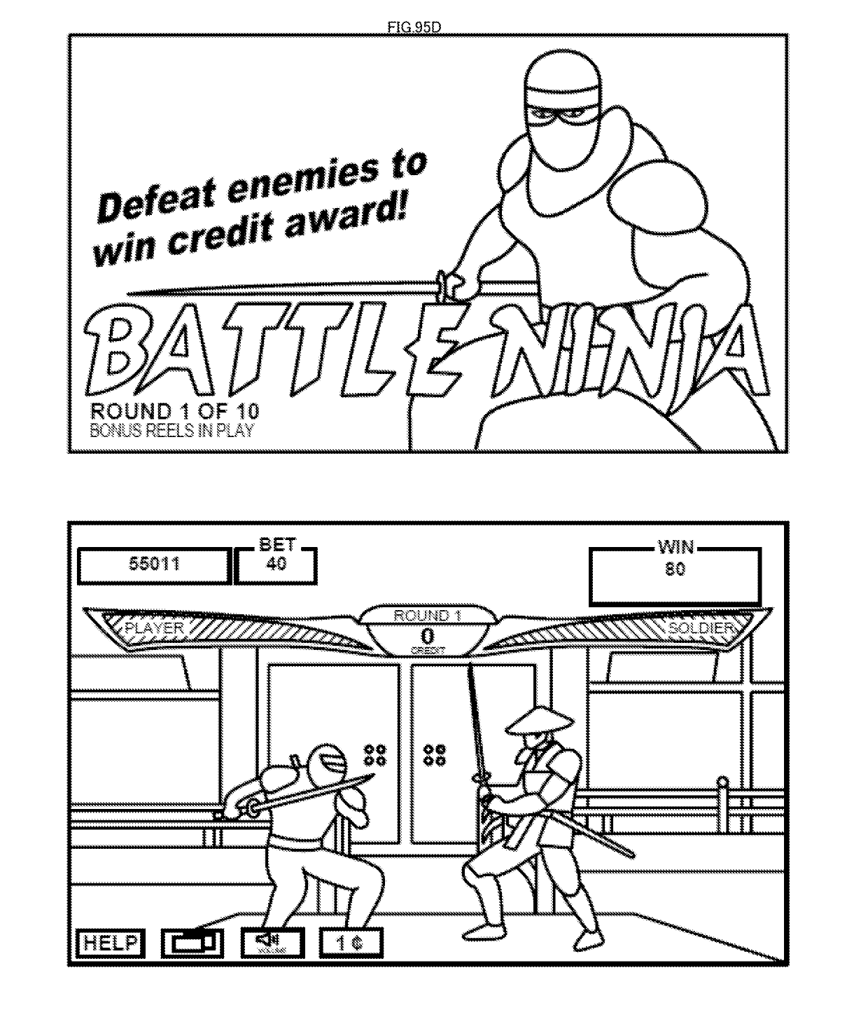

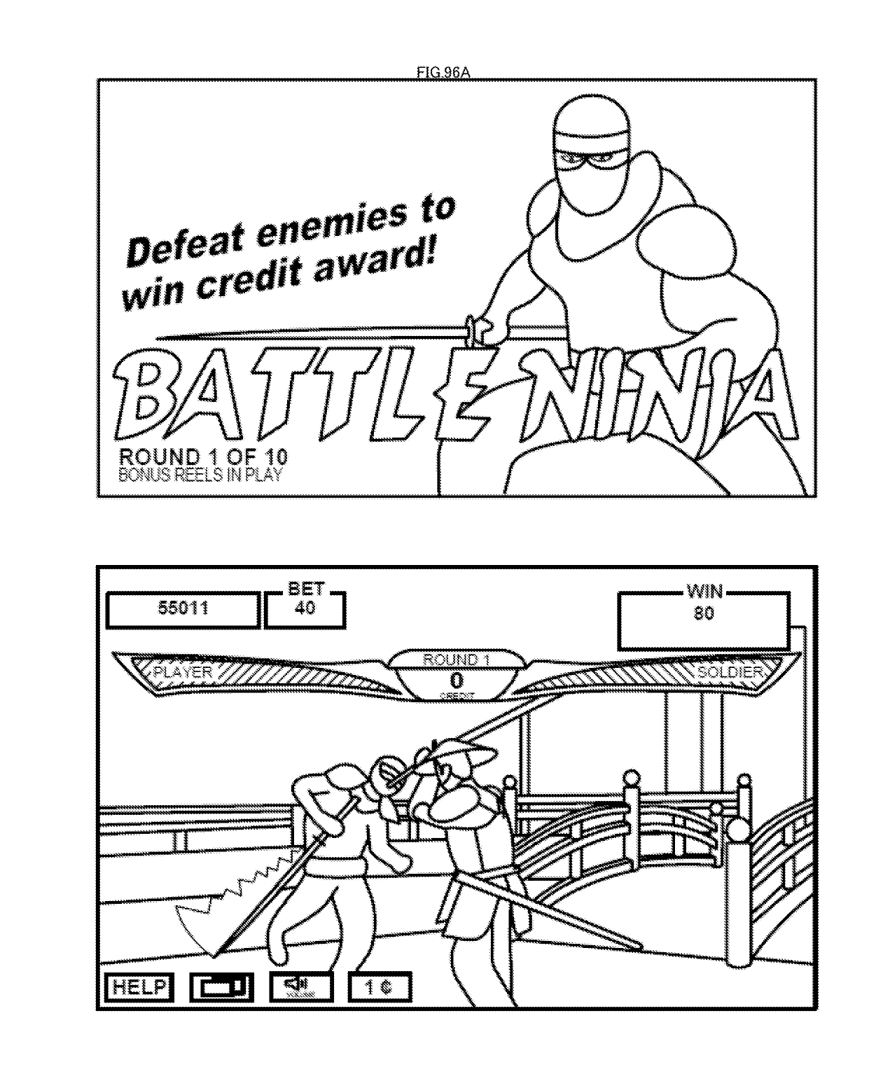

the feature game mode is a game mode in which an image being different from an image in which the plurality of symbols are rearranged is displayed on the display as the image in accordance with the class of the payout (for example, FIG. 95C to FIG. 111D or the like).

The game in the base game mode is the game in which by rearranging the plurality of symbols, the outcome of the unit game is displayed on the display. On the other hand, in the game in the feature game mode, the image in which the plurality of symbols are rearranged is not displayed, and the image in accordance with the class of the payout is displayed. In the feature game mode, the game which is clearly different from the game in the base game mode is executed, thereby allowing an interest of a player to be attracted and enabling a feeling of expectation to be enhanced. In addition, since the image in accordance with the class of the payout is displayed, a player predicts or expect a payout, thereby allowing a player to be attracted to the feature game mode.

The gaming machine according to the present embodiment further includes

a memory for storing a class correspondence table which defines relationship between the classes of the payouts and images in accordance with the classes of the payouts, and

the process (B-1-3) includes

a process (B-3-1) in which after executing the process (B-1-2), the class correspondence table is referenced based on the class of the payout, the image in accordance with the class of the payout is determined (step S3613 or S3617 in FIG. 36).

Since the gaming machine has the class correspondence table which defines the relationship between the classes of the payouts and the images in accordance with the classes of the payouts, by referencing the class correspondence table, the image in accordance with the class of the payout can be immediately determined from the classes of the payouts, thereby allowing effects to be smoothly determined. In particular, even in a case when a configuration in which a plurality of images in accordance with the classes of the payouts are to be displayed is employed, the plurality of images can be quickly determined and executed.

Further, in the gaming machine according to the present embodiment,

the display has a first display part (lower display device 141) and a second display part (upper display device 131),

in the base game mode, the plurality of symbols are rearrange on the first display part (for example, FIG. 92A to FIG. 92D or the like), and

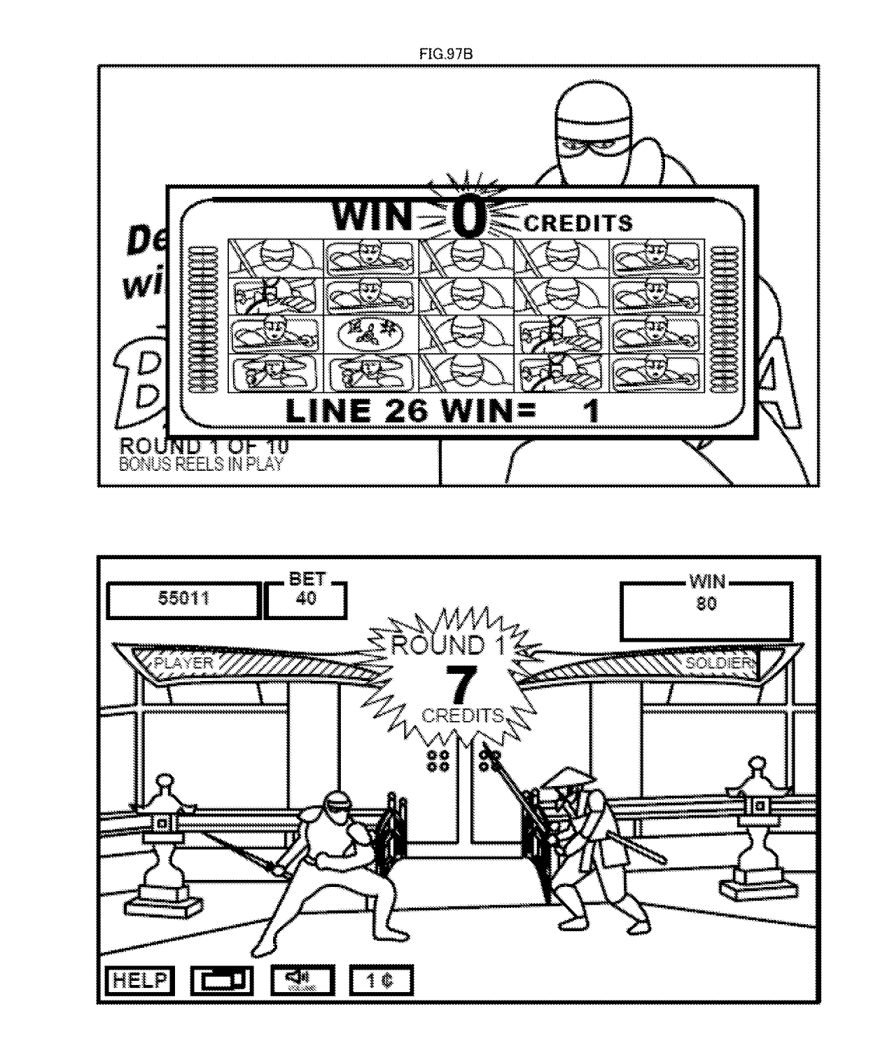

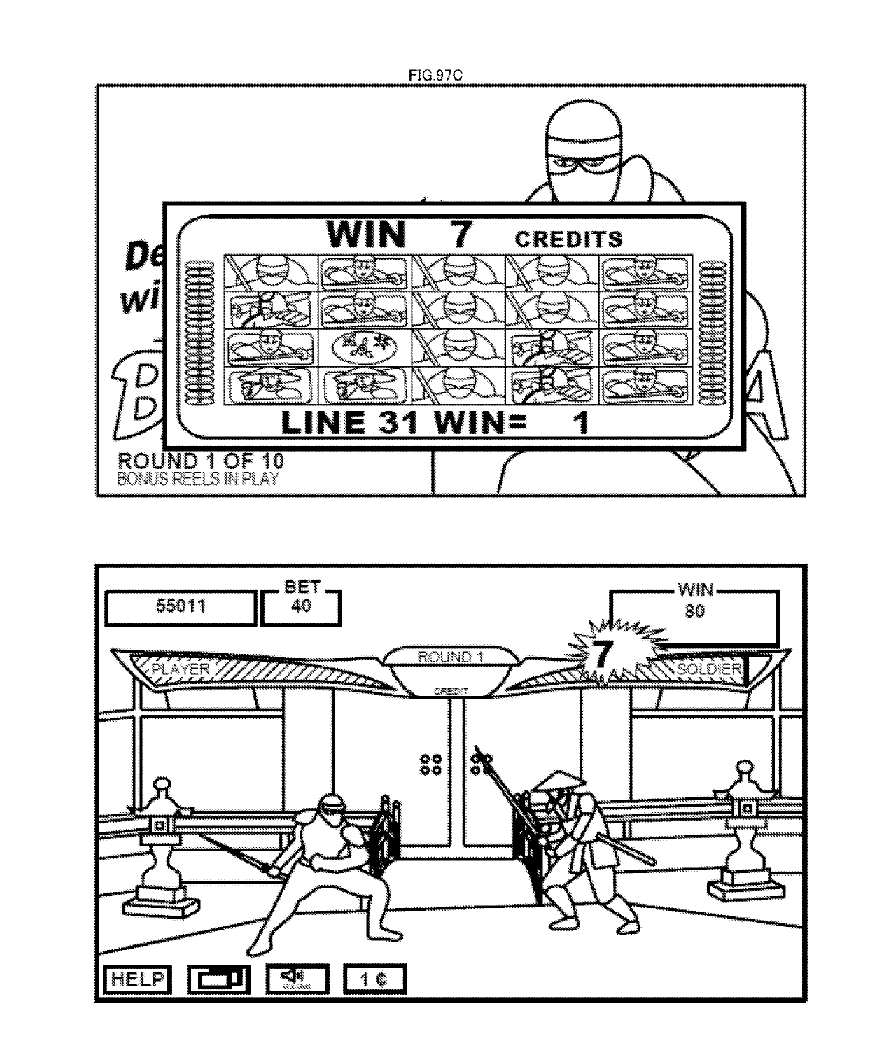

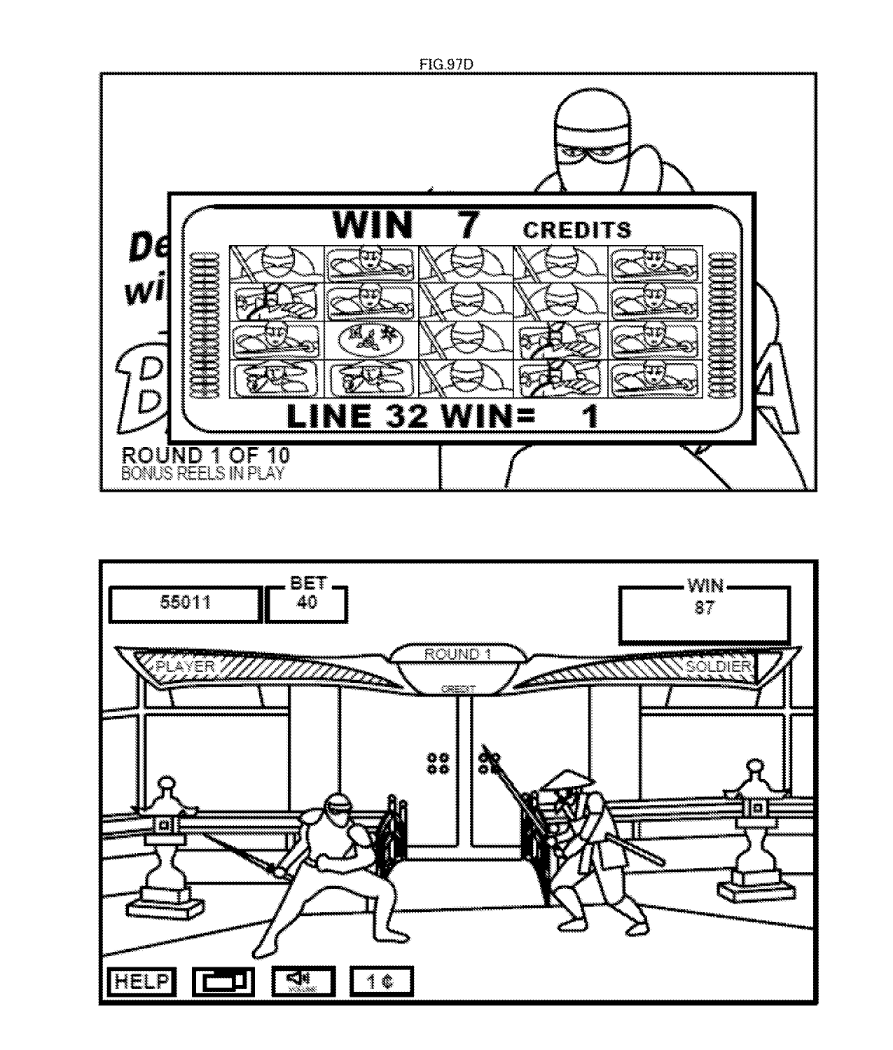

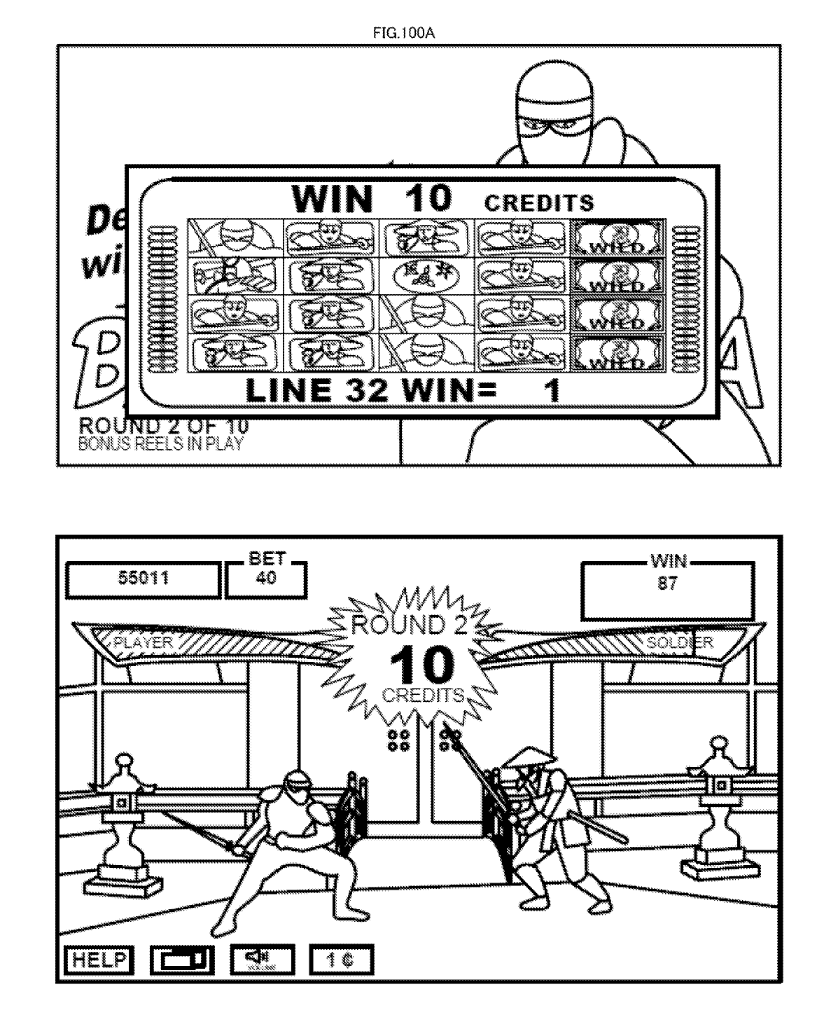

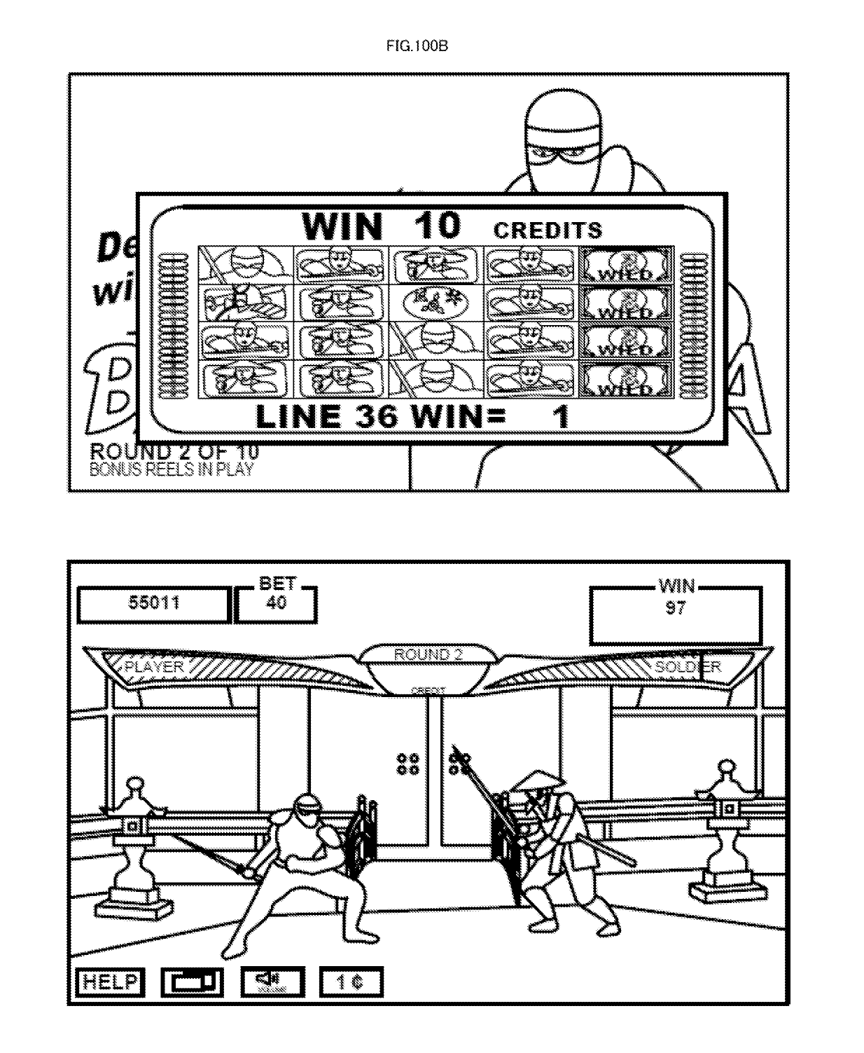

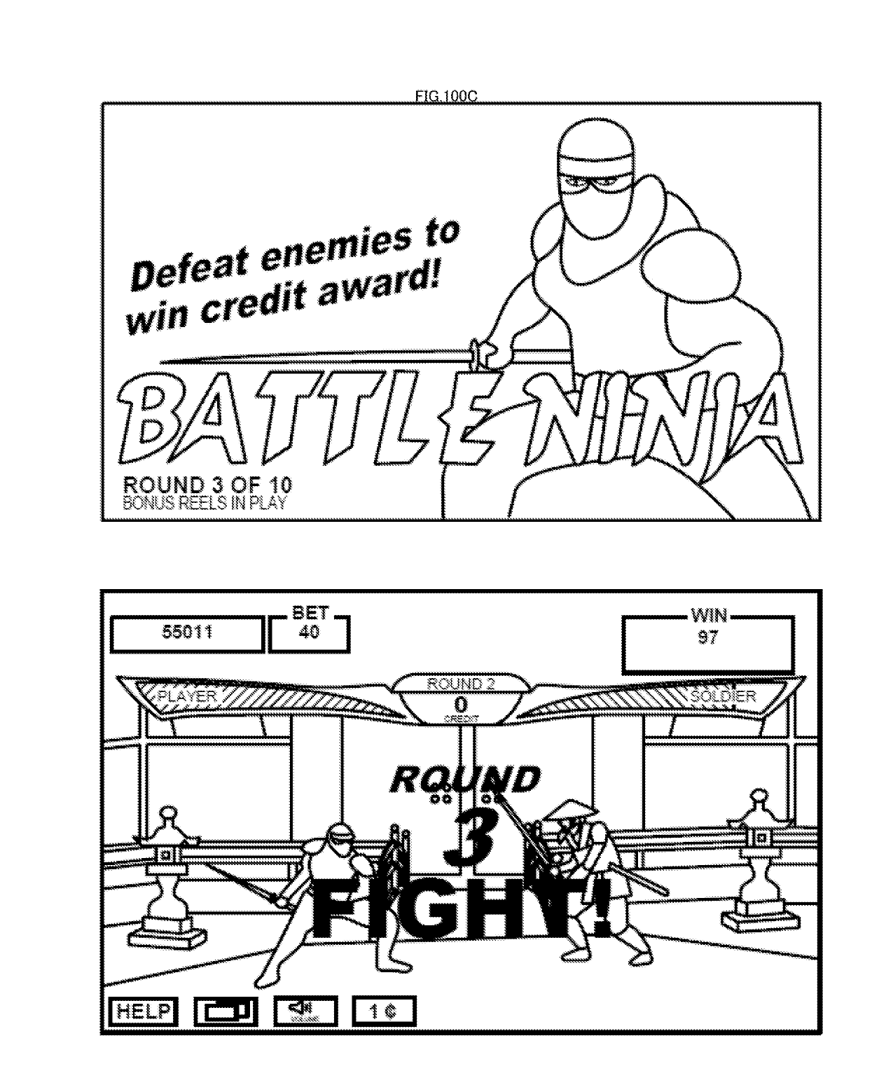

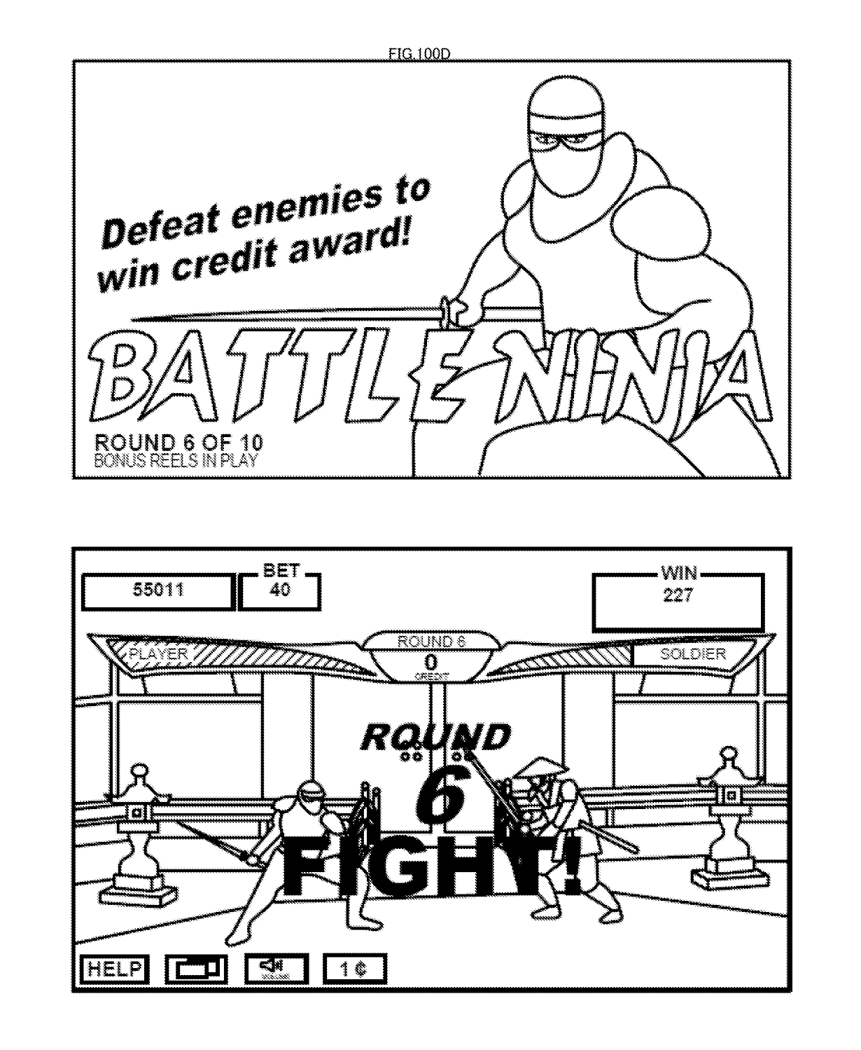

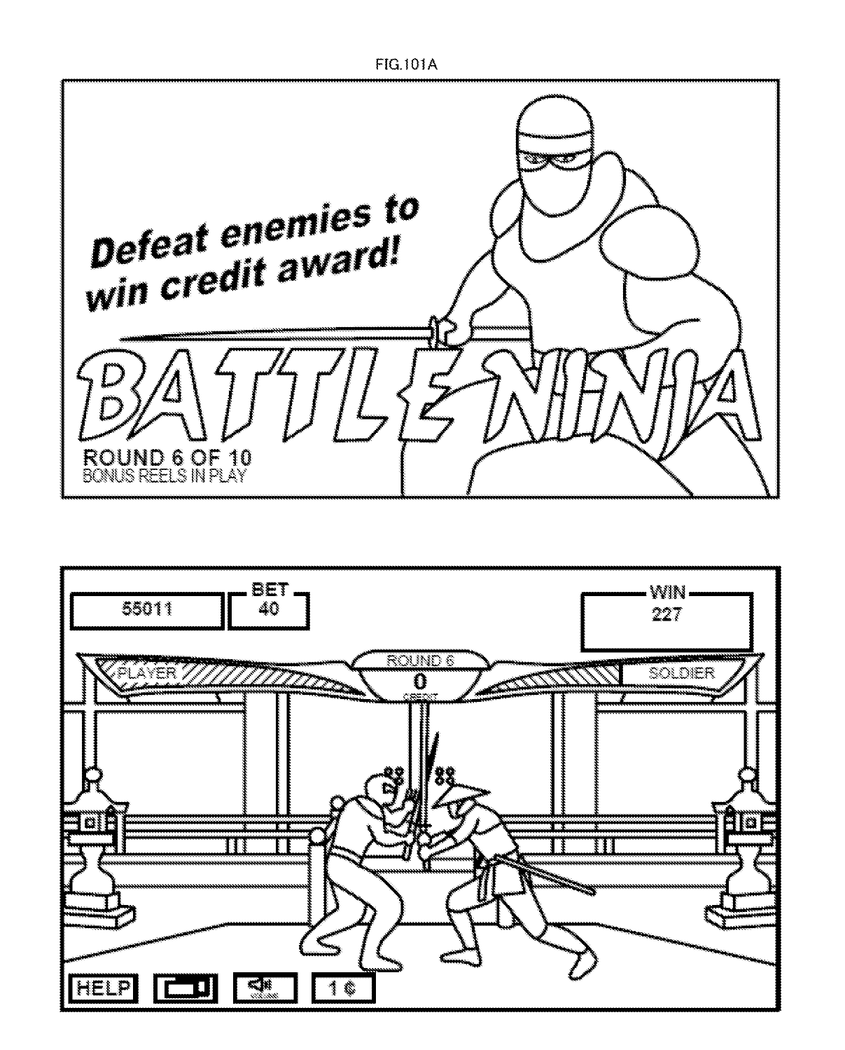

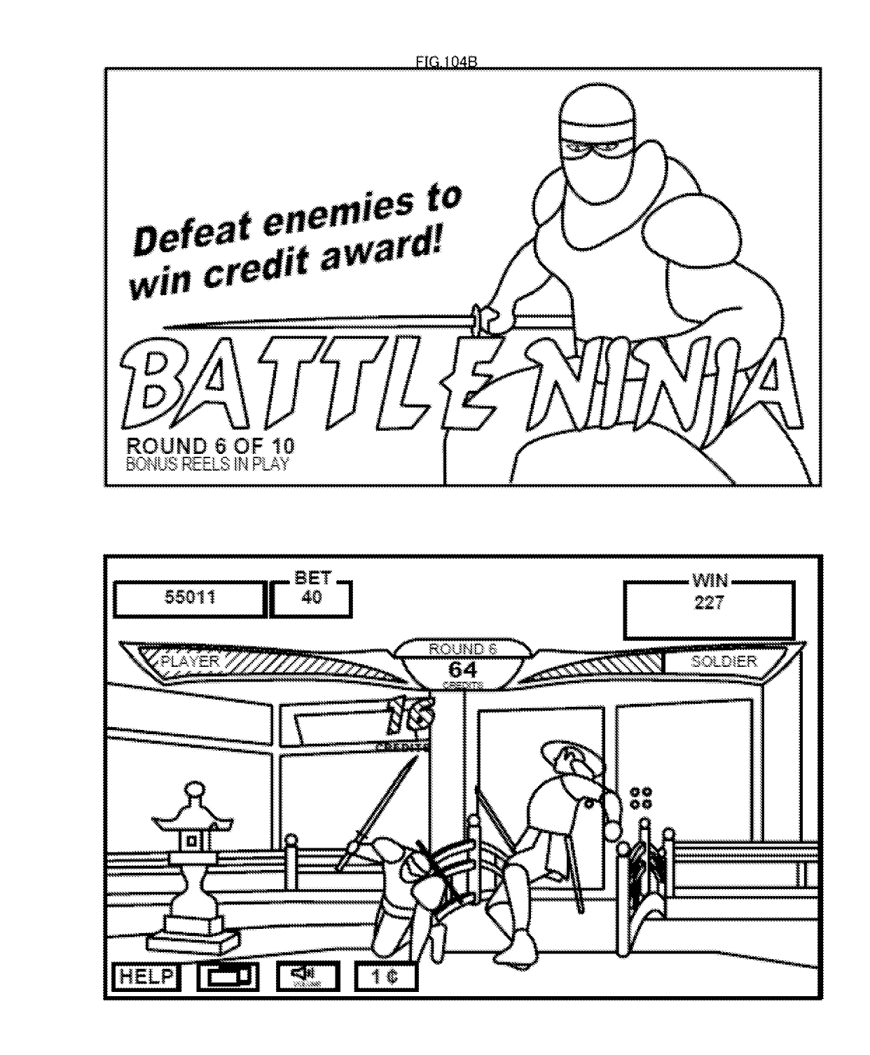

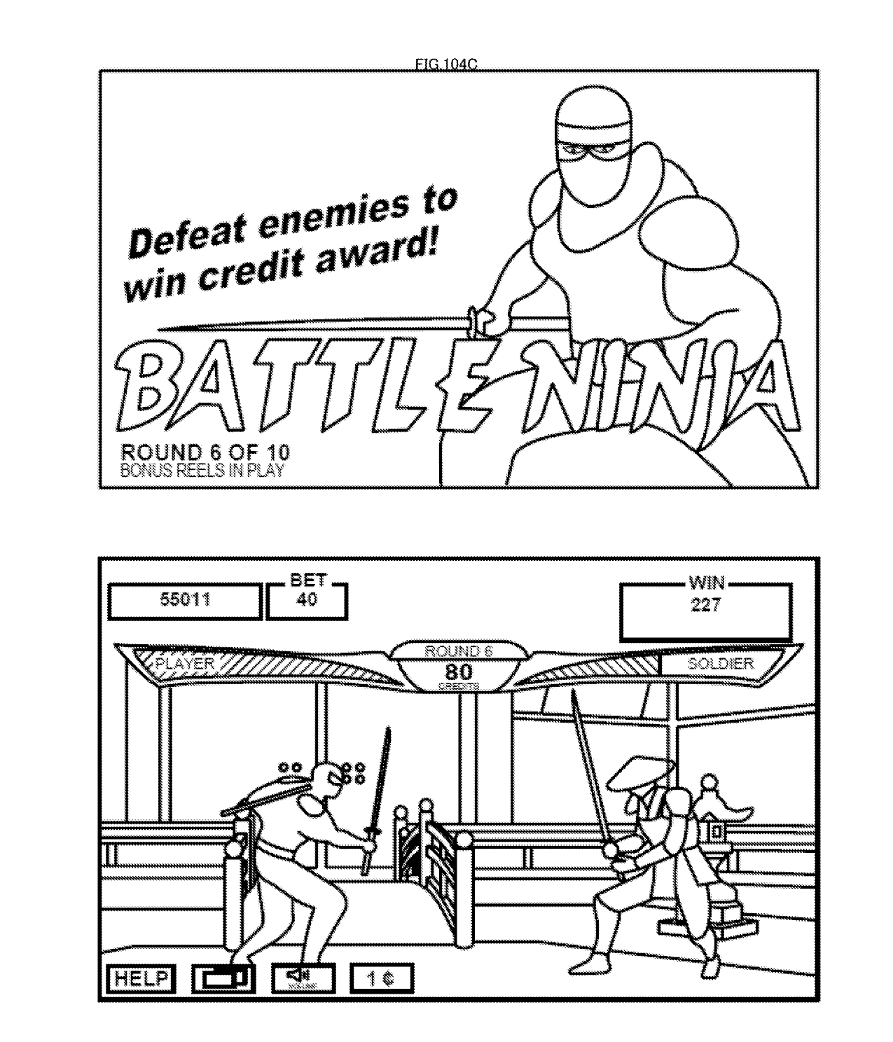

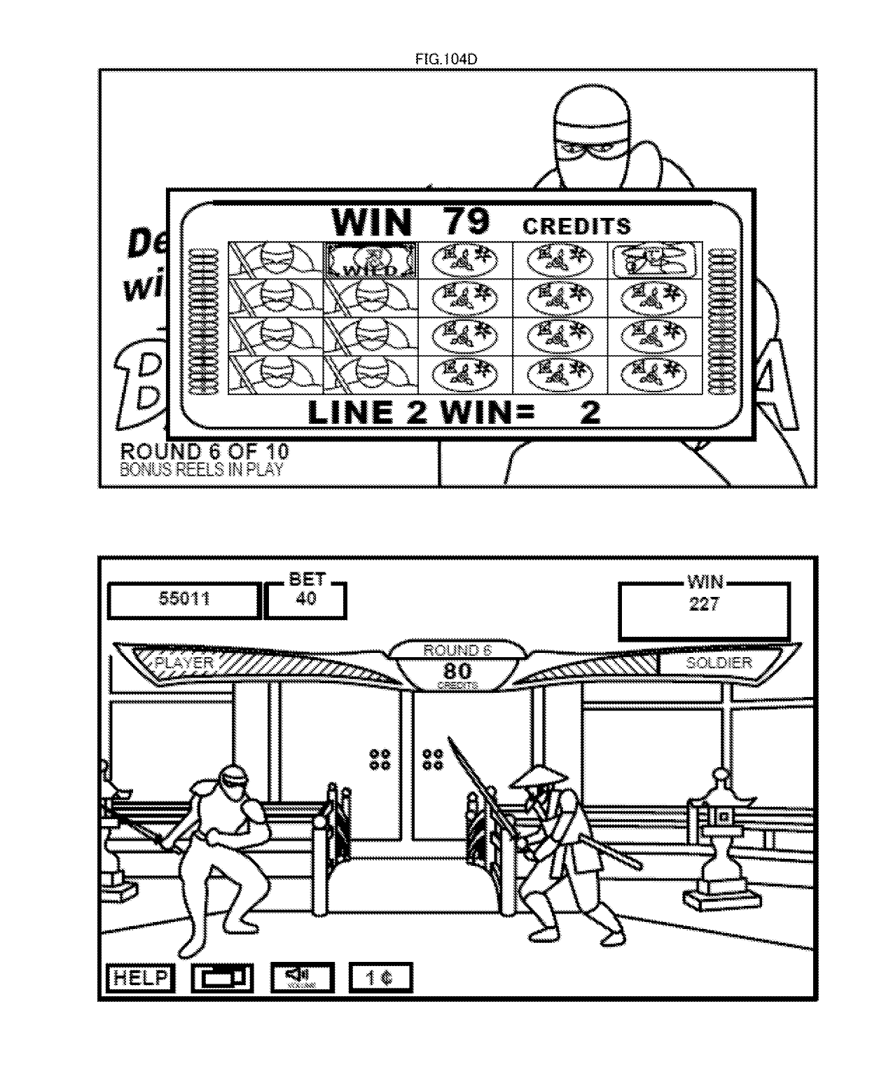

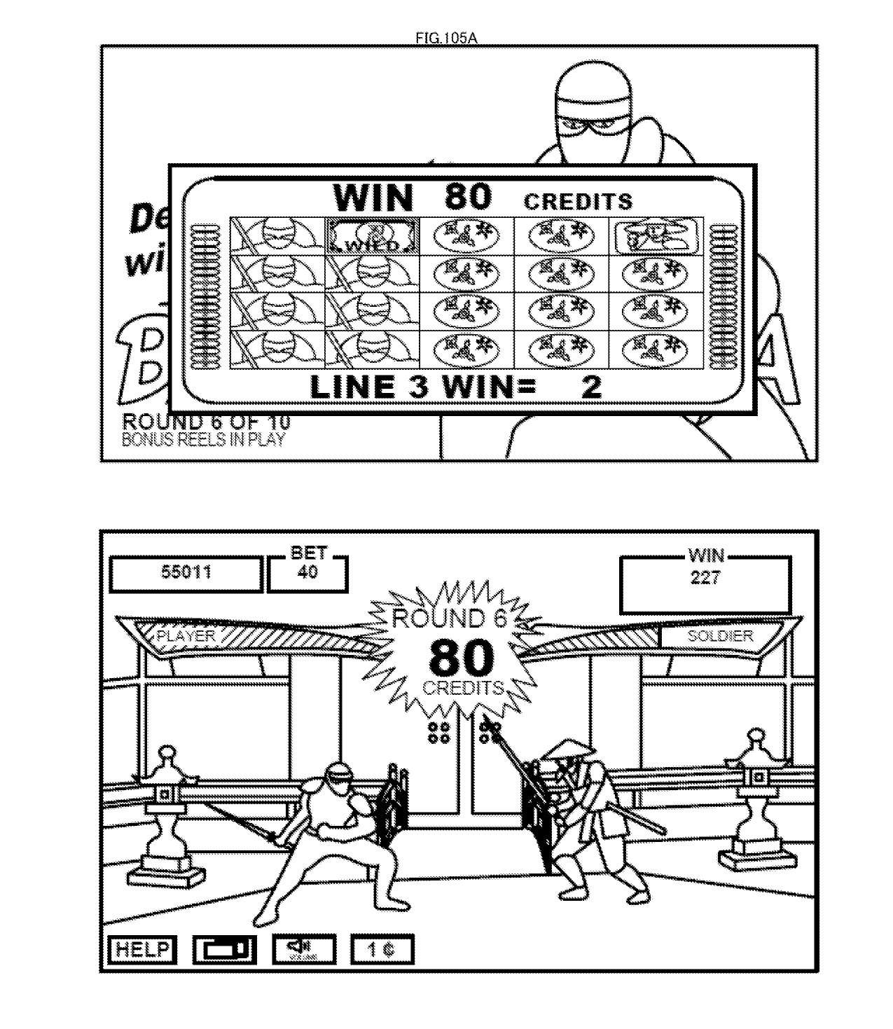

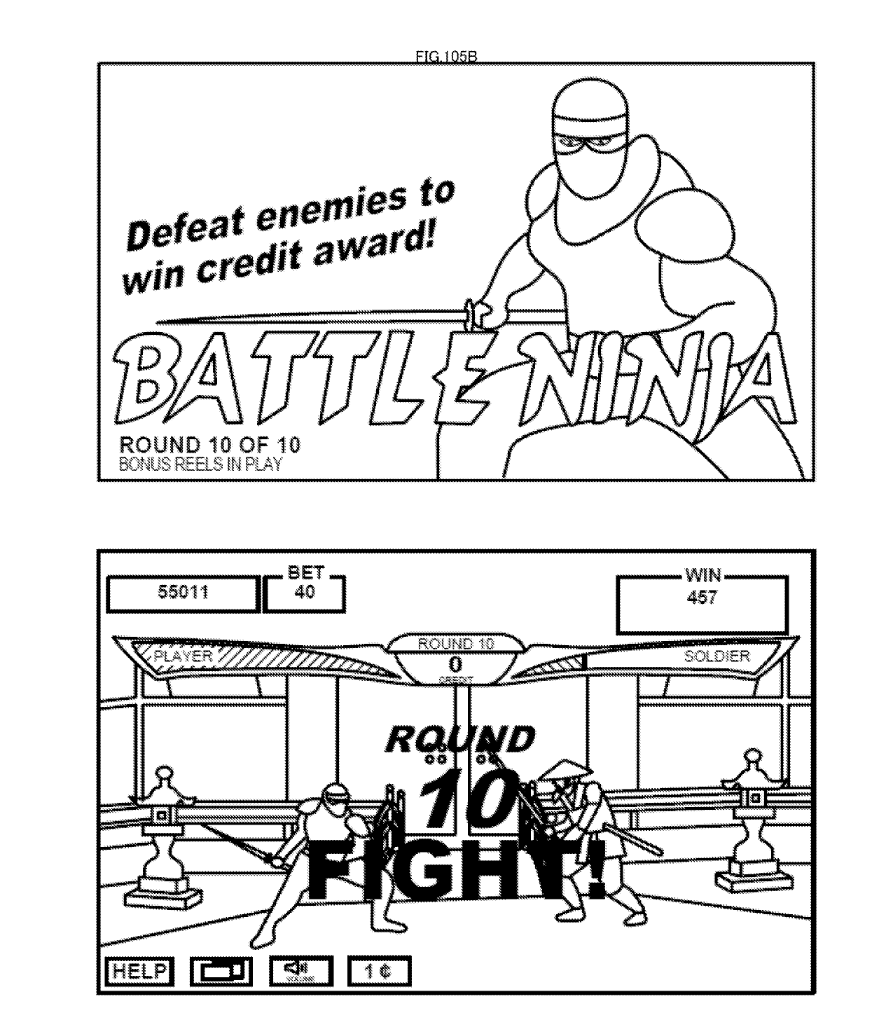

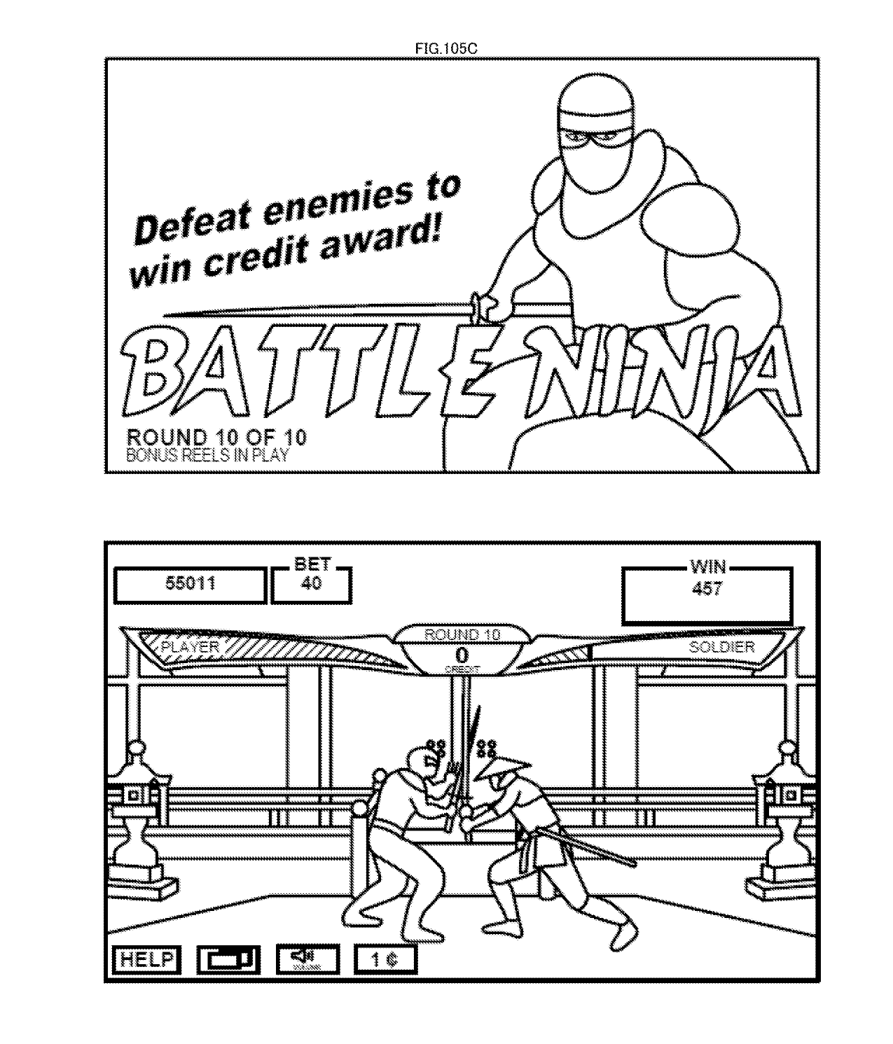

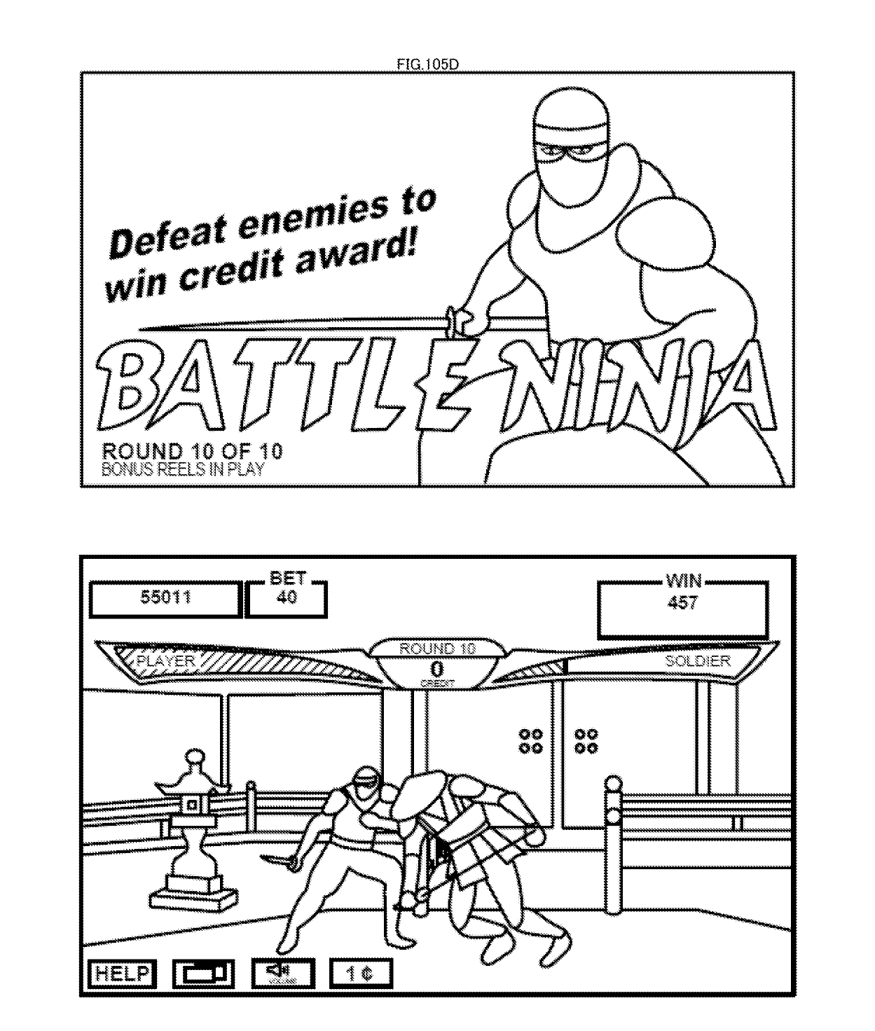

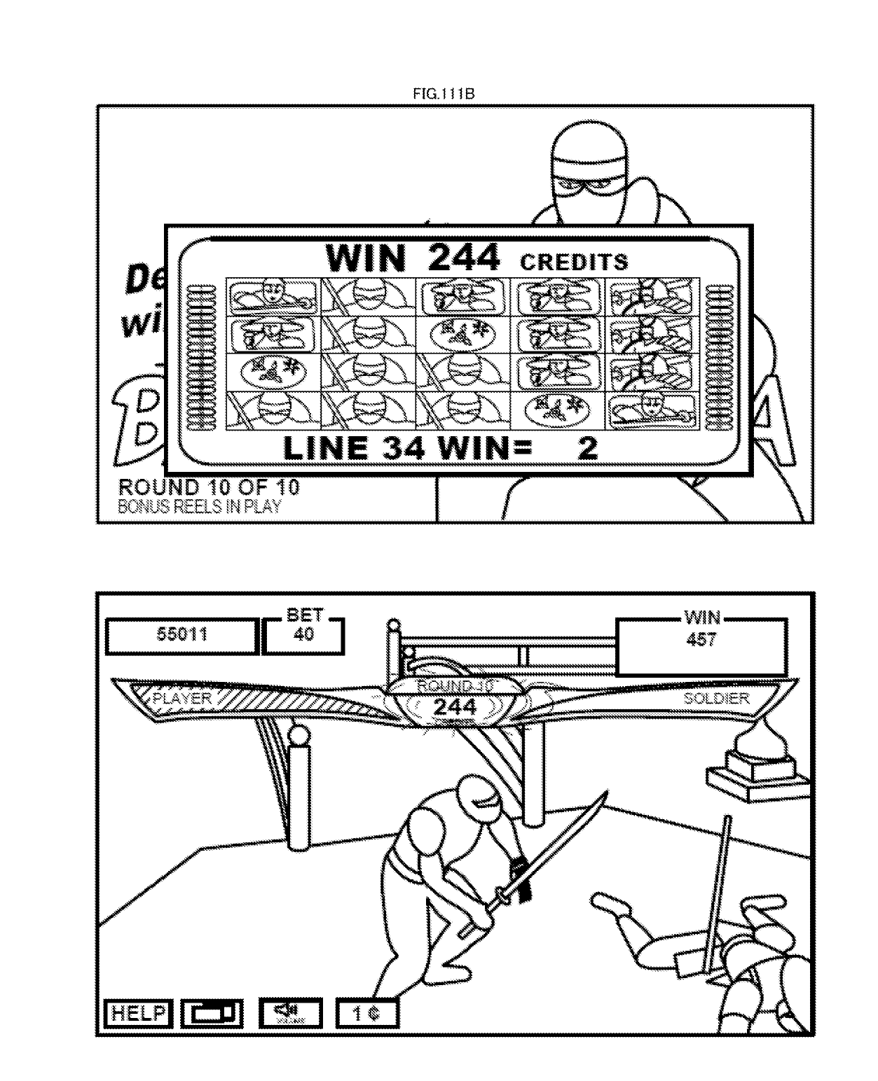

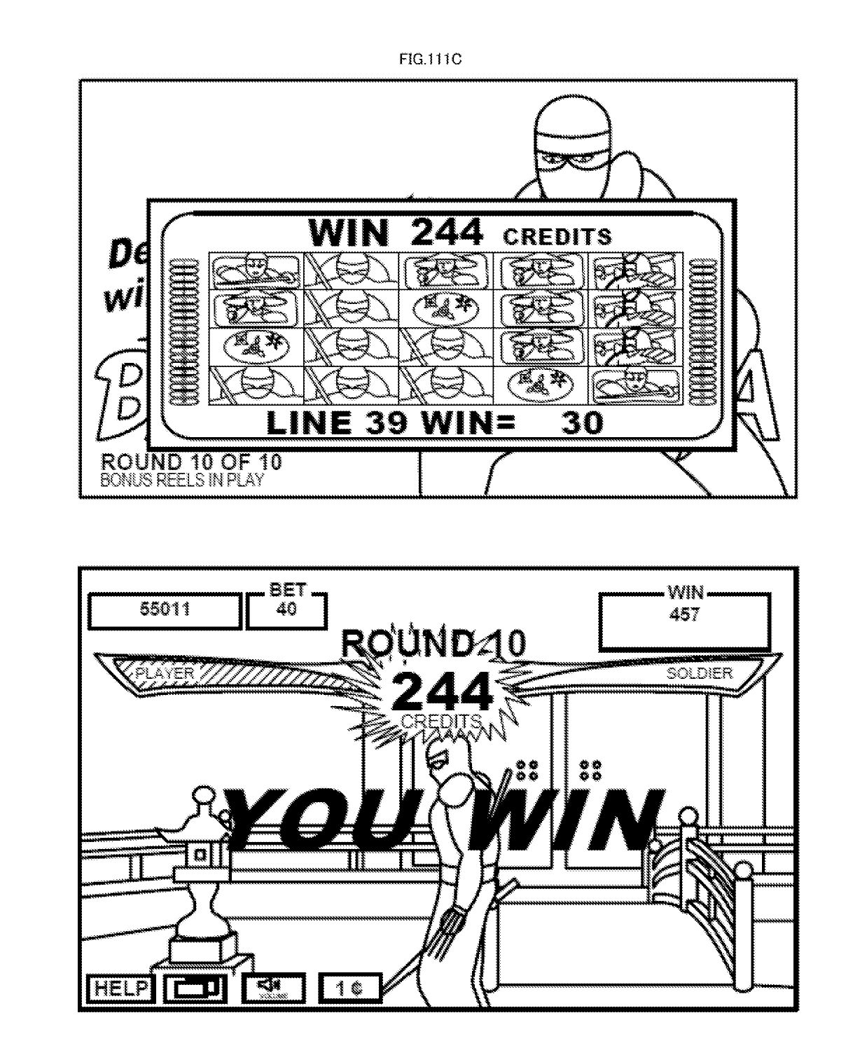

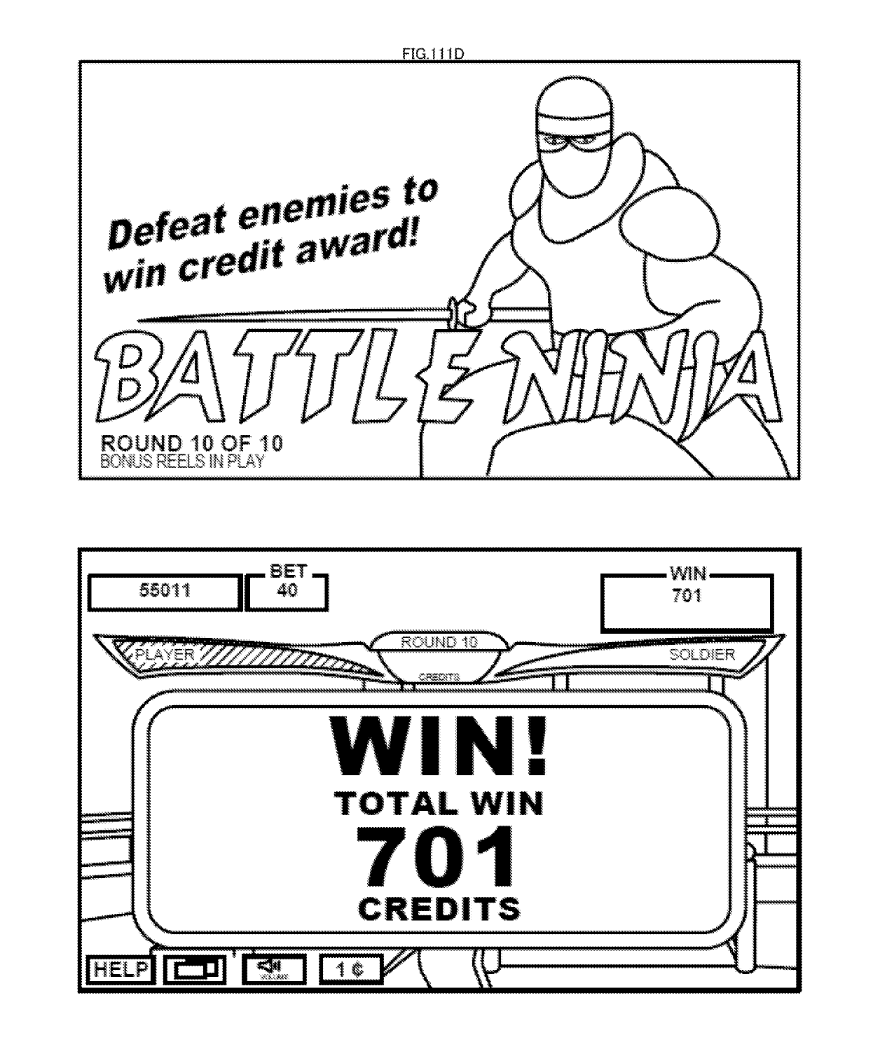

in the feature game mode, each of the images in accordance with the classes of the payouts is displayed on the first display part (for example, FIG. 95C to FIG. 111D or the like), and the plurality of symbols are rearranged on the second display part (FIG. 97B to FIG. 97D, FIG. 100A to FIG. 100B, FIG. 104D to FIG. 105A, and FIG. 111A to FIG. 111C).

In the base game mode, the game in which the plurality of symbols are rearranged on the first display part is executed. On the other hand, in the feature game mode, on the first display part, each of the images in accordance with the classes of the payouts is displayed, and on the second display part, the plurality of symbols are rearranged. Since also in the feature game mode, each of the images in accordance with the classes of the payouts is displayed on the first display part, a player can play the game in the feature game mode without moving his or her line of sight. In addition, since in the feature game mode, the game which is clearly different from the game in the base game mode is executed, a feeling of expectation of a player can be enhanced. Further, since on the second display part, the plurality of symbols are rearranged, a player is notified of a basis of the image in accordance with the class of the payout, thereby allowing reliability of the game to be enhanced and enabling a player to be relieved and to play the game.

Further, the gaming machine according to the present embodiment includes:

a display for displaying a game in a base game mode and for displaying a unit game in a feature game mode being different from the base game mode; and

a controller for determining a payout in the unit game in the feature game mode, and the controller is programmed to execute processes described below:

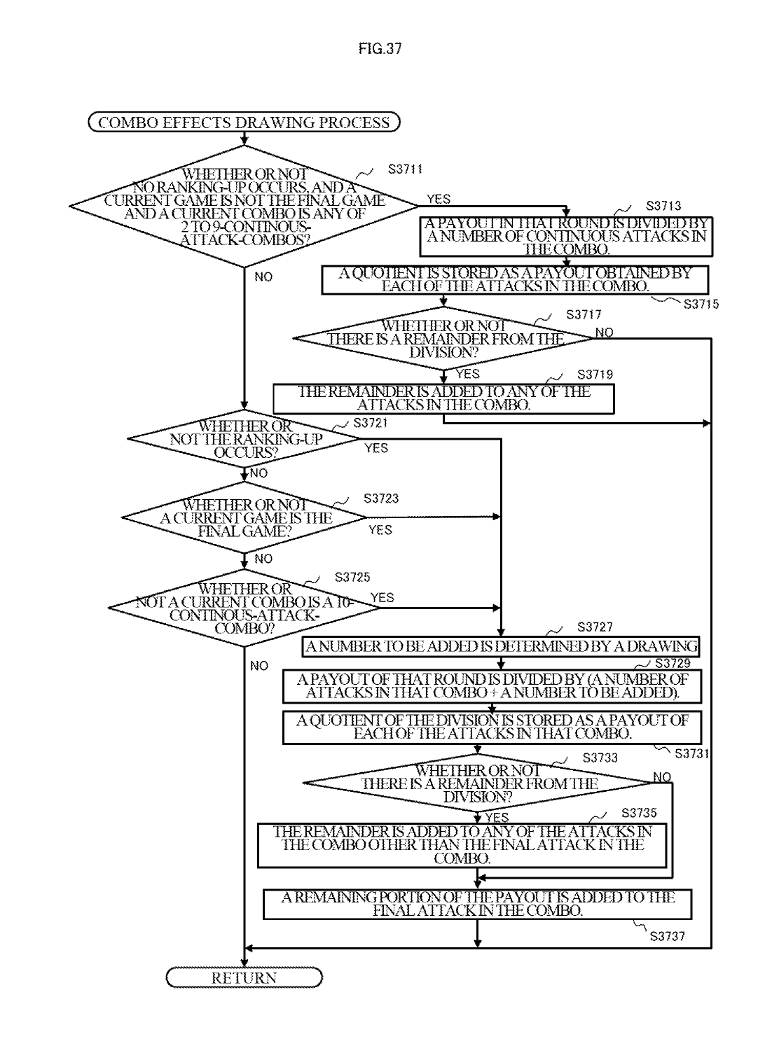

a process (C-1-1) in which a number of times at which information pertinent to a payout is displayed is determined by a drawing process (for example, the later-described process of combo effects in FIG. 37 or the like); and

a process (C-1-2) in which in the predetermined number-th unit game among the plurality of unit games, in accordance with the number of times determined by the process (C-1-1), the information pertinent to the payout is generated from the payout (for example, the later-described payout of each combo in FIG. 37 or the like).

In the predetermined number-th unit game, the information pertinent to the payout is displayed over divided times, thereby allowing a player to expect that a payout which is different from a payout in a normal unit game is likely to be provided and enabling the feature game mode to be prevented from becoming monotonous.

Further, in the gaming machine according to the present embodiment,

the controller is configured to execute processes described below:

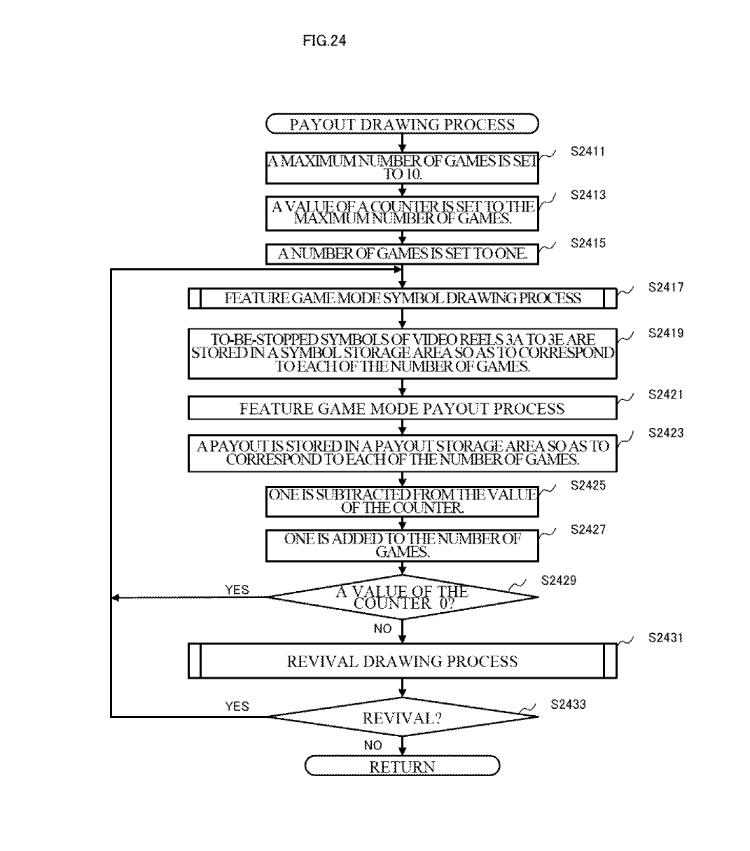

a process (C-2-1) in which all of payouts in the plurality of unit games in the feature game mode are determined (for example, a process in FIG. 24); and

a process (C-2-2) in which as the process (C-1-1), after executing the process (C-2-1), a number of times at which the information pertinent to the payout is displayed is determined by a drawing process (for example, a process in FIG. 37).

First, all of the payouts in the plurality of unit games in the feature game mode are determined and thereafter, the number of times at which the information pertinent to the payout is displayed is determined. While all of the payouts in the plurality of unit games in the feature game mode are reflected, the predetermined number-th unit game, the number of times at which the information pertinent to the payout is displayed in the predetermined number-th unit game, and the information pertinent to the payout can be determined. In other words, effects can be executed by utilizing the information pertinent to the payout from the overall flow of the plurality of unit games. Effects which causes a player to expect can be executed.

Further, in the gaming machine according to the present embodiment,

the controller is configured to execute processes described below:

a process (C-3-1) in which a payout is determined each time each of the plurality of unit games in the feature game mode is executed;

a process (C-3-2) in which it is determined whether or not a unit game is the predetermined number-th unit game among the plurality of unit games; and

a process (C-3-3) in which when the unit game is the predetermined number-th unit game, as the process (C-1-1), the number of times at which the information pertinent to the payout is displayed is determined by a drawing process.

While the payout is determined each time each of the plurality of unit games is executed, when the unit game is the predetermined number-th unit game, the number of times at which the information pertinent to the payout is displayed is determined by the drawing process. Since without being limited by all of the payouts in the feature game mode, the number of times at which the information pertinent to the payout is displayed is determined by the drawing process, effects utilizing the information pertinent to the payout can be executed in an unexpected manner, thereby allowing effects which surprise a player to be executed.

Further, in the gaming machine according to the present embodiment,

the controller is configured to execute processes described below:

a process (C-4-1) in which it is determined whether or not a unit game is the predetermined number-th unit game among the plurality of unit games; and

a process (C-4-2) in which when the unit game is the predetermined number-th unit game, as the process (C-1-1), based on the payout of the predetermined number-th unit game, the number of times at which the information pertinent to the payout is displayed is determined by a drawing process (for example, step S3613, S3617, S3621, S3625, S3629, and the like in FIG. 36, combo A to combo C, or the like).

Based on the payout of the predetermined number-th unit game, the number of times at which the information pertinent to the payout is displayed is determined, thereby allowing a player to predict or expect the payout based on the number of times at which the information pertinent to the payout is displayed.

In addition, the gaming machine according to the present embodiment includes:

a display for displaying a game in a base game mode and for displaying a unit game in a feature game mode being different from the base game mode; and

a controller for determining payouts of a plurality of unit games in the feature game mode, and

the controller is programmed to execute processes described below:

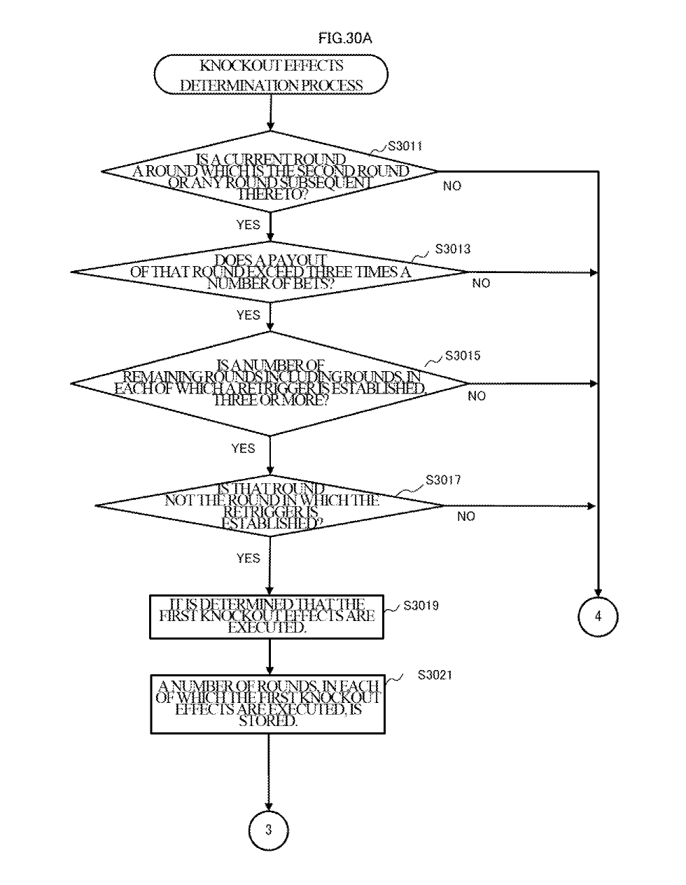

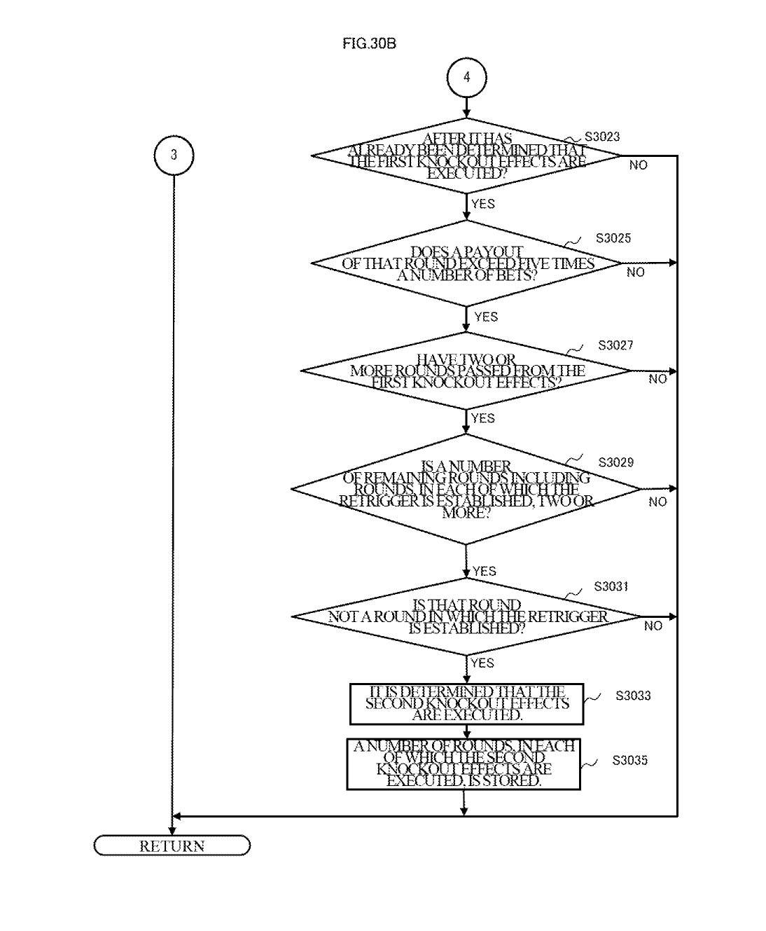

a process (D-1-1) in which in the predetermined number-th unit game among the plurality of unit games, it is determined whether the feature game mode is continued or finished (for example, step S3017 in FIG. 30A and FIG. 30B or the like);

a process (D-1-2) in which it is determined whether or not the payout satisfies a condition regarding a payout (for example, step S3013 in FIG. 30A and FIG. 30B or the like);

a process (D-1-3) in which it is determined whether or not the predetermined number-th time satisfies a condition regarding the number of times (for example, step S3011 and S3015 in FIG. 30A and FIG. 30B, or the like); and

a process (D-1-4) in which based on results of the determination processes of the process (D-1-1) to the process (D-1-3), contents of effects in the predetermined number-th unit game is determined (for example, step S3019 in FIG. 30A and FIG. 30B or the like).

The contents of effects in the predetermined number-th unit game is determined based on the predetermined number-th unit game, the payout, and whether or not the feature game mode is continued. Based on the various conditions in the unit games in the feature game mode, the contents of effects can be appropriately modified, thereby allowing diverse effects to be conducted and enabling a feeling of expectation of a player to be enhanced by the progress of the effects.

In addition, in the gaming machine according to the present embodiment,

the controller further executes processes described below:

a process (D-2-1) in which in the predetermined number-th unit game, when the contents of effects have not been determined in the determination process of the process (D-1-4), first effects are determined as the contents of effects (step S3023 in FIG. 30A and FIG. 30B or the like); and

a process (D-2-2) in which in the predetermined number-th unit game, when the contents of effects have already been determined in the determination process of the process (D-1-4), second effects which are different from the first effects are determined as the contents of effects (step S3033 in FIG. 30A and FIG. 30B or the like).

Since depending on whether or not the contents of effects have already been determined, the contents of effects are made different, repeating the same effects is prevented and the different effects are executed in accordance with the progress of the unit game, thereby allowing a player not to get bored.

In addition, in the gaming machine according to the present embodiment,

the controller further executes

a process in which in the process (D-1-3), when the feature game mode is continued, it is determined whether or not a condition regarding the number of times is satisfied, the condition including a number of times at which the feature game mode is continued (for example, step S3015 and S3029 in FIG. 30A and FIG. 30B, or the like).

Since it is determined whether or not the condition regarding the number of times is satisfied, the condition including the number of times at which the feature game mode is continued, even when the feature game mode is continued, the contents of effects can be determined while the overall flow of the feature game mode is reflected.

The controller further executes processes described below:

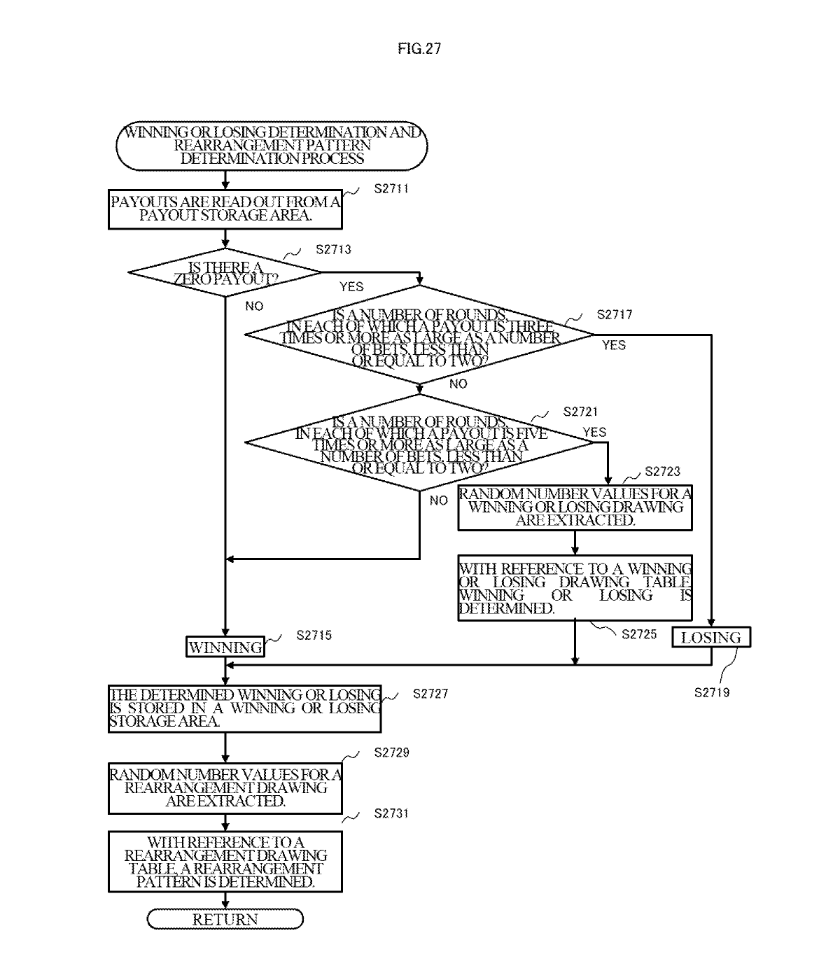

a process (D-4-1) in which winning or losing in each of the plurality of unit games is determined based on the payout (for example, the later-described process in FIG. 27 or the like); and

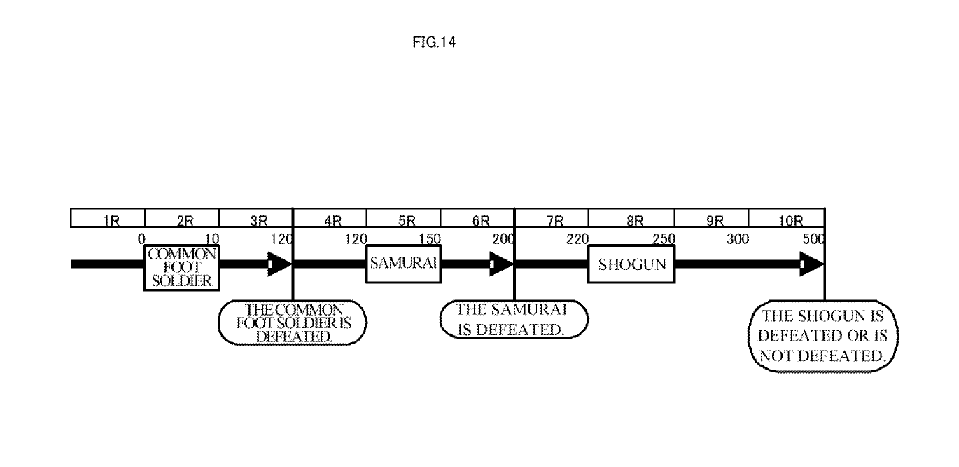

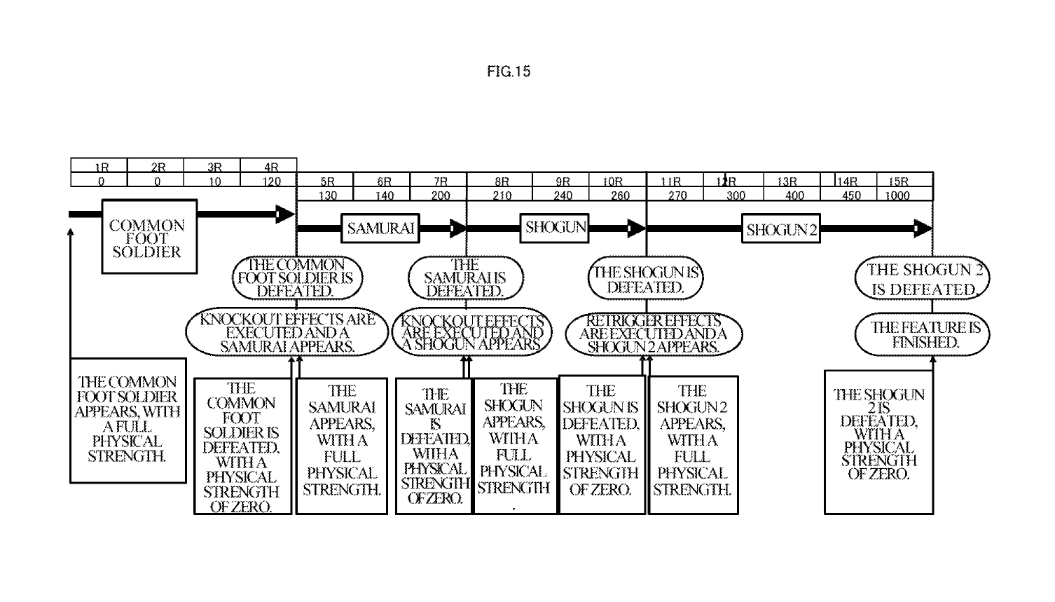

a process (D-4-2) in which based on the payout and whether or not a result of the determination of the winning or losing is winning, effects are conducted (for example, the later-described process in FIG. 30A and FIG. 30B, kinds of enemy characters in FIG. 14 and FIG. 15, or the like).

When the result of the determination of the winning or losing is the winning, an image being different from the image which has been so far displayed is displayed. For example, an image in which a character being different from the character which has so far appeared appears is displayed, thereby allowing a feeling of expectation to be enhanced.

In addition, the gaming machine according to the present embodiment includes:

a display for displaying a game in a base game mode and for displaying a unit game in a feature game mode being different from the base game mode; and

a controller for determining payouts of a plurality of unit games in the feature game mode, and the controller is programmed to execute processes described below:

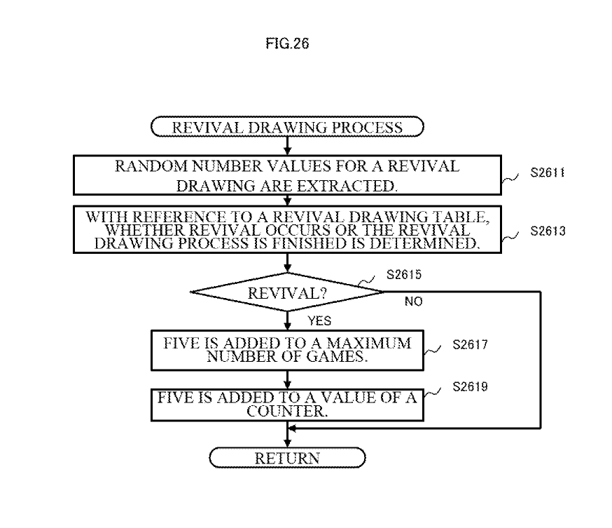

a process (E-1-1) in which in the predetermined number-th unit game among the plurality of unit games, it is determined whether the feature game mode is continued or finished (for example, the later-described process in FIG. 26 or the like);

a process (E-1-2) in which when the feature game mode is continued, a payout of each of all of unit games which includes unit games to be continued is determined (for example, the later-described process in FIG. 24 or the like); and

a process (E-1-3) in which based on the payout determined in the process (E-1-2), effects are executed (for example, the later-described process at step S2331 in FIG. 23 or the like).

The overall development such as the number of times, at which the unit game in the feature game mode is executed, can be previously determined, thereby allowing a player to be easily attracted to the feature game mode.

In the gaming machine according to the present embodiment,

when the feature game mode is continued, the plurality of times is a number of times including a number of unit game to be continued, and

the controller executes processes described below:

a process (E-2-1) in which a payout of each of a plurality of unit games in the feature game mode is determined (for example, a process in FIG. 24); and

a process (E-2-2) in which effects based on the payout of the unit game executed are executed each time each of the plurality of unit games is executed (for example, a process at step S2331 in FIG. 23).

When the unit games in the feature game mode are continued, the payout of each of all of the unit games including the continued unit games is determined, and the effects based on the payout are executed each time each of the unit games is executed. Since the effects are executed based on the payout of each of all of the unit games in the feature game mode, continuity of the effects based on the payout can be ensured. For example, smooth effects such as effects having story nature are executed, thereby attracting a player and allowing a feeling of expectation to be enhanced.

In the gaming machine according to the present embodiment,

the controller executes described below:

a process (E-3-1) in which a payout of each of all of the plurality of unit games in the feature game mode is determined (for example, a process in FIG. 24); and

a process (E-3-2) in which in any unit game among the plurality of unit games, effects based on the payout of each of the plurality of unit games are executed before the unit game is initiated.

The payout of each of all of the plurality of unit games in the feature game mode is determined and in any unit game, the effects based on the payout of each of all of the plurality of unit games are executed. For example, in an initial unit game in the feature game mode, the effects based on the payout of each of all of the unit games are executed. Since in any unit game, the effects based on the payout are executed, a player can know the payout provided in the feature game mode, thereby allowing a feeling of expectation of a player to be enhanced. In particular, when in the initial unit game in the feature game mode, the effects are executed, a feeling of expectation of a player can be maintained over the feature game mode.

In the gaming machine according to the present embodiment,

the controller executes processes described below:

a process (E-4-1) in which displaying order in which the plurality of unit games in the feature game mode are displayed is determined (for example, the later-described step S2311 in FIG. 23 or the like); and

a process (E-4-2) in which the displaying order is rearranged (for example, the later-described step S2315 in FIG. 23, or the like).

Since the displaying order is previously changed, the overall development of the unit games in the feature game mode is previously determined, thereby allowing a feeling of expectation to be enhanced and enabling a player to be attracted to the feature game mode.

In the gaming machine according to the present embodiment,

the controller executes

a process in which in the process (E-4-2), except for the predetermined number-th unit game among the plurality of unit games, the displaying order is rearranged (step S2817 or S2833 in FIG. 28, step S2919 or S2939in FIG. 29).

Since the displaying order is rearranged except for the predetermined number-th unit game, the displaying order is prevented from being similarly rearranged, thereby allowing the progress of the unit games to be prevented from becoming simple.

In the gaming machine according to the present embodiment,

the controller executes

a process in which in the process (E-4-2), displaying order in which the another predetermined number-th unit game, which is different from said predetermined number-th unit game, among the plurality of unit games is displayed is randomly determined (at step S2827 to S2831 and S2837 to S2841 in FIG. 28, at step S2933 to S2937 and S2945 to S2949 in FIG. 29).

Since the displaying order in which the particular number-th unit game is displayed is randomly determined, the particular number-th unit games can be randomly dispersed, thereby allowing the progress of the unit games to be prevented from becoming simple.

Further, the gaming machine according to the present embodiment includes:

a display for displaying a game in a base game mode and for displaying a unit game in a feature game mode being different from the base game mode;

a memory for storing symbol arrays arranged in a first kind of a group of reel strips, symbol arrays arranged in a second kind of reel strips, and a winning pattern determination table for determining winning patterns; and

a controller being programmed to execute processes (α-1-1) to (α-1-13) described below:

a process (α-1-1) in which in the base game mode, symbols are determined by a drawing from the symbol arrays arranged in the first kind of the group of reel strips;

a process (α-1-2) in which on the condition that a predetermined winning pattern is established by the symbols determined by the process (α-1-1), a game mode is shifted from the base game mode to the feature game mode;

a process (α-1-3) in which with respect to each of a plurality of unit games in the feature game mode, symbols are determined by a drawing from the symbol arrays arranged in the second kind of the group of reel strips;

a process (α-1-4) in which in the predetermined number-th unit game, it is determined by a drawing whether or not the unit games are continued;

a process (α-1-5) in which with respect to the plurality of unit games, payouts are determined by the symbols determined by the process (α-1-3);

a process (α-1-6) in which based on the payouts determined by the process (α-1-5), the order in which the plurality of unit games are executed is rearranged;

a process (α-1-7) in which based on the payouts determined by the process (α-1-5), winning or losing in a battle between mutually opposing two kinds of characters is determined;

a process (α-1-8) in which based on the payouts determined by the process (α-1-5), it is determined that the character is changed;

a process (α-1-9) in which in accordance with the payouts determined by the process (α-1-5) and the winning or losing determined by the process (α-1-7), physical strengths for the battle between the two kinds of characters are determined with respect to each of the plurality of unit games; a process (α-1-10) in which in accordance with the payouts determined by the process (α-1-5) and

the winning or losing determined by the process (α-1-7), contents of the battle between the two kinds of characters are determined;

a process (α-1-11) in which in the order in which the plurality of unit games are executed, the battle between the two kinds of characters is executed;

a process (α-1-12) in which when the battle between the two kinds of characters has been finished, the symbols determined by the process (α-1-3) are displayed; and

a process (α-1-13) in which on the condition that the plurality of unit games have been finished, the game mode is shifted from the feature game mode to the base game mode.

Further, in the gaming machine according to the present embodiment,

the two kinds of characters are an ally character of a player side and an enemy character opposing a player, and

a plurality of characters constitute the enemy character, and one character is changed to other character by knockout effects.

Further, in the gaming machine according to the present embodiment,

the two kinds of characters are the ally character of a player side and the enemy character opposing a player, and

the plurality of characters constitute the enemy character, and one character is changed to other character by the knockout effects for the battle in accordance with the payout

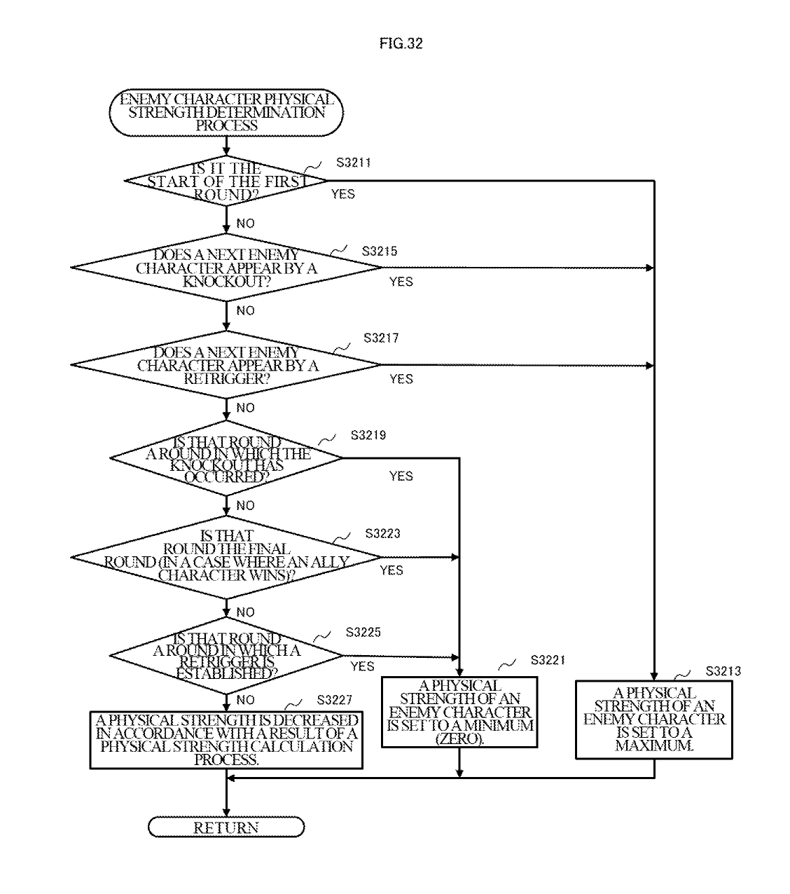

Before and after the knockout effects, physical strengths of the one character and physical strengths of the other character are defined (for example, the later-described step S3213 and S3221 in FIG. 32, or the like).

The unit game in which the process (α-1-4) is executed is not subjected to the rearrangement in the process (α-1-6). In other words, the order in which the unit games (rounds), in each of which a retrigger occurs, are executed is unchanged.

<<<Concept and Others>>>

A slot machine 10 is a kind of a gaming machine. In the present embodiment, the slot machine 10 is described as one example of the gaming machine. However, the present invention is not limited thereto and may be an apparatus in which a game in any base game mode is independently executed and a game mode is developed from the base game mode to other game mode such as a feature game mode.

A game executed in the base game mode in the present embodiment is executed on the slot machine 10. In the present embodiment, the game in the base game mode is referred to as a base game. The base game is a slot game in which a plurality of symbols are rearranged. The base game is a game whose concept is opposed to that of the feature game.

Specifically, the rearrangement of the symbols in the slot game is realized by five video reels 3a to 3e which are capable of varying and stopping. The rearranged symbols are displayed in a manner in which the symbols are stopped in a symbol display region 141d of a lower display device 141 (lower liquid crystal panel 141b).

The slot game has the base game mode and the feature game mode. The base game mode is a game mode in which a unit game (base game), in which on the condition that a gaming value is bet, a plurality of symbols are rearranged in the symbol display region 141d and a normal payout in accordance with the rearranged symbols is paid out, is executed. The game in the base game mode is not limited to the slot game and may be a game which can be independently executed on a game terminal such as the slot machine 10.

Upon initiating the unit game, five to-be-stopped symbols are determined by a drawing process. With respect to each of the five video reels 3a to 3e, one to-be-stopped symbol is determined. Subsequently, the rearrangement of the plurality of symbols is once released. The rearrangement of the plurality of symbols is released, and the symbols are thereby displayed in a varying manner (the later-described being displayed in a scrolling manner) After the elapse of a predetermined period of time, the to-be-stopped symbols are displayed in a stopped manner in predetermined positions. The five to-be-stopped symbols are displayed in the stopped manner, and the plurality of symbols are thereby rearranged in the symbol display region 141d. The plurality of symbols are rearranged, and an outcome of the unit game is thereby displayed in the symbol display region 141d. In the present embodiment, the displaying of the symbols in the stopped manner is synonymous with the appearing and the rearranging of the symbols.

The feature game mode is a game mode which is different from the base game mode and is a game mode in which a larger profit than that in the base game mode is likely to be obtained.

It is only required for the symbols to be symbols which are rearranged in the symbol display region 141d so as to be viewable, and kinds and numbers thereof are not limited. The concept of the symbols is a superordinate concept of specific symbols and normal symbols. The specific symbols are added to the normal symbols as needed.

For example, the specific symbols include wild symbols (for example, the later-described symbols of WILD, or the like) and trigger symbols (for example, the later-described symbols of FEATURE, or the like). The wild symbols can serve as substitute symbols as other kinds of symbols. The wild symbols are replaced with other symbols so as to establish an advantageous winning pattern. The trigger symbols are symbols which serve as a trigger which initiates the execution of at least a bonus game. In addition, the trigger symbols may have a function to increase the specific symbols in the bonus game, that is, to increase the specific symbols of at least one of the trigger symbols and the wild symbols. In addition, the trigger symbols may have a function to increase the number of games in the bonus game.

Specifically, the symbols collectively mean symbols of WILD (wild symbols), PICT_A, PICT_B, PICT_C, PICT_D, PICT_E, PICT_F, PICT_G, PICT_H, PICT_I, PICT_J, PICT_K, and FEATURE (trigger symbols).

The gaming value is coins, bills, or electrical valuable information corresponding to these. The gaming value in the present embodiment is not particularly limited, and for example, may be gaming media such as medals, a token, electronic money, and a ticket. The ticket is not particularly limited, and for example, may be the-later-described ticket with a barcode and the like.

The bonus game is synonymous with a feature game. For example, a game in which a unit game is repeated may be the bonus game. It is only required for the bonus game to be a game whose gaming state is more advantageous than that in the base game mode, and as such a bonus game, any kind of a game may be adopted. In addition, if a gaming state is an advantageous gaming state for a player, that is, if the gaming state in the game in the bonus game mode is more advantageous than that in the game in the base game mode, a plurality of kinds of bonus games may be combined and the combined plurality of kinds of bonus games may be adopted. For example, the bonus game may be realized, singly by each of the kinds of states or by combining the kinds of states such as a state in which a larger amount of a gaming value can be obtained than that in the base game mode and a state in which a gaming value can be obtained at a higher probability than that in the base game mode.

It is only required for the game (bonus game) in the feature game mode to be a game which is different from a game in the base game mode, and as such a game, any game may be adopted. In the present embodiment, the game in the feature game mode can be a game which can be executed by placing a smaller bet of a gaming value than that in the base game and in which a gaming value of an amount in accordance with a winning pattern which is established based on rearranged symbols is paid out

A state of the rearrangement means a state in which after the arrangement of symbols has been released, symbols are again arranged in the symbol display region 141d. By initiating the unit game (slot game), the arrangement of symbols is released, and thereafter, symbols are again arranged (rearranged), and based on the rearranged symbols, an outcome of the unit game is determined, thereby finishing the unit game. A state of the “arrangement” means a state in which a player external thereto can visually confirm the symbols.

<<<<Specific Outline of Slot Machine of the Present Embodiment>>>>

An outline of a slot machine of the present embodiment is as described below. The details thereof will be described later.

The slot machine 10 has five video reel 3a, 3b, 3c, 3d, and 3e. The five video reel 3a, to 3e are displayed by images on a lower display device 141b. Along a longitudinal direction of each of the five video reels 3a to 3e, a plurality of symbols are arranged. Each of the plurality of symbols arranged on each of the five video reels 3a to 3e is displayed by an image.

One reel strip (one symbol array) is constituted of the plurality of symbols arranged on each of the video reels. As described above, since the plurality of symbols are displayed by the images, the reel strips in the present embodiment are virtual and are arrays of symbols, in each of which the plurality of symbols are arranged in a column state. The images of the plurality of symbols are displayed in the column state, thereby allowing one reel strip to be displayed as one video reel on the lower liquid crystal display panel 141b. The five reel strips (five symbol arrays) are constituted of the five video reels 3a to 3e. In the present embodiment, the reel strips are synonymous with symbol arrays, and the five reel strips and the plurality of reel strips are collectively referred to as a group of reel strips. The video reels 3a to 3e are displayed in the varying manner and are displayed in the stopped manner, whereby scroll lines of the symbol arrays are configured.

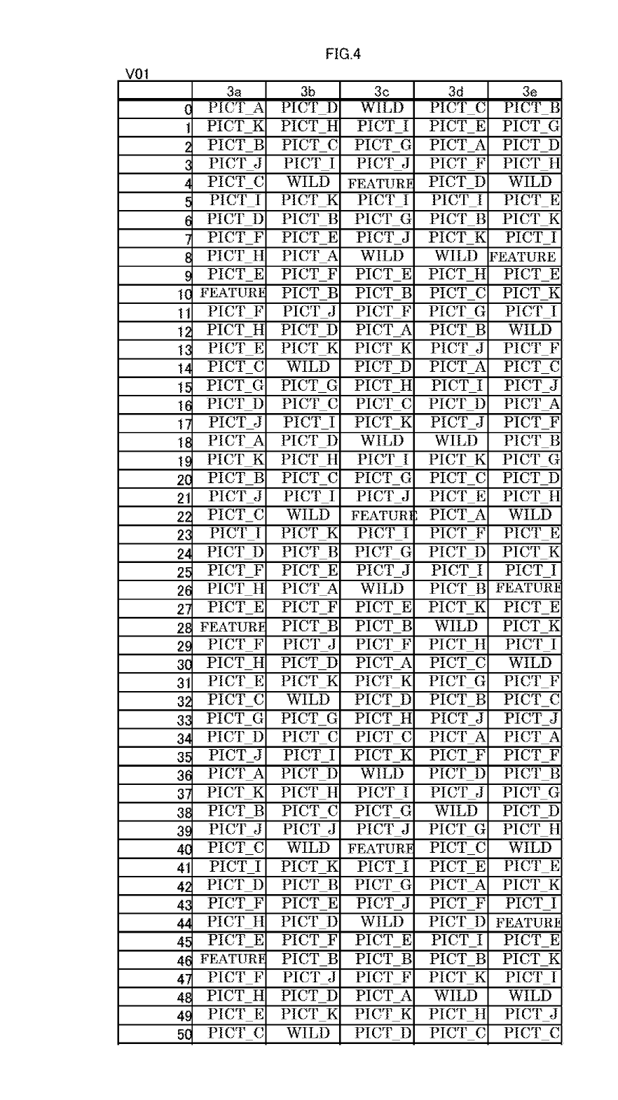

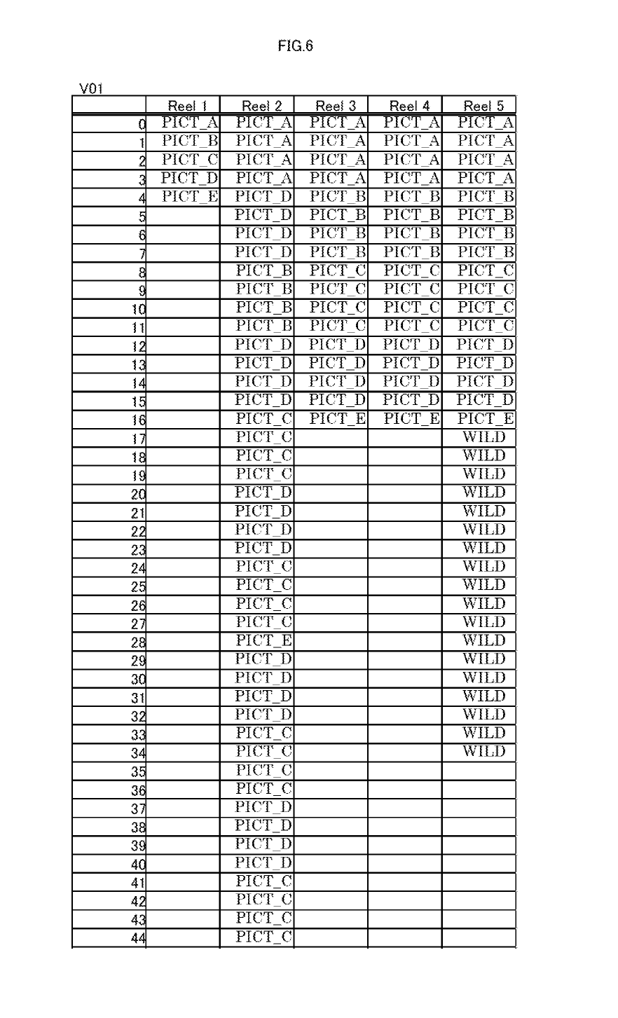

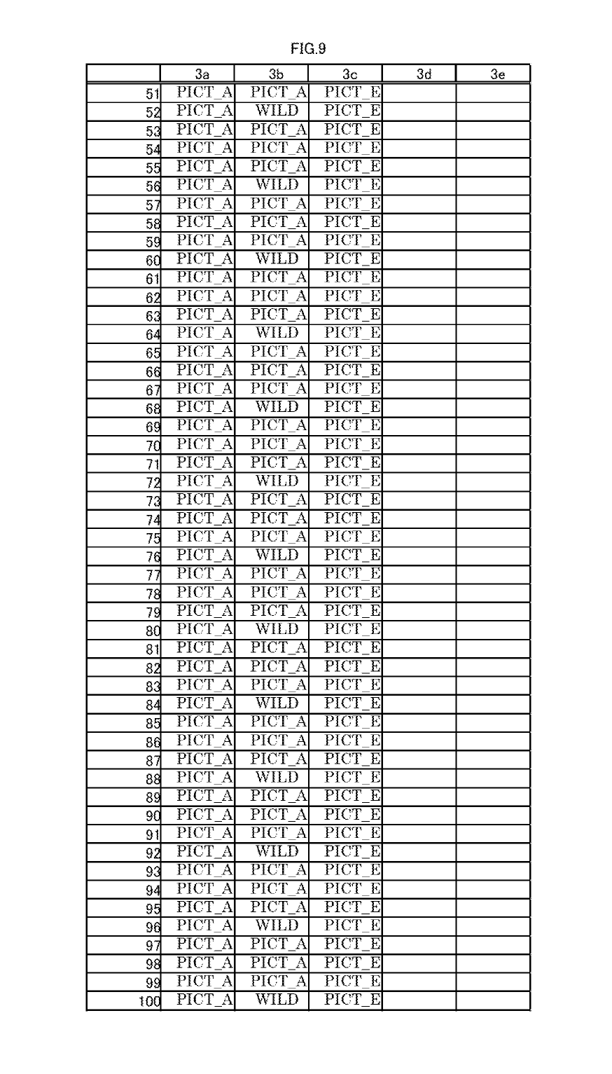

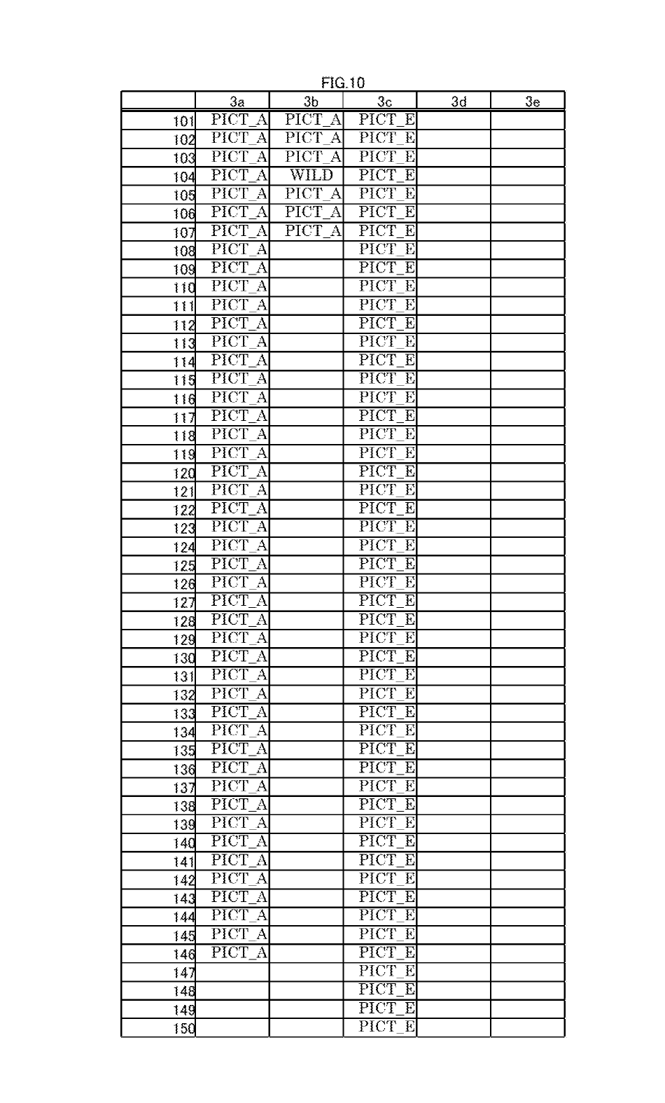

In the present embodiment, there are two kinds of game modes: the base game mode and the feature game mode. Five reel strips used in each of these game modes are different from each other. As described later, in FIG. 4 and FIG. 15, five reel strips used in the base game mode are shown. In the present embodiment, the five reel strips used in the base game mode are referred to as Reel Strip Base Game. In FIG. 6 to FIG. 10, five reel strips used in the feature game mode are shown. In the present embodiment, there are three kinds of the five reel strips used in the feature game mode, the respective kinds thereof are referred to as Reel Strip Feature Game_{—}0, Reel Strip Feature Game_{—}1, and Reel Strip Feature Game_{—}2.

In a symbol display region 141d of the slot machine 10, 40 paylines are formed. The 40 paylines are fixed, irrespective of any BET. In other words, in each of the unit games, the 40 paylines are invariably active. Accordingly, even when a number of BETs per line is one, the total number of BETs is 40 and is consumed.

For example, when a number of BETs per line is one, the total number of BETs is 40. When a number of BETs per line is two, the total number of BETs is 80. When a number of BETs per line is three, the total number of BETs is 120. When a number of BETs per line is five, the total number of BETs is 200. When a number of BETs per line is 10, the total number of BETs is 400.

The kinds of symbols in the slot machine 10 according to the present embodiment are symbols of WILD (wild symbols), PICT_A, PICT_B, PICT_C, PICT_D, PICT_E, PICT_F, PICT_G, PICT_H, PICT_I, PICT_J, PICT_K, and FEATURE (trigger symbols).

The symbol of WILD is a symbol which is replaced with other symbol when it is determined whether or not a winning pattern along a payline is established. The WILD is replaced with other symbol so as to establish an advantageous winning pattern, thereby determining that any winning pattern is established. In the slot machine 10 according to the present embodiment, the symbols of WILD are present only on the video reels 3b to 3e.

The symbol of FEATURE is a scatter symbol. Irrespective of any payline, when it is determined by a symbol drawing process that a predetermined number of symbols, for example, three symbols of FEATURE appear in the symbol display region 141d, a winning pattern is established. For example, when it is determined that two symbols of FEATURE appear on the video reel 3a and one symbol of FEATURE appear on the video reel 3d in the symbol display region 141d, a winning pattern is established.

The winning pattern of FEATURE is established, whereby the feature game mode is triggered. The winning pattern of FEATURE is established only in the base game mode and is not established in the feature game mode.

In the slot machine 10 according to the present embodiment, the symbols of FEATURE are present only on the video reels 3a, 3c, and 3e.

<Feature Game Mode>

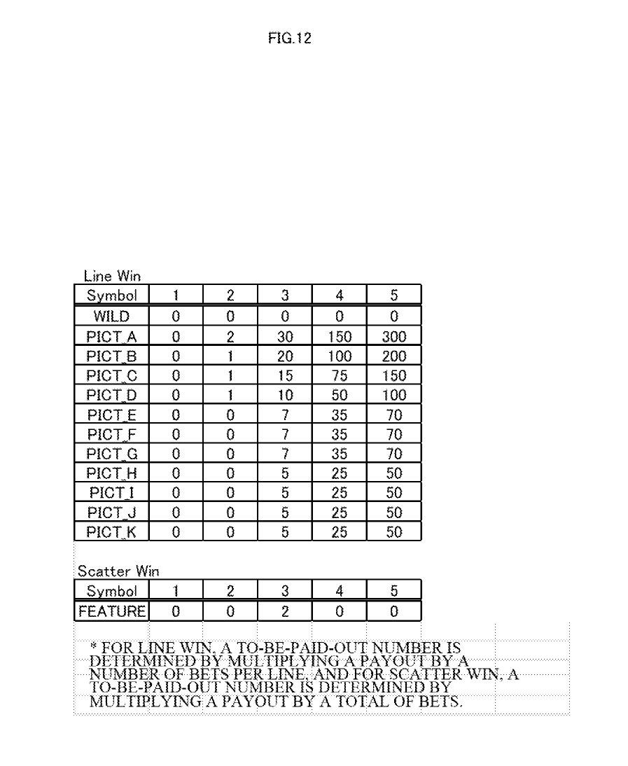

In the base game mode, three symbols of FEATURE have appeared in the symbol display region 141d, thereby triggering the feature game mode (refer to FIG. 12). Specifically, the symbols of FEATURE have appeared on three video reels 3a, 3c, and 3e, thereby triggering the feature game mode (refer to FIG. 92D).

At the start of the feature game mode, 10 unit games are provided. In the feature game mode, one kind of reel strips among three kinds of reel strips (refer to FIG. 6 to FIG. 10) which are different from those used in the base game mode are determined by a drawing process and are used.

Since on the reel strips used in the feature game mode, no symbols of FEATURE are present, no retrigger by symbols occurs. Instead, when a number of remaining unit games comes to be zero, a retrigger by a revival drawing process is executed. When the revival occurs by the revival drawing process, five unit games are added by executing the revival drawing process once. When the game is finished by the revival drawing process, no unit game is added, the feature game mode is finished, and the game mode returns to the base game mode. The revival drawing process can be conducted at up to eight times, and in the feature game mode, up to 50 unit games can be played by the revival drawing process.

Upon shifting to the feature game mode, a maximum number of unit games is determined, and to-be-stopped symbols for each of all of the maximum number of unit games are determined by a symbol drawing process. Further, the order in which the unit games are executed is rearranged such that in principle, a payout which is determined from the to-be-stopped symbols determined by the symbol drawing process is increased as the game proceeds to the latter half thereof.

In the feature game mode, although the drawing process for determining the to-be-stopped symbols is executed, scrolling of the reel strips is not displayed on the lower display device 141. The display of the five video reels 3a to 3e is moved from the lower display device 141 to an upper display device 131. In the feature game mode, images of effects, in each of which two kinds of characters which are an ally character and an enemy character who are mutually opposing have a battle, are displayed on the lower display device 141. The ally character is a character on a side of a player. One round of battle effects corresponds to one unit game. An outcome of the battle is determined based on a payout determined from the to-be-stopped symbols. Accordingly, when no retrigger is executed, 10 rounds of the battle (10 unit games) are executed, and up to 50 rounds of the battle (50 unit games) are executed.

In the present embodiment, in the feature game mode, the unit game is synonymous with the round. In other words, timing at which the unit game is initiated is the same as timing at which the round is initiated, timing at which the unit game is finished is the same as timing at which the round is finished. One unit game is the same as one round. When the scrolling of the symbols or the like is described, mainly, the unit game is used as a term, and when the battle effects of the characters are described, mainly, the round is used as a term.

In the slot machine 10 according to the present embodiment, three kinds (four kinds) of enemy characters are present. By defeating the enemy character, a stronger enemy character appears, and effects which enhances a degree of expectation regarding a payout are executed. The ally character and the enemy character have a battle, and a credit is obtained in accordance with the development of the battle. The credit which can be obtained is determined based on a payout determined from the to-be-stopped symbols determined by the symbol drawing process.

When the game is finished by the revival drawing process, the feature game mode is finished, and the game mode returns to the base game mode.

<<<Overall Game System>>>

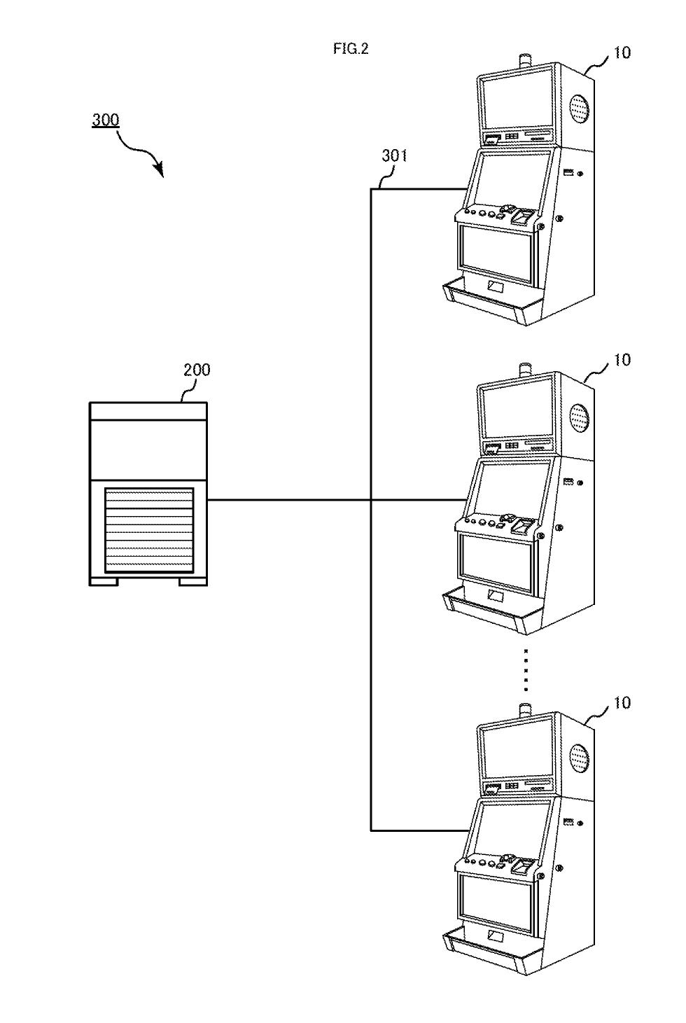

The basic functions of the slot machine 10 (gaming machine 1) are as described above. Next, with reference to FIG. 2, a game system including the slot machines 10 will be described.

FIG. 2 is a diagram illustrating the game system including the slot machines 10 according to the embodiment of the present invention.

A game system 300 includes a plurality of slot machines 10 and an external control device 200 that is connected to each of the slot machines 10 through a communication line 301.

The external control device 200 is for controlling the plurality of slot machines 10. In the present embodiment, the external control device 200 is a so-called hall server which is installed in a game facility having the plurality of slot machines 10. Each of the slot machines 10 is provided with a unique identification number, and the external control device 200 identifies transmission sources of data transmitted from the respective slot machines 10 by using the identification numbers. Also in the case when the external control device 200 transmits data to the slot machines 10, the identification numbers are used for specifying the transmission destination.

It is to be noted that the game system 300 may be constructed within a single game facility where various games can be conducted, such as a casino, or may be constructed among a plurality of game facilities. Further, when the game system 300 is constructed in a single game facility, the game system 300 may be constructed in each floor or section of the game facility. The communication line 301 may be a wired or wireless line, and can adopt a dedicated line, an exchange line, or the like.

<<<Overall Configuration of Slot Machine 10>>>

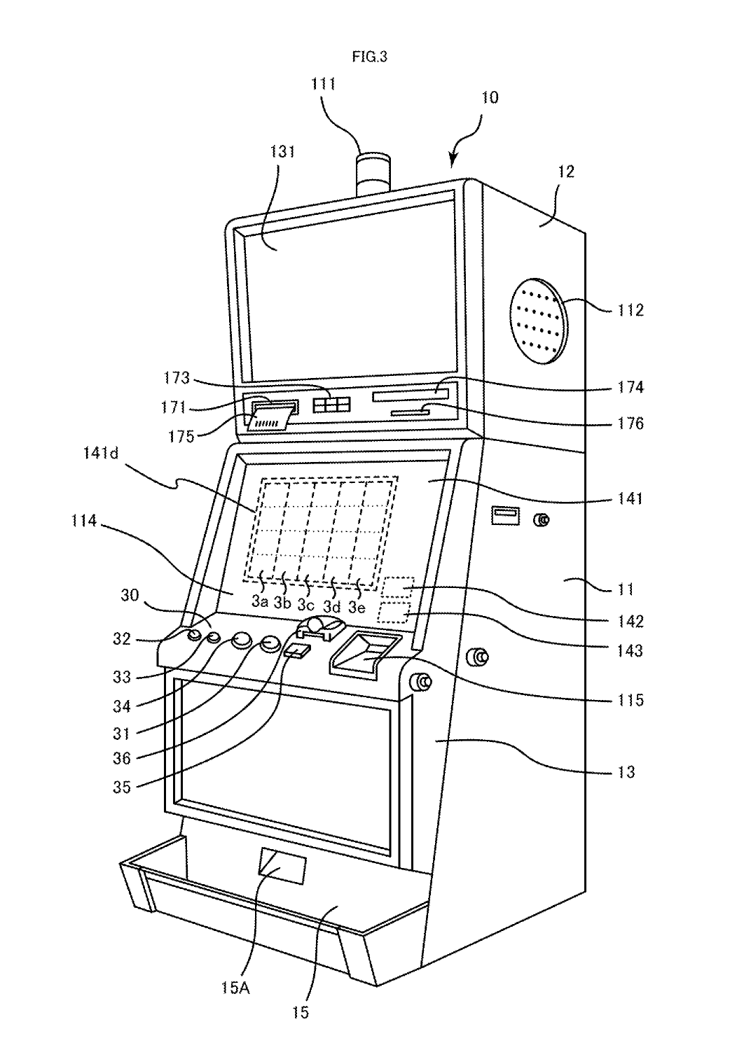

The game system according to the present embodiment is as described above. Next, with reference to FIG. 3, an overall configuration of the slot machine 10 will be described. FIG. 3 is a diagram illustrating the overall configuration of the slot machine 10 according to the embodiment of the present invention.

A coin, a bill, or electrically valuable information corresponding to these is used as a game medium in the slot machine 10. Further, in the present embodiment, a later-described ticket with a barcode is also used. It is to be noted that the game medium is not limited to these, and for example a medal, a token, electric money or the like can be adopted.

The slot machine 10 includes a cabinet 11, a top box 12 installed on the upper side of the cabinet 11, and a main door 13 provided at the front face of the cabinet 11.

A lower liquid crystal display panel 141b is provided at the center of the main door 13. The lower liquid crystal display panel 141b includes a liquid crystal panel and forms the display. The lower liquid crystal display panel 141b has the symbol display region 141d. In the symbol display region 141d, five video reels 3a, 3b, 3c, 3d, and 3e are displayed. In the present embodiment, a video reel depicts through videos the rotational and stop motions of a mechanical reel having a plurality of symbols drawn on the peripheral surface thereof. To each of the five video reels 3a to 3e, a symbol array comprised of a previously determined plurality of symbols is assigned (refer to the later-described FIG. 4 to FIG. 10).

In the present embodiment, in the symbol display region 141d, as stop positions for symbols of each of the video reels 3a to 3e, four regions which are an uppermost row (first row), an upper middle row (second row), a lower middle row (third row), and a lowermost row (fourth row) are defined. Accordingly, when the five video reels 3a to 3e (five reel strips) are displayed in a stopped manner, the total of 20 symbols, which is calculated by 5 reels×4 rows (5 columns×4 rows), appear (are displayed in the stopped manner) in the symbol display region 141d. Upon initiating a unit game, the five video reels 3a to 3e start varying. Thereafter, after the elapse of a predetermined period of time, the five video reels 3a to 3e are displayed in the stopped manner. This causes the 20 symbols to appear (to be displayed in the stopped manner) in the symbol display region 141d, thereby rearranging the symbols. In other words, each time a unit game is played, symbols are rearranged in the symbol display region 141d and an outcome of the unit game is displayed.

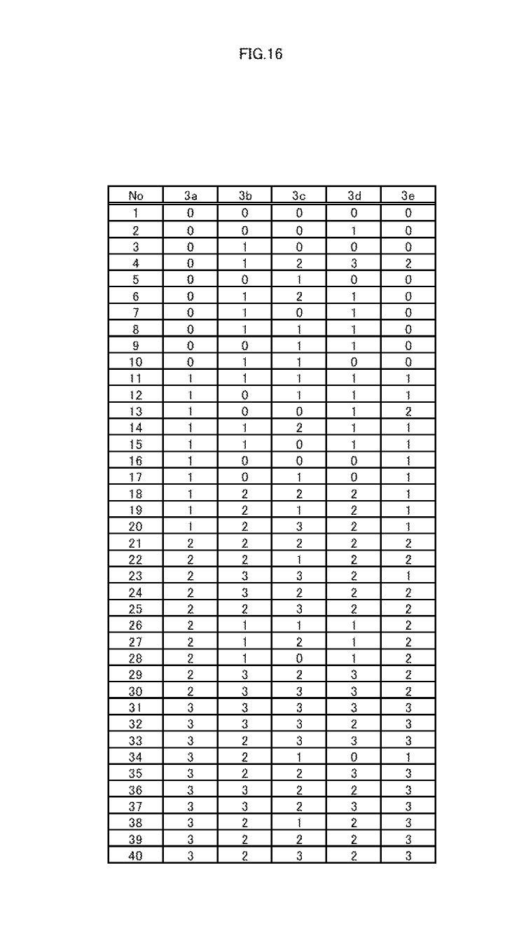

In the present embodiment, a line formed by selecting and connecting any regions of the above-mentioned four uppermost row, upper middle row, lower middle row, and lowermost row in accordance with the five video reels 3a to 3e is referred to as a payline (refer to FIG. 16). It is to be noted that any desired shape of the winning line can be adopted, and examples of the shape of the winning line may include a straight line formed by connecting regions of the upper middle row (second row) for the respective five video reels 3a to 3e, a V-shaped line, and a bent line. Also, any desired number of lines can be adopted, and the number can be, for example, 30 lines.

In addition, the lower liquid crystal display panel 141b has a number-of-credits display region 142 and a to-be-paid-out number display region 143. The number-of-credits display region 142 displays the number of coins (hereinafter, also referred to as “the number of credits”) owned by a player and retained inside the slot machine 10. In addition, the to-be-paid-out number display region 143 displays the number of coins (hereinafter, also referred to as the “to-be-paid-out number”) to be paid out to a player when winning is established.

In addition, the lower liquid crystal display panel 141b has a built-in lower touch panel 141a. A player can input a variety of instructions by touching the lower touch panel 141a.

Below the lower liquid crystal display panel 141b, a variety of buttons located on a control panel 30 and a variety of devices to be operated by a player are located.

A spin button 31 is used when starting scrolling of the symbol arrays of the respective video reels 3. A change button 32 is used when requesting a game facility staff member to exchange money. A CASHOUT button 33 is used when paying out the coins retained inside the slot machine 10 to a coin tray 15.

In addition, a 1-BET button 34 and a MAX-BET button 35 are used for determining the number of coins (hereinafter, also referred to as “the number of BETs”) to be used in the game from the coins retained inside the slot machine 10. The 1-BET button 34 is used when determining one coin at a time for the aforementioned number of BETs. The MAX-BET button 35 is used when setting the aforementioned number of BETs to a defined upper limit number.

A coin accepting slot 36 is provided to accept coins. A bill validator 115 is provided to accept bills. The bill validator 115 validates a bill, and accepts a valid bill into the cabinet 11. It is to be noted that the bill validator 115 may be configured so as to be capable of reading the later-described ticket 175 with a barcode.

An upper display device 131 is provided at the front face of the top box 12. The upper display device 131 includes a liquid crystal panel and forms the display. The upper display device 131 displays images related to effects and displays a roulette game, a jackpot game, and a feature game, each of which is the later-described bonus game, and the like, and in addition thereto, displays images showing introduction of the game contents and explanation of the game rules. In addition, the top box 12 is provided with a speaker 112 and a lamp 111. In the slot machine 10, effects are executed by displaying images, outputting sounds, and outputting light.

Below the upper display device 131, a ticket printer 171, a card slot 176, a data display 174, and a keypad 173 are provided.

The ticket printer 171 prints on a ticket a barcode representing encoded data of the number of credits, date, the identification number of the slot machine 10, and the like, and outputs the ticket as the ticket 175 with a barcode. A player can make a gaming machine read the ticket 175 with a barcode so as to play a game thereon and can also exchange the ticket 175 with a barcode with a bill or the like at a predetermined place (for example, a cashier in a casino) in the game facility.

The card slot 176 is for inserting a card in which predetermined data is stored. For example, the card stores data for identifying a player, and data about the history of games played by a player. When the card is inserted into the card slot 176, a later-described card reader 172 reads data from the card or writes data into the card. It is to be noted that the card may store data corresponding to a coin, a bill or a credit.

The data display 174 includes a fluorescent display, LEDs, and the like and displays the data read by the card reader 172 or the data inputted by a player via the keypad 173, for example. The keypad 173 is for inputting an instruction and data related to ticket issuance or the like.

Although herein, the slot machine 10 according to the embodiment of the present invention is a type of a slot machine which controls the displaying of the video reels on the display, the slot machine 10 may be a type of a slot machine which displays symbols to a player by driving mechanical reels by using a stepping motor or the like.

<Configuration of Reel Strips>

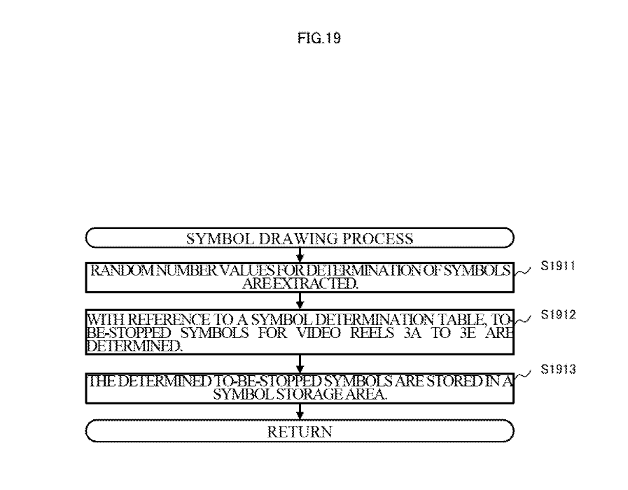

FIG. 4 to FIG. 10 show tables showing groups of reel strips (symbol arrays) which constitute five video reels 3a to 3e. Code Nos. showing symbols shown in FIG. 4 to FIG. 10 are made into data and are stored in a RAM 73. These tables shown in FIG. 4 to FIG. 10 function as symbol determination tables for determining five to-be-stopped symbols in a symbol drawing process shown in each of FIG. 19 and FIG. 25. In other words, random number values are extracted and the symbol determination tables shown in FIG. 4 to FIG. 10 are referenced, thereby determining the five code Nos. and determining symbols corresponding to the code Nos. as the five to-be-stopped symbols.

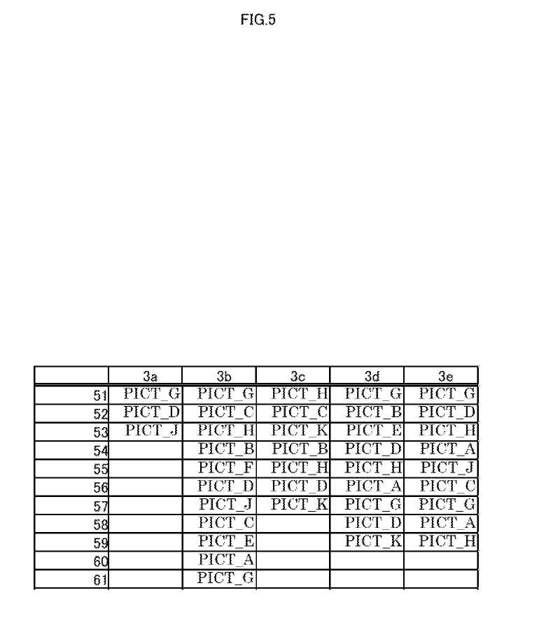

FIG. 4 and FIG. 5 show a table showing a group of reel strips used in a base game mode. FIG. 6 to FIG. 10 show tables of three kinds of groups of reel strips which are Reel Strip Feature Game_{—}0, Reel Strip Feature Game_{—}1, and Reel Strip Feature Game_{—}2.

As shown in FIG. 4 and FIG. 5, 13 kinds of symbols of WILD, PICT_A, PICT_B, PICT_C, PICT_D, PICT_E, PICT_F, PICT_G, PICT_H, PICT_J, PICT_I, PICT_K, and FEATURE are assigned to the group of reel strips used in the base game mode. For example, the symbol of PICT_B is assigned to code No. 10 of the video reel 3c.

Fifty-three symbols are assigned to the reel strip of the video reel 3a; 61 symbols are assigned to the reel strip of the video reel 3b; 57 symbols are assigned to the reel strip of the video reel 3c; 59 symbols are assigned to the reel strip of the video reel 3d; and 59 symbols are assigned to the reel strip of the video reel 3e. By the symbol drawing process, one to-be-stopped symbol is selected at an equal probability with respect to each of the five video reels 3a to 3e.

In the present embodiment, the symbols of FEATURE are arranged only on the video reels 3a, 3c, and 3e. As described above, in the base game mode, when it is determined that the symbol of FEATURE appears on each of the three video reels 3a, 3c, and 3e in the symbol display region 141d, a winning pattern is established. The winning pattern is established, thereby triggering the feature game mode and shifting the game mode from the base game mode to the feature game mode.

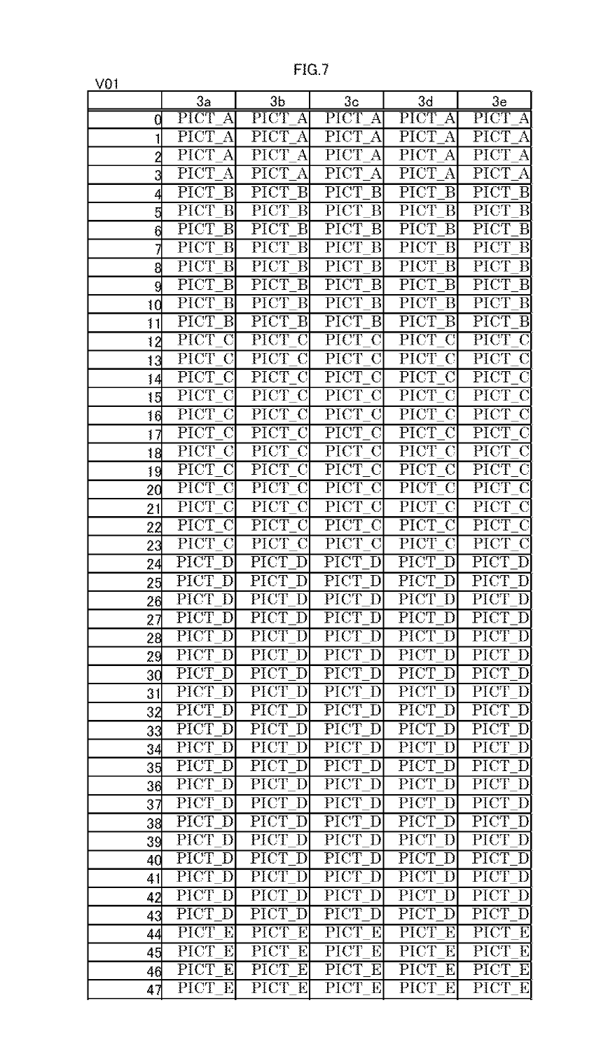

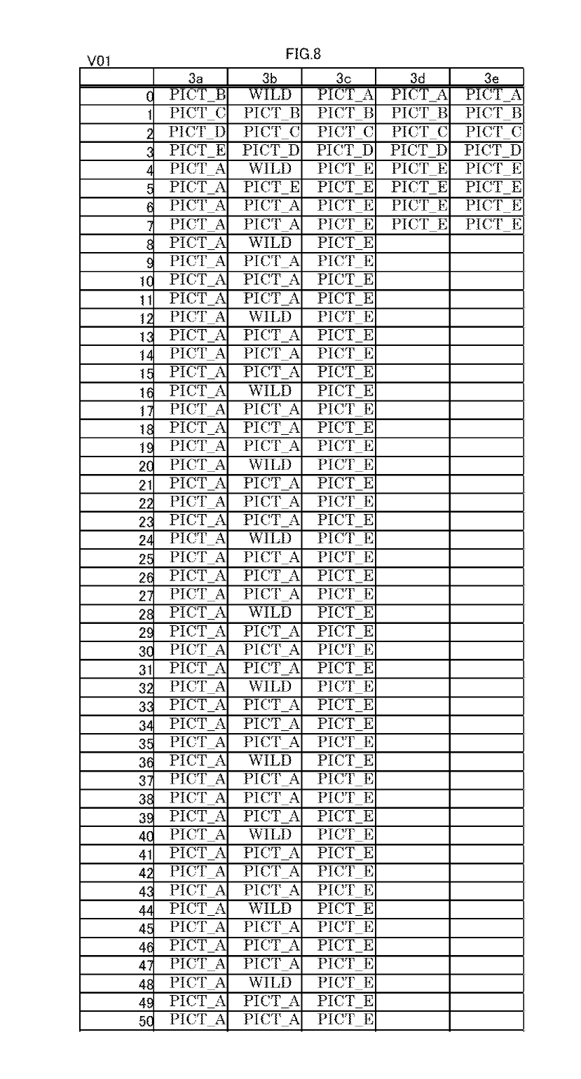

FIG. 6 to FIG. 10 show tables three groups of reel strips used in the feature game mode, which are Reel Strip Feature Game_{—}0, Reel Strip Feature Game_{—}1 and Reel Strip Feature Game_{—}2. FIG. 6 shows the table showing the group of reel strips, Reel Strip Feature Game_{—}0, FIG. 7 shows the table showing the group of reel strips, Reel Strip Feature Game_{—}1, and FIG. 8 to FIG. 10 show the table showing the group of reel strips, Reel Strip Feature Game_{—}2.

As shown in FIG. 6 to FIG. 10, the symbols of FEATURE are not assigned to the groups of reel strips, Reel Strip Feature Game_{—}0 to Reel Strip Feature Game_{—}2 used in the feature game mode. Accordingly, in the feature game mode, a retrigger by the symbols of FEATURE is not established.

As described later, in the feature game mode, one kind of reel strips among the three kinds of the groups of reel strips, Reel Strip Feature Game_{—}0 to Reel Strip Feature Game_{—}2, is determined by a drawing process and is used.

FIG. 6 shows the table showing the group of reel strips, Reel Strip Feature Game_{—}0. In this group of reel strips, Reel Strip Feature Game_{—}0, four symbols are assigned to the reel strip of the video reel 3a; 44 symbols are assigned to the reel strip of the video reel 3b; 16 symbols are assigned to the reel strip of the video reel 3c; 16 symbols are assigned to the reel strip of the video reel 3d; and 34 symbols are assigned to the reel strip of the video reel 3e.

FIG. 7 shows the table showing the group of reel strips, Reel Strip Feature Game_{—}1. In this group of reel strips, Reel Strip Feature Game_{—}1, 47 symbols are assigned to each of the reel strips of the five video reels 3a to 3e, respectively.

FIG. 8 to FIG. 10 show the table showing the group of reel strips, Reel Strip Feature Game_{—}2. In this group of reel strips, Reel Strip Feature Game_{—}2, 146 symbols are assigned to the reel strip of the video reel 3a; 107 symbols are assigned to the reel strip of the video reel 3b; 150 symbols are assigned to the reel strip of the video reel 3c, and seven symbols are assigned to each of the reel strips of the video reel 3d and the video reel 3e, respectively.

[Configuration of Circuitry included in Slot Machine 10]

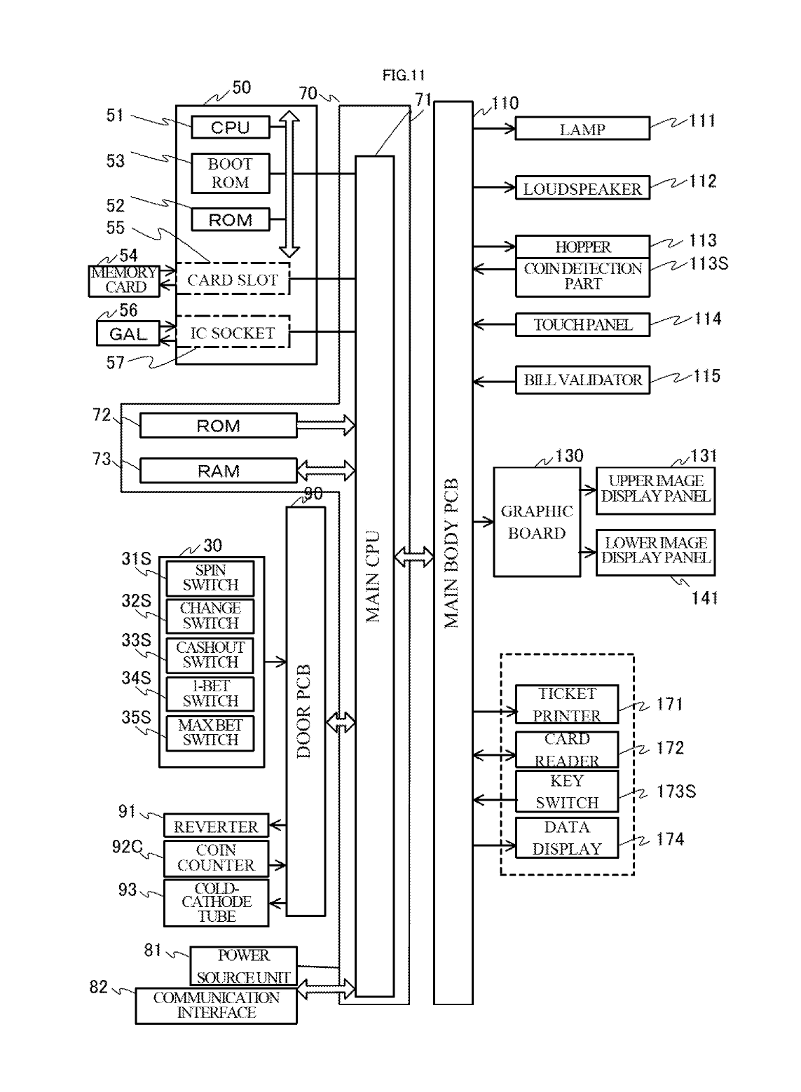

With reference to FIG. 11, a configuration of circuitry included in the slot machine 10 will be described. FIG. 11 is a block diagram illustrating an internal configuration of the slot machine 10 according to the embodiment of the present invention.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

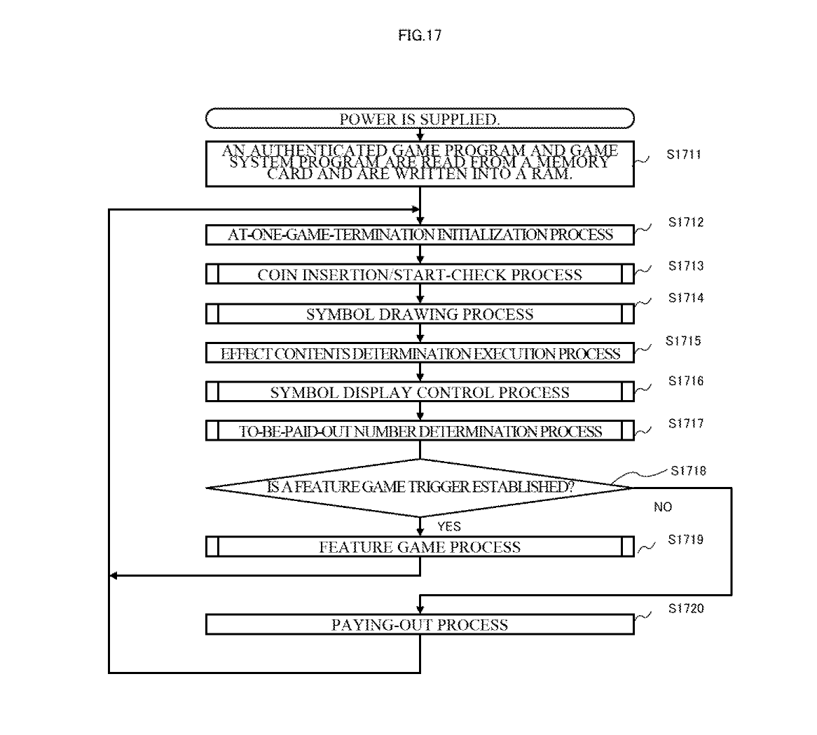

The memory card 54 includes a non-volatile memory, and stores a game program and a game system program. The game program includes a program related to game progression, a drawing program, and a program for producing effects by images and sounds (for example, refer to FIG. 17 to FIG. 37 which are described later). Further, the aforementioned game program includes data (refer to FIG. 4 to FIG. 10) specifying the configuration of the symbol array assigned to each video reel 3.

The drawing program is a program for determining to-be stopped symbols for the five video reels 3a to 3e by a drawing. The to-be-stopped symbols are symbols for determining symbols to be displayed by the symbol display region 141d among a plurality of symbols which constitute symbol arrays. The slot machine 10 according to the present embodiment determines, as the to-be-stopped symbols, symbols to be displayed in predetermined stop positions (for example, an uppermost row (first row)) of the respective five video reels 3a to 3e in the symbol display region 141d.

In the slot machine 10 according to the present embodiment, each of the to-be-stopped symbols with respect to the respective five video reels 3a to 3e is determined at an equal probability. A weight may be defined with respect to each of the plurality of symbols in the symbol determination tables shown in FIG. 4 to FIG. 10, and a symbol by which winning easily occurs and a symbol by which the winning hardly occurs may be defined.

In addition, the card slot 55 is configured so that the memory card 54 can be inserted thereinto and removed therefrom, and is connected to a motherboard 70 by an IDE bus.

The GAL 56 is a type of PLD (Programmable Logic Device) having a fixed OR array structure. The GAL 56 is provided with a plurality of input ports and output ports, and predetermined input into the input port causes output of the corresponding data from the output port.

In addition, the IC socket 57 is configured so that the GAL 56 can be inserted thereinto and removed therefrom, and is connected to the motherboard 70 by a PCI bus. The contents of the game to be played on the slot machine 10 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the pre-authentication program, and the like. The authentication program is a program (tamper check program) for authenticating the game program and the game system program. The pre-authentication program is a program for authenticating the aforementioned authentication program. The authentication program and the pre-authentication program are written along a procedure (authentication procedure) for proving that the program to be the subject has not been tampered.

The motherboard 70 is provided with a main CPU 71, a ROM 72, a RAM 73, and a communication interface 82.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted; further, through the gaming board 50, processing of loading the game program and the game system program stored in the memory card 54 is started.

The RAM 73 stores data and programs which are used in operation of the main CPU 71. For example, when the processing of loading the aforementioned game program, game system program or authentication program is conducted, the RAM 73 can store the program. The RAM 73 is provided with working areas used for operations in execution of these programs. Examples of the areas include: an area that stores the number of games, the number of BETs, the number of payouts, the number of credits and the like; and an area that stores symbols (code Nos.) determined by a drawing.

The communication interface 82 is for communicating with the external control device 200 such as a server, through the communication line 301. Further, the motherboard 70 is connected with a later-described door PCB (Printed Circuit Board) 90 and a body PCB 110 by respective USBs. The motherboard 70 is also connected with a power supply unit 81. When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the body PCB 110 are connected with input devices such as a switch and a sensor, and peripheral devices the operations of which are controlled by the main CPU 71. The door PCB 90 is connected with a control panel 30, a reverter 91, a coin counter 92C and a cold cathode tube 93.

The control panel 30 is provided with a spin switch 31S, a change switch 32S, a CASHOUT switch 33S, a 1-BET switch 34S, and a maximum BET switch 35S which correspond to the aforementioned respective buttons. Each of the switches outputs a signal to the main CPU 71 upon detection of press of the button corresponding thereto by a player.

The coin counter 92C validates a coin inserted into the coin accepting slot 36 based on its material, shape and the like, and outputs a signal to the main CPU 71 upon detection of a valid coin. Invalid coins are discharged from a coin payout exit 15A.

The reverter 91 operates based on a control signal outputted from the main CPU 71, and distributes valid coins validated by the coin counter 92C into a hopper 113 or a cash box (not shown). That is, coins are distributed into the hopper 113 when the hopper 113 is not filled with coins, while coins are distributed into the cash box when the hopper 113 is filled with coins.

The cold cathode tube 93 functions as a backlight installed on the rear face sides of the upper display device 131 and the lower display device 141 and lights up based on a control signal outputted from the main CPU 71.

The body PCB 110 is connected with the lamp 111, the speaker 112, the hopper 113, a coin detection part 113S, the touch panel 114, the bill validator 115, a graphic board 130, the ticket printer 171, the card reader 172, a key switch 173S and the data display 174.

The lamp 111 lights up based on a control signal outputted from the main CPU 71. The speaker 112 outputs sounds such as BGM, based on a control signal outputted from the main CPU 71.

The hopper 113 operates based on a control signal outputted from the main CPU 71, and pays out coins of the specified number of payouts from the coin payout exit 15A to the coin tray 15. The coin detection part 113S outputs a signal to the main CPU 71 upon detection of coins paid out by the hopper 113.

The touch panel 114 detects a place on the lower image display panel touched by a player's finger or the like, and outputs to the main CPU 71 a signal corresponding to the detected place. In addition, similarly, the upper display device 131 can be configured as a touch panel. Upon acceptance of a valid bill, the bill validator 115 outputs to the main CPU 71 a signal corresponding to the face amount of the bill.

The graphic board 130 controls display of images conducted by the respective upper display device 131 and lower display device 141, based on a control signal outputted from the main CPU 71. The symbol display region 141d of the lower display device 141 displays the five video reels 3a to 3e by which the scrolling and stop motions of the symbol arrays included in the respective five video reels 3a to 3e are displayed. The graphic board 130 is provided with a VDP generating image data, a video RAM temporarily storing the image data generated by the VDP, and the like. The number-of-credits display region 142 of the lower display device 141 displays the number of credits stored in the RAM 73. The to-be-paid-out number display region 143 of the lower display device 141 displays the number of coins to be paid out

The graphic board 130 is provided with the VDP (Video Display Processor) generating image data based on a control signal outputted from the main CPU 71, the video RAM temporarily storing the image data generated by the VDP, and the like. It is to be noted that the image data used in generation of image data by the VDP is included in the game program that has been read from the memory card 54 and stored into the RAM 73.

Based on a control signal outputted from the main CPU 71, the ticket printer 171 prints on a ticket a barcode representing encoded data of the number of credits stored in the RAM 73, date, the identification number of the slot machine 10, and the like, and then outputs the ticket as the ticket 175 with a barcode.

The card reader 172 reads data stored in a card inserted into the card slot 176 and transmits the data to the main CPU 71, or writes data into the card based on a control signal outputted from the main CPU 71.

The key switch 173S is provided in the keypad 173, and outputs a predetermined signal to the main CPU 71 when the keypad 173 has been operated by a player.

The data display 174 displays data read by the card reader 172 and data inputted by a player through the keypad 173, based on a control signal outputted from the main CPU 71.

<Payout Table>

FIG. 12 shows an example of a payout table. The payout table shown in FIG. 12 defines 13 kinds of winning patterns.

The payout table shows a relationship of the winning patterns, the numbers of Kinds of symbols, and payouts. The numbers of Kinds are the numbers of symbols constituting the winning patterns and represent the numbers of symbols which are respectively arranged in succession from a left side to a right side along a payline. As described above, in the slot machine 10 according to the present embodiment, except for the symbols of CHANCE and FEATURE, winning is determined by symbols arranged in a LEFT TO RIGHT manner. Accordingly, a payout is determined by a kind and a number of symbols which are arranged in succession along a payline, starting from the video reel 3a on the leftmost side toward the video reel 3e on the rightmost side. A winning pattern may be determined by a number of symbols arranged along a payline, instead of the symbols arranged in the LEFT TO RIGHT manner.

The first winning pattern is a pattern in which symbols of WILD are arranged. In the present embodiment, any direct payout is not defined for the arrangement of the symbols of WILD. The symbols of WILD are replaced with other symbols so as to establish an advantageous winning pattern. When the symbols of WILD are replaced with other symbols and the final winning pattern is established, a payout corresponding to that winning pattern is determined. It is to be noted that in the present embodiment, the symbol of WILD is not replaced with the symbol of BONUS.

The second winning pattern is a pattern in which two to five symbols of PICT_A are arranged in succession along a payline. For example, a payout obtained when five symbols of PICT_A are arranged along a payline is defined as 300.

The third winning pattern is a pattern in which two to five symbols of PICT_B are arranged in succession along a payline. For example, a payout obtained when five symbols of PICT_B are arranged along a payline is defined as 200.

The fourth winning pattern is a pattern in which two to five symbols of PICT_C are arranged in succession along a payline. For example, a payout obtained when five symbols of PICT_C are arranged along a payline is defined as 150.

The fifth winning pattern is a pattern in which two to five symbols of PICT_D are arranged in succession along a payline. For example, a payout obtained when five symbols of PICT_D are arranged along a payline is defined as 100.

The sixth winning pattern is a pattern in which three to five symbols of PICT_E are arranged in succession along a payline. For example, a payout obtained when five symbols of PICT_E are arranged along a payline is defined as 70.

The seventh winning pattern is a pattern in which three to five symbols of PICT_F are arranged in succession along a payline. For example, a payout obtained when five symbols of PICT_F are arranged along a payline is defined as 70.

The eighth winning pattern is a pattern in which three to five symbols of PICT_G are arranged in succession along a payline. For example, a payout obtained when five symbols of PICT_G are arranged along a payline is defined as 70.

The ninth winning pattern is a pattern in which three to five symbols of PICT_H are arranged in succession along a payline. For example, a payout obtained when five symbols of PICT_H are arranged along a payline is defined as 50.

The 10th winning pattern is a pattern in which three to five symbols of PICT_I are arranged in succession along a payline. For example, a payout obtained when five symbols of PICT_I are arranged along a payline is defined as 50.

The 11th winning pattern is a pattern in which three to five symbols of PICT_J are arranged in succession along a payline. For example, a payout obtained when five symbols of PICT_J are arranged along a payline is defined as 50.

The 12th winning pattern is a pattern in which three to five symbols of PICT_K are arranged in succession along a payline. For example, a payout obtained when five symbols of PICT_K are arranged along a payline is defined as 50.

The 13th winning pattern is a patter in which three symbols of FEATURE have appeared. As described above, the symbol of FEATURE is a scatter symbol. Accordingly, the arrangement of the symbols of FEATURE along a payline is not a condition for the establishment of a winning pattern, and the establishment of the 13th winning pattern is determined by the number of symbols of FEATURE which have appeared. A payout obtained when three symbols of FEATURE have appeared is defined as two.

As described above, on the condition that it is determined by the symbol drawing process that the three symbols of FEATURE are to appear in the symbol display region 141d, the feature game mode is triggered. Accordingly, when it is determined by the symbol drawing process that the three symbols of FEATURE are to appear in the symbol display region 141d, a player is provided with both benefits of the provision of a payout and the shifting to the feature game mode.

<<Game State Transition>>

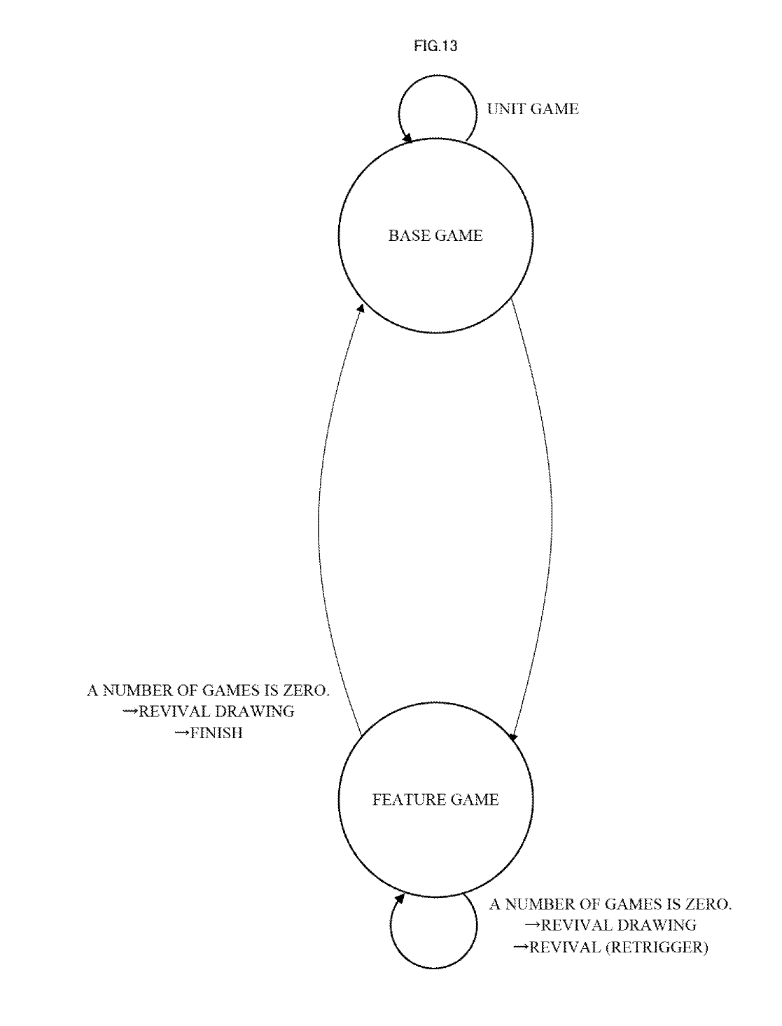

FIG. 13 is a diagram illustrating state transition in a slot machine 10. Specifically, FIG. 13 shows the state transition in a base game mode and a feature game mode.

The slot machine 10 has two kinds of game modes including the base game mode and the feature game mode. On the slot machine 10, a unit game is executed in the base game mode as a main game mode, and when a trigger (event) of a feature game has occurred in the base game mode, the game mode is shifted to the feature game mode.

As shown in FIG. 13, in the base game mode, the unit game is repeated until the trigger of the feature game is established. The game in the base game mode is a game in which the unit game can be played by consuming (betting) gaming media such as medals or the like. In this base game mode, when any of winning patterns shown in FIG. 12 is established, an amount of a payout in accordance with a payout corresponding to that winning pattern is paid out

In the base game mode, a winning pattern by symbols of FEATURE is established, thereby triggering the feature game mode. The symbols of FEATURE are scatter symbols, by which a winning pattern is established, irrespective of any payline. It is determined by the number of symbols of BONUS appearing in the symbol display region 141d whether or not the winning pattern is established.

The feature game mode is triggered, thereby shifting the game mode to the feature game mode. It is only required for the game in the feature game mode to be a more advantageous game than the game in the base game mode. The game in the feature game mode may be a game in which a unit game is played without consuming gaming media such as medals. In the present embodiment, upon shifting to the feature game mode, a maximum number of times at which the unit game in the feature game mode is played is determined. A player can play the unit game in the feature game mode at up to the maximum number of times.

In the feature game mode, when a number of remaining unit games comes to be zero, a retrigger is executed by a revival drawing process. When the revival occurs by the revival drawing process, five unit games are added by executing the revival drawing process once. When the game is finished by the revival drawing process, no unit game is added, the feature game mode is finished, and the game mode returns to the base game mode. The revival drawing process can be conducted at up to eight times, and in the feature game mode, up to 50 unit games can be played by the revival drawing process. The retrigger occurs in each of the 10th, 15th, 20th, 25th, 30th, 35th, 40th, and 45th unit games (rounds).

When all of the maximum number of unit games determined by the roulette game are consumed, the feature game mode is finished, and the game mode returns to the base game mode.

As described above, in the feature game mode, although the drawing process for the to-be-stopped symbols is executed, the scrolling of reel strips is not displayed. Instead, in the feature game mode, the images of effects, in each of which the two kinds of characters which are the mutually opposing ally character and enemy character, have a battle, are displayed.

One round of the battle corresponds to one unit game. Accordingly, effects of the battles of the maximum number of unit games are displayed.

<Payline>

FIG. 16 is a table showing an example of a payline definition table which defines paylines adopted in a slot machine 10. As described above, in the slot machine 10 according to the present embodiment, in a symbol display region 141d, as stop positions of symbols of five video reels 3a to 3e, four rows which are an uppermost row (first row=0), an upper middle row (second row=1), a lower middle row (third row=2), and a lowermost row (fourth row=3) are defined. In the slot machine 10, 40 paylines are set in a symbol matrix of 5 arrays×4 rows (5 columns×4 rows). The payline definition table defines the paylines formed by connecting four regions in the uppermost row, the upper middle row, the lower middle row, and the lowermost row of each of the five video reels 3a to 3e in the symbol display region 141d.

For example, a region in the uppermost row of the video reel 3a (first reel strip), a region in the uppermost row of the video reel 3b (second reel strip), a region in the uppermost row of the video reel 3c (third reel strip), a region in the uppermost row of the video reel 3d (fourth reel strip), and a region in the uppermost row of the video reel 3e (fifth reel strip) constitute one payline (payline No. 1 in FIG. 16).

In the slot machine 10 according to the present embodiment, all of the 40 paylines are active, irrespective of a bet amount and any selection by a player. The paylines may be made active in accordance of the selection by a player. In addition, a total number of the paylines can be appropriately determined in accordance with a size of the symbol matrix.

<<Kinds of Characters>>

As described above, in the feature game mode in the slot machine 10 according to the present embodiment, the images of effects, in each of which the two kinds of characters which are the mutually opposing ally character and enemy character have a battle, are displayed. There are three kinds (four kinds) of enemy characters. There may be a case when knockout effects, in which the ally character defeats the enemy character, whereby a stronger enemy character appears, are conducted.

FIG. 14 and FIG. 15 are diagrams each illustrating an outline of the knockout effects. FIG. 14 is a diagram illustrating knockout effects in which three kinds of enemy characters which are a common foot soldier, a samurai, and a shogun appear. FIG. 15 is a diagram illustrating knockout effects in which four kinds of enemy characters which are a common foot soldier, a samurai, shogun, and a shogun 2 appear. Each time the enemy character is defeated, a degree of expectation of a payout which can be obtained changes. Basically, the battle starts from a battle with the common foot soldier ranking the lowest. When the enemy character is defeated during the battle, the enemy character ranking higher appears and the degree of expectation of a payout is increased. There may be a case when no knockout effects occurs.

A number of rounds of the battle is, basically, 10. When a retrigger has occurred, the number of rounds of the battle is increased by five rounds. Accordingly, when the retrigger has occurred once, the number of rounds is 15. When the retrigger has occurred twice, the number of rounds is 20. The retrigger occurs at up to nine times, and a maximum number of rounds is 50.

In the example shown in FIG. 14, in the first round, the common foot soldier appears; in the third round, the ally character defeats the common foot soldier; in the fourth round, the samurai appears; in the sixth round, the ally character defeats the samurai; in the seventh round, the shogun appears; and in the 10th round, the ally character defeats the shogun (wins) or the ally character is defeated by the shogun (loses), thereby finishing the feature game.

In the example shown in FIG. 15, in the first round, the common foot soldier appears; in the fourth round, the ally character defeats the common foot soldier; in the fifth round, the samurai appears; in the seventh round, the ally character defeats the samurai; in the eighth round, the shogun appears; in the 10th round, the ally character defeats the shogun; in the 11th round, the shogun 2 appears; and in the 15th round, the ally character defeats the shogun 2, thereby finishing the feature game.

As show in FIG. 15, the version “shogun 2” whose appearance is different from that of the “shogun” is present as the third knockout enemy character. In a state in which the “shogun” has already appeared in the knockout battle and the retrigger has occurred, in the subsequent rounds, the enemy character is changed to the “shogun 2”. Unlike the other enemy characters, the “shogun 2” appears upon the occurrence of the retrigger, instead of the knockout. It is to be noted that in the present embodiment, the shogun 2 is merely different slightly from the shogun in the appearance, and is the shogun as the character.

In the case when the retrigger occurs, in each of the rounds (the 10th round, the 15th round, the 20th round, the 25th round, and the like) in which the retrigger occurs, effects in which the ally character defeats the enemy character and wins are invariably generated, and effects for finishing the feature game and retrigger effects are displayed. In addition, after the retrigger, the next enemy character ranking higher by one rank (enemy character after the knockout) appears.

<<Contents of Programs>>

Next, with reference to FIG. 17 to FIG. 37, programs executed by a slot machine 10 will be described.

<Main Control Process>

First, with reference to FIG. 17, a main control process will be described. FIG. 17 is a flowchart of the main control process for the slot machine 10 according to the embodiment of the present invention. A game mode in the main control process shown in FIG. 17 is a base game mode.

First, when the power is supplied to the slot machine 10, the main CPU 71 reads the authenticated game program and game system program from the memory card 54 through the gaming board 50, and writes the programs into the RAM 73 (step S1711).

Next, the main CPU 71 conducts an at-one-game-end initialization process (step S1712). For example, data that becomes unnecessary after each game in the working areas of the RAM 73, such as the number of BETs and the symbols determined by a drawing, is cleared.

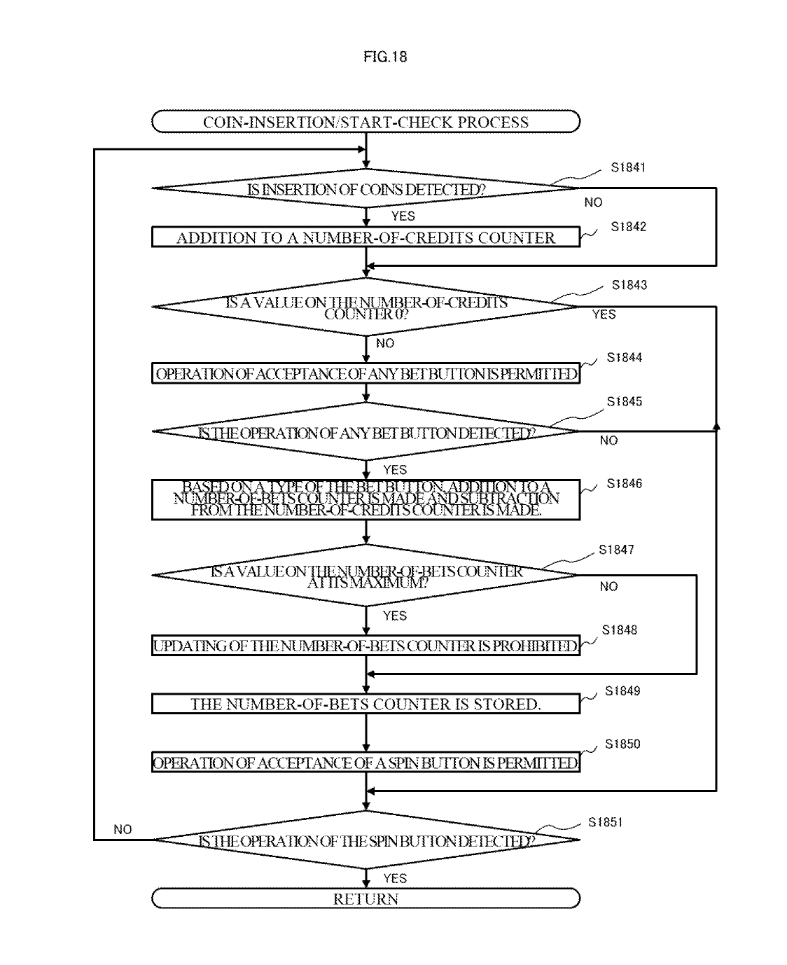

The main CPU 71 conducts a coin-insertion/start-check process which is described later with reference to FIG. 18 (step S1713). In the process, input from the BET switch and the spin switch is checked.

The main CPU 71 then conducts a symbol drawing process which is described later with reference to FIG. 19 (step S1714). In the process, to-be stopped symbols are determined based on the random values for symbol determination, and when the symbols of FEATURE are determined, the feature game trigger is established.

Next, the main CPU 71 conducts an effect contents start process (step S1715). In the process at step S1715, the main CPU 71 extracts random number values for effects, determines any of a predetermined plurality of effect contents by a drawing, and executes the effect contents at the timing of the determined effect contents. For example, the main CPU 71 displays video for effects on an upper display device 131, outputs audio from a loudspeaker 112, lights a lamp 111, and performs the control, for example, by subjecting these to effect processes.

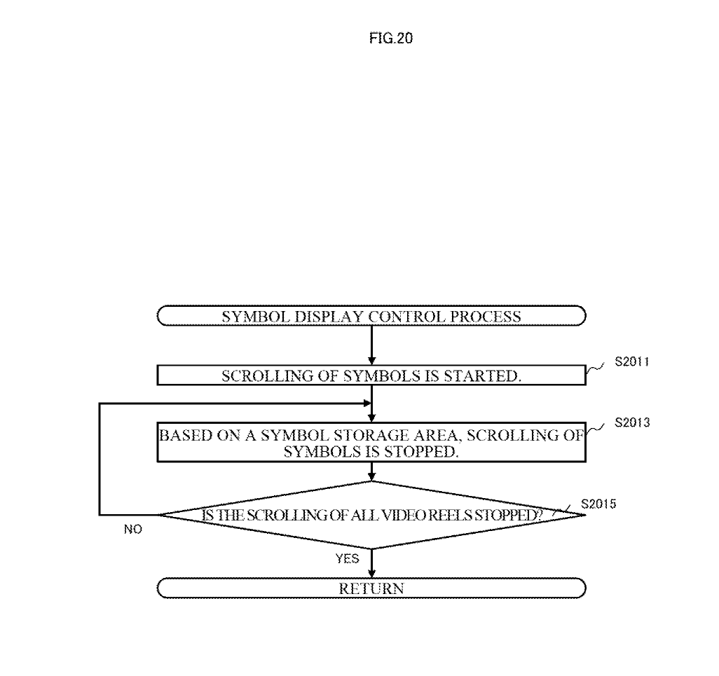

Next, the main CPU 71 conducts a symbol display control process which is described later with reference to FIG. 20 (step S1716). In this process, scrolling of five video reels 3a to 3e (five reel strips) is started, and the to-be stopped symbols determined in the symbol drawing process at step S1714 are stopped at predetermined positions.

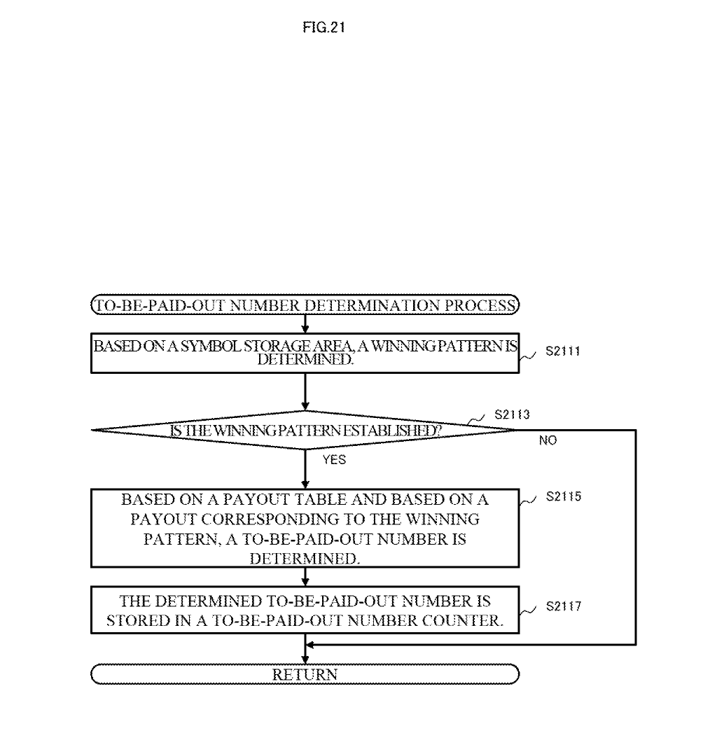

Next, the main CPU 71 conducts a to-be-paid-out number determination process which is described later with reference to FIG. 21 (step S1717). In this process, it is determined from the five to-be-stopped symbols stored in a symbol storage area by the later-described symbol drawing process whether or not a winning pattern in the payout table (refer to FIG. 12) is established. A to-be-paid-out number based on the payout table (refer to FIG. 12) in accordance with the winning pattern is determined and is stored in a to-be-paid-out number storage area (to-be-paid-out number counter) provided in the RAM 73.

Next, the main CPU 71 determines whether or not the feature game trigger is established (step S1718). When the main CPU 71 determines that the feature game trigger is established, the main CPU 71 conducts a feature game mode process which is described later with reference to FIG. 23 (step S1719) and returns the process to step S1712.

Next, when the main CPU 71 determines at step S1718 that the feature game trigger is not established, the main CPU 71 conducts a paying-out process (step S1720). The main CPU 71 adds a value stored in the to-be-paid-out number storage area (to-be-paid-out number counter) to a value stored in a number-of-credits storage area provided in the RAM 73 (number-of-credits counter). It is to be noted that the driving of a hopper (not shown) may be controlled, thereby discharging coins in accordance with the to-be-paid-out number counter from a coin payout exit. In addition, the driving of a ticket printer (not shown) may be controlled, thereby issuing a ticket with a barcode having the to-be-paid-out number counter registered thereon.

Next, the main CPU 71 returns the processing to step S1712.

<Coin-Insertion/Start-Check Process>

Next, with reference to FIG. 18, a coin-insertion/start-check process will be described. FIG. 15 is a flowchart of the coin-insertion/start-check process for the slot machine 10 according to the embodiment of the present invention.

First, the main CPU 71 determines whether or not insertion of coins has been detected by a coin counter (step S1841). When the main CPU 71 determines that the insertion of coins has been detected, the main CPU 71 adds a value of inserted coins to a value stored in the number-of-credits storage area (number-of-credits counter) (step S1842). It is to be noted that in addition to the determination of the insertion of coins, the main CPU 71 may determine whether or not insertion of bills has been detected based on bill validation data (for example, by a PTS terminal (not shown) or the like), and when the main CPU 71 determines that the insertion of bills has been detected, the main CPU 71 may add a value in accordance with the bills to a value of the number-of-credits counter.

After step S1842, or when at step S1841, the main CPU 71 determines that the insertion of coins has not been detected, the main CPU 71 determines whether or not a value of the number-of-credits counter is zero (step S1843). When the main CPU 71 determines that the value of the number-of-credits counter is not zero, the main CPU 71 permits acceptance of an operation of any of BET buttons (step S1844).

Next, the main CPU 71 determines whether or not the operation of any of the BET buttons has been detected (step S1845). When the main CPU 71 determines by a BET switch that any of the BET buttons has been pressed by a player, based on a kind of the pressed button among the BET buttons, the main CPU 71 performs addition of a value stored in a number-of-BETs storage area (number-of-BETs counter) provided in the RAM 73 and performs subtraction for the number-of-credits counter (step S1846).

Next, the main CPU 71 determines whether or not a value of the number-of-BETs counter is at its maximum (step S1847). When the main CPU 71 determines that the value of the number-of-BETs counter is at its maximum, the main CPU 71 prohibits updating of the number-of-BETs counter (step S1848).

Next, after step S1848, or when at step S1847, the main CPU 71 determines that the value of the number-of-BETs counter is not at its maximum, the main CPU 71 stores a value of the number-of-BETs counter (step S1849). In the feature game mode, without consuming any gaming media such as medals, the feature game (unit game) can be played. Accordingly, without placing any BET, the feature game can be initiated, and a value of the number-of-BETs counter cannot be determined by the BET operation. Therefore, upon shifting to the feature game mode, a value of the number-of-BETs counter in the base game mode immediately prior to shifting thereto is used. The value of the number-of-BETs counter stored at step S1849 is read out and used upon shifting to the feature game mode.

Next, the main CPU 71 permits acceptance of an operation of the spin button (step S1850).

After step S1850, or when at step S1845, the main CPU 71 determines that the operation of any of the BET buttons has not been detected or at step S1843, determines that the value of the number-of-credits counter is zero, the main CPU 71 determines whether or not the operation of the spin button has been detected (step S1851). When the main CPU 71 determines that the operation of the spin button has not been detected, the main CPU 71 shifts to step S1841.

When the main CPU 71 determines that the operation of the spin button has been detected, the main CPU 71 finishes the coin-insertion/start-check process.

<Symbol Drawing Process>

Next, with reference to FIG. 19, a symbol drawing process will be described. FIG. 19 is a flowchart of the symbol drawing process in the slot machine 10 according to the embodiment of the present invention.

First, the main CPU 71 extracts five random number values for the determination of symbols (step S1911). Next, the main CPU 71 determines to-be-stopped symbols of the five video reels 3a to 3e from the five random number values by a drawing (step S1912).

In the process at step S1912, with reference to each symbol determination table, the five to-be-stopped symbols are determined. In the present embodiment, the symbol determination tables are symbol determination tables shown in FIG. 4 to FIG. 10.

When the game mode is the base game mode, with reference to the symbol determination table for the base game mode shown in FIG. 4 and FIG. 5, five to-be-stopped symbols are determined.

It is to be noted that as described later, when the game mode is the feature game mode, with reference to each of the symbol determination tables for the feature game mode shown in FIG. 6 to FIG. 10, five to-be-stopped symbols are determined. Specifically, when the group of reel strips, Reel Strip Feature Game_{—}0, is selected, the symbol determination table for the feature game mode shown in FIG. 6 is referenced. When the group of reel strips, Reel Strip Feature Game_{—}1, is selected, the symbol determination table for the feature game mode shown in FIG. 7 is referenced. When the group of reel strips, Reel Strip Feature Game_{—}2, is selected, the symbol determination table for the feature game mode shown in FIG. 8 to FIG. 10 is referenced.

In other words, the main CPU 71 extracts five random number values for symbol determination, and in accordance with the game mode, with reference to any symbol determination table among the symbol determination tables shown in FIG. 4 to FIG. 10, one symbol with respect to each of the five video reels 3a to 3e is determined as a to-be stopped symbol.

In the present embodiment, each of the five to-be-stopped symbols is determined at an equal probability.

By conducting the process at step S1912, the five to-be-stopped symbols corresponding to the five video reels 3a to 3e are determined. The stopping of the five video reels 3a to 3e is controlled such that the determined five to-be-stopped symbols stop in an uppermost row of a symbol matrix (uppermost row of the symbol display region 141d).

Next, the main CPU 71 stores the determined to-be stopped symbols of the five video reels 3a to 3e in a symbol storage area provided in the RAM 73 (step S1913).

In the present embodiment, each of the five to-be-stopped symbols is determined by the symbol drawing process at the equal probability. In contrast to this, predetermined weights may be defined with respect to the plurality of symbols constituting the respective five video reels 3a to 3e, and in accordance with the weights, the five to-be-stopped symbols may be determined.

<Symbol Display Control Process>

Next, with reference to FIG. 20, a symbol display control process will be described. FIG. 20 is a flowchart of the symbol display control process in the slot machine 10 according to the present embodiment.

The main CPU 71 starts the scrolling of five video reels 3a to 3e displayed in a symbol display region 141d of a lower display device 141 (step S2011).

A speed, a direction, and the like of the scrolling of the five video reels 3a to 3e are controlled by a variety of parameters for predictive and ready-to-win effects.

In the present embodiment, the five video reels 3a to 3e shown in FIG. 4 to FIG. 10 are displayed as the reel strips.

Next, based on the symbol storage area, the main CPU 71 stops the scrolling of any predetermined video reel among the five video reels 3a to 3e (step S2013). The video reel to be stopped and the timing of the stopping are determined by the variety of parameters for the predictive and ready-to-win effects.

Next, the main CPU 71 determines whether or not all of the five video reels 3a to 3e have been stopped (step S2015). When the main CPU 71 determines that all of the five video reels 3a to 3e have not been stopped, the main CPU 71 returns the processing to step S2013. On the other hand, when the main CPU 71 determines that all of the five video reels 3a to 3e have been stopped, the main CPU 71 finishes this sub-routine.

In the present embodiment, for a period from when the scrolling of the five video reels 3a to 3e is started to when the scrolling of the five video reels 3a to 3e is stopped, the speed, the direction, a period of time, and the like of the scrolling of the five video reels 3a to 3e are controlled by the main CPU 71, thereby allowing the predictive and ready-to-win effects to be executed.

<To-Be-Paid-Out Number Determination Process>

Next, with reference to FIG. 21, a to-be-paid-out number determination process will be described. FIG. 21 is a flowchart of the to-be-paid-out number determination process in the slot machine 10 according to the embodiment of the present invention.

First, with reference to a payout table shown in FIG. 14, the main CPU 71 determines a winning pattern based on the symbols stored in a symbol storage area (step S2111).

Next, in accordance with a kind of the symbols determined at step S2111, the main CPU 71 determines whether or not a winning pattern has been established (step S2113).

Next, when the winning pattern is established, based on the symbol storage area and the payout table (FIG. 12), the main CPU 71 determines a to-be-paid-out number based on a payout which satisfies the winning pattern (step S2115).

Next, the main CPU 71 stores the determined to-be-paid-out number in the to-be-paid-out number counter of the to-be-paid-out number storage area (step S2117) and finished this sub-routine.

When in the determination process at step S2113, the main CPU 71 determines that the winning pattern has not been established, the main CPU 71 immediately finishes this sub-routine.

<<Outline of Feature Game Mode>>

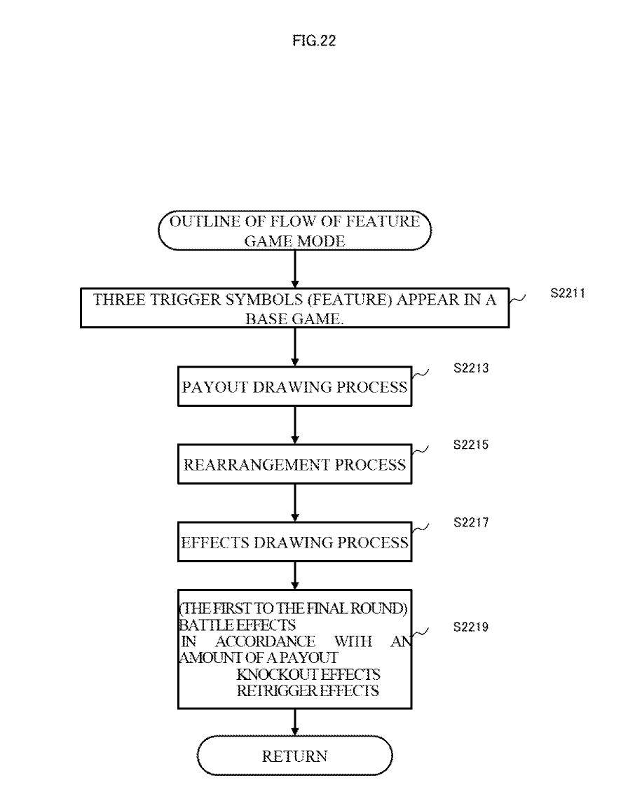

FIG. 22 is a flowchart showing an outline of the feature game mode.

In a unit game in the base game mode, on the condition that three symbols of FEATURE (trigger symbols) have appeared in the symbol display region 141d, the game mode shifts to the feature game mode (step S2211).

Next, a drawing process for each payout is executed. As described above, upon shifting to the feature game mode, a maximum number of unit games is determined, and payouts of all of the unit games (rounds) are determined (step S2213).

Next, the rearrangement of the determined payouts is executed. Except for a part of the unit games (rounds), the rearrangement is executed such that each payout increases as the unit games (rounds) proceed, and the rearrangement is stored in the RAM 73 (step S2215).

Next, battle effects in each of all of the unit games (rounds) are determined by a drawing process (step S2217).

From the first round to the final round (all of the unit games (rounds)), the determined battle effects are executed (step S2219). As described later, the battle effects include knockout effects, retrigger effects, and the like.

<Feature Game Mode Process>

With reference to FIG. 23, a feature game mode process will be described. FIG. 23 is a flowchart of the feature game mode process in the slot machine 10 according to the present embodiment

First, the main CPU 71 invokes and executes a payout drawing process shown in FIG. 24 (step S2311).

Next, the main CPU 71 invokes and executes a winning or losing determination and rearrangement pattern determination process shown in FIG. 27 (step S2313).

Next, the main CPU 71 invokes and executes a rearrangement execution process shown in FIG. 28 (step S2315).

By executing the above-mentioned processes at step S2311 to S2315, the oder in which the unit games in the feature game mode, that is, the rounds of battle effects are executed can be determined.

Next, the main CPU 71 invokes and executes a knockout effects determination process shown in FIG. 30A and FIG. 30B (step S2317).

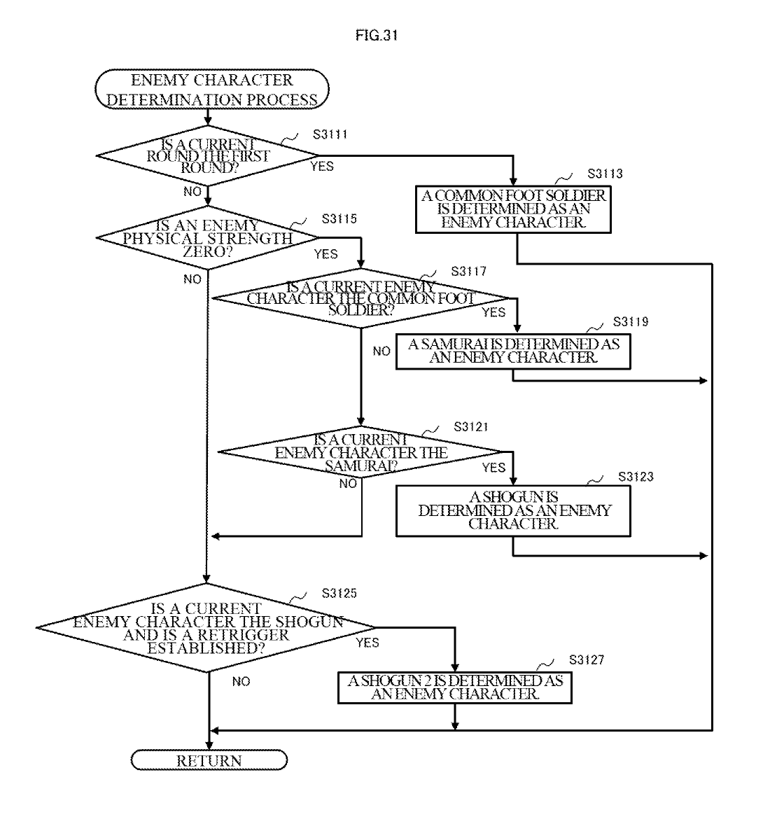

Next, the main CPU 71 invokes and executes an enemy character determination process shown in FIG. 31 (step S2319).

Next, the main CPU 71 invokes and executes an enemy character physical strength determination process shown in FIG. 32 (step S2321).

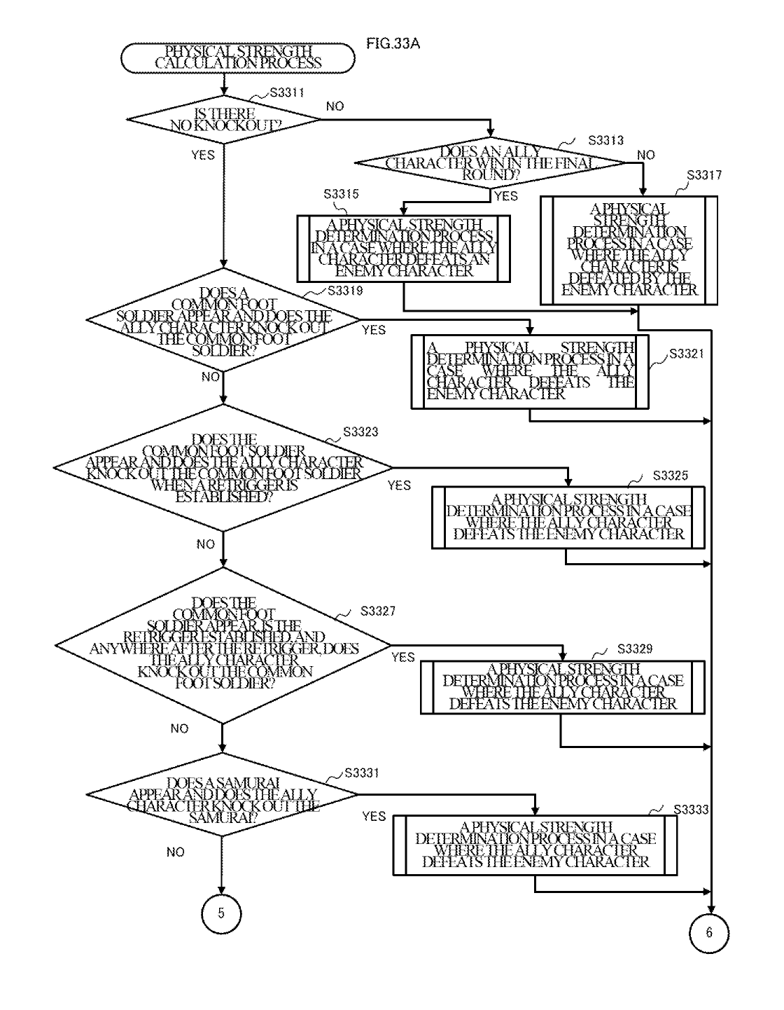

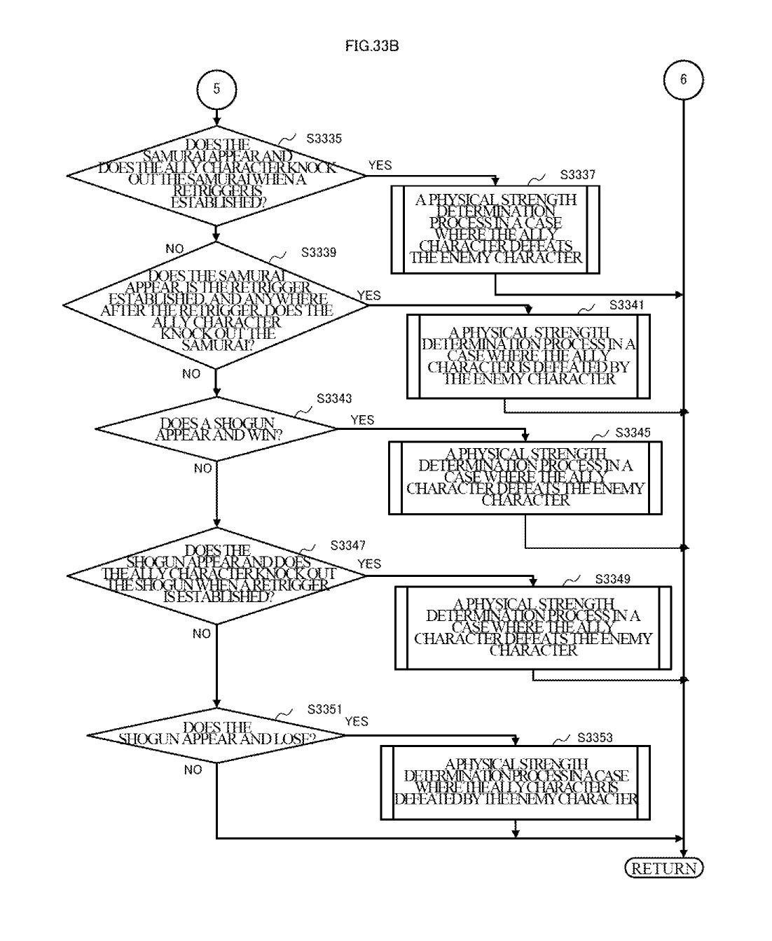

Next, the main CPU 71 invokes and executes a physical strength calculation process shown in FIG. 33A and FIG. 33B (step S2323).

Next, the main CPU 71 invokes and executes a battle effects drawing process shown in FIG. 36 (step S2325).

By executing the above-mentioned processes at step S2317 to S2325, specific contents of the battle effects in the fea8ture game mode can be determined for each round (each unit game). By conducting the below-mentio36ed processes at step S2329 to S2337, the determined battle effects are executed for each round (each unit game).

Next, the main CPU 71 sets a number of games to one (step S2329).

Next, the main CPU 71 executes the battle effects corresponding to the number of games (step S2331). The executed battle effects are displayed in the symbol display region 141d of the lower display device 141.

Next, the main CPU 71 rearranges and displays symbols in accordance with to-be-stopped symbols corresponding to the number of games (step S2333). In the feature game mode according to the present embodiment, the rearrangement of the symbols is displayed on the upper display device 131.

Next, the main CPU 71 adds only one to the number of games (step S2335).

Next, the main CPU 71 determines whether or not the number of games is less than or equal to a maximum number of games (step S2337). This maximum number of games is synonymous with a number of rounds from the first round to the final round.

When the main CPU 71 determines that the number of games is less than or equal to the maximum number of games, the main CPU 71 returns the processing to step S2331.

When the main CPU 71 determines that the number of games is larger than the maximum number of games, the main CPU 71 finishes this sub-routine. This returns the game mode from the feature game mode to the base game mode.

<Payout Drawing Process>

FIG. 24 is a flowchart of a payout drawing process in the slot machine 10 according to the present embodiment. The payout drawing process is a process in which payouts of all of the unit games (all rounds) in the feature game mode are determined. In the slot machine 10 according to the present embodiment, upon shifting from the base game mode to the feature game mode, the payouts of all of the unit games in the feature game mode are previously determined. Accordingly, the payout drawing process here is different from a payout drawing process in which each time a unit game is initiated, a payout of the unit game is determined by a drawing process.

As described above, the payouts of all of the unit games in the feature game mode are previously determined, thereby allowing contents of battle effects to be previously determined for each round and enabling the battle effects to be executed so as to gradually enhance a feeling of expectation.

First, the main CPU 71 sets a maximum number of games to 10 (step S2411). The maximum number of games is a maximum number of times in the feature game mode, each of at which the unit game is played, and means a number of rounds from the first round to the final round, in each of which battle effects are executed. It is to be noted that at this point in time, the maximum number of games (the number of rounds from the first round to the final round) is not determined, since a retrigger might be established, and upon executing and finishing this sub-routine, the maximum number of games (the number of rounds from the first round to the final round) is determined.

Next, the main CPU 71 sets a value of a counter to the maximum number of games (step S2413). The value of the counter is a variable used for determining whether or not a retrigger is established.

Next, the main CPU 71 sets the number of games to one (step S2415).

Next, the main CPU 71 invokes and executes a feature game mode symbol drawing process shown in FIG. 25 (step S2417). By conducting this process, the five to-be-stopped symbol corresponding to the five video reels 3a to 3e are determined by the drawing process. In the feature game mode, one kind of reel strips among the three kinds of groups of reel strips, Reel Strip Feature Game_{—}0, Reel Strip Feature Game_{—}1, and Reel Strip Feature Game_{—}2, is selected by the drawing process, and the five to-be-stopped symbols are determined.

Next, the main CPU 71 makes the respective five to-be-stopped symbols correspond to each game of the number of games and stores the corresponding respective five to-be-stopped symbols in the symbol storage area provided in the RAM 73 (step S2419).

Next, the main CPU 71 executes a payout process in the feature game mode (step S2421). With reference to the payout table shown in FIG. 12, when a winning pattern is established by the five to-be-stopped symbols, a payout corresponding to the winning pattern is determined.

Next, the main CPU 71 makes the payout determined at step S2421 correspond to each game of the number of games and stores the corresponding payout in a payout storage area (step S2423).

Next, the main CPU 71 subtracts one from the value of the counter (step S2425).

Next, the main CPU 71 adds one to the number of games (step S2427).

Next, the main CPU 71 determines whether or not a value of the counter is larger than zero (step S2429). As described above, it is determined by the value of the counter whether or not the retrigger is established. When the value of the counter comes to be zero, the retrigger is established.

When the main CPU 71 determines that the value of the counter is larger than zero, the main CPU 71 returns the processing to step S2417. In other words, when no retrigger is established, the main CPU 71 returns the processing to step S2417.

When the main CPU 71 determines that the value of the counter is less than or equal to zero, the main CPU 71 reads out and executes a revival drawing process shown in FIG. 26 (step S2431). In other words, when the retrigger is established, the revival drawing process is executed.

By the revival drawing process, the main CPU 71 determines whether or not revival occurs (step S2433).

When by executing the revival drawing process, the main CPU 71 determines that the revival occurs, the main CPU 71 returns the processing to step S2417. As described with reference to FIG. 26, when the retrigger is established and the revival occurs, the maximum number of games in the feature game mode can be increased.

When by executing the revival drawing process, the main CPU 71 determines that the revival drawing process is finished, the main CPU 71 finishes this sub-routine.

As described above, at this point in time, the maximum number of games of the unit games in the feature game mode (number of rounds from the first round to the final rounds) is determined.

In the present embodiment, the establishment of the retrigger is determined only when it is determined that the value of the counter is less than or equal to zero. Specifically, in each of the 10th, 15th, 20th, 25th, 30th, 35th, 40th, and 45th rounds, it is determined whether or not the retrigger is established. When the retrigger is not established at all, the final round is the 10th round. When all of the retriggers are established, the final round is the 50th round.

<Feature Game Mode Symbol Drawing Process>

FIG. 25 is a flowchart of a feature game mode symbol drawing process in the slot machine 10 according to the present embodiment. In the feature game mode, the three kinds of reel strips, Reel Strip Feature Game_{—}0 (FIG. 6), Reel Strip Feature Game_{—}1 (FIG. 7), and Reel Strip Feature Game_{—}2 (FIG. 8 to FIG. 10) are used.

First, the main CPU 71 extracts random number values for reel strip determination (step S2511). The random number values are 10 integer values from 0 to 9.

Next, the main CPU 71 selects one kind of reel strips among the three kinds of reel strips of Reel Strip Feature Game_{—}0 to 2 by using the number of games with reference to a reel strip drawing table shown in FIG. 40 (step S2513).

As shown in FIG. 40, the reel strip drawing table defines weights for the three kinds of reel strips, Reel Strip Feature Game_{—}0 to 2, so as to correspond to the first to the 50th unit games of the number of games (rounds). In the reel strip drawing table, in each of the 10th, 15th, 20th, 25th, 30th, 35th, 40th, 45th, and 50th games among the number of games, the reel strips of Reel Strip Feature Game_{—}2 is invariably selected. In each of the games other than the 10th, 15th, 20th, 25th, 30th, 35th, 40th, 45th, and 50th games mentioned above, a weight for the reel strips of Reel Strip Feature Game_{—}0 is defined as nine, and a weight for the reel strips of Reel Strip Feature Game_{—}1 is defined as one. Accordingly, the weights are defined such that the reel strips of Reel Strip Feature Game_{—}0 is easily selected.

Next, the main CPU 71 extracts random number values for symbol determination in accordance with the determined reel strips (step S2515).

Next, with reference to the symbol determination table of the determined reel strips, the main CPU 71 determines five to-be-stopped symbols corresponding to the respective five video reels 3a to 3e (step S2517) and finishes this sub-routine. When the reel strips of Reel Strip Feature Game_{—}0 is selected, with reference to the symbol determination table shown in FIG. 6, the five to-be-stopped symbols are determined. When the reel strips of Reel Strip Feature Game_{—}1 is selected, with reference to the symbol determination table shown in FIG. 7, the five to-be-stopped symbols are determined. When the reel strips of Reel Strip Feature Game_{—}2 is selected, with reference to the symbol determination table shown in FIG. 8 to FIG. 10, the five to-be-stopped symbols are determined.

<Revival Drawing Process>

FIG. 26 is a flowchart of a revival drawing process in the slot machine 10 according to the present embodiment.

First, the main CPU 71 extracts random number values for a revival drawing (step S2611). The random number values are two integer values of 0 to 1.

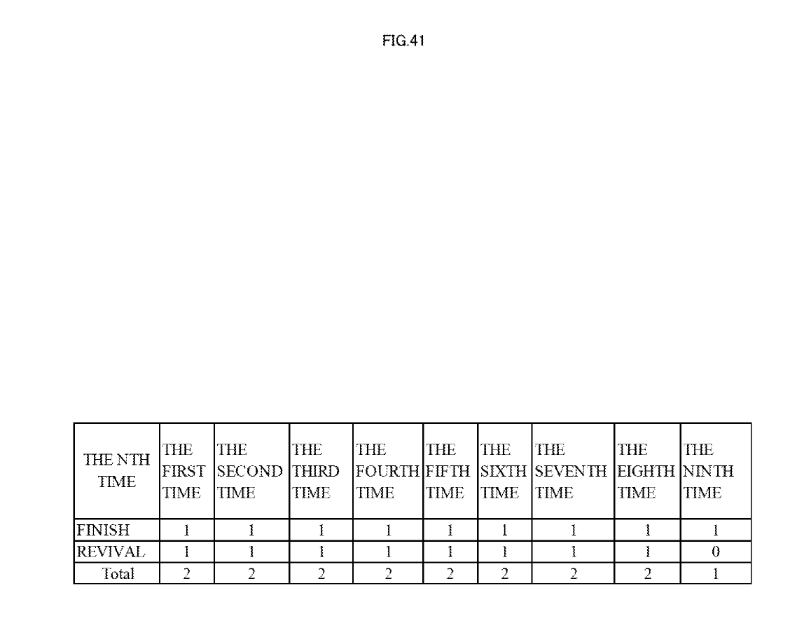

Next, with reference to a revival drawing table shown in FIG. 41, the main CPU 71 determines whether revival occurs or the revival drawing process is finished (step S2613).

Next, by the processing at step S2613, the main CPU 71 determine whether or not the revival occurs (step S2615).

When the main CPU 71 determines that the revival occurs, the main CPU 71 adds five to a maximum number of games (step S2617), adds five to a value of a counter (step S2619), and finishes this sub-routine. When the main CPU 71 determines that the revival does not occur, the main CPU 71 immediately finishes this sub-routine.

By adding five to the maximum number of games, the maximum number of games in the feature game mode can be increased by five. In other words, the final round comes to be five rounds behind. In addition, by increasing the value of the counter by five, timing at which the retrigger is determined can be set to be five games later.

<Winning or Losing Determination and Rearrangement Pattern Determination Process>

FIG. 27 is a flowchart of a winning or losing determination and rearrangement pattern determination process in the slot machine 10 according to the present embodiment. Winning or losing here means winning or losing of an ally character and means the final winning or losing. In battle effects in the final round (game played at the maximum number-th time), it is determined whether the ally character defeats an enemy character or the ally character is defeated by the enemy character.

In the present embodiment, the winning or losing of the ally character is determined by a payout determined in the process at step S2421. All of the payouts of the first round to the final round have already been determined by the payout drawing process shown in FIG. 24. The winning or losing of the ally character is determined by the all of the payouts of the first round to the final round.

First, the main CPU 71 reads out the payouts from a payout storage area (step S2711). The payouts are stored in the payout storage area so as to correspond to each game of the number of games in the process at step S2423 shown in FIG. 24. In the process at step S2711, the payouts of the respective rounds of the first round to the final round which is played at the maximum number-th time are read out

Next, the main CPU 71 determines whether or not a zero payout (a payout is 0) is included in the read-out payouts (step S2713). In other words, it is determined whether or not a round which results in the zero payout is present.

When the main CPU 71 determines that the zero payout is not included in the read-out payouts, the main CPU 71 determines that the ally character has defeated the enemy character (step S2715).

When the main CPU 71 determines that the zero payout is included in the read-out payouts, the main CPU 71 determines whether or not a number of rounds, in each of which a payout is three times or more as large as a number of BETs, is less than or equal to two (step S2717).

When the main CPU 71 determines that the number of rounds, in each of which a payout is three times or more as large as a number of BETs, is less than or equal to two, the main CPU 71 determines that the ally character is defeated by the enemy character (step S2719).

When the main CPU 71 determines that the number of rounds, in each of which a payout is three times or more as large as a number of BETs, is larger than two, the main CPU 71 determines whether or not a number of rounds, in each of which a payout is five times or more as large as a number of BETs, is less than or equal to two (step S2721).

When the main CPU 71 determines that the number of rounds, in each of which a payout is five times or more as large as a number of BETs, is larger than two, the main CPU 71 determines that the ally character defeats the enemy character (step S2715).

When the main CPU 71 determines that the number of rounds, in each of which a payout is five times or more as large as a number of BETs, is less than or equal to two, the main CPU 71 extracts random number values for a winning or losing drawing (step S2723). The random number values are 10 integer values of 0 to 9.

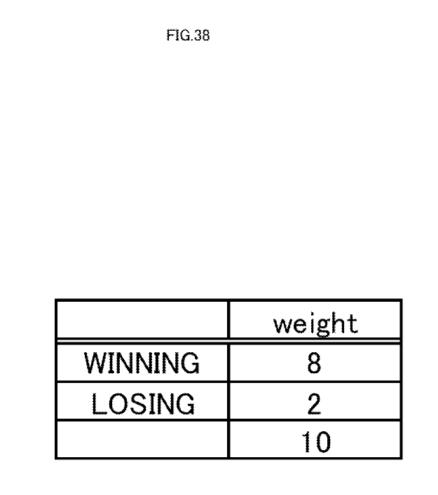

Next, with reference to a winning or losing drawing table, the main CPU 71 determines winning or losing (step S2725). FIG. 38 shows the winning or losing drawing table. A weight of winning is 8 and a weight of losing is 2. When a value of the random number value for the winning or losing drawing is 0 to 7, the winning is determined, and when a value of the random number value for the winning or losing drawing is eight or nine, the losing is determined.

After the main CPU 71 has executed the processes at the above-mentioned step S2715, S2719, or S2725, the main CPU 71 stores information indicating the determined winning or losing in a winning or losing storage area (step S2727).

Next, main CPU 71 extracts random number values for a rearrangement drawing (step S2729). The random number values are 10 integer values of 0 to 9.

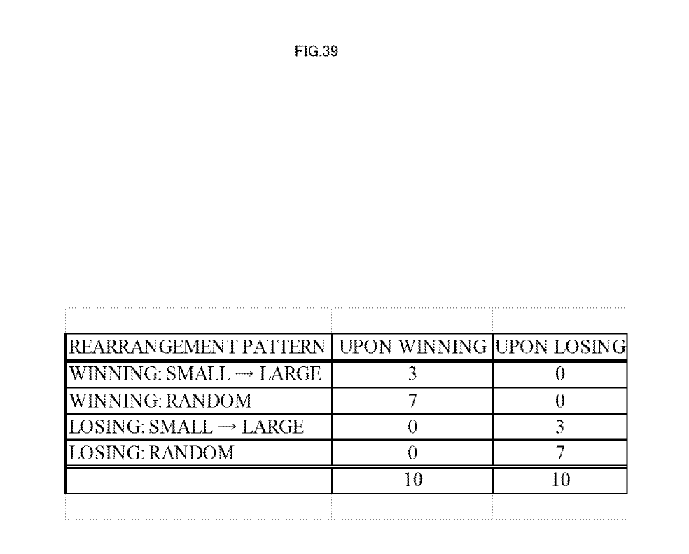

Next, with reference to a rearrangement drawing table, the main CPU 71 determines a rearrangement pattern (step S2731) and finishes this sub-routine. FIG. 39 shows the rearrangement drawing table.

When the winning is determined by the processes at step S2711 to S2725, “winning: small→large” and “winning: random” in FIG. 39 are referenced. When the random number value extracted in the process at step S2729 is 0 to 2, “winning: small→large” is determined, and when the random number value is 3 to 9, “winning: random” is determined.

On the other hand, when the losing is determined by the processes at step S2711 to S2725, “losing: small→large” and “losing: random” in FIG. 39 are referenced. When the random number value extracted in the process at step S2729 is 0 to 2, “losing: small→large” is determined, and when the random number value extracted therein is 3 to 9, “losing: random” is determined.

As described above, by the winning or losing determination and rearrangement pattern determination process shown in FIG. 27, in the battle effects of the final round, it is determined whether the ally character wins or loses.

<Rearrangement Execution Process>

FIG. 28 is a flowchart of a rearrangement execution process in the slot machine 10 according to the present embodiment

In the present embodiment, the rearrangement is determined by the payouts determined in the process at step S2421. All of the payouts of the first round to the final round have already been determined by the payout drawing process shown in FIG. 24. The rearrangement is determined by the payouts of the first round to the final round, and the order in which the first round to the final round are executed is rearranged. By this rearrangement process, the order in which unit games are executed, that is, the order in which rounds of battle effects are executed is changed.

First, the main CPU 71 determines whether or not in the process at step S2731 shown in FIG. 27, “winning: small→large” is determined (step S2811).

When the main CPU 71 determines that “winning: small→large” is determined, the main CPU 71 determines whether or not a retrigger is included in the rounds up to the round which is played at the maximum number-th time (step S2813).

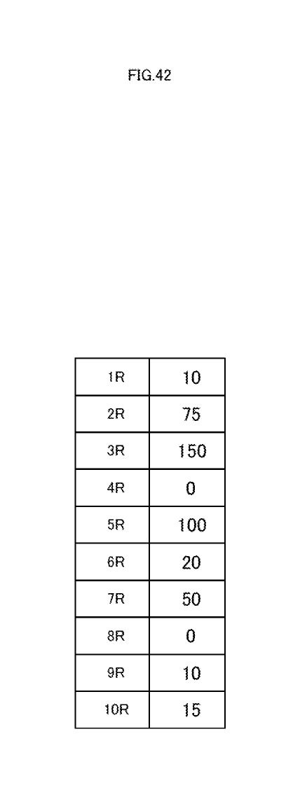

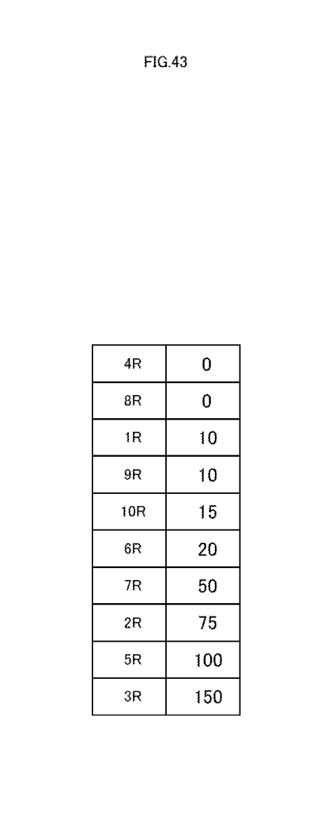

When the main CPU 71 determines that the retrigger is not included, the main CPU 71 rearranges the order of unit games to be executed in the ascending order of the payouts (step S2815). For example, payouts shown in FIG. 42 are rearranged in the ascending order of the payout as shown in FIG. 43.

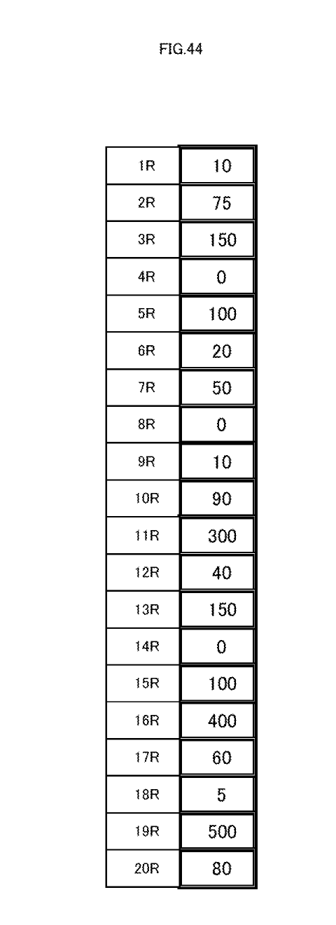

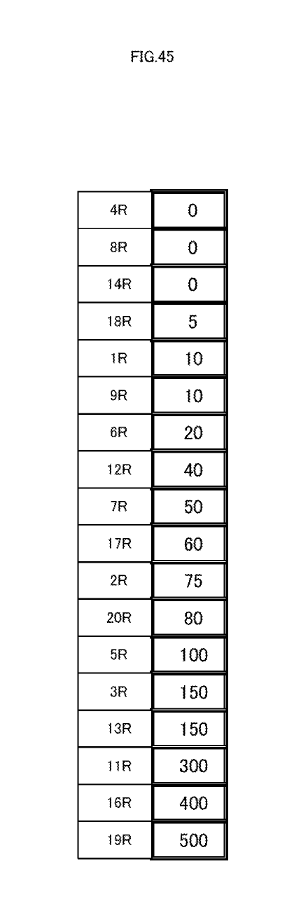

When the main CPU 71 determines that the retrigger is included, the main CPU 71 rearranges payouts other than payouts in the rounds, in each of which the retrigger is established, in the ascending order (step S2817). For example, payouts shown in FIG. 44 are rearranged in the ascending order of the payouts as shown in FIG. 45. Next, as shown in FIG. 46, the payout (90) in the 10th round and the payout (100) in the 15th round, in each of which the retrigger is established, are returned to the original positions of these rounds.

When the main CPU 71 determines that “winning: small→large” is not determined, the main CPU 71 determines whether or not “winning: random” is determined (step S2819).

When the main CPU 71 determines that “winning: random” is determined, the main CPU 71 determines whether or not the retrigger is included in the rounds up to the round which is played at the maximum number-th time (step S2821).

When the main CPU 71 determines that the retrigger is not included, the main CPU 71 rearranges the order of unit games to be executed in the ascending order of the payouts (step S2823). This is the same as in FIG. 42 and FIG. 43.

Next, the main CPU 71 determines a number of rounds, whose positions are changed, by a drawing (step S2825).

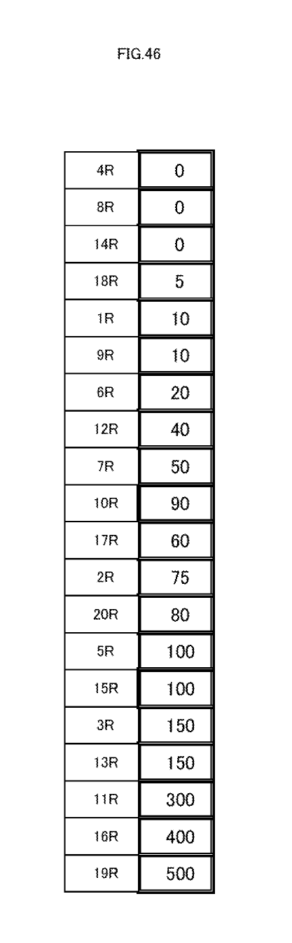

FIG. 47 is a number-of-position-changed-rounds drawing table. In the number-of-position-changed-rounds drawing table, numbers of position-changed-rounds in accordance with numbers of times, at each of which the retrigger is established are defined.

When a number of times, at which the retrigger is established, is zero, a number of position-changed-rounds is two or three, and weights are 50, respectively.

When a number of times, at which the retrigger is established, is one, a number of position-changed-rounds is two, three, or four, weights are 25, 25, and 50, respectively.

When a number of times, at each of which the retrigger is established, is two, a number of position-changed-rounds is three, four, or five, weights are 25, 25, and 50, respectively.

When a number of times, at each of which the retrigger is established, is three, a number of position-changed-rounds is four, five, or six, weights are 25, 25, and 50, respectively.

When a number of times, at each of which the retrigger is established, is four, a number of position-changed-rounds is five, six, or seven, weights are 25, 25, and 50, respectively.

When a number of times, at each of which the retrigger is established, is five, a number of position-changed-rounds is five, seven, or 10, weights are 25, 50, and 25, respectively.

When a number of times, at each of which the retrigger is established, is six, a number of position-changed-rounds is seven, 10, or 12, weights are 50, 25, and 25, respectively.

When a number of times, at each of which the retrigger is established, is seven, a number of position-changed-rounds is seven, 10, or 12, weights are 25, 50, and 25, respectively.

When a number of times, at each of which the retrigger is established, is eight, a number of position-changed-rounds is 10, 12, or 15, weights am 25, 50, and 25, respectively.

Next, the main CPU 71 determines, as position-changed-rounds, rounds from the first round to the round, whose each number is determined in the process at step S2825 (step S2827).

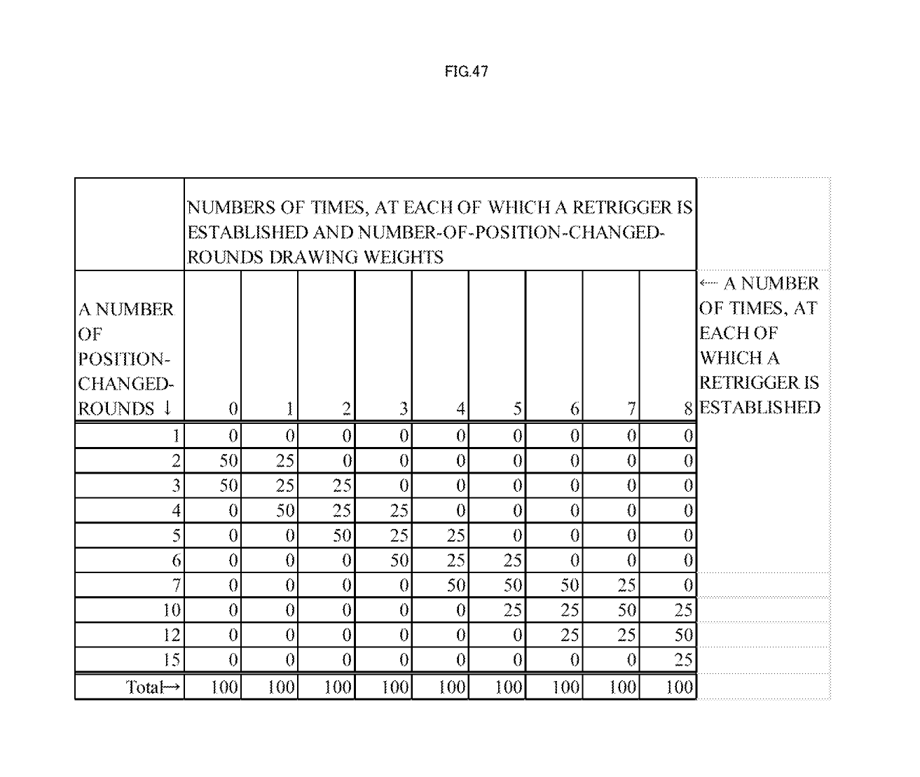

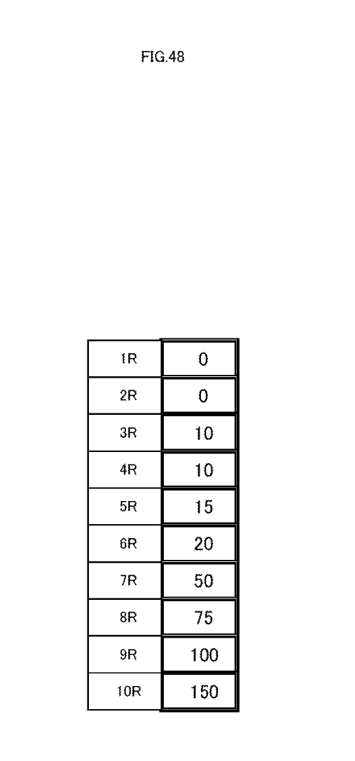

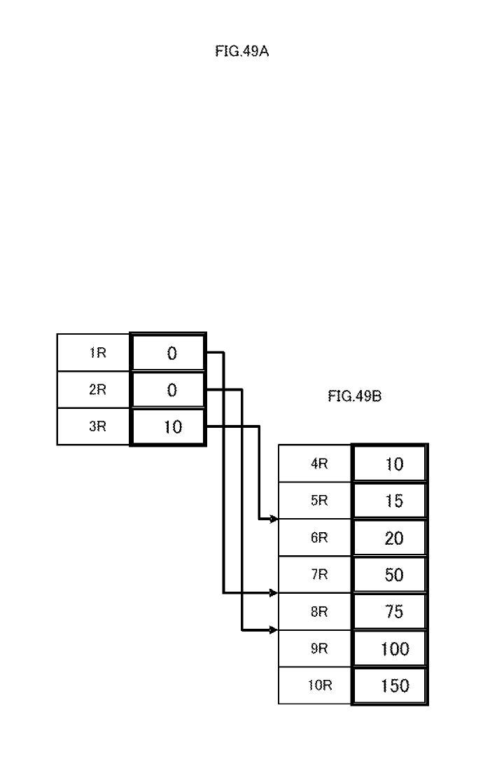

For example, when in the process at step S2825, it is determined that the number of position-changed-rounds is three, in the process at step S2827, the first round to the third round are targeted for the position change. Specifically, three rounds which are the first round, the second round, and the third round shown in FIG. 48 are targeted for the position change and are determined as the position-changed-rounds (FIG. 49A). The fourth round and rounds subsequent thereto are not targeted for the position change (FIG. 49B).

Next, the main CPU 71 determines position change destinations of the position-changed-rounds determined by the process at step S2827 by a drawing process (step S2829).

For example, by the drawing process, a position change destination of the first round is determined to be between the seventh round and the eighth round; a position change destination of the second round is determined to be between the eighth round and the ninth round; and a position change destination of the second round is determined to be between the fifth round and the sixth round.

Next, the main CPU 71 moves the position-changed-rounds to the position change destinations determined by the process at step S2829 (step S2831).

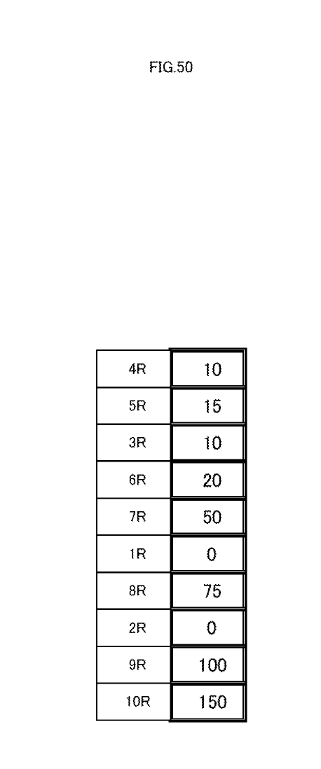

For example, as shown in FIG. 50, the first round is moved to between the seventh round and the eighth round; the second round is moved to between the eighth round and the ninth round; and the third round is moved to between the fifth round and the sixth round.

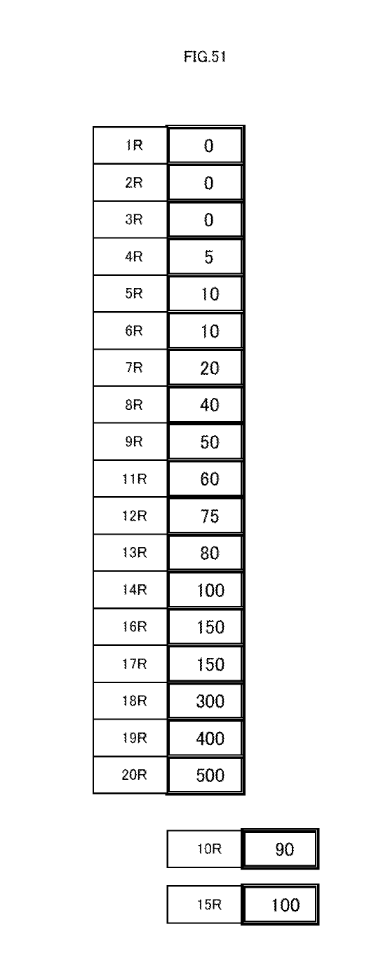

When in the determination process at step S2821, the main CPU 71 determines that the retrigger is included, first, the main CPU 71 rearranges the payouts other than the payouts of the rounds, in each of which the retrigger is included, in the ascending order (step S2833). For example, as shown in FIG. 51, the payouts of the rounds other than the 10th round and the 15th round, in each of which the retrigger is established, are rearranged in the ascending order.

Next, the main CPU 71 determines a number of position-changed-rounds by a drawing (step S2835). This process is the same as the above-described process at step S2825, and with reference to the number-of-position-changed-rounds drawing table shown in FIG. 47, the determination is made.

Next, the main CPU 71 determines, as the position-changed-rounds, the rounds from the first round up to the round, whose number is determined in the process at step S2825 (step S2837). This process is the same as the above-described process at step S2827.

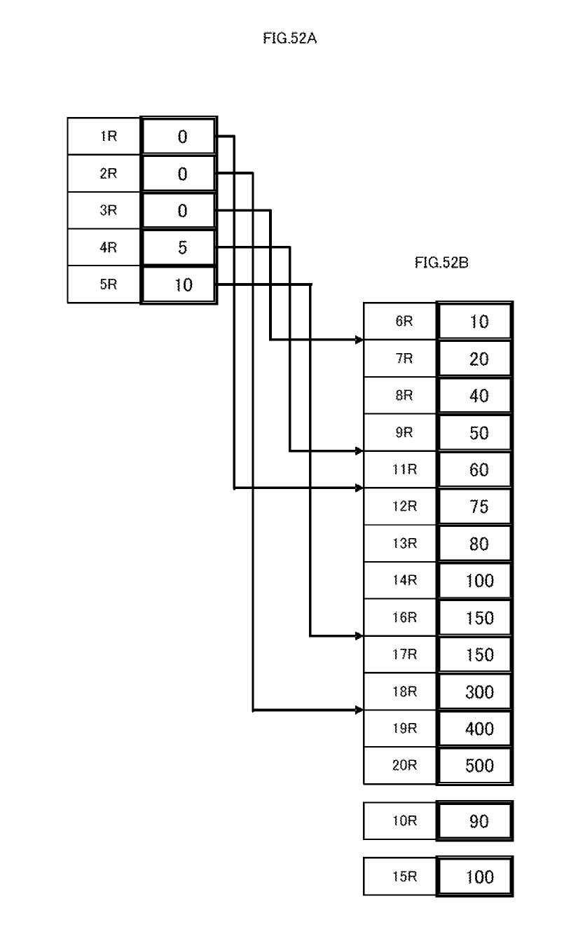

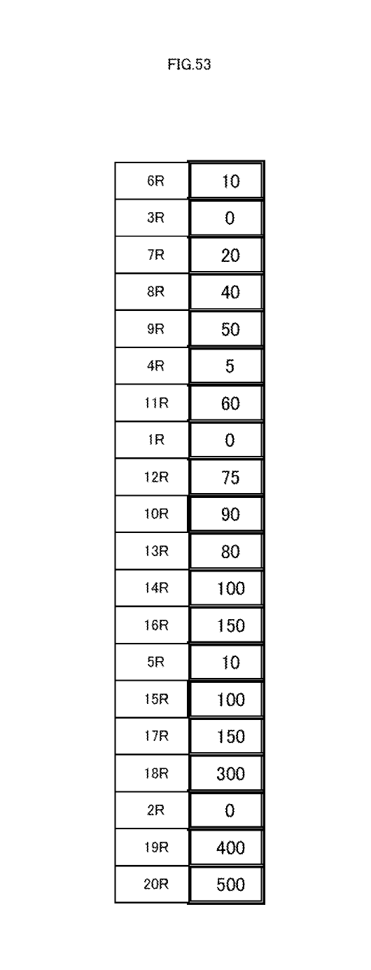

For example, when in the process at step S2835, it is determined that a number of position-changed-rounds is five, in the process at step S2837, the first round to the fifth round are targeted for the position change. Specifically, five rounds which are the first round, the second round, the third round, the fourth round, and the fifth round shown in FIG. 52A are targeted for the position change and are determined as the position-changed-rounds. The sixth round and rounds subsequent thereto are not targeted for the position change (FIG. 52B).

Next, the main CPU 71 determines position change destinations of the position-changed-rounds determined by the process at step S2837 by a drawing process (step S2839).

For example, by the drawing process, a position change destination of the first round is determined to be between the 11th round and the 12th round; a position change destination of the second round is determined to be between the 18th round and the 19th round; a position change destination of the third round is determined to be between the sixth round and the seventh round; a position change destination of the fourth round is determined to be between the ninth round and the 11th round; and a position change destination of the fifth round is determined to be between the 16th round and the 17th round.

Next, the main CPU 71 moves the position-changed-rounds to the position change destinations determined by the process at step S2829 (step S2841).

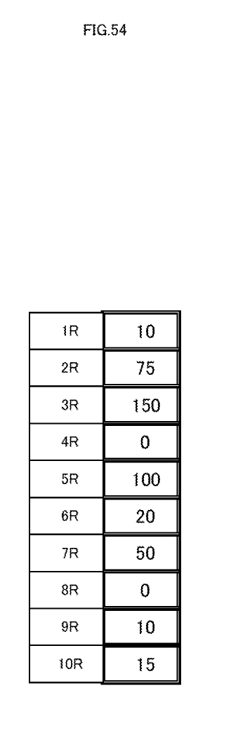

For example, as shown in FIG. 53, the first round is moved to between the 11th round and the 12th round; the second round is moved to between the 18th round and the 19th round; the third round is moved to between the sixth round and the seventh round; the fourth round is moved to between the ninth round and the 11th round; and the fifth round is moved to between the 16th round and the 17th round. It is to be noted that since the rounds, in each of which the retrigger is established, are returned to the original positions, the 10th round and the 15th round are returned to the original positions as shown in FIG. 53.

When in the determination process at step S2819, the main CPU 71 determines that “winning: random” is not determined, the main CPU 71 determines whether or not “losing: small→large” is determined (step S2911).

When the main CPU 71 determines that “losing: small→large” is determined, the main CPU 71 determines whether or not in any of the rounds up to the round played at the maximum number-th time, the retrigger is included (step S2913).

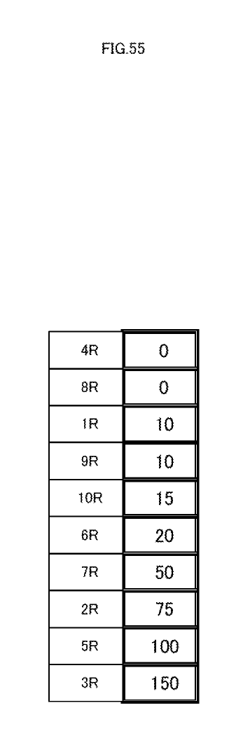

When the main CPU 71 determines that the retrigger is not included, the main CPU 71 rearranges the payouts in the ascending order of the payouts (step S2915). For example, the payouts shown in FIG. 54 are rearranged in the ascending order of the payouts as shown in FIG. 55.

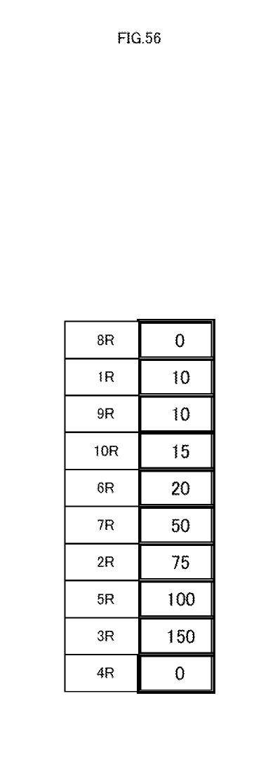

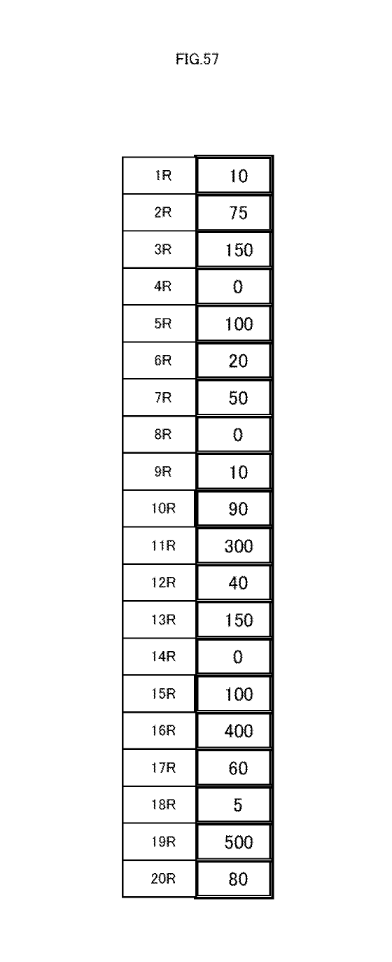

Next, the main CPU 71 moves an initial zero payout to the final round (step S2917). For example, as shown in FIG. 55, the fourth round whose payout is the initial zero payout is moved to the final round as shown in FIG. 56.

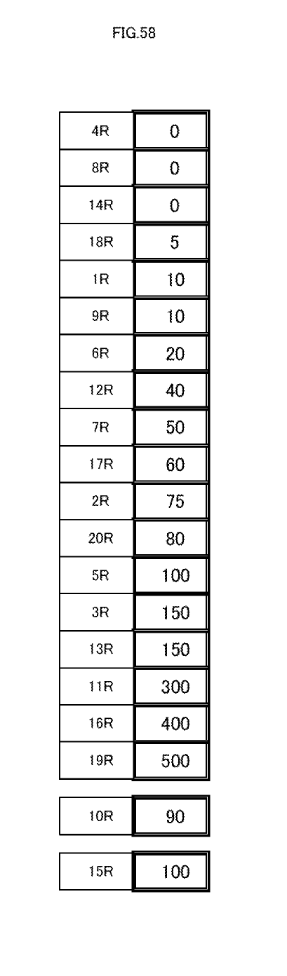

When in the determination process at step S2913, the main CPU 71 determines that the retrigger is included, the main CPU 71 rearranges payouts other than the payouts in the rounds, in each of which the retrigger is established, in the ascending order (step S2919). For example, the payouts shown in FIG. 57 are rearranged in the ascending order of the payouts as shown in FIG. 58.

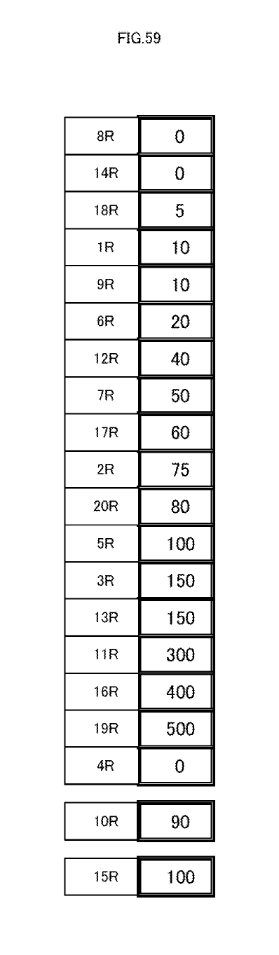

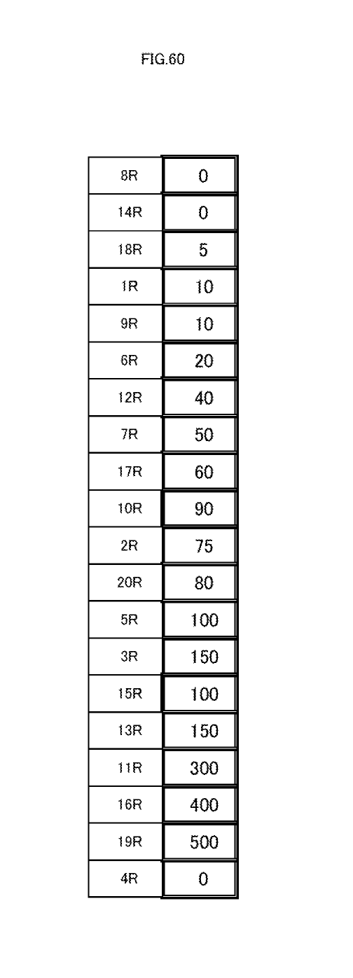

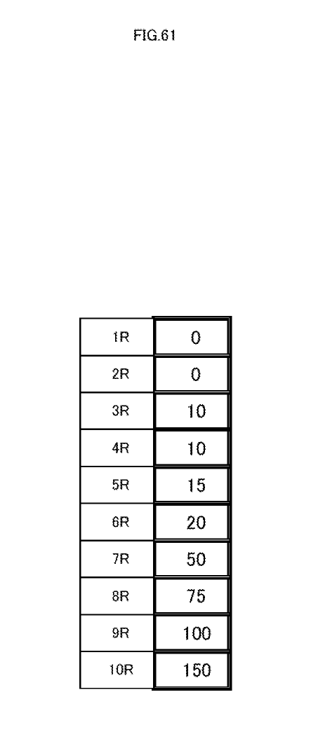

Next, the main CPU 71 moves the initial zero payout to the final round (step S2921). For example, as shown in FIG. 58, the fourth round whose payout is the initial zero payout is moved to the final round as shown in FIG. 59. Next, as shown in FIG. 60, the payout (90) of the 10th round and the payout (100) of the 15th round, in each of which the retrigger is established, are returned to the original positions of these rounds.

When the main CPU 71 determines that “losing: small→large” is not determined, the main CPU 71 determines whether or not “losing: random” is determined (step S2923).

When the main CPU 71 determines that “losing: random” is determined, the main CPU 71 determines whether or not in any of the rounds up to the round played at the maximum number-th time, the retrigger is included (step S2925).

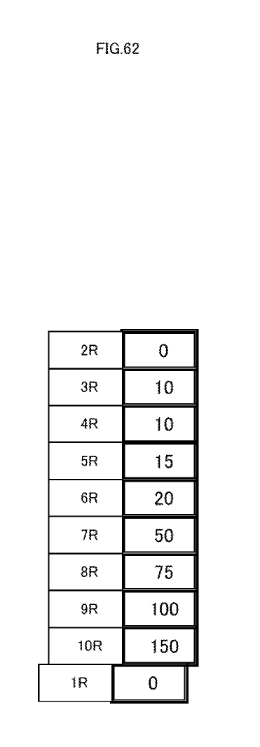

When the main CPU 71 determines that the retrigger is not included, the main CPU 71 rearranges the payouts in the ascending order of the payouts (step S2927). For example, the payouts shown in FIG. 42 are rearranged in the ascending order of the payouts as shown in FIG. 61.

Next, the main CPU 71 moves an initial zero payout to the final round (step S2929). For example, as shown in FIG. 61, the first round whose payout is the initial zero payout is moved to the final round as shown in FIG. 62.

Next, the main CPU 71 determines a number of position-changed-rounds by a drawing (step S2931). This process is the same as each of the above-described processes at step S2825 and S2835, and with reference to the number-of-position-changed-rounds drawing table shown in FIG. 47, the determination is made.

Next, the main CPU 71 determines, as position-changed-rounds, rounds from a leading round up to the round played at the number-th time, the number of rounds being determined in the process at step S2931 (step S2933). This process is the same as each of the above-described processes at step S2827 and S2837.

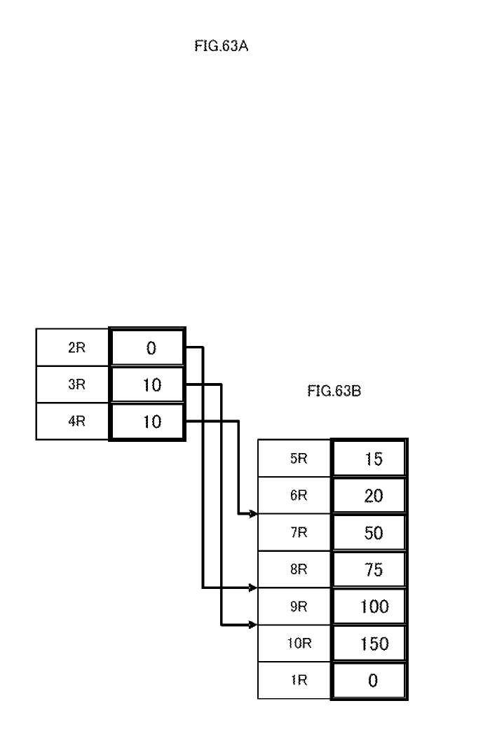

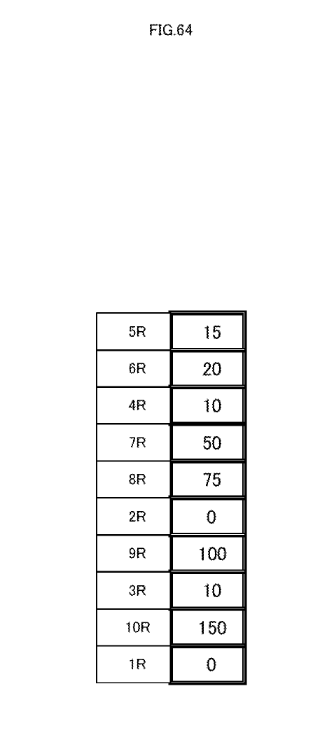

For example, when in the process at step S2931, it is determined that a number of position-changed-rounds is three, in the process at step S2933, the second round which is the current leading round to the fourth round are targeted for the position change. As described above, since the first round whose payout is an initial zero payout is moved to the final round, the current leading round is the second round. Specifically, the three rounds which are the second round, the third round, and the fourth round shown in FIG. 63A are targeted for the position change and are determined to be the position-changed-rounds. The fifth round and rounds subsequent thereto are not targeted for the position change (FIG. 63B).

Next, the main CPU 71 determines position change destinations of the position-changed-rounds determined by the process at step S2933 by a drawing process (step S2935).

For example, by the drawing process, the second round is determined to be between the eighth round and the ninth round; the third round is determined to be between the ninth round and the 10th round; and the fourth round is determined to be between the sixth round and the seventh round.

Next, the main CPU 71 moves the position-changed-rounds to the position change destinations determined by the process at step S2935 (step S2937).

For example, as shown in FIG. 64, the second round is moved to between the eighth round and the ninth round; the third round is moved to between the ninth round and the 10th round; and the fourth round is moved to between the sixth round and the seventh round.

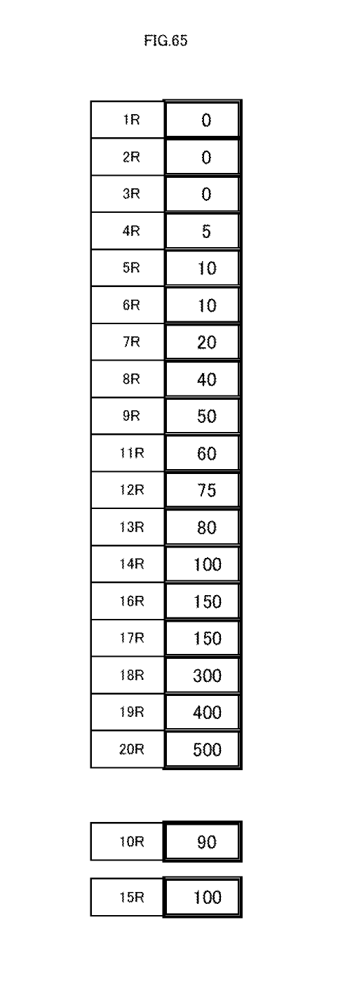

When in the determination process at step S2925, the main CPU 71 determines that the retrigger is included, first, the main CPU 71 rearranges the payouts of the rounds other than the rounds, in each of which retrigger is established, in the ascending order (step S2939). For example, as shown in FIG. 65, the payouts of the rounds other than the 10th round and the 15th round, in each of which the retrigger is established, in the ascending order thereof.

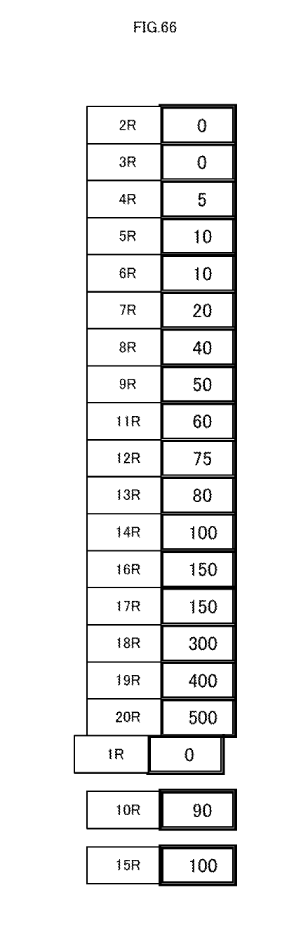

Next, the main CPU 71 moves an initial zero payout to the final round (step S2941). For example, as shown in FIG. 65, the first round whose payout is the initial zero payout is moved to the final round as shown in FIG. 66. This process is the same as the above-described process at step S2929.

Next, the main CPU 71 determines a number of position-changed-rounds by a drawing (step S2943). This process is the same as the above-described process at step S2931, and with reference to the number of position-changed-rounds drawing table shown in FIG. 47, the determination is made.

Next, the main CPU 71 determines, as the position-changed-rounds, rounds from a leading round up to the round played at the number-th time, the number of rounds being determined in the process at step S2943 (step S2945). This process is the same as each of the above-described processes at steps S2827, S2837, and S2933.

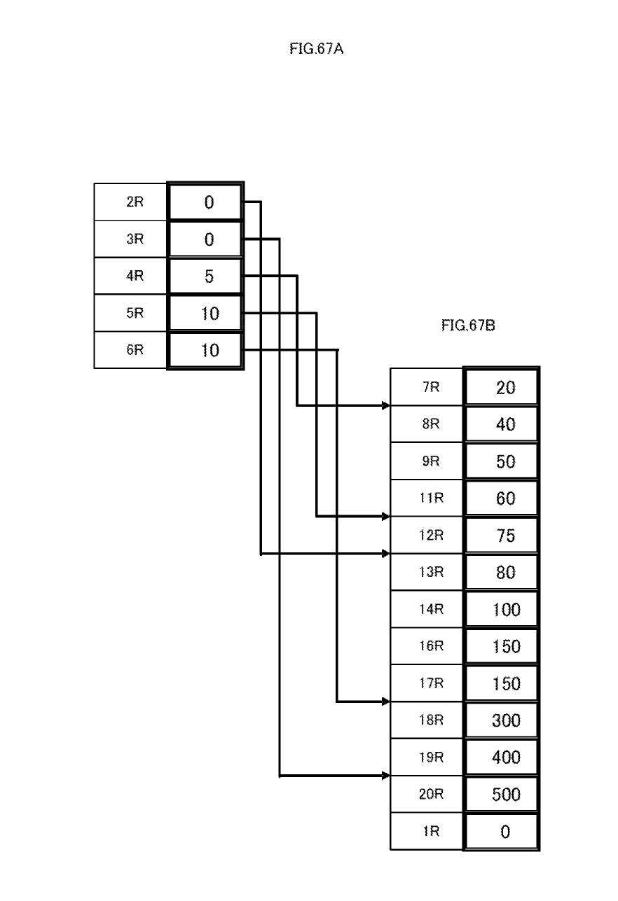

For example, when in the process at step S2943, it is determined that the number of position-changed-rounds is five, in the process at step S2945, the second round, which is the current leading round, up to the sixth round are targeted for the position change. As described above, since the first round whose payout is the initial zero payout is moved to the final round, the current leading round is the second round. Specifically, the five rounds which are the second round, the third round, the fourth round, the fifth round, and the sixth round shown in FIG. 67A are targeted for the position change and are determined to be the position-changed-rounds. The seventh round and rounds subsequent thereto are not targeted for the position change (FIG. 67B).

Next, the main CPU 71 determines position change destinations of the position-changed-rounds determined by the process at step S2945 by a drawing process (step S2947).

For example, by the drawing process, the second round is determined to be between the 12th round and the 13th round; the third round is determined to be between the 19th round and the 20th round; the fourth round is determined to be between the seventh round and the eighth round; the fifth round is determined to be between the 11th round and the 12th round; and the sixth round is determined to be between the 17th round and the 18th round.

Next, the main CPU 71 moves the position-changed-rounds to the position change destinations determined by the process at step S2947 (step S2949).

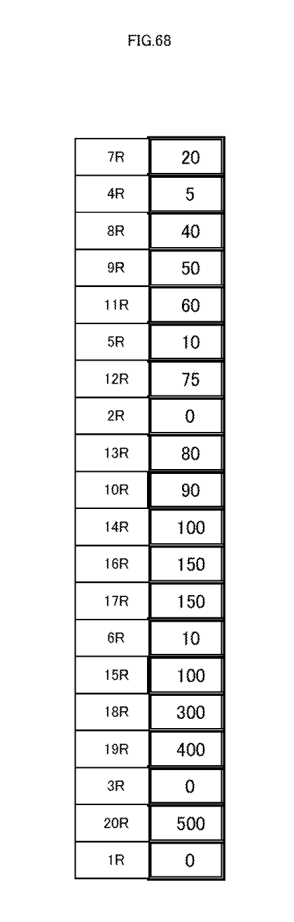

For example, as shown in FIG. 68, the second round is moved to between the 12th round and the 13th round; the third round is moved to between the 19th round and the 20th round; the fourth round is moved to between the seventh round and the eighth round; the fifth round is moved to between the 11th round and the 12th round; and the sixth round is moved to between the 17th round and the 18th round. It is to be noted that since the rounds, in each of which the retrigger is established, are returned to the original positions, the 10th round and the 15th round are returned to the original positions as shown in FIG. 68.

As described above, except for the rounds, in each of which the retrigger or the like is established, in principle, the rearrangement is made such that as the respective battle effects proceed, the payout is gradually increased, thereby allowing the battle effects to be executed so as to gradually enhance a feeling of expectation.

<Knockout Effects Determination Process>

FIG. 30A and FIG. 30B are flowcharts of a knockout effects determination process in the slot machine 10 according to the present embodiment. As described above, in battle effects of the present embodiment, three kinds of characters which are a common foot soldier, a samurai, and a shogun appear. In the case where a shogun 2 appears, four kinds of enemy characters which are the common foot soldier, the samurai, the shogun, and the shogun 2 appear.

As described with reference to FIG. 14 and FIG. 15, knockout effects in which an ally character defeats one kind of the enemy character, and a stronger next enemy character thereby appears are conducted. The knockout effects are not invariably executed and are determined by a knockout effects determination process shown in FIG. 30A and FIG. 30B.

In the present embodiment, knockout effects are determined by payouts of the first round to the final round, which number-th round a current round is, and establishment of a retrigger. Another enemy character ranking higher appears by the knockout effects. In the below-described processing, each determination is sequentially made from the first round to the final round.

First, the main CPU 71 determines whether or not a current round is a round which is the second round or any round subsequent thereto (step S3011).

When the main CPU 71 determines that the current round is the second round or any round subsequent thereto, the main CPU 71 determines whether or not a payout of that round exceeds three times a number of BETs (step S3013).

When the main CPU 71 determines that the payout of that round exceeds three times the number of BETs, the main CPU 71 determines whether or not a number of remaining rounds including rounds, in each of which a retrigger is established, is three or more (step S3015).

When the main CPU 71 determines that the number of remaining rounds including the rounds, in each of which the retrigger is established, is three or more, the main CPU 71 determines whether or not that round is not the round in which the retrigger is established (step S3017).

When the main CPU 71 determines that that round is not the round in which the retrigger is established, the main CPU 71 determines that the first knockout effects are executed (step S3019).

Next, the main CPU 71 stores a number of rounds, in each of which the first knockout effects are executed (step S3021), finishing this sub-routine.

When in the determination process at step S3011, the main CPU 71 determines that that round is not the second round or any round subsequent thereto; when in the determination process at step S3013, the main CPU 71 determines that the payout of that round does not exceed three times the number of BETs; when in the determination process at step S3015, the main CPU 71 determines that the number of remaining rounds including the rounds, in each of which the retrigger is established, is not three or more; or when in the determination process at step S3017, the main CPU 71 determines that that round is the round in which the retrigger is established, the main CPU 71 determines whether or not it is after it has already been determined that the first knockout effects are executed (step S3023).

When the main CPU 71 determines that it is after it has already been determined that the first knockout effects are executed, the main CPU 71 determines whether or not a payout of that round exceeds five times a number of BETs (step S3025).

When the main CPU 71 determines that the payout of that round exceeds five times the number of BETs, the main CPU 71 determines whether or not two or more rounds have passed from the first knockout effects (step S3027).

When the main CPU 71 determines that two or more rounds have passed from the first knockout effects, the main CPU 71 determines whether or not a number of remaining rounds including rounds, in each of which the retrigger is established, is two or more (step S3029).

The main CPU 71 determines whether or not that round is not a round in which the retrigger is established (step S3031).

When the main CPU 71 determines that that round is not the round in which the retrigger is established, the main CPU 71 determines that the second knockout effects are executed (step S3033).

Next, the main CPU 71 stores the number of rounds, in each of which the second knockout effects are executed (step S3035), finishing this sub-routine.

When in the determination process at step S3023, the main CPU 71 determines that it is not determined that the first knockout effects are executed; when in the determination process at step S3025, the main CPU 71 determines that the payout of that round does not exceed five times the number of BETs; when in the determination process at step S3027, the main CPU 71 determines that two or more rounds have not passed from the first knockout effects; when in the determination process at step S3029, the main CPU 71 determines that the number of remaining rounds including the rounds, in each of which the retrigger is established, is not two or more; or when in the determination process at step S3031, the main CPU 71 determines that that round is the round in which the retrigger is established, the main CPU 71 finishes this sub-routine.

<Enemy Character Determination Process>

FIG. 31 is a flowchart of an enemy character determination process in the slot machine 10 according to the present embodiment. In the battle effects in the present embodiment, enemy characters such as a common foot soldier, a samurai, a shogun, and a shogun 2 appear. By the enemy character determination process, any of the enemy characters to appear is determined.

First, the main CPU 71 determines whether or not a current round is the first round, from the number of games described with reference to FIG. 24 (step S3111).

When the main CPU 71 determines that the current round is the first round, the main CPU 71 determines the common foot soldier as an enemy character (step S3113), finishing this sub-routine.

When the main CPU 71 determines that the current round is not the first round, the main CPU 71 determines whether or not an enemy physical strength is zero (step S3115).

When the main CPU 71 determines that the enemy physical strength is zero, the main CPU 71 determines whether or not a current enemy character is the common foot soldier (step S3117).

When the main CPU 71 determines that the current enemy character is the common foot soldier, the main CPU 71 determines the samurai as an enemy character (step S3119), finishing this sub-routine.

When the main CPU 71 determines that the current enemy character is not the common foot soldier, the main CPU 71 determines whether or not the current enemy character is the samurai (step S3121).

When the main CPU 71 determines that the current enemy character is the samurai, the main CPU 71 determines the shogun as an enemy character (step S3123), finishing this sub-routine.

When in the determination process at step S3115, the main CPU 71 determines that the enemy physical strength is not zero or when in the determination process at step S3121, the main CPU 71 determines that the enemy character is not the samurai, the main CPU 71 determines whether or not the current enemy character is the shogun and that round is a round in which a retrigger is established (step S3125).

When the main CPU 71 determines that the current enemy character is the shogun and that round is the round in which the retrigger is established, the main CPU 71 determines the shogun 2 as an enemy character (step S3127), finishing this sub-routine.

When the main CPU 71 determines that the current enemy character is not the shogun or that round is not the round in which the retrigger is established, the main CPU 71 immediately finishes this sub-routine.

<Enemy Character Physical Strength Determination Process>

FIG. 32 is a flowchart of an enemy character physical strength determination process in the slot machine 10 according to the present embodiment

First, the main CPU 71 determines whether or not it is the start of the first round, from the number of games described with reference to FIG. 24 (step S3211).

When the main CPU 71 determines that it is the start of the first round, the main CPU 71 sets a physical strength of an enemy character to a maximum (step S3213), finishing this sub-routine.

When the main CPU 71 determines that it is not the start of the first round, the main CPU 71 determines whether or not a next enemy character appears by a knockout (step S3215).

When the main CPU 71 determines that the next enemy character appears by the knockout, the main CPU 71 sets a physical strength of an enemy character to a maximum (step S3213), finishing this sub-routine.

When the main CPU 71 determines that the next enemy character does not appear by the knockout, the main CPU 71 determines whether or not a next enemy character appears by a retrigger (step S3217).

When the main CPU 71 determines that the next enemy character appears by the retrigger, the main CPU 71 sets a physical strength of an enemy character to a maximum (step S3213), finishing this sub-routine.

When the main CPU 71 determines that the next enemy character does not appear by the retrigger, the main CPU 71 determines whether or not that round is a round in which the knockout has occurred (step S3219).

When the main CPU 71 determines that that round is the round in which the knockout has occurred, the main CPU 71 sets a physical strength of an enemy character to a minimum (step S3221), finishing this sub-routine.

When the main CPU 71 determines that that round is not the round in which the knockout has occurred, the main CPU 71 determines whether or not that round is the final round and an ally character (player) wins (step S3223).

When the main CPU 71 determines that that round is the final round and the ally character (player) wins, the main CPU 71 sets a physical strength of an enemy character to a minimum (step S3221), finishing this sub-routine.

When the main CPU 71 determines that that round is not the final round and the ally character (player) loses, the main CPU 71 determines whether or not that round is a round in which a retrigger is established (step S3225).

When the main CPU 71 determines that that round is the round in which the retrigger is established, the main CPU 71 sets a physical strength of an enemy character to a minimum (step S3221), finishing this sub-routine.

When the main CPU 71 determines that that round is not the round in which the retrigger is established, the main CPU 71 decreases the physical strength of the enemy character in accordance with a result of a physical strength calculation process shown in FIG. 33A and FIG. 33B (step S3227), finishing this sub-routine.

As described above, the physical strength of the enemy character can be decreased by the occurrence of the knockout and the establishment of the retrigger.

<Physical Strength Calculation Process>

FIG. 33A and FIG. 33B are flowcharts of a physical strength calculation process in the slot machine 10 according to the present embodiment. In the below-described process, the first round to the final round are sequentially determined. In this process, a physical strength of an ally character and a physical strength of an enemy character in each of the rounds of the first round to the final round are calculated.

First, the main CPU 71 determines whether or not there is no knockout in the first round to the final round (step S3311).

When the main CPU 71 determines that there is no knockout in the first round up to the final round, the main CPU 71 determines whether or not the ally character wins in the final round (step S3313).

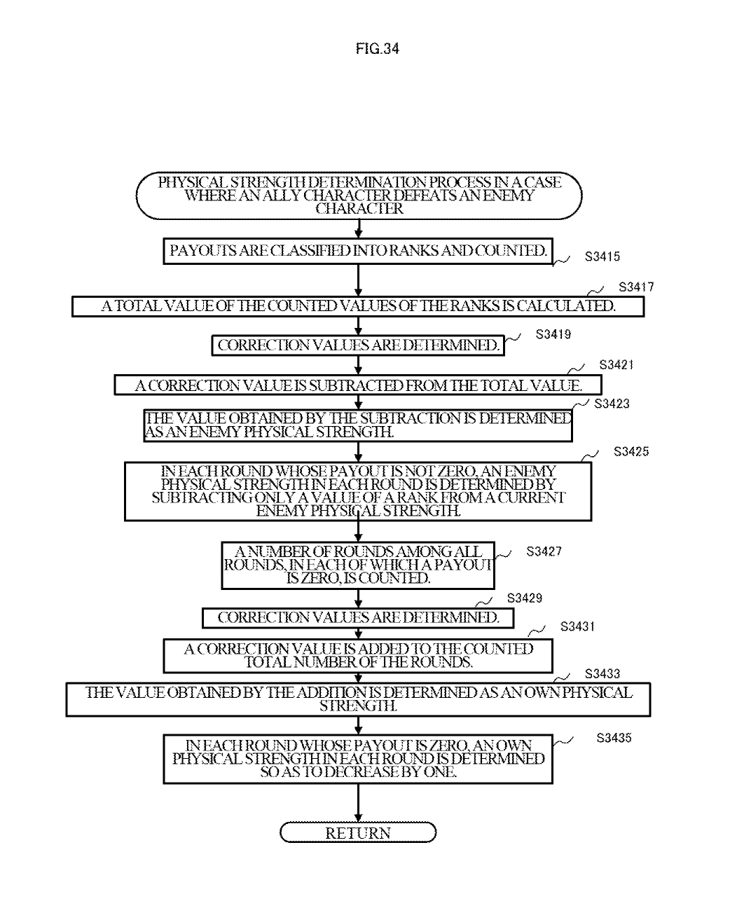

When the main CPU 71 determines that the ally character wins in the final round, the main CPU 71 invokes and executes a physical strength determination process shown in FIG. 34 executed in a case where the ally character defeats the enemy character (step S3315), finishing this sub-routine.

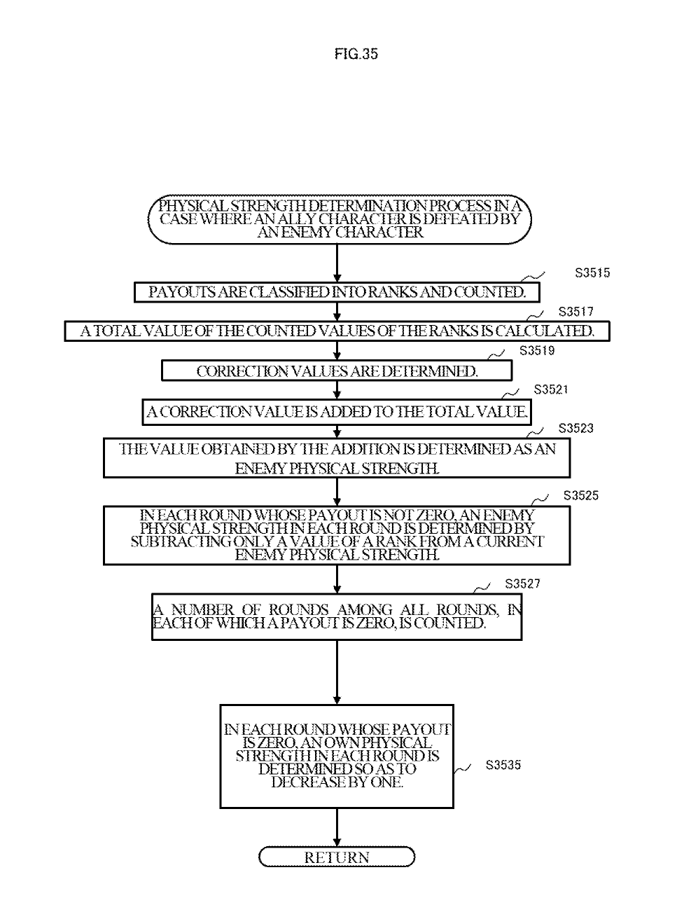

When the main CPU 71 determines that the ally character loses in the final round, the main CPU 71 invokes and executes a physical strength determination process shown in FIG. 35 executed in a case where the ally character is defeated by the enemy character (step S3317), finishing this sub-routine.

When the main CPU 71 determines that there is a knockout in the first round up to the final round, the main CPU 71 determines whether or not a common foot soldier appears and the ally character knocks out the common foot soldier (step S3319).

When the main CPU 71 determines that the common foot soldier appears and the ally character knocks out the common foot soldier, the main CPU 71 invokes and executes the physical strength determination process shown in FIG. 34 executed in the case when the ally character defeats the enemy character (step S3321), finishing this sub-routine.

When the main CPU 71 determines that the common foot soldier appears and the ally character does not knock out the common foot soldier, the main CPU 71 determines whether or not the common foot soldier appears and when a retrigger is established, the ally character knocks out the common foot soldier (step S3323).

When the main CPU 71 determines that the common foot soldier appears and when the retrigger is established, the ally character knocks out the common foot soldier, the main CPU 71 invokes and executes the physical strength determination process shown in FIG. 34 executed in the case where the ally character defeats the enemy character (step S3325), finishing this sub-routine.

When the main CPU 71 determines that the common foot soldier appears and when the retrigger is established, the ally character does not knock out the common foot soldier, the main CPU 71 determines whether or not the common foot soldier appears, the retrigger is established, and anywhere after the retrigger, the ally character knocks out the common foot soldier (step S3327).

When the main CPU 71 determines that the common foot soldier appears, the retrigger is established, and anywhere after the retrigger, the ally character knocks out the common foot soldier, the main CPU 71 invokes and executes the physical strength determination process shown in FIG. 34 executed in the case when the ally character defeats the enemy character (step S3329), finishing this sub-routine.

When the main CPU 71 determines that the common foot soldier appears, the retrigger is established, and anywhere after the retrigger, the ally character does not knock out the common foot soldier, the main CPU 71 determines whether or not a samurai appears and the ally character knocks out the samurai (step S3331).

When the main CPU 71 determines that the samurai appears and the ally character knocks out the samurai, the main CPU 71 invokes and executes the physical strength determination process shown in FIG. 34 executed in the case when the ally character defeats the enemy character (step S3333), finishing this sub-routine.

When the main CPU 71 determines that the samurai appears and the ally character does not knock out the samurai, the main CPU 71 determines whether or not the samurai appears and when a retrigger is established, the ally character knocks out the samurai (step S3335).

When the main CPU 71 determines that the samurai appears and when the retrigger is established, the ally character knocks out the samurai, the main CPU 71 invokes and executes the physical strength determination process shown in FIG. 34 executed in the case when the ally character defeats the enemy character (step S3337), finishing this sub-routine.

When the main CPU 71 determines that the samurai appears and when the retrigger is established, the ally character does not knock out the samurai, the main CPU 71 determines whether or not the samurai appears, the retrigger is established, and anywhere after the retrigger, the ally character knocks out the samurai (step S3339).

When the main CPU 71 determines that the samurai appears, the retrigger is established, and anywhere after the retrigger, the ally character knocks out the samurai, the main CPU 71 invokes and executes a physical strength determination process shown in FIG. 35 executed in the case when the ally character is defeated by the enemy character (step S3341), finishing this sub-routine.

When the main CPU 71 determines that the samurai appears, the retrigger is established, and anywhere after the retrigger, the ally character does not knock out the samurai, the main CPU 71 determines whether or not a shogun appears and the ally character defeats the shogun (step S3343).

When the main CPU 71 determines that the shogun appears and the ally character defeats the shogun, the main CPU 71 invokes and executes the physical strength determination process shown in FIG. 34 executed in the case where the ally character defeats the enemy character (step S3345), finishing this sub-routine.

When the main CPU 71 determines that the shogun appears and the ally character does not defeat the shogun, the main CPU 71 determines whether or not the shogun appears and when a retrigger is established, the ally character knocks out the shogun (step S3347).

When the main CPU 71 determines that the shogun appears and when the retrigger is established, the ally character knocks out the shogun, the main CPU 71 invokes and executes the physical strength determination process shown in FIG. 34 executed in the case where the ally character defeats the enemy character (step S3349), finishing this sub-routine.

When the main CPU 71 determines that the shogun appears and when the retrigger is established, the ally character does not knock out the shogun, the main CPU 71 determines whether or not the shogun appears and the ally character is defeated by the shogun (step S3351).

When the main CPU 71 determines that the shogun appears and the ally character is defeated by the shogun, the main CPU 71 invokes and executes the physical strength determination process shown in FIG. 35 executed in the case where the ally character is defeated by the enemy character(step S3353), finishing this sub-routine. When the main CPU 71 determines that the shogun appears and the ally character is not defeated by the shogun, the main CPU 71 immediately finishes this sub-routine.

<Physical Strength Determination Process in Case where Ally Character Defeats Enemy Character>

FIG. 34 is a flowchart of a physical strength determination process in a case where an ally character defeats an enemy character in the slot machine 10 according to the present embodiment

<Enemy Physical Strength Determination>

Next, the main CPU 71 classifies and counts payouts (step S3415).

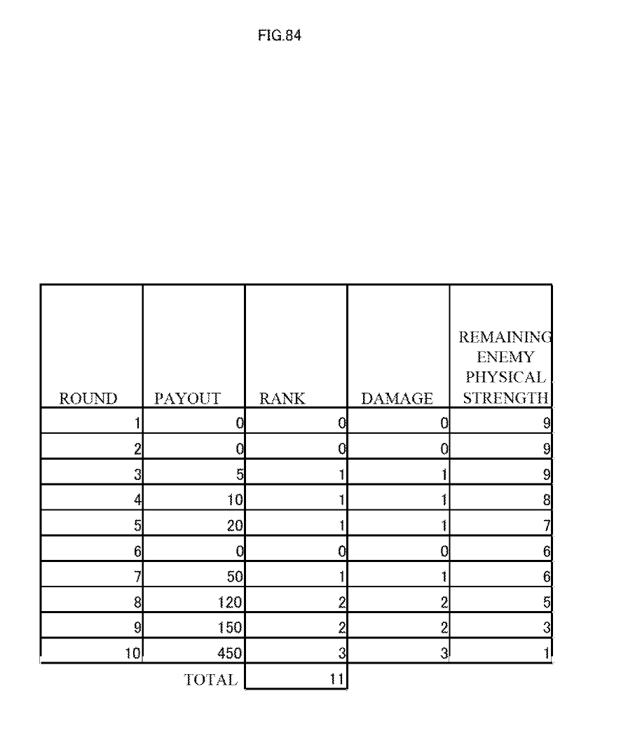

Specifically, a value which is calculated by multiplying a number of BETs by a predetermined multiplier and each payout are compared, the payouts are classified into five ranks, and how many payouts of each of the ranks are in all of rounds are counted. For example, as shown in FIG. 81, when a payout is zero, a rank is zero; when a payout is two or less times as large as a number of BETs, a rank is 1; when a payout is five or less times as large as a number of BETs, a rank is 2; when a payout is 10 or less times as large as a number of BETs, a rank is 3; and when a payout is more than 10 times as large as a number of BETs, a rank is 4.

Next, the main CPU 71 calculates a total value of the counted values of the ranks (step S3417).

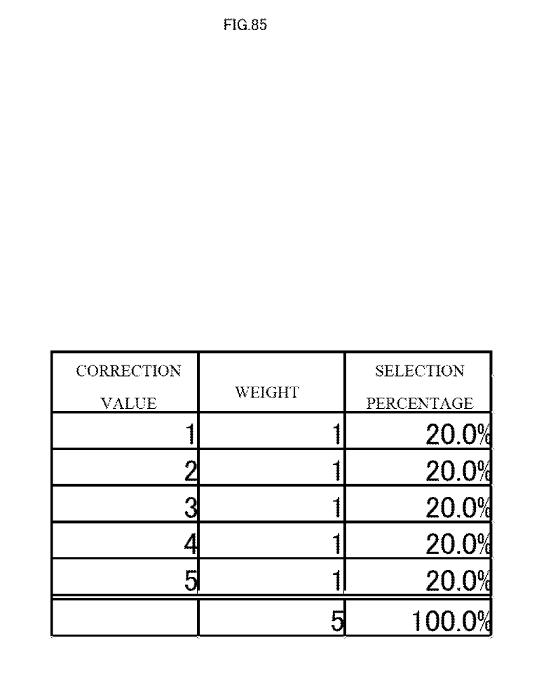

For example, as shown in FIG. 82, it is assumed that a payout in the first round is zero, a payout in the second round is zero, a payout in the third round is five, a payout in the fourth round is 10, a payout in the fifth round is 20, a payout in the sixth round is zero, a payout in the seventh round 50, a payout in the eighth round is 120, a payout in the ninth round is 150, and a payout in the 10th round is 450. In this case, since the payout in the first round is zero, the rank is zero; since the payout in the second round is zero, the rank is zero; since the payout in the third round is five, the rank is 1; the payout in the fourth round is 10, the rank is 1; since the payout in the fifth round is 20, the rank is 1; the payout in the sixth round is zero, the rank is zero; since the payout in the seventh round is 50, the rank is 1; since the payout in the eighth round is 120, the rank is 2; since the payout in the ninth round is 150, the rank is 2; and since the payout in the 10th round is 450, the rank is 3. Accordingly, the total value of the counted values of the ranks is 11.

Next, the main CPU 71 determines correction values (step S3419).

For example, as shown in FIG. 83, three correction values of 0, 1, and 2 are determined by a drawing process each at an equal probability. As shown in FIG. 82, the rank in the 10th round which is the final round is 3, a value of 2 calculated by subtracting 1 from 3 is determined as a maximum value among the correction values, and integer values in a range of 0 to 2 are determined as correction values. For example, if a rank in the final round is 9, a value of 8 calculated by subtracting 1 from 9 is determined as a maximum value among the correction values, and integer values in a range of 0 to 8 are determined as correction values.

Next, the main CPU 71 subtracts a correction value from a total value (step S3421).

For example, when in the example shown in FIG. 82, a correction value of 2 is determined by the drawing process, the correction value of 2 is subtracted from 11 which is the total value of the ranks, thereby obtaining a value of 9.

Next, the main CPU 71 determines the value obtained by the subtraction as an enemy physical strength (step S3423).

For example, in the example shown in FIG. 82, 9 calculated in the process at step S3421 is determined as the enemy physical strength.

Next, in the round in which a payout is not zero, the main CPU 71 determines an enemy physical strength in that round by subtracting only a value of the rank from the current enemy physical strength (step S3425).

For example, as shown in FIG. 84, in the round in which the payout is not zero, the enemy physical strength is determined by subtracting only a value of the rank therefrom. Specifically, the determination is made as described below. In the first round, 9 calculated in the process at step S3421 is determined as an enemy physical strength. In the second round, since the payout in the first round is zero, no subtraction is made and 9 is determined as an enemy physical strength. In the third round, since the payout in the second round is zero, no subtraction is made and 9 is determined as an enemy physical strength. In the fourth round, since the payout in the third round is 5, 1 of the rank is subtracted and an enemy physical strength is determined as 8. In the fifth round, since the payout in the fourth round is 10, 1 of the rank is subtracted and an enemy physical strength is determined as 7. In the sixth round, since the payout in the fifth round is 20, 1 of the rank is subtracted and an enemy physical strength is determined as 6. In the seventh round, since the payout in the sixth round is zero, no subtraction is made and 6 is determined as an enemy physical strength. In the eighth round, since the payout in the seventh round is 50, 1 of the rank is subtracted and an enemy physical strength is determined as 5. In the ninth round, since the payout in the eighth round is 120, 2 of the rank is subtracted and an enemy physical strength is determined as 3. In the 10th round, since the payout in the ninth round is 150, 2 of the rank is subtracted and an enemy physical strength is determined as 1. As described above, in this example, in the 10th round which is the final round, the enemy physical strengths is 1. It is to be noted that in the final round, there may be a case when an enemy physical strength is a negative value depending on any correction value.

The above-described processes at step S3415 to S3425 are processes for determining the enemy physical strengths of the enemy characters in each round.

<Own Physical Strength Determination>

Next, the main CPU 71 counts a number of rounds among all rounds, in each of which a payout is zero (step S3427).

For example, in the case of the example shown in FIG. 82, rounds, in each of which the payout is zero, are three rounds which are the first round, the second round, and the sixth round.

Next, the main CPU 71 determines correction values (step S3429).

For example, as shown in FIG. 85, the main CPU 71 determines five correction values 1, 2, 3, 4, and 5 each at an equal probability by a drawing process. Unlike in the case of the enemy physical strengths of the enemy characters, a maximum value of the correction values is invariably five, and one correction value is determined from among the five correction values 1, 2, 3, 4, and 5 by the drawing process.

Next, the main CPU 71 adds the correction value to the number of rounds counted in the process at step S3427 (step S3431).

For example, when in the example shown in FIG. 85, a correction value of 1 is determined by the drawing process, the correction value of 1 is added to 3 which is the number of rounds counted as above, thereby obtaining 4

Next, the main CPU 71 determines the value obtained by the addition as an own physical strength (step S3433).

For example, 4 calculated in the process at step S3431 is determined as the own physical strength.

Next, the main CPU 71 determines each of the own physical strengths so as to decrease by 1 in the rounds, in each of which the payout is zero (step S3435).

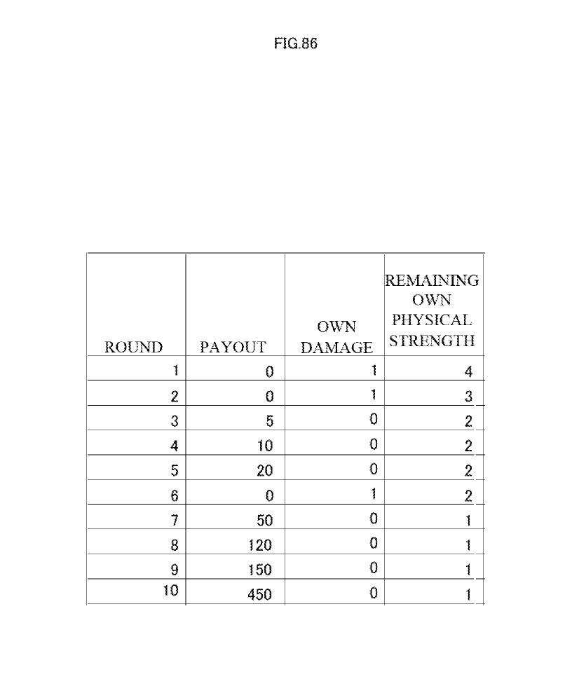

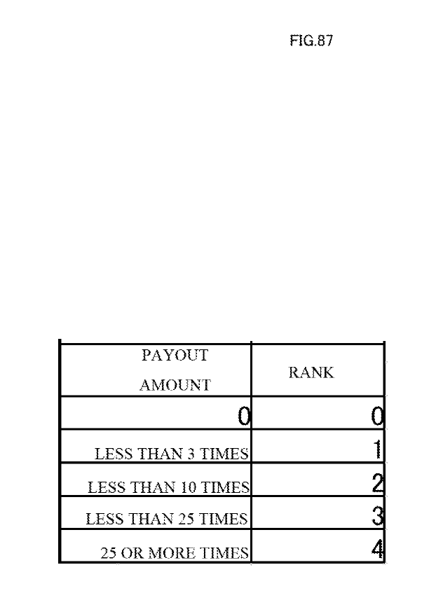

For example, as shown in FIG. 86, in the rounds, in each of which the payout is zero, each of the own physical strengths is determined so as to decrease by 1. Specifically, the determination is made as described below. In the first round, 4 calculated in the process at step S3433 is determined as an own physical strength. In the second round, since a payout in the first round is zero, the subtraction of 1 is made, and an own physical strength is determined as 3. In the third round, since a payout in the second round is zero, the subtraction of 1 is made, and an own physical strength is determined as 2. In the fourth round, since a payout in the third round is 5, no subtraction is made, and an own physical strength is determined as 2. In the fifth round, a payout in the fourth round is 10, no subtraction is made, and an own physical strength is determined as 2. In the sixth round, since a payout in the fifth round is 20, no subtraction is made, and an own physical strength is determined as 2. In the seventh round, a payout in the sixth round is zero, the subtraction of 1 is made, and an own physical strength is determined as 1. In the eighth round, since a payout in the seventh round is 50, no subtraction is made, and an own physical strength is determined as 1. In the ninth round, since a payout in the eighth round is 120, no subtraction is made, and an own physical strength is determined as 1. In the 10th round, since a payout in the ninth round is 150, no subtraction is made, and an own physical strength is determined as 1. As described above, in this example, in the 10th round which is the final round, the own physical strength is 1. It is to be noted that in the final round, there may be a case when an own physical strength is zero depending on any correction value.

The above-described processes at step S3427 to S3435 are processes for determining the own physical strengths of the ally character in each round.

<Physical Strength Determination Process in Case where Ally Character is Defeated by Enemy Character>

FIG. 35 is a flowchart of a physical strength determination process in a case when an ally character is defeated by an enemy character in the slot machine 10 according to the present embodiment

<Enemy Physical Strength Determination>

Next, main CPU 71 classifies payouts into ranks and counts (step S3515).

Specifically, a value which is calculated by multiplying a number of BETs by a predetermined multiplier and each payout are compared, the payouts are classified into five ranks, and how many payouts of each of the ranks are in all of rounds are counted. For example, as shown in FIG. 87, when a payout is zero, a rank is zero; when a payout is less than three times as large as a number of BETs, a rank is 1; when a payout is less than 10 times as large as a number of BETs, a rank is 2; when a payout is less than 25 times as large as a number of BETs, a rank is 3; and when a payout is 25 or more times as large as a number of BETs, a rank is 4.

Next, the main CPU 71 calculates a total value of the counted values of the ranks (step S3517).

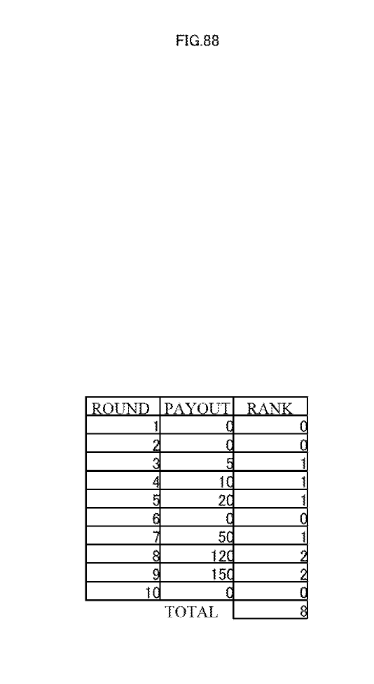

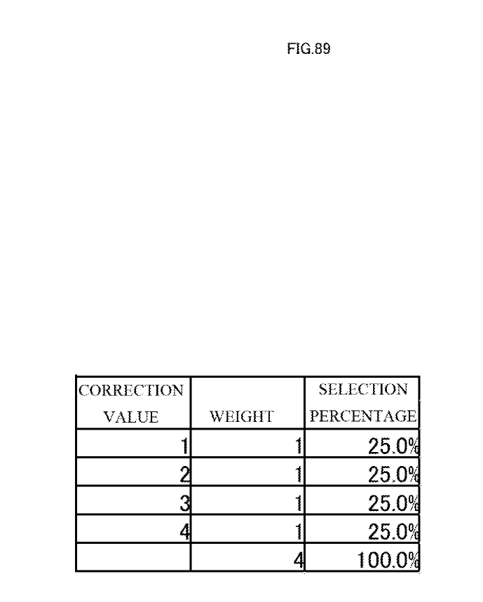

For example, as shown in FIG. 88, it is assumed that a payout in the first round is zero, a payout in the second round is zero, a payout in the third round is five, a payout in the fourth round is 10, a payout in the fifth round is 20, a payout in the sixth round is zero, a payout in the seventh round 50, a payout in the eighth round is 120, a payout in the ninth round is 150, and a payout in the 10th round is zero. In this case, since the payout in the first round is zero, the rank is zero; since the payout in the second round is zero, the rank is zero; since the payout in the third round is five, the rank is 1; the payout in the fourth round is 10, the rank is 1; since the payout in the fifth round is 20, the rank is 1; the payout in the sixth round is zero, the rank is zero; since the payout in the seventh round is 50, the rank is 1; since the payout in the eighth round is 120, the rank is 2; since the payout in the ninth round is 150, the rank is 2; and since the payout in the 10th round is zero, the rank is zero. Accordingly, the total value of the counted values of the ranks is 8.

Next, the main CPU 71 determines correction values (step S3519).

For example, as shown in FIG. 89, four correction values of 1, 2, 3, and 4 are determined by a drawing process each at an equal probability.

Next, the main CPU 71 adds a correction value to the total value (step S3521).

For example, when in the example shown in FIG. 89, a correction value of 2 is determined by the drawing process, 2 is added to 8 which is the total value of the ranks, thereby obtaining 10.

Next, the main CPU 71 determines the value obtained by the addition as an enemy physical strength (step S3523).

For example, in the example shown in FIG. 89, 10 calculated in the process at step S3521 is determined as the enemy physical strength

Next, in the round in which a payout is not zero, the main CPU 71 determines an enemy physical strength in that round by subtracting only a value of the rank from the current enemy physical strength (step S3525).

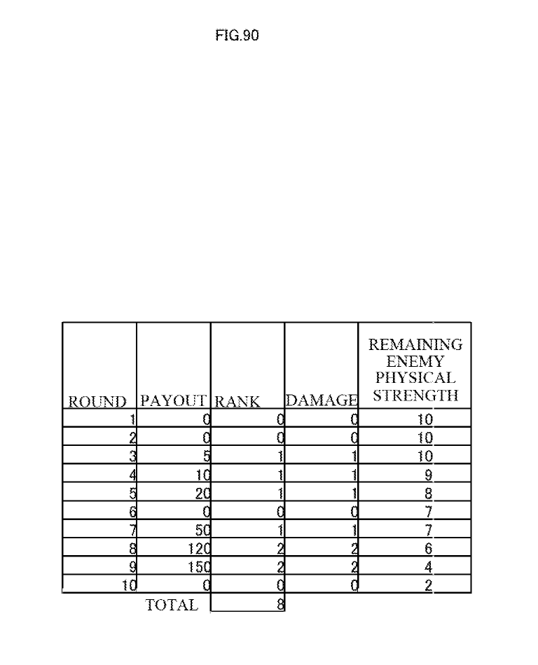

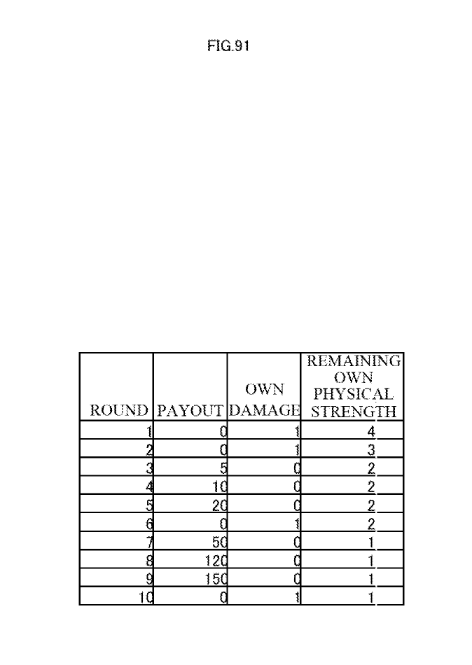

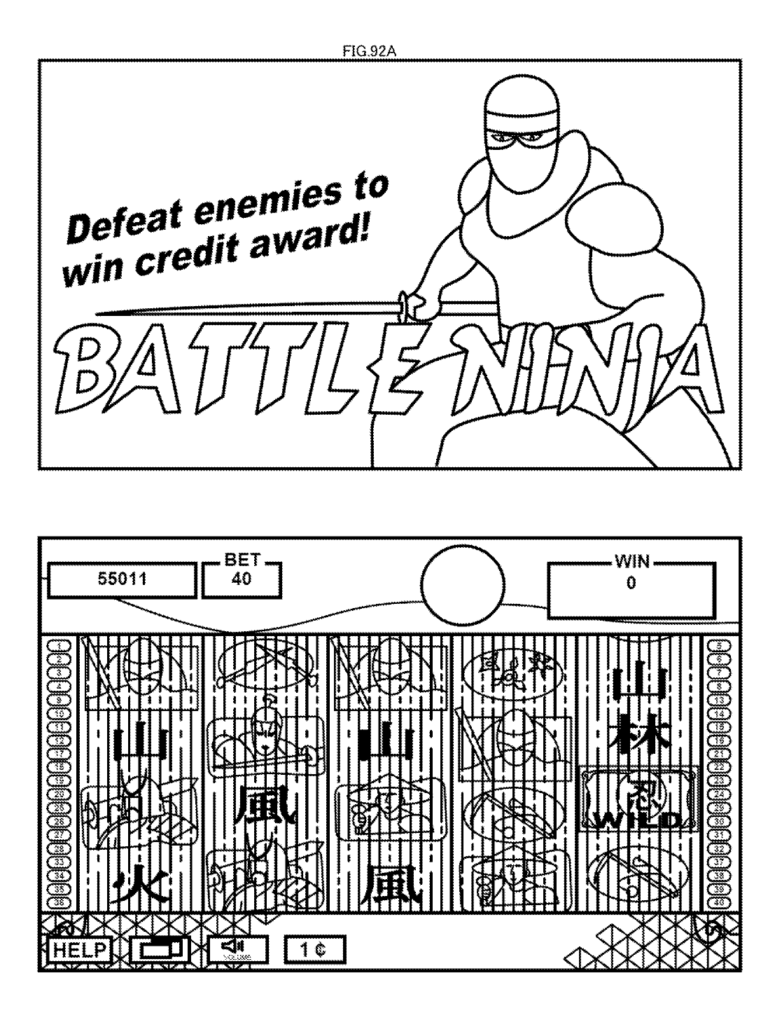

For example, as shown in FIG. 90, in the round in which the payout is not zero, the enemy physical strength is determined by subtracting only a value of the rank therefrom. Specifically, the determination is made as described below. In the first round, 10 calculated in the process at step S3521 is determined as an enemy physical strength. In the second round, since the payout in the first round is zero, no subtraction is made and 10 is determined as an enemy physical strength. In the third round, since the payout in the second round is zero, no subtraction is made and 10 is determined as an enemy physical strength. In the fourth round, since the payout in the third round is 5, 1 of the rank is subtracted and an enemy physical strength is determined as 9. In the fifth round, since the payout in the fourth round is 10, 1 of the rank is subtracted and an enemy physical strength is determined as 8. In the sixth round, since the payout in the fifth round is 20, 1 of the rank is subtracted and an enemy physical strength is determined as 7. In the seventh round, since the payout in the sixth round is zero, no subtraction is made and 7 is determined as an enemy physical strength. In the eighth round, since the payout in the seventh round is 50, 1 of the rank is subtracted and an enemy physical strength is determined as 6. In the ninth round, since the payout in the eighth round is 120, 2 of the rank is subtracted and an enemy physical strength is determined as 4. In the 10th round, since the payout in the ninth round is 150, 2 of the rank is subtracted and an enemy physical strength is determined as 2. As described above, in this example, in the 10th round which is the final round, the enemy physical strengths is 2. It is to be noted that in the final round, there may be a case when an enemy physical strength is zero depending on any correction value.

The above-described processes at step S3515 to S3525 are processes for determining the enemy physical strengths of the enemy characters in each round.

<Own Physical Strength Determination>

Next, the main CPU 71 counts a number of rounds among all rounds, in which a payout is zero (step S3527).

For example, in the case of the example shown in FIG. 88, rounds, in each of which the payout is zero, are four rounds which are the first round, the second round, the sixth round, and the 10th round.

Next, the main CPU 71 determines each of the own physical strengths in each of the rounds so as to decrease by 1 in the rounds, in each of which the payout is zero (step S3535).

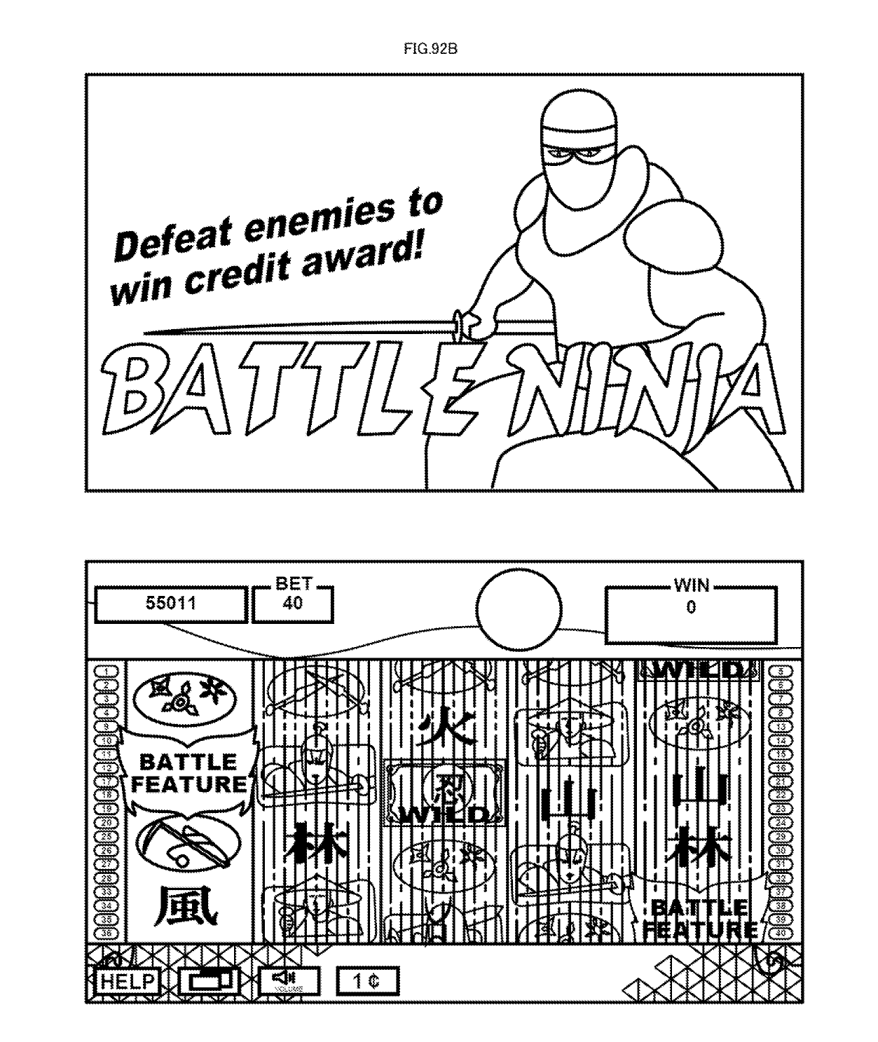

For example, as shown in FIG. 91, in the rounds, in each of which the payout is zero, each of the own physical strengths is determined so as to subtract decrease by 1. Specifically, the determination is made as described below. In the first round, 4 calculated in the process at step S3527 is determined as an own physical strength. In the second round, since a payout in the first round is zero, the subtraction of 1 is made, and an own physical strength is determined as 3. In the third round, since a payout in the second round is zero, the subtraction of 1 is made, and an own physical strength is determined as 2. In the fourth round, since a payout in the third round is 5, no subtraction is made, and an own physical strength is determined as 2. In the fifth round, a payout in the fourth round is 10, no subtraction is made, and an own physical strength is determined as 2. In the sixth round, since a payout in the fifth round is 20, no subtraction is made, and an own physical strength is determined as 2. In the seventh round, a payout in the sixth round is zero, the subtraction of 1 is made, and an own physical strength is determined as 1. In the eighth round, since a payout in the seventh round is 50, no subtraction is made, and an own physical strength is determined as 1. In the ninth round, since a payout in the eighth round is 120, no subtraction is made, and an own physical strength is determined as 1. In the 10th round, since a payout in the ninth round is 150, no subtraction is made, and an own physical strength is determined as 1. As described above, in this example, in the 10th round which is the final round, the own physical strength is 1. It is to be noted that in the final round, there may be a case when an own physical strength is zero depending on any correction value.

The above-described processes at step S3527 to S3535 are processes for determining the own physical strengths of the ally character in each round.

<<<Outline Of Battle Effects>>>

In the present embodiment, in a feature game mode, in the first unit game (the first round) to the maximum number-th unit game (the final round), effects in which an ally character and an enemy character have a battle in accordance with a payout of a unit game are executed. Images of the effects of having the battle are displayed in a symbol display region 141d of a lower display device 141.

Each time a battle of each of the rounds is finished, rearranged symbols determined by to-be-stopped symbols of a unit game corresponding to that round are displayed on an upper display device 131. A player can confirm that a payout provided in the unit game corresponds to an outcome of the battle.

Physical strengths of the ally character and the enemy character increases or decreases in accordance with offense and defense in the battle. In a unit game (round) in which a payout is provided, the physical strength of the enemy character decreases, and in a unit game (round) in which no payout is provided, the physical strength of the ally character decreases.

As an offensive battle, there are single attacks and combos.

<Single Attack S1, Single Attack S2, And Single Attack S3>

As single attacks, there are three kinds which are a single attack S1, a single attack S2, and a single attack S3. With respect to these three attacks, there is no change in a degree of expectation of a payout.

When an attack of an ally character hits an enemy character, a payout is obtained by one hit. In addition, when the attack of the ally character is guarded by the enemy character, no payout can be obtained and the ally character receives a counterattack

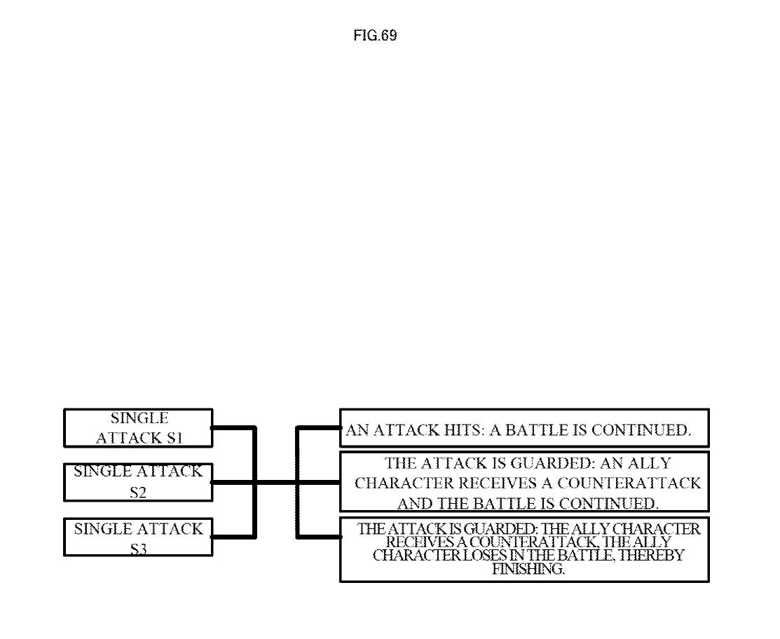

As shown in FIG. 69, as kinds of branching of the single attacks S1, S2, and S3, there are: a case whew the attack hits the enemy character, and the battle is continued; a case where the attack is guarded by the enemy character, the ally character further receives the counterattack from the enemy character, and the battle is continued; and a case where the attack is guarded by the enemy character, the ally character further receives the counterattack from the enemy character, and the ally character loses in the battle, thereby finishing.

<Single Attack S, Single Attack M, And Single Attack L>

As single attacks, there are three kinds which are a single attack S, a single attack M, and a single attack L, and a degree of expectation of a payout changes. Specifically, the payout of the degree of expectation increases as in the order: single attack S<single attack M<single attack L. When the attack of the ally character hits the enemy character, a payout is obtained by one hit

When the attack of the ally character is guarded by the enemy character, no payout can be obtained and the ally character receives the counterattack. In addition, there is also a case when the attack of the ally character hits the enemy character and the ally character defeats the enemy character, and ranking-up of an enemy character occurs by a knockout. In the present embodiment, the knockout and the ranking-up are synonymous with each other.

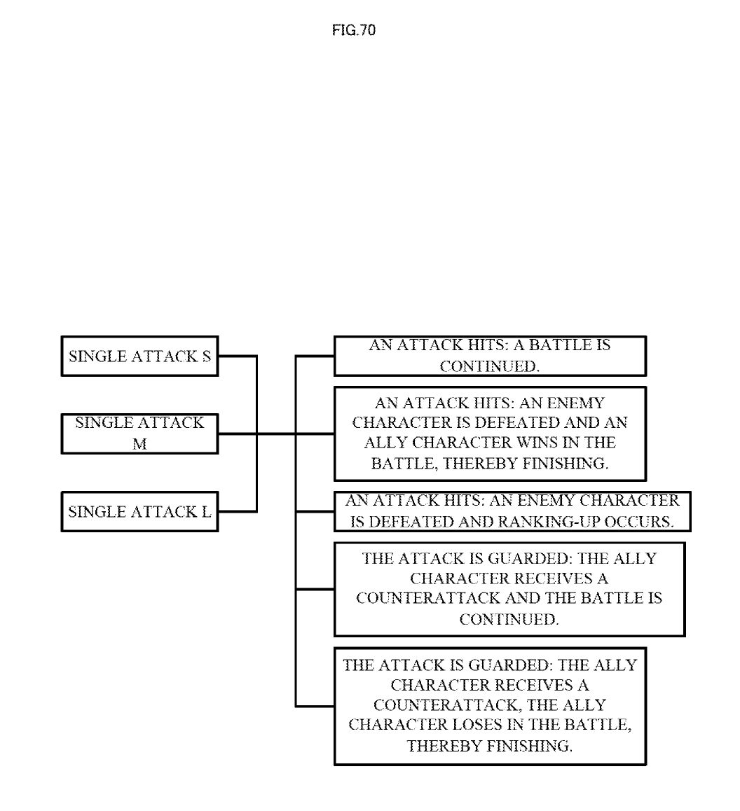

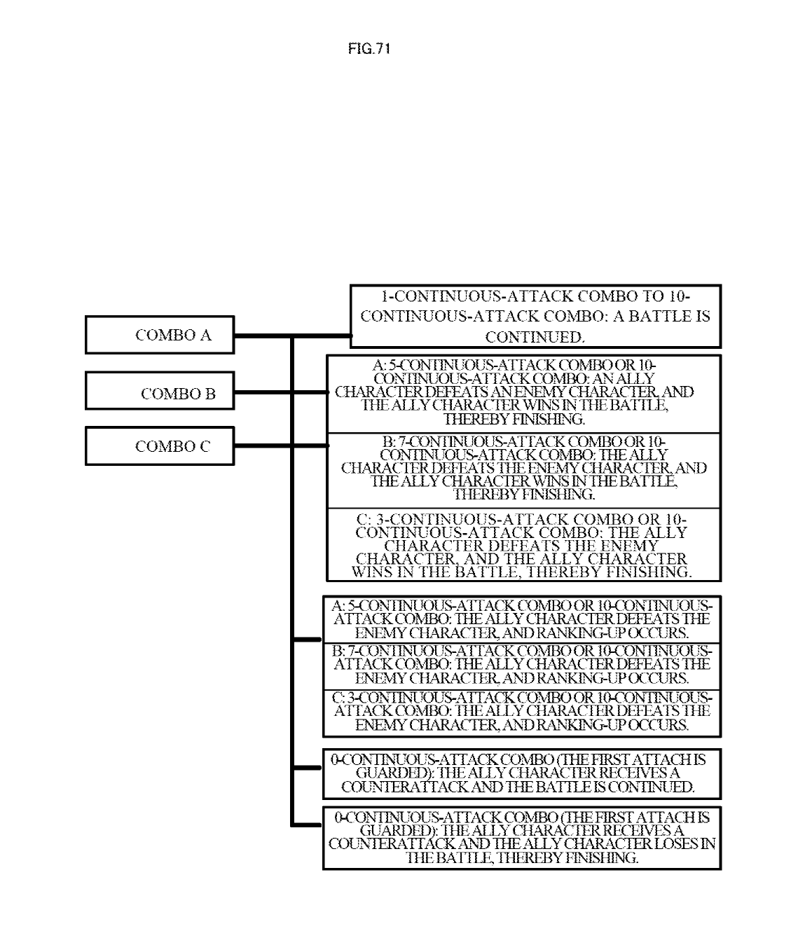

As shown in FIG. 70, as kinds of branching of the single attacks S, M, and L, there are: a case when the attack hits the enemy character, and the battle is continued; a case when the attack hits the enemy character, the ally character defeats the enemy character, and the ally character wins in the battle, thereby finishing; a case when the attack hits the enemy character, the ally character defeats the enemy character, and ranking-up occurs; the attack is guarded by the enemy character, the ally character further receives a counterattack from the enemy character; and the battle is continued; and a case where the attack is guarded by the enemy character, the ally character further receives the counterattack from the enemy character; and the ally character loses in the battle, thereby finishing

<Combo A, Combo B, and Combo C>

In combo effects, an attack in one round is divided into a plurality of attacks. Each payout is sequentially obtained by each of the attacks of a combo and a total of payouts in one round are obtained by the final attack of the combo. In other words, when all of the plurality of attacks in the combo have been finished, the payouts in one round (one unit game) can be obtained.

As kinds of the combos, there are three kinds which are a combo A, a combo B, and a combo C. The kinds of the combos have no relation to a degree of expectation of a payout

In the combo A, the combo B, and the combo C, branching points, at each of which an ally character defeats an enemy character in the middle of the attacks in the combo, thereby leading to ranking-up effects (knockout effects), are different from one another. In the combo A, in the fifth attack and the 10th attack in the combo, when the ally character hits the enemy character, the ally character defeats the enemy character, thereby branching thereto. In the combo B, in the seventh attack and the 10th attack in the combo, when the ally character hits the enemy character, the ally character defeats the enemy character, thereby branching thereto. In the combo C, in the third attack and the 10th attack in the combo, when the ally character hits the enemy character, the ally character defeats the enemy character, thereby branching thereto.

Further, in the combo A, the combo B, and the combo C, there are 11 kinds of continuous attack combos: a 0-continuous-attack combo (in a case where the attack is guarded by the enemy character and the ally character does not hit the enemy character); and a 10-contiuous-attack combo at a maximum (in each of the first attack up to the 10th attack, the ally character continuously hits the enemy character). In other words, in each of the combo A, the combo B, and the combo C, there are 11 kinds of continuous-attack combos: 11 kinds of a combo A-0-continuous-attack combo to a combo A-10-continuous-attack combo; 11 kinds of a combo B-0-continuous-attack combo to a combo B-10-continuous-attack combo; and 11 kinds of a combo C-0-continuous-attack combo to a combo C-10-continuous-attack combo.

In the present embodiment, in the 5-continuous-attack combo, the ally character continuously hits the enemy character in each of the first attack to the fifth attack, and in the sixth attack, the attack is guarded by the enemy character and the ally character does not hit the enemy character. In other words, in the n-continuous-attack combo, the ally character continuously hits the enemy character in each of the first attack to the nth attack, and in the n+1th attack, the attack is guarded by the enemy character and the ally character does not hit the enemy character.

Accordingly, when the continuous attacks in the combo whose number is within 9 are finished, the attack is guarded by the enemy character in the middle of attacks in the combo, thereby finishing the combo. When the continuous attacks in the combo whose number is 10, the ally character continuously hits the enemy character up to the end.

As shown in FIG. 71, in the combo A, the combo B, and the combo C, there are a variety of types of branching

In each of the combos, the battle is continued in the 1-continuous-attack combo to the 10-continuous-attack combo.

In addition, in the combo A, there may be a case when the 5-continuous-attack combo or the 10-continuous-attack combo is conducted, the ally character defeats the enemy character, and the ally character wins in the battle, thereby finishing. In the combo B, there may be a case when the 7-continuous-attack combo or the 10-continuous-attack combo is conducted, the ally character defeats the enemy character, and the ally character wins in the battle, thereby finishing. In the combo C, there may be a case where the 3-continuous-attack combo or the 10-continuous-attack combo is conducted, the ally character defeats the enemy character, and the ally character wins in the battle, thereby finishing

Further, in the combo A, there may be a case when the 5-continuous-attack combo or the 10-continuous-attack combo is conducted, the ally character defeats the enemy character, and the ranking-up occurs. In the combo B, there may be a case where the 7-continuous-attack combo or the 10-continuous-attack combo is conducted, the ally character defeats the enemy character, and the ranking-up occurs. In the combo C, there may be a case when the 3-continuous-attack combo or the 10-continuous-attack combo is conducted, the ally character defeats the enemy character, and the ranking-up occurs.

In addition, there may be a case when the 0-continuous-attack combo is conducted (in the first attack, the attack is guarded by the enemy character), the ally character receives the counterattack from the enemy character, and the battle is continued; and a case where the 0-continuous-attack combo is conducted (in the first attack, the attack is guarded by the enemy character), the ally character receives the counterattack from the enemy character, and the ally character loses in the battle, thereby finishing

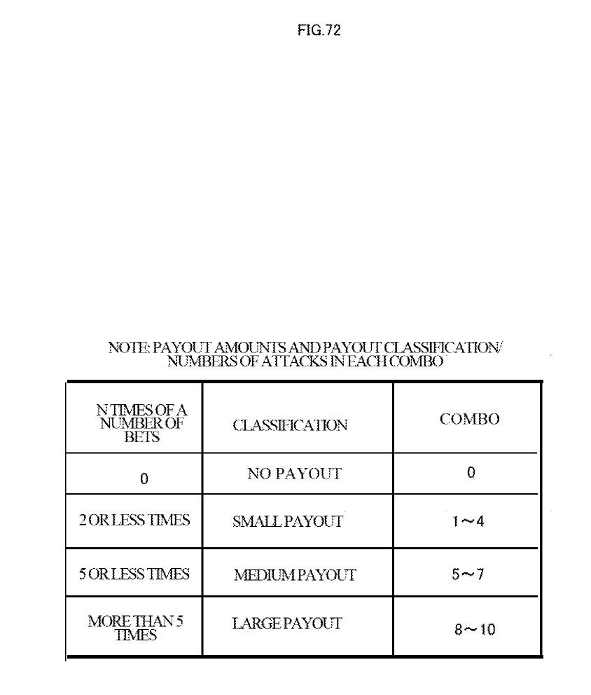

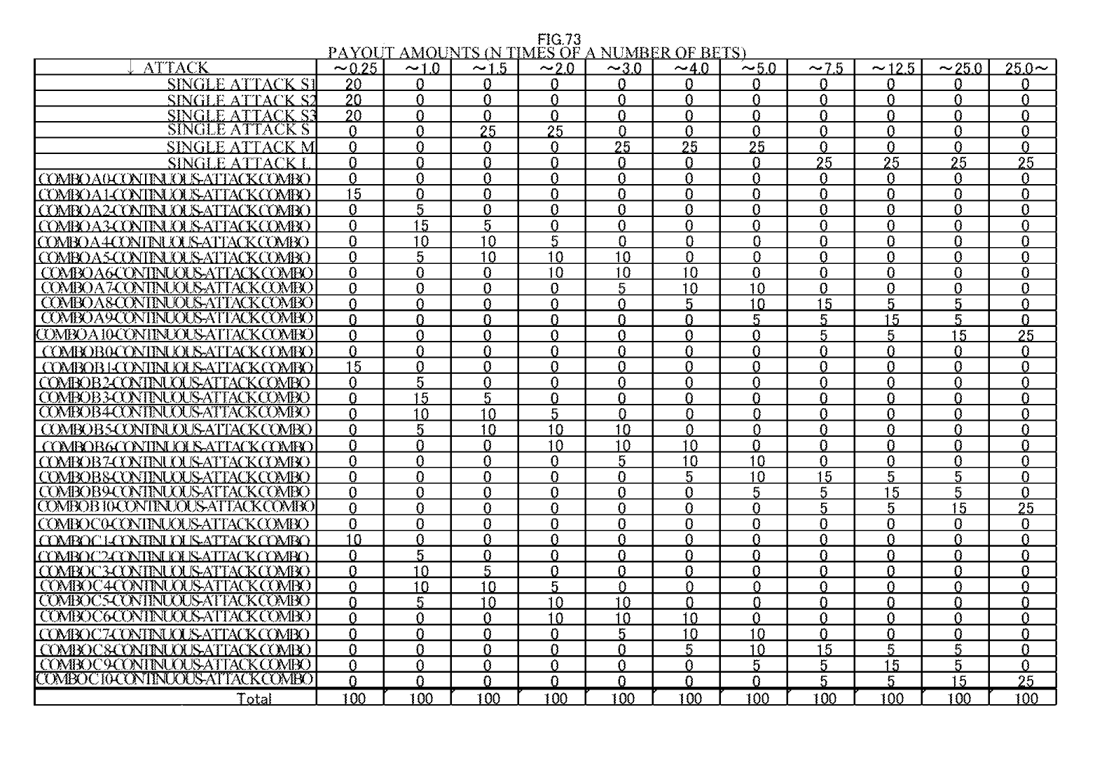

Basically, as shown in FIG. 72, when a payout is 0 times as large as a number of BETs, a 0-continuous-attack combo is conducted and is associated with no payout. When a payout is two or less times as large as a number of BETs, each of the 1 to 4-continuous-attack combo is conducted and is associated with a small payout. When a payout is five or less times as large as a number of BETs, each of the 5 to 7-continuous-attack combo is conducted and is associated with a medium payout. When a payout is more than five times as large as a number of BETs, each of the 8 to 10-continuous-attack combo is conducted and is associated with a large payout

<Battle Effects Drawing Process>

FIG. 36 is a flowchart of a battle effects drawing process in the slot machine 10 according to the present embodiment. As described above, the ranking-up is synonymous with the knockout

First, the main CPU 71 determines whether or not a payout is provided, no ranking-up occurs, and a current game is not the final game (step S3611).

When the main CPU 71 determines that the payout is provided, no ranking-up occurs, and the current game is not the final game, with reference to a battle effects drawing table shown in FIG. 73, the main CPU 71 determines battle effects by a drawing process (step S3613). In this case, after an attack of an ally character has hit an enemy character, a battle is continued.

As shown in FIG. 73, the battle effects drawing table defines weights of respective kinds of battles in accordance with 11 kinds of relationships between payouts and multipliers of numbers of BETs.

The 11 kinds of relationships between the payouts and the multipliers of the numbers of BETs are: a case when a payout is less than 0.25 times as large as a number of BETs; a case when a payout is less than 1.0 times as large as a number of BETs; a case when a payout is less than 1.5 times as large as a number of BETs; a case when a payout is less than 2.0 times as large as a number of BETs; a case when a payout is less than 3.0 times as large as a number of BETs; a case when a payout is less than 4.0 times as large as a number of BETs; a case when a payout is less than 5.0 times as large as a number of BETs; a case where a payout is less than 7.5 times as large as a number of BETs; a case when a payout is less than 12.5 times as large as a number of BETs; a case when a payout is less than 25.0 times as large as a number of BETs; and a case when a payout is 25.0 or more times as large as a number of BETs.

Kinds of battles are: a single attack S1, a single attack S2, a single attack S3, a single attack S, a single attack M, a single attack L, a combo A 0-continous-attack-combo to a combo A 10-continous-attack-combo, a combo B 0-continous-attack-combo to a combo B 10-continous-attack-combo, and a combo C 0-continous-attack-combo to a combo C 10-continous-attack-combo.

Next, when the main CPU 71 determines that no payout is provided, or the ranking-up occurs, or the current game is the final game, the main CPU 71 determines whether or not no payout is provided and there is a next round (step S3615).

When the main CPU 71 determines that no payout is provided and there is a next round, with reference to a battle effects drawing table shown in FIG. 74, the main CPU 71 determines battle effects by a drawing process (step S3617). In this case, after the attack of the ally character has been guarded by the enemy character, the ally character receives the counterattack from the enemy character and the battle is continued.

As shown in FIG. 74, the battle effects drawing table defines weights of respective kinds of battles in accordance with payouts.

Kinds of battles are: a single attack S1, a single attack S2, a single attack S3, a single attack S, a single attack M, a single attack L, a combo A 0-continous-attack-combo to a combo A 10-continous-attack-combo, a combo B 0-continous-attack-combo to a combo B 10-continous-attack-combo, and a combo C 0-continous-attack-combo to a combo C 10-continous-attack-combo.

Next, when the main CPU 71 determines that a payout is provided or there is no next round, the main CPU 71 determines whether or not ranking-up occurs (step S3619).

When the main CPU 71 determines that the ranking-up occurs, with reference to a battle effects drawing table shown in FIG. 75, the main CPU 71 determines battle effects by a drawing process (step S3621). In this case, after the attack of the ally character has hit the enemy character, the ally character defeats the enemy character, and the battle effects shift to ranking-up effects (knockout effects).

A shown in FIG. 75, the battle effects drawing table defines weights of respective kinds of battles in accordance with 11 kinds of relationships between payouts and multipliers of numbers of BETs.

The 11 kinds of relationships between the payouts and the multipliers of the numbers of BETs are:

a case when a payout is less than 0.25 times as large as a number of BETs; a case when a payout is less than 1.0 times as large as a number of BETs; a case when a payout is less than 1.5 times as large as a number of BETs; a case when a payout is less than 2.0 times as large as a number of BETs; a case when a payout is less than 3.0 times as large as a number of BETs; a case when a payout is less than 4.0 times as large as a number of BETs; a case when a payout is less than 5.0 times as large as a number of BETs; a case where a payout is less than 7.5 times as large as a number of BETs; a case when a payout is less than 12.5 times as large as a number of BETs; a case when a payout is less than 25.0 times as large as a number of BETs; and a case when a payout is 25.0 or more times as large as a number of BETs.

Kinds of battles are: a single attack S1, a single attack S2, a single attack S3, a single attack S, a single attack M, a single attack L, a combo A 0-continous-attack-combo to a combo A 10-continous-attack-combo, a combo B 0-continous-attack-combo to a combo B 10-continous-attack-combo, and a combo C 0-continous-attack-combo to a combo C 10-continous-attack-combo.

Next, when the main CPU 71 determines that no ranking-up occurs, the main CPU 71 determines whether or not in the final game, the ally character wins in the battle, thereby finishing (step S3623).

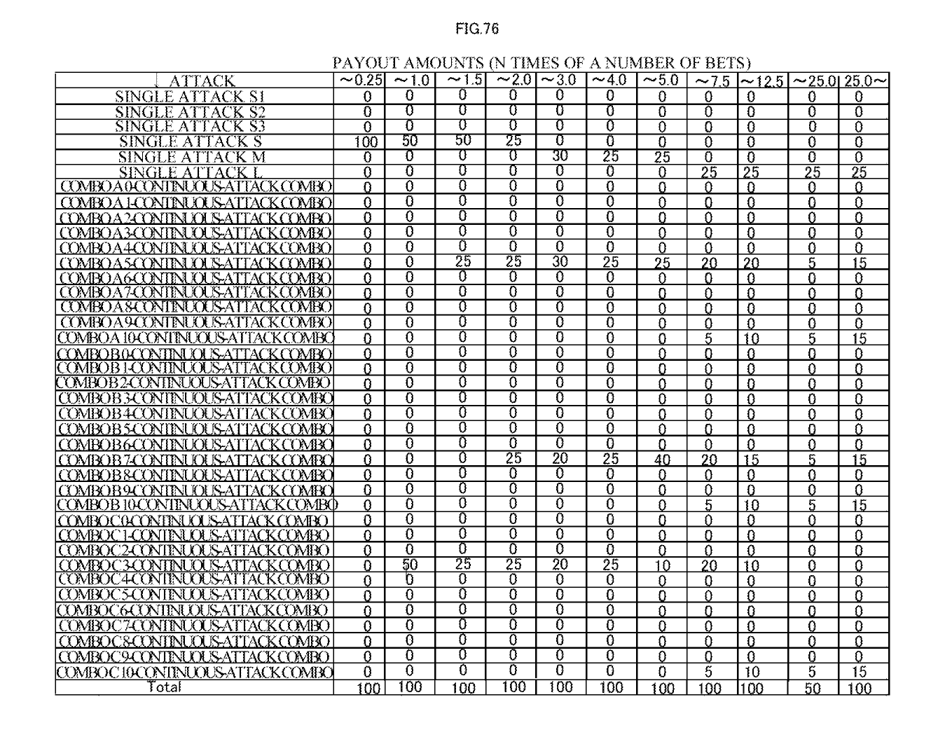

When the main CPU 71 determines that the ally character wins in the battle, thereby finishing, with reference to a battle effects drawing table shown in FIG. 76, the main CPU 71 determines battle effects by a drawing process (step S3625). In this case, after the attack of the ally character has hit the enemy character, the ally character defeats the enemy character, and the battle effects shift to effects in which the battle is finished.

As shown in FIG. 76, the battle effects drawing table defines weights of respective kinds of battles in accordance with 11 kinds of relationships between payouts and multipliers of numbers of BETs.

The 11 kinds of relationships between the payouts and the multipliers of the numbers of BETs are: a case when a payout is less than 0.25 times as large as a number of BETs; a case when a payout is less than 1.0 times as large as a number of BETs; a case where a payout is less than 1.5 times as large as a number of BETs; a case when a payout is less than 2.0 times as large as a number of BETs; a case when a payout is less than 3.0 times as large as a number of BETs; a case when a payout is less than 4.0 times as large as a number of BETs; a case when a payout is less than 5.0 times as large as a number of BETs; a case where a payout is less than 7.5 times as large as a number of BETs; a case when a payout is less than 12.5 times as large as a number of BETs; a case when a payout is less than 25.0 times as large as a number of BETs; and a case when a payout is 25.0 or more times as large as a number of BETs.

Kinds of battles are: a single attack S1, a single attack S2, a single attack S3, a single attack S, a single attack M, a single attack L, a combo A 0-continous-attack-combo to a combo A 10-continous-attack-combo, a combo B 0-continous-attack-combo to a combo B 10-continous-attack-combo, and a combo C 0-continous-attack-combo to a combo C 10-continous-attack-combo.

Next, when the main CPU 71 determines that in the final game, the ally character does not win in the battle, thereby not finishing, the main CPU 71 determines whether or not in the final game, the ally character loses in the battle, thereby finishing (step S3627).

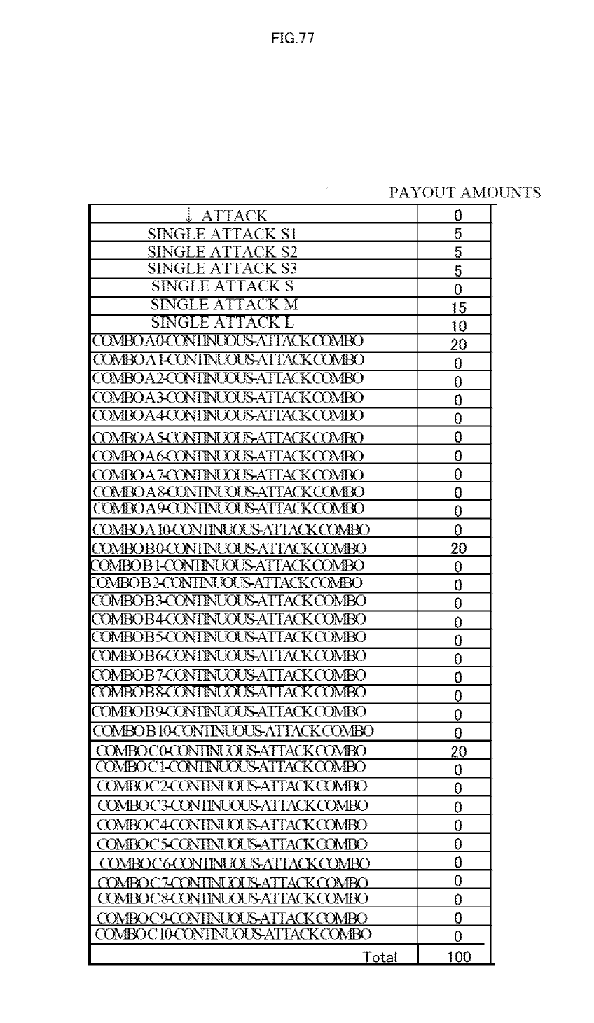

When the main CPU 71 determines that in the final game, the ally character loses in the battle, thereby finishing, with reference to a battle effects drawing table shown in FIG. 77, the main CPU 71 determines battle effects by a drawing process (step S3629). In this case, after the attack of the ally character has been guarded by the enemy character, the ally character receives the counterattack of the enemy character, the ally character is defeated, and the battle effects shifts to effects in which the battle is finished.

As shown in FIG. 77, the battle effects drawing table defines weights of respective kinds of battles in accordance with payouts.

Kinds of battles are: a single attack S1, a single attack S2, a single attack S3, a single attack S, a single attack M, a single attack L, a combo A 0-continous-attack-combo to a combo A 10-continous-attack-combo, a combo B 0-continous-attack-combo to a combo B 10-continous-attack-combo, and a combo C 0-continous-attack-combo to a combo C 10-continous-attack-combo.

After executing the above-described processes at step S3613, S3617, S3621, S3625, and S3629, or in the determination process at step S3627, when the main CPU 71 determines that in the final game, the ally character does not lose in the battle, thereby not finishing, the main CPU71 reads out and executes a combo effects drawing process shown in FIG. 37 (step S3631), finishing this sub-routine. When by the drawing process with reference to each of the above-described battle effects drawing tables, any of the combo A 0-continous-attack-combo to the combo A 10-continous-attack-combo, the combo B 0-continous-attack-combo to the combo B 10-continous-attack-combo, and the combo C 0-continous-attack-combo to the combo C 10-continous-attack-combo is selected, specific contents of combo effects are determined by a combo effects drawing process.

<Combo Effects Drawing Process>

FIG. 37 is a flowchart of the combo effects drawing process in the slot machine 10 according to the present embodiment. When any combo is selected in the battle, a payout of that round is displayed by dividing the payout thereof by a number of attacks in the combo, and each divided payout is obtained in each of the attacks.

First, the main CPU 71 determines whether or not no ranking-up occurs, and a current game is not the final game and a current combo is any of 2 to 9-continous-attack-combos (step S3711).

When the main CPU 71 determines that no ranking-up occurs, and the current game is not the final game and the current combo is any of 2 to 9-continous-attack-combos, a payout in that round is divided by a number of continuous attacks in the combo (step S3713).

Next, the main CPU 71 stores a quotient of the division as each payout obtained by each of the attacks in the combo (step S3715).

Next, the main CPU 71 determines whether or not there is a remainder from the division (step S3717).

When the main CPU 71 determines that there is no remainder from the division, the main CPU 71 immediately finishes this sub-routine.

When the main CPU 71 determines that there is a remainder from the division, the main CPU 71 adds the remainder to any of the attacks in the combo (step S3719), finishing this sub-routine. The attack in the combo to which the remainder is added can be randomly determined by a drawing process or the like.

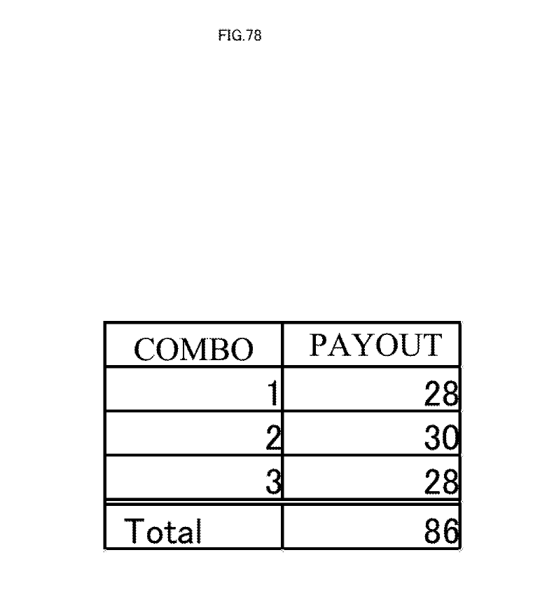

For example, when a current combo is a 3-continous-attack-combo and a payout is 86, “86÷3=28, with a remainder of 2” is calculated by the process at step S3713, in which the quotient is 28 and the remainder is 2. When the second attack in the combo among the 3-continuous attacks in the combo, to which the remainder is added, is selected, the payout in the second attack of the combo is 28+2=30. As a result, as shown in FIG. 78, a payout in the first attack of the combo is 28, the payout in the second attack in the combo is 30, and a payout in the third attack of the combo is 28.

When in the determination process at step S3711, the main CPU 71 determines that the ranking-up occurs, or the current game is the final game, or the current combo is not any of the 2 to 9-continous-attack-combos, the main CPU 71 determines whether or not the ranking-up occurs (step S3721).

When the main CPU 71 determines that the ranking-up does not occur, the main CPU 71 determines whether or not the current game is the final game (step S3723).

When the main CPU 71 determines that the current game is not the final game, the main CPU 71 determines whether or not a current combo is a 10-continous-attack-combo (step S3725).

When the main CPU 71 determines that the current combo is not the 10-continous-attack-combo, the main CPU 71 finishes this sub-routine.

When in the determination process at step S3721, the main CPU 71 determines that the ranking-up occurs, when in the determination process at step S3723, the main CPU 71 determines that the current game is the final game, and when in the determination process at step S3725, the main CPU 71 determines that the current combo is the 10-continous-attack-combo, the main CPU 71 determines a number to be added by a drawing (step S3727).

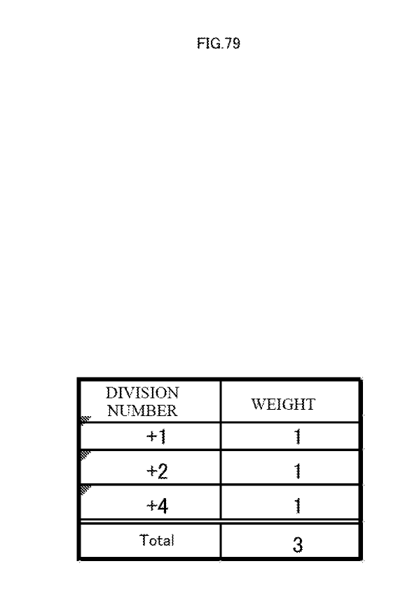

For example, with reference to a table as shown in FIG. 79, the number to be added is determined by a drawing process. In the table shown in FIG. 79, three kinds of numbers of 1, 2, and 4 are determined each at an equal probability.

Next, the main CPU 71 divides a payout of that round by (a number of attacks in that combo+a number to be added) (step S3729).

Next, the main CPU 71 stores a quotient of the division as a payout of each of the attacks in that combo (step S3731).

Next, the main CPU 71 determines whether or not there is a remainder from the division (step S3733).

When the main CPU 71 determines that there is the remainder from the division, the remainder is added to any of the attacks in the combo other than the final attack in the combo (step S3735). The attack in the combo to which the remainder is added can be randomly determined by a drawing process or the like.

After executing the process at step S3735, or when the main CPU 71 determines that there is no remainder from the division, the main CPU 71 adds a remaining portion of the payout to the final attack in the combo (step S3737), finishing this sub-routine. The remaining portion of the payout is calculated by subtracting a total sum of payouts of the first attack to an attack immediately preceding the final attack in the combo from all the payouts in this round.

For example, when the current combo is the 10-continous-attack-combo and a payout is 825, 4 is determined as a number to be added by the process at step S3727, and “825÷(10+4)=58, with a remainder of 13” is calculated by the process at step S3729. In this case, 4 as the number to be added is added to 10 of the 10-continous-attack-combo, and “825÷14” is calculated. As a result, the quotient is 58 and the remainder is 13. When the third attack in the combo among the attacks in the 10-continous-attack-combo is selected as the attack in the combo to which the remainder is added, a payout of the third attack in the combo is “58+13=71”. A payout of each of the first attack to the ninth attack in the combo, other than the third attack in the combo, is 58 which is the quotient. Further, a payout of the 10th attack in the combo which is the final attack in the combo is 290. This 290 can be calculated by “825−71−8×58=290”.

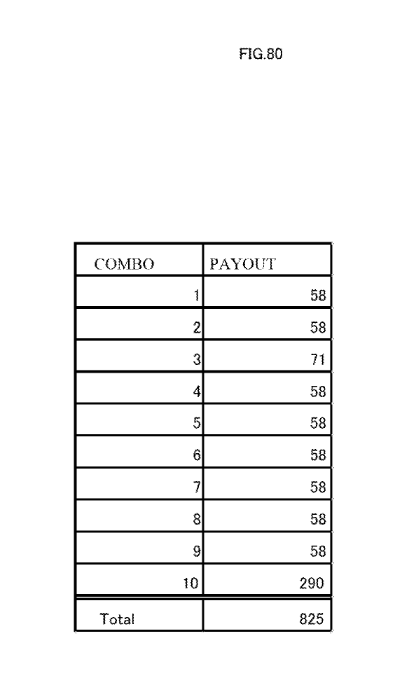

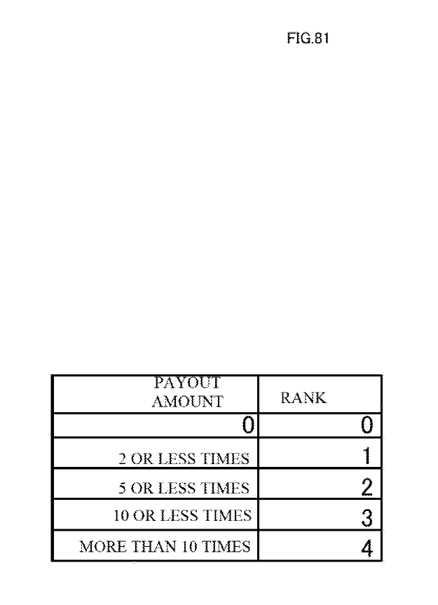

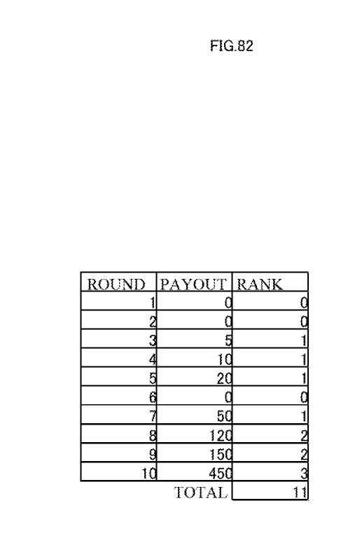

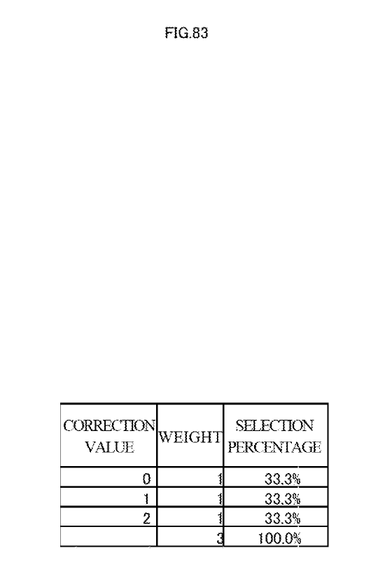

Accordingly, as shown in FIG. 80, each of the payouts of the first attack, the second attack, and the fourth to the ninth attacks in the combo is 58, the payout of the third attack in the combo is 71, and the payout of the 10th attack is 290.

<<Examples of Battle Effects>>

FIG. 92A to FIG. 92D to FIG. 111A to FIG. 111D are diagrams illustrating images of examples of battle effects. In each of FIG. 92A to FIG. 92D to FIG. 111A to FIG. 111D, an upper image is an image displayed on an upper display device 131 and a lower image is an image displayed on a lower display device 141.

<Shifting from Base Game Mode to Feature Game Mode>

As shown in FIG. 92A to FIG. 92D, in a base game mode, on the upper display device 131, a regular effects image with an image of a character and letters such as “BATTLE NINJA” is displayed. On the lower display device 141, five video reels 3a to 3e are displayed. On the lower display device 141, a unit game in the base game mode is displayed by the five video reels 3a to 3e.

As shown in FIG. 92A, on the lower display device 141, all of the five video reels 3a to 3e are displayed in a scrolling manner.

As shown in FIG. 92B, the video reel 3a is stopped, and a trigger symbol of FEATURE of the video reel 3a is displayed in an upper middle row (second row). It is to be noted that in the example of the battle effects, a symbol of FEATURE is displayed as a symbol of “BATTLE FEATURE”.

As shown in FIG. 92C, the video reels 3b to 3d are displayed in a stopped manner, and a trigger symbol of FEATURE of the video reel 3c is displayed in the stopped manner in the upper middle row (second row).

As shown in FIG. 92D, the video reel 3e is displayed in the stopped manner, and a trigger symbol of FEATURE of the video reel 3e is displayed in the upper middle row (second row). In this way, the trigger symbols of FEATURE of the three video reels 3a, 3c, and 3e are displayed in the stopped manner in the upper middle row (second row), thereby triggering a feature game mode.

As shown in FIG. 92D, all of the five video reels 3a to 3e are stopped, thereby rearranging 20 (=5 reels×4 rows) symbols on the lower display device 141. Thus, an outcome of the unit game in the base game mode is displayed.

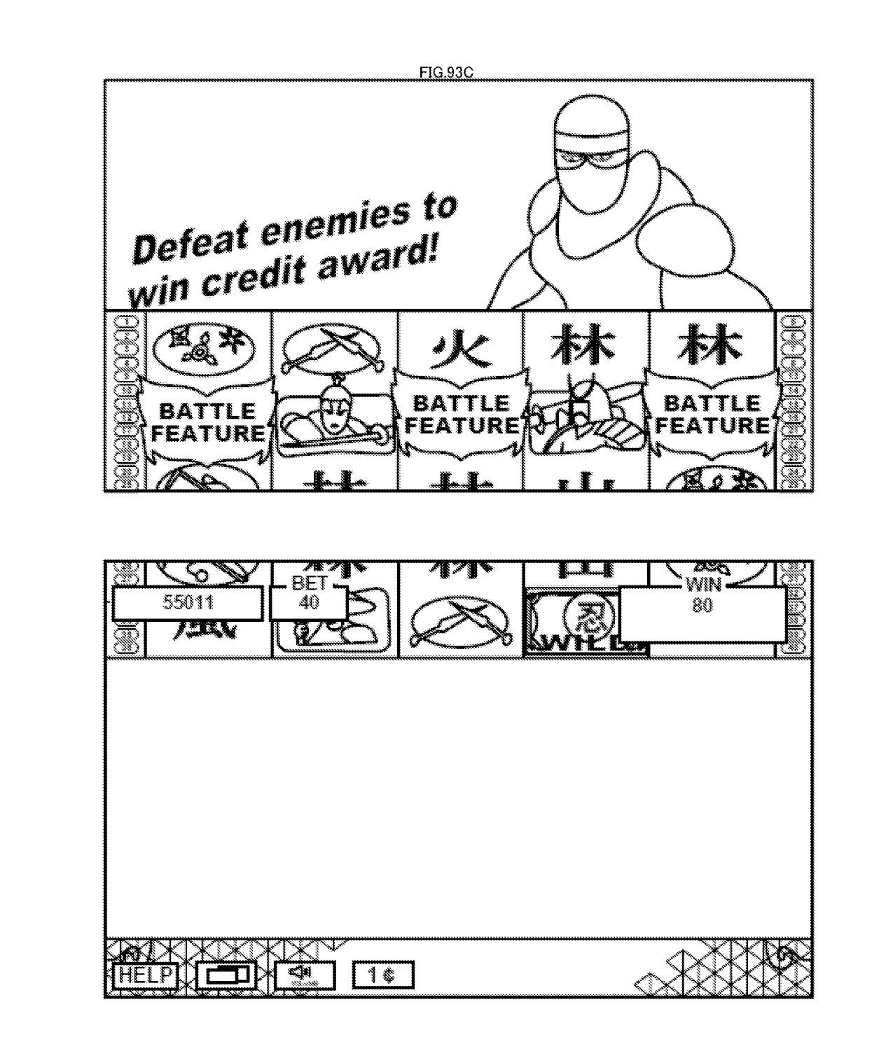

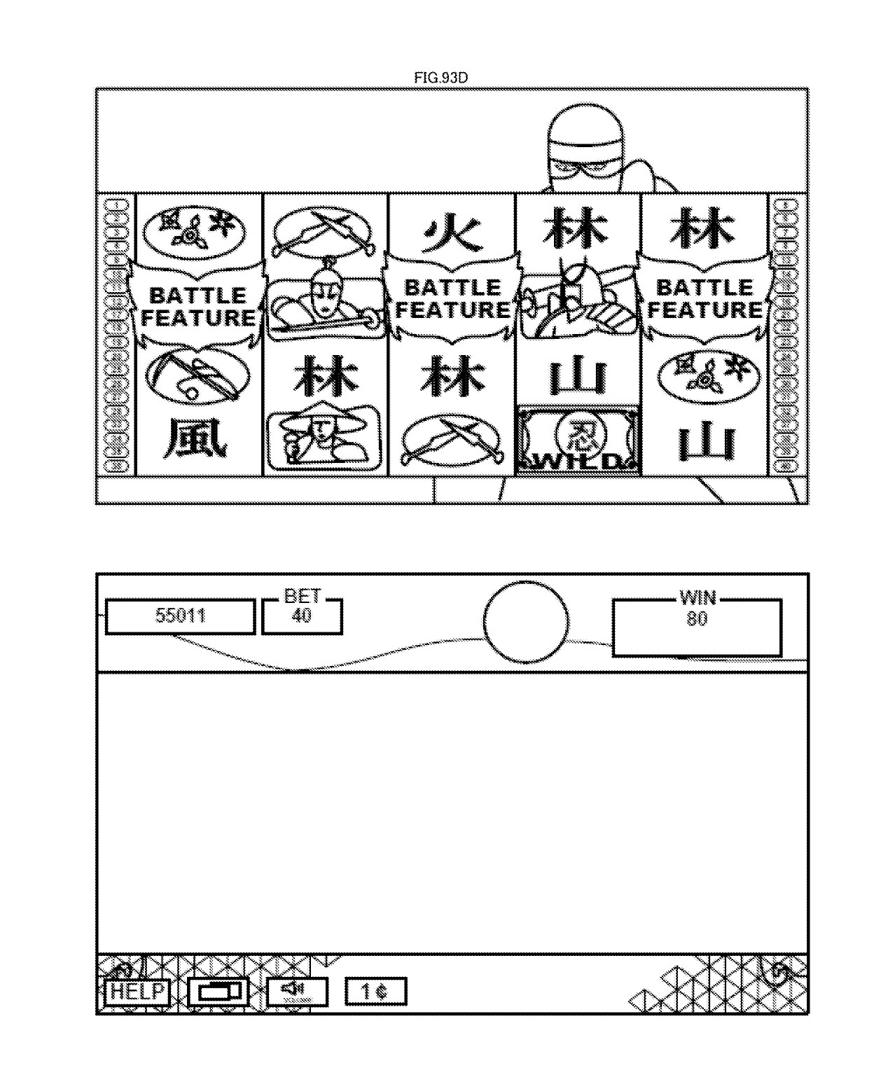

As shown in FIG. 93A to FIG. 93D, a state in which all of the five video reels 3a to 3e are stopped is maintained, and displaying is conducted so as to gradually move from the lower display device 141 to the upper display device 131. Thus, the base game mode is finished, thereby shifting to the feature game mode.

<Start of Feature Game Mode>

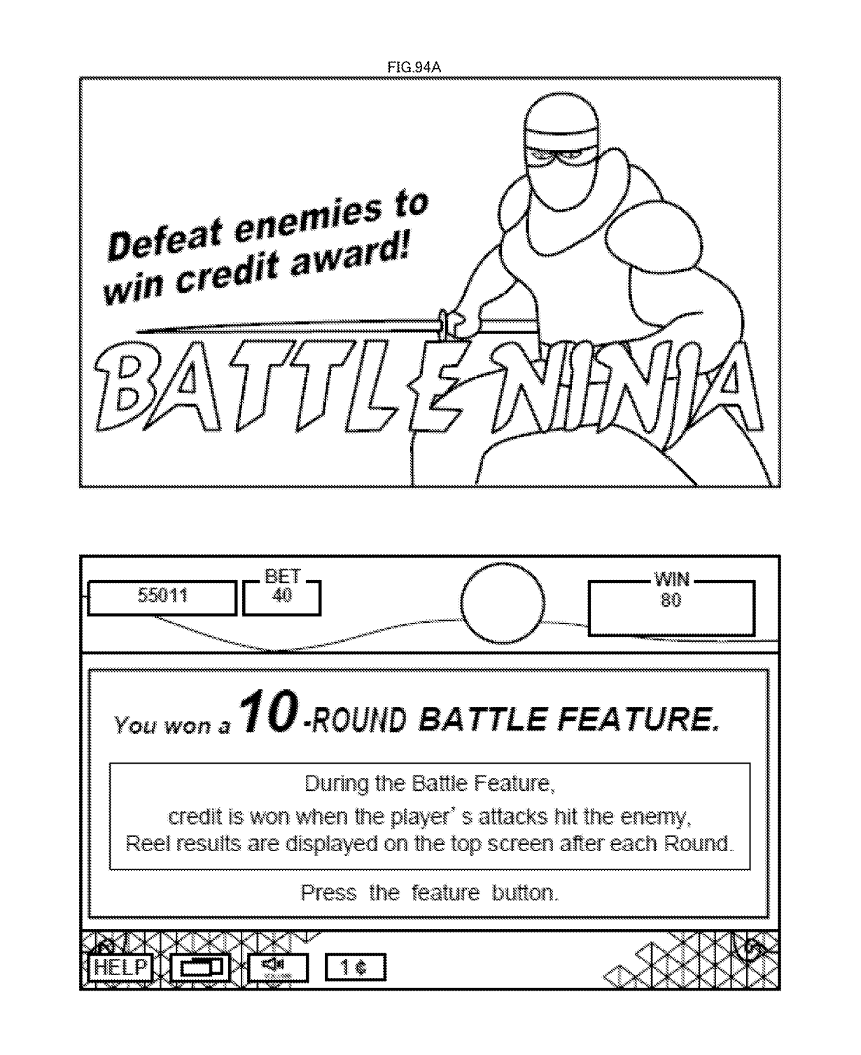

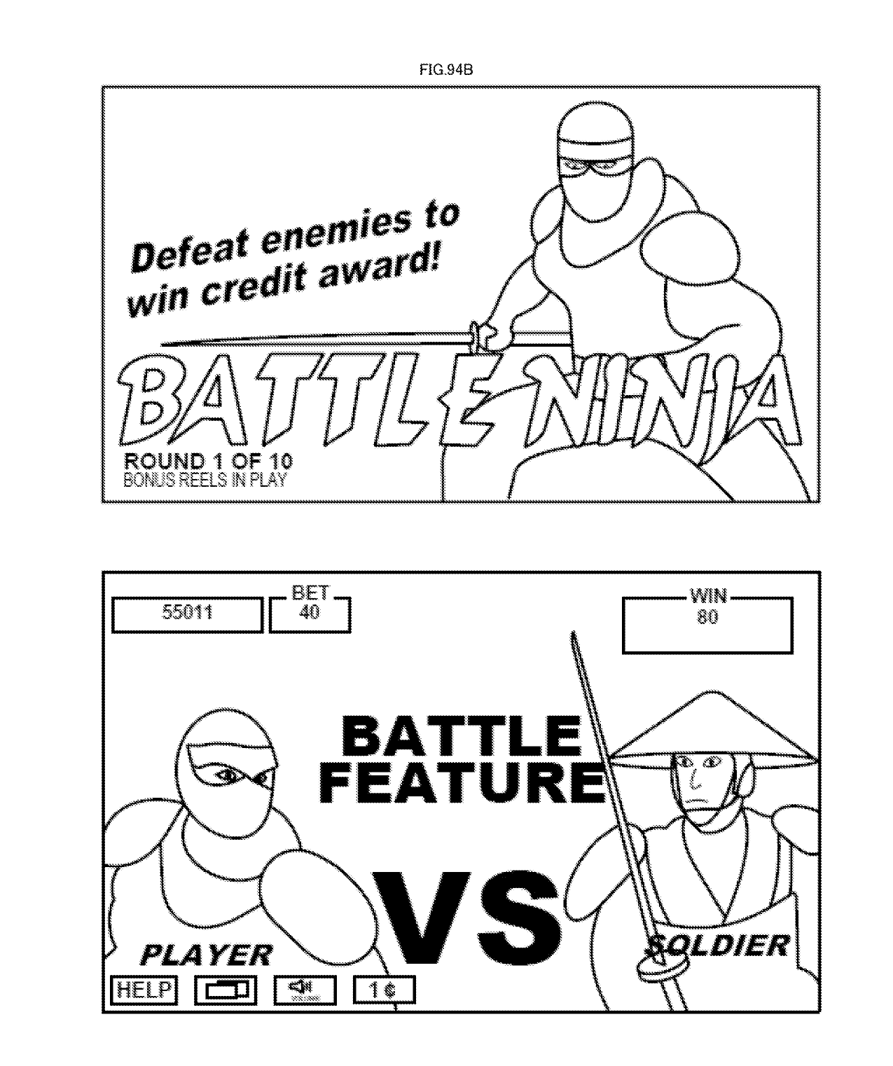

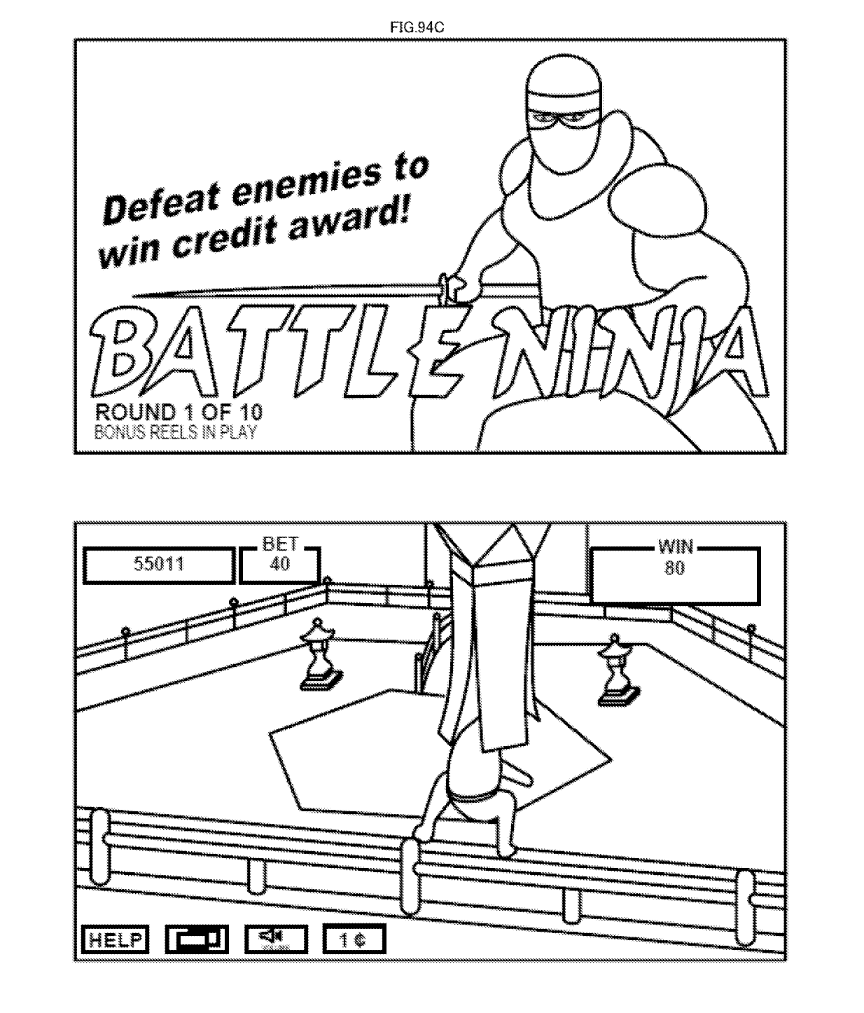

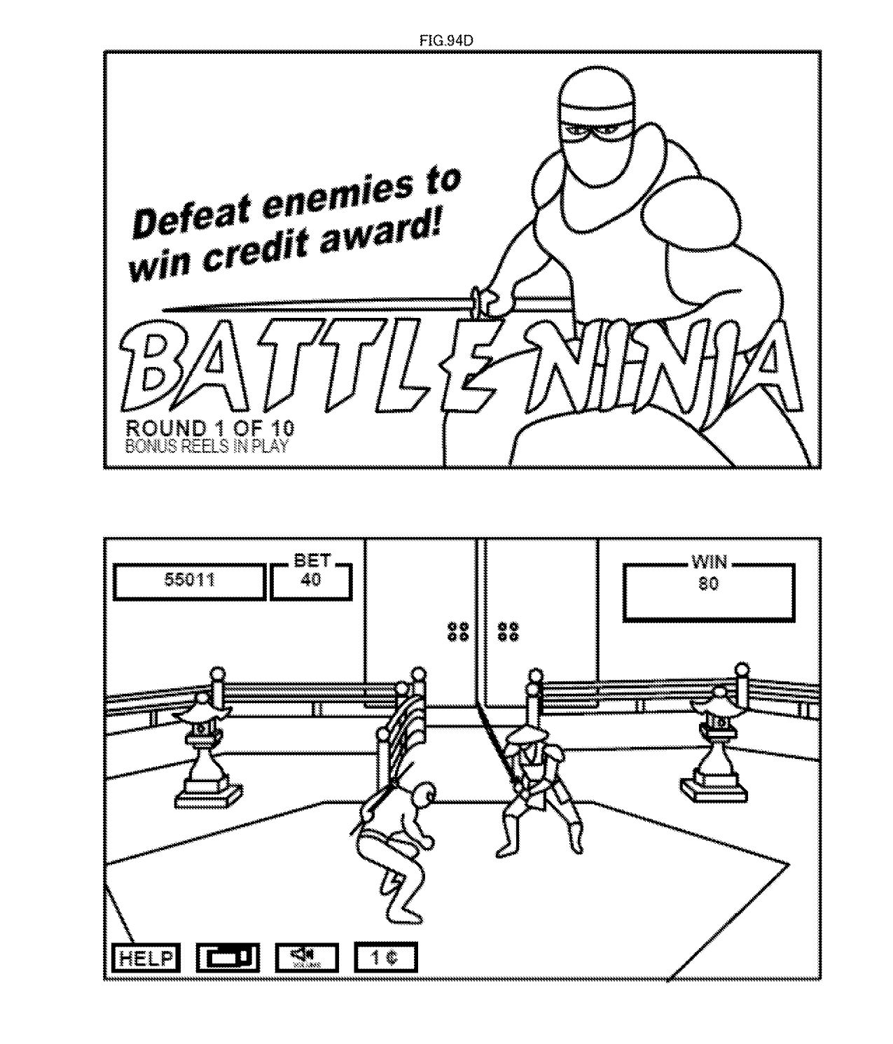

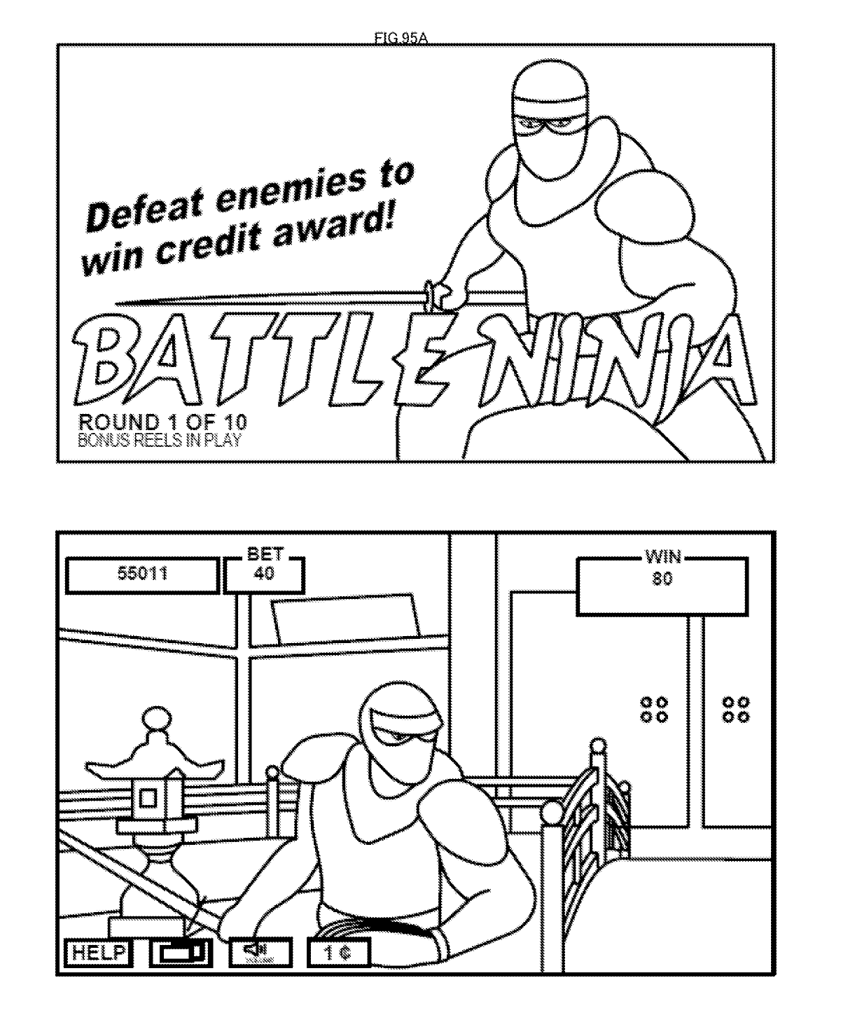

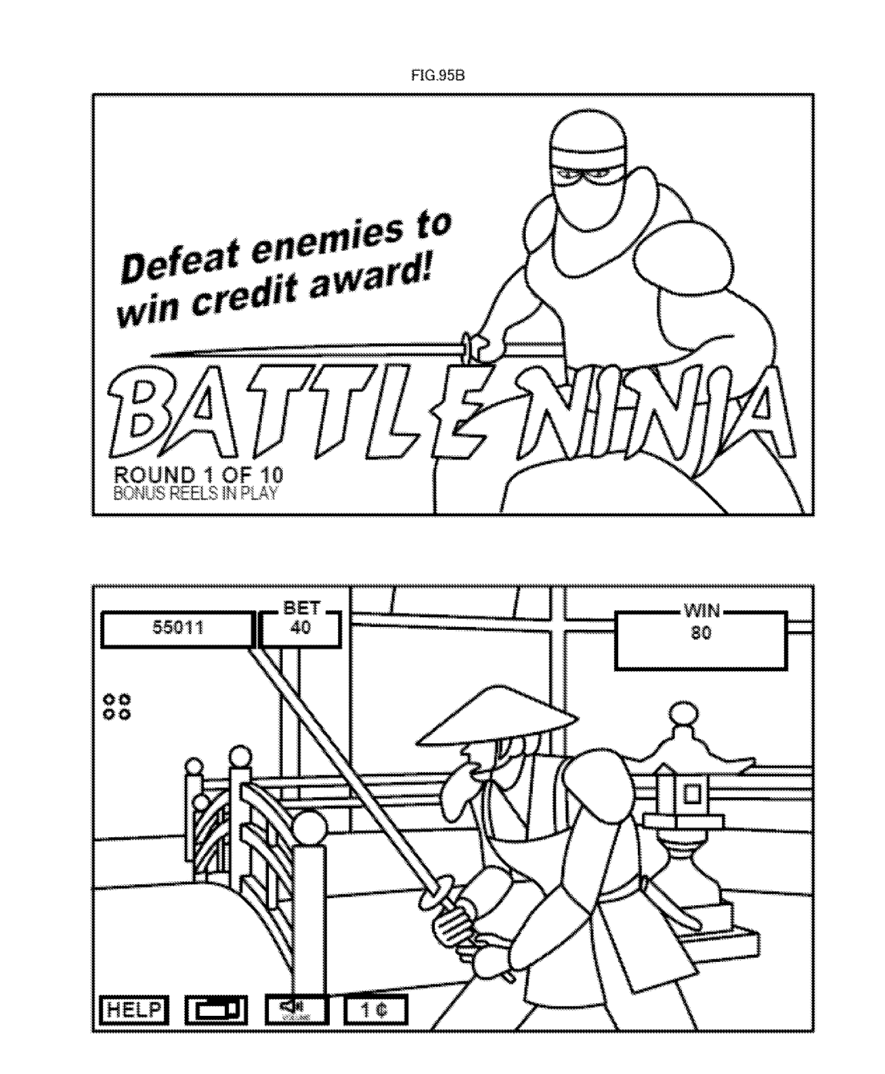

As shown in FIG. 94A, on the upper display device 131, all of the five video reels 3a to 3e are cleared, and the original effects image is displayed again.

At this point in time, the processes at step S2311 to S2325 in FIG. 23 are executed, a drawing for to-be-stopped symbols for battle effects, payouts, rearrangement, a knockout, contents of effects, and the like are determined. In the later-described battle effects, the final round is the 10th round, and a drawing for to-be-stopped symbols for each of all the first round (first unit game) to the 10th round (the 10th unit game), payouts, rearrangement, a knockout, contents of effects, and the like are determined.

As shown in FIG. 94B to FIG. 95B, an ally character and an enemy character are displayed on the lower display device 141, thereby allowing a player to visually recognize that in the feature game mode, the battle effects are displayed and started. A character on a player side is the ally character (PLAYER), and a character who fights against a player side is the enemy character (SOLDIER).

Hereinunder, the processes at step S2329 to S2337 in FIG. 23 are executed.

<Battle Effects of the First Round>

As shown in FIG. 95C, “ROUND 1 FIGHT!” is displayed, thereby starting the first round. Upon starting battle effects, in the central portion of an upper side of the lower display device 141, numerical values indicating round No. and a payout in the round are displayed. On a left side of the upper side thereof, a display area of “BET” indicating a number of BETs is formed. On a right side of the upper side thereof, a display area of “WIN” indicating a payout which can be obtained is formed. Below the display area of “BET”, a gauge (PLAYER part) indicating a physical strength of the ally character is displayed. Below the display area of “WIN”, a gauge (SOLDIER part) indicating a physical strength of the enemy character is displayed.

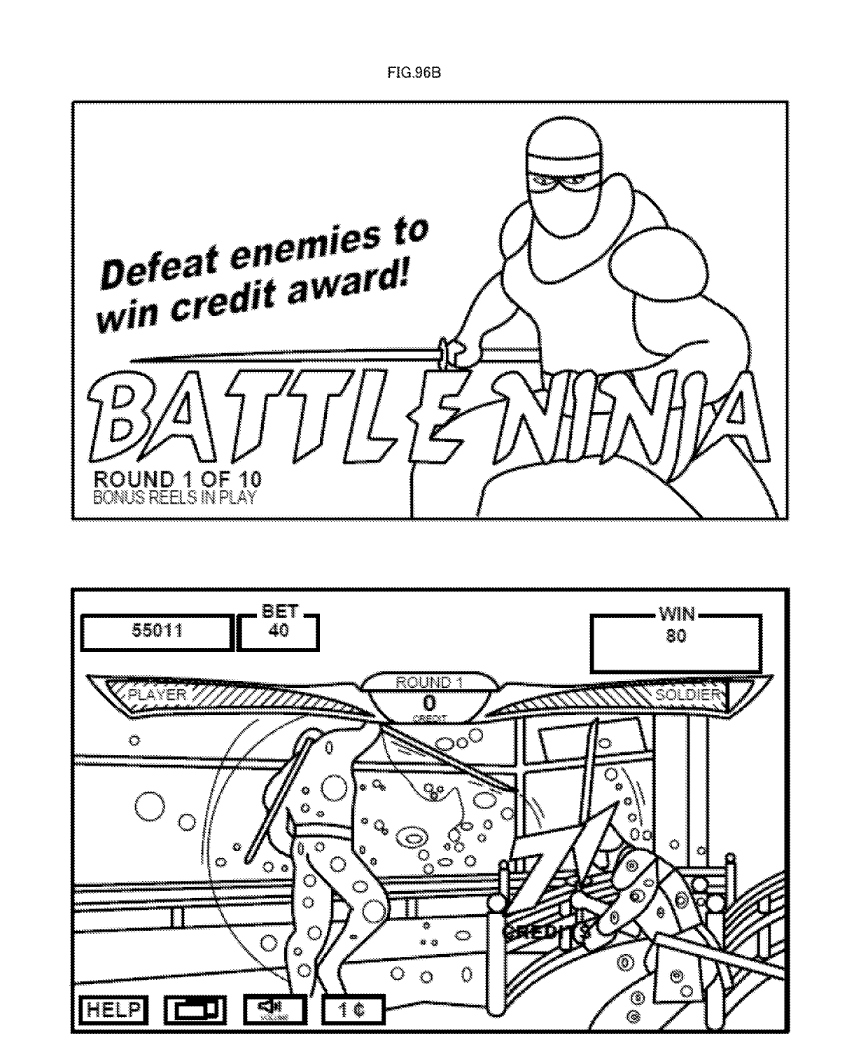

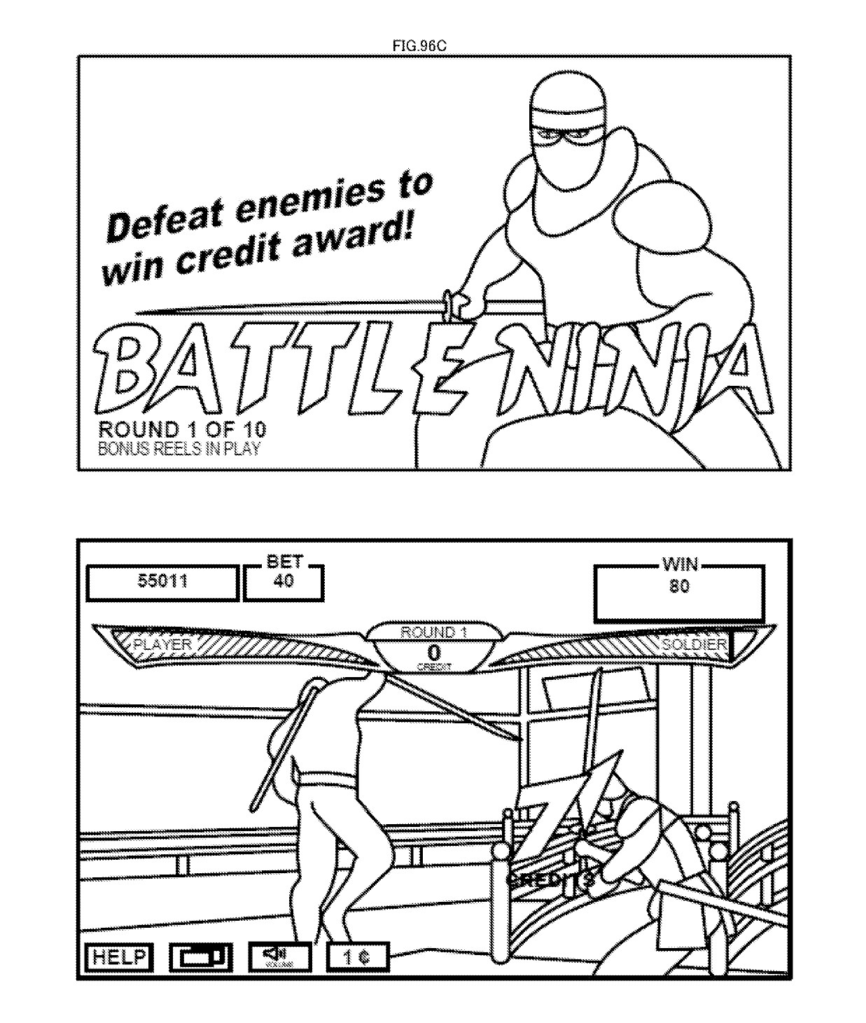

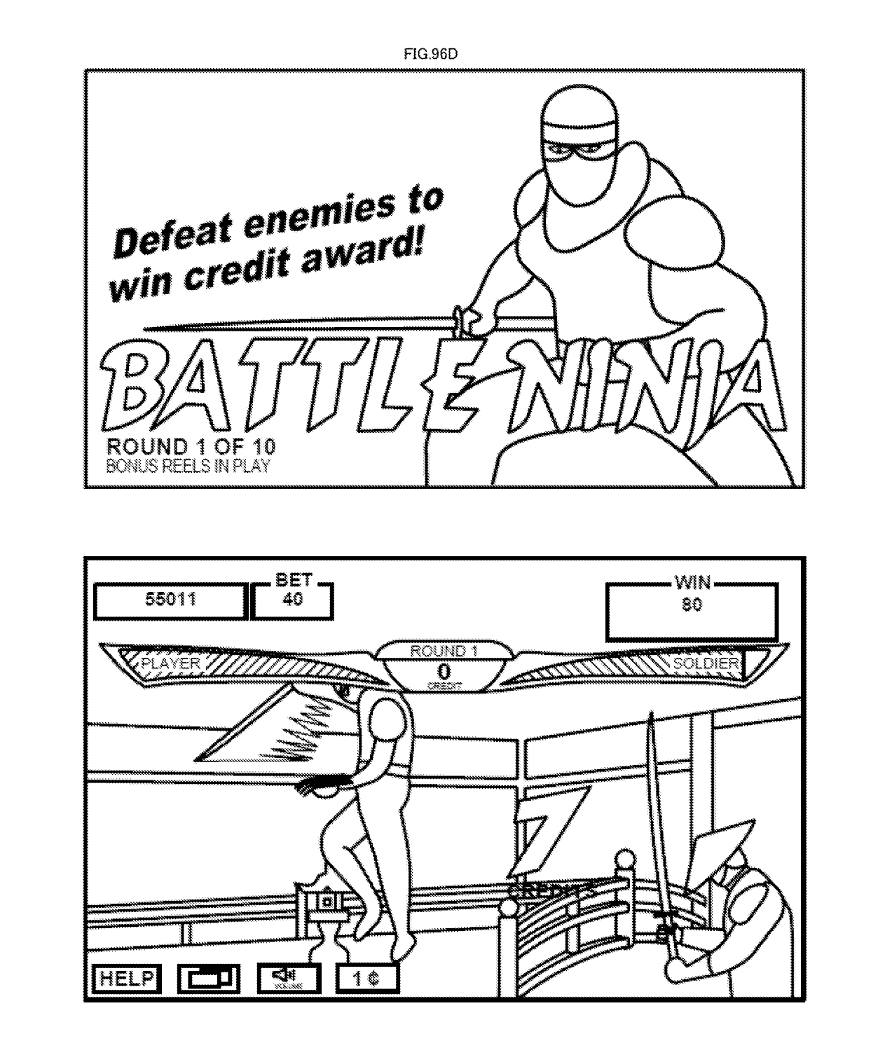

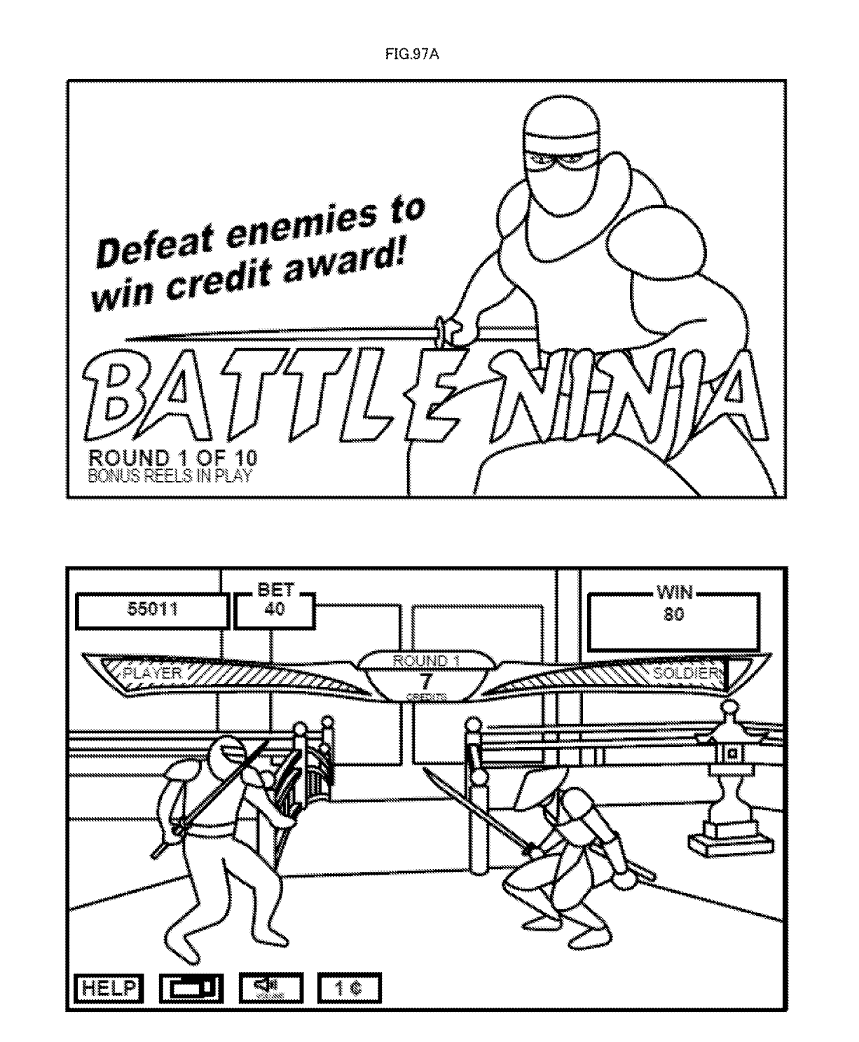

As shown in FIG. 95D to FIG. 96D, an image in which the ally character attacks the enemy character is displayed. In the first round, the ally character attacks the enemy character with a sword. As shown in FIG. 96B, a small decrease in the physical strength of the enemy character is displayed on the gauge (SOLDIER part). As shown in FIG. 96C and FIG. 96D, at the point in time when the enemy character has lost, a numeric character “7” indicating a payout is displayed from the vicinity of the enemy character. As shown in FIG. 97A, in the central portion of the upper side of the lower display device 141, it is displayed that the payout of 7 is obtained in the first round. As shown in FIG. 97B, “7” indicating the payout is displayed in an enlarged manner as in “ROUND 17 CREDITS”, and as shown in FIG. 97C, “7” indicating the payout is displayed so as to gradually move toward the display area of “WIN”. As shown in FIG. 97D, in the display area of “WIN”, a value of “WIN” is increased from 80 to 87, thereby indicating that the payout of 7 is added.

As shown in FIG. 97C and FIG. 97D, on the upper display device 131, the five video reels 3a to 3e are displayed, 20 symbols in the first round are displayed, and a player is notified that the payout which corresponds to a winning pattern by the rearranged symbols is 7.

<Battle Effects of the Second Round>

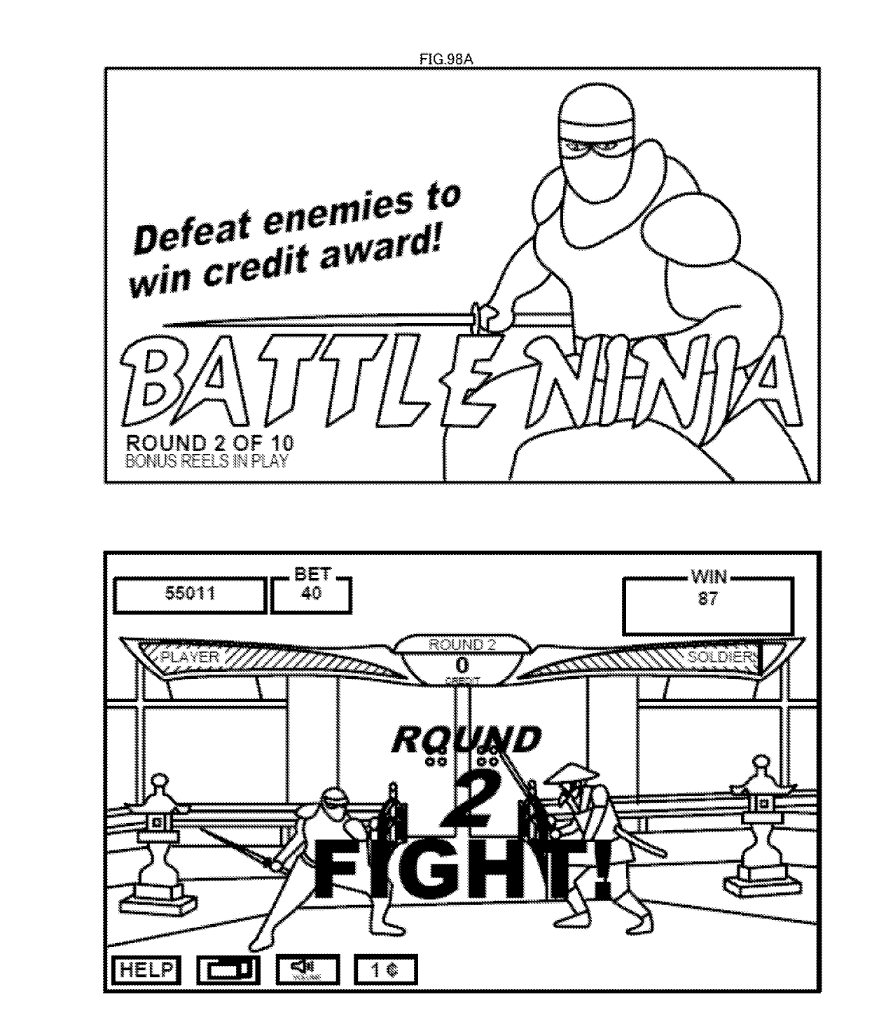

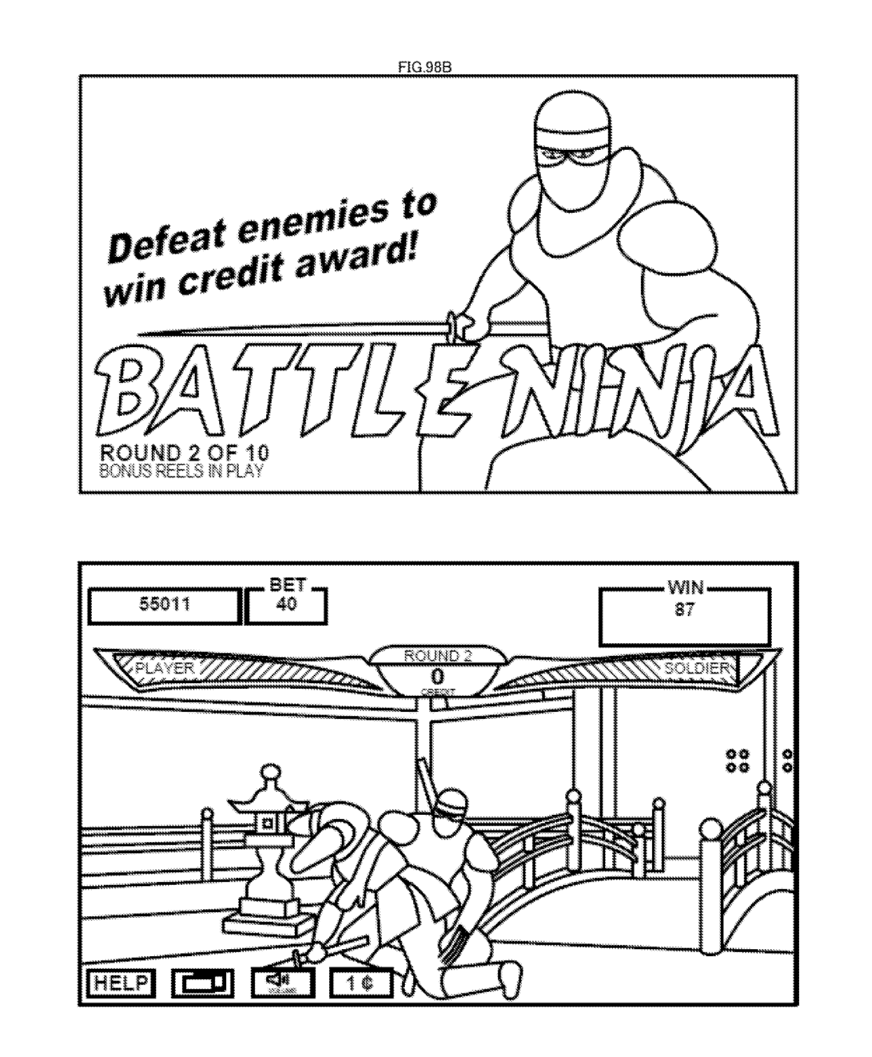

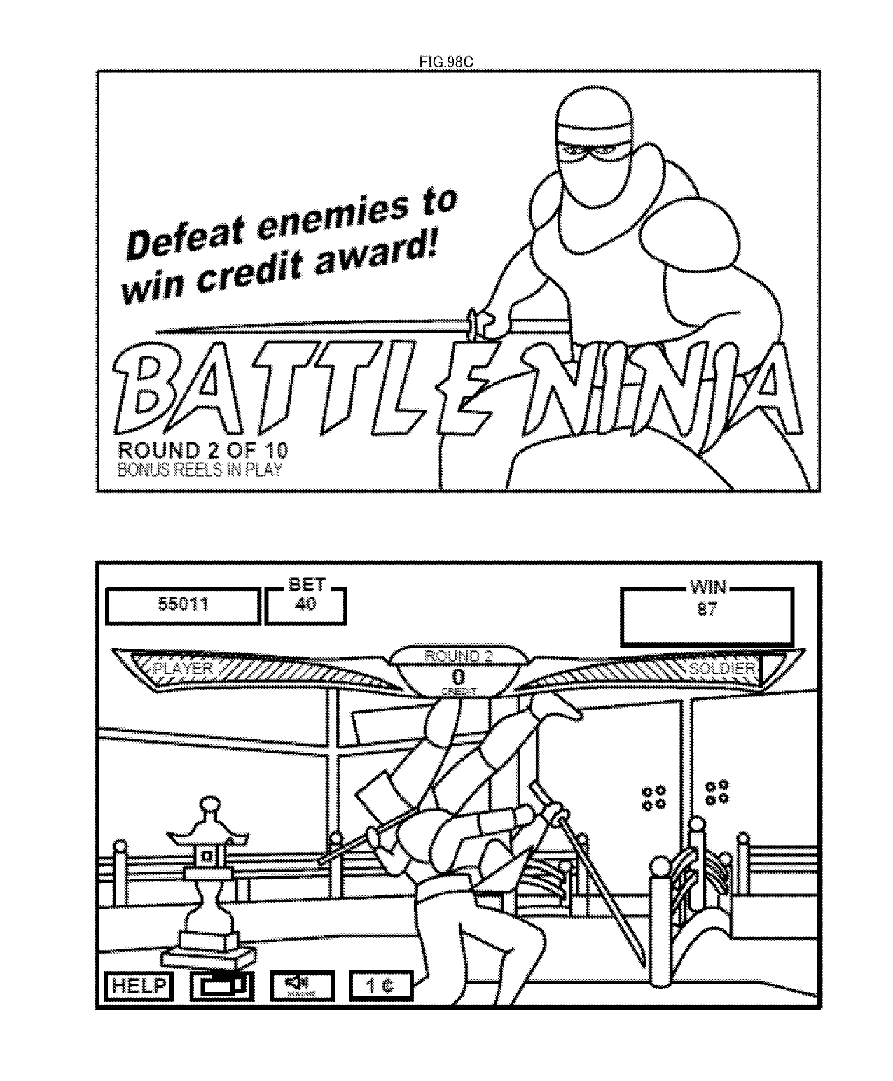

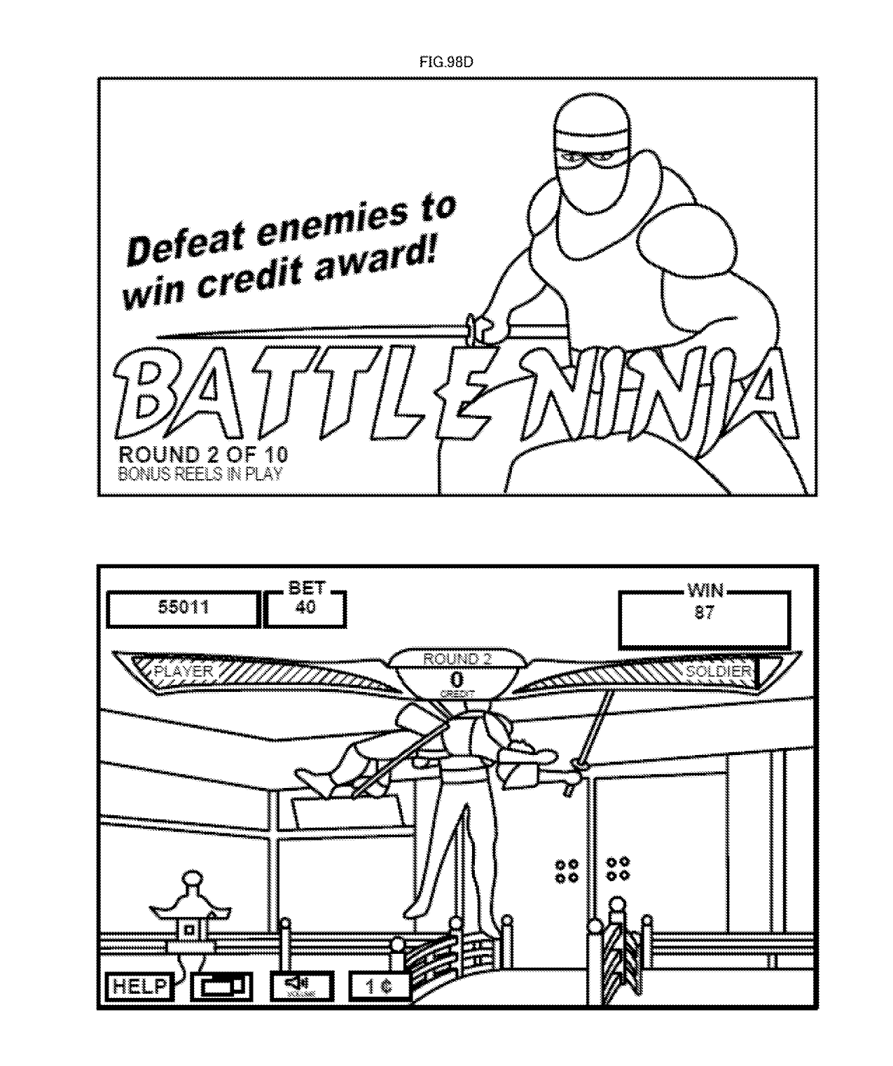

As shown in FIG. 98A, “ROUND 2 FIGHT!” is displayed, thereby starting the second round. Upon starting battle effects in the second round, as in the battle effects in the first round, in the central portion of the upper side of the lower display device 141, numerical values indicating round No. and a payout are displayed. On the left side of the upper side, the gauge (PLAYER part) indicating the physical strength of the ally character is displayed. On the right side of the upper side, the gauge (SOLDIER part) indicating the physical strength of the enemy character is displayed.

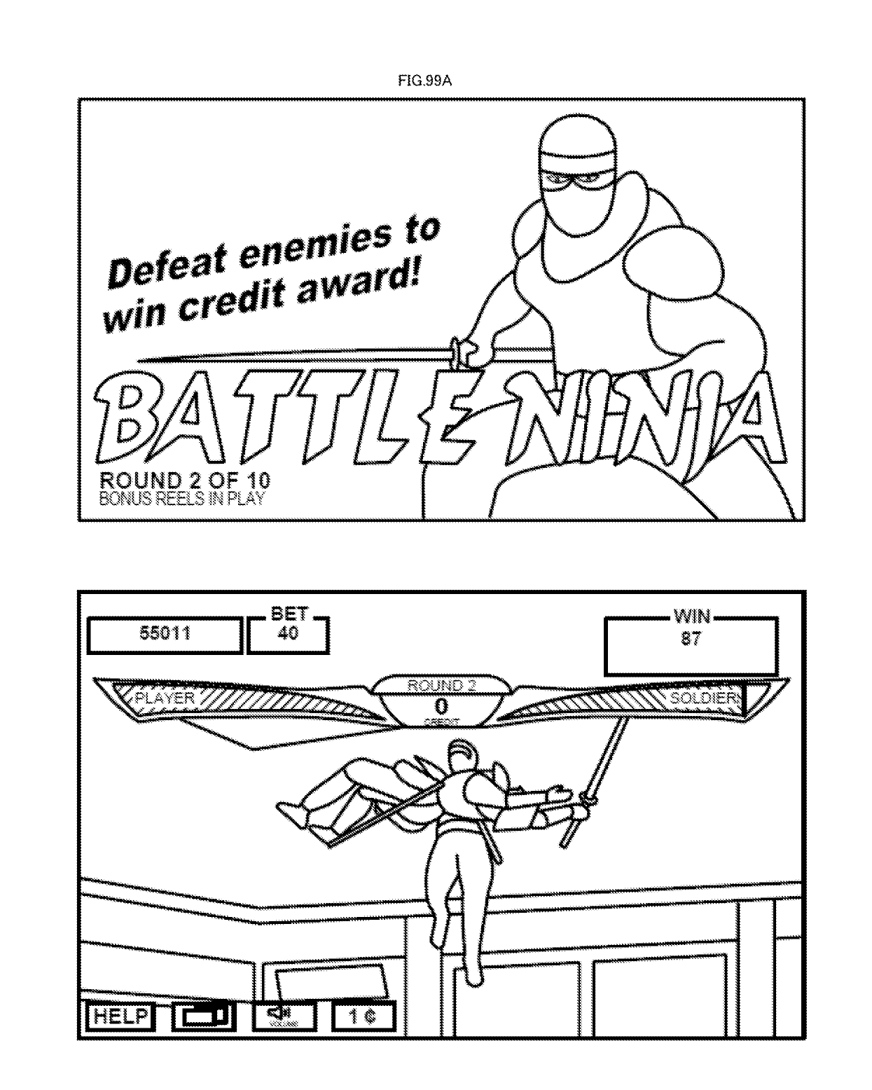

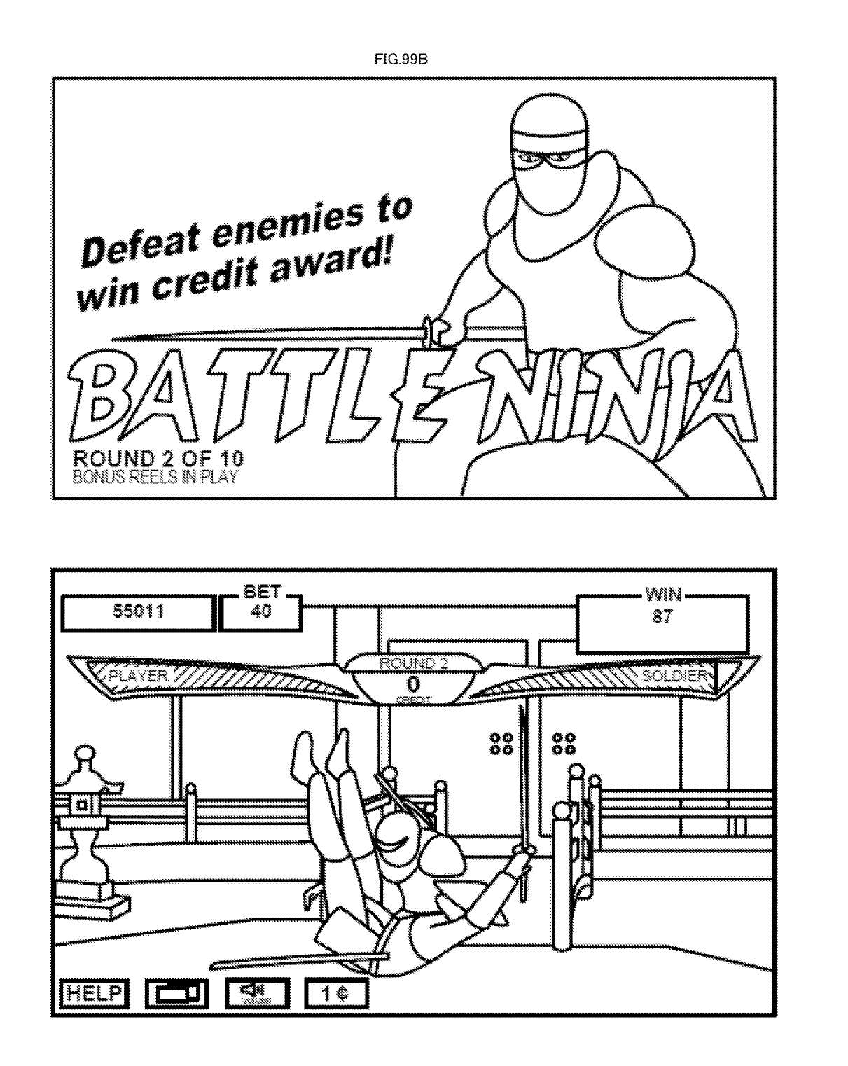

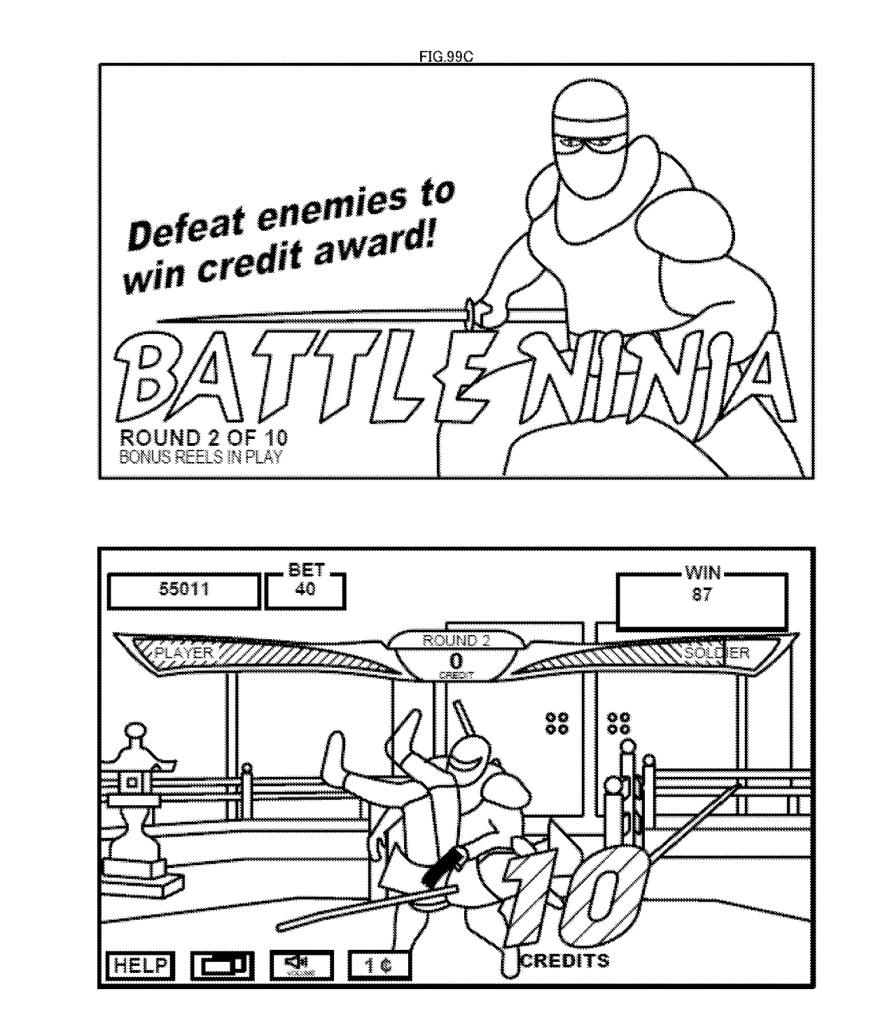

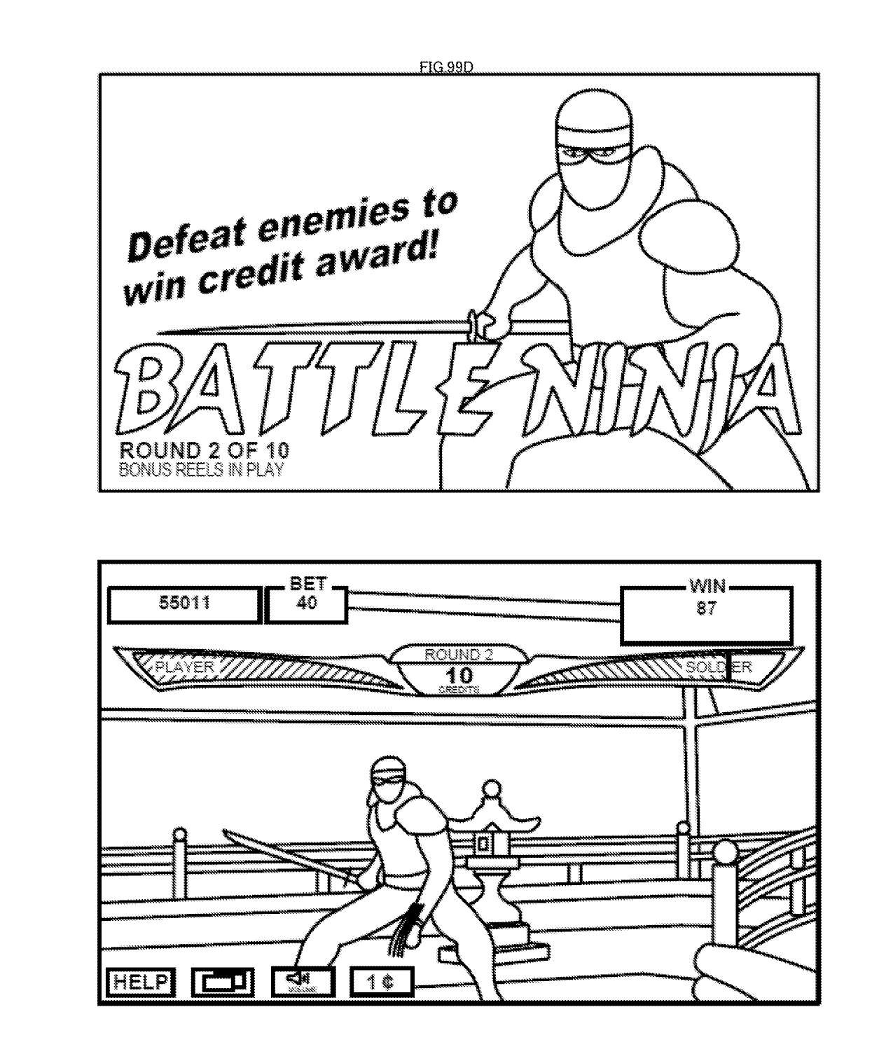

As shown in FIG. 98A to FIG. 99D, an image in which the ally character attacks the enemy character is displayed. In the second round, the ally character attacks the enemy character by wrestling, and battle effects which are different from those in the first round are displayed. As shown in FIG. 99C, at the point in time when the enemy character has lost, a numeric character “10” indicating a payout is displayed from the vicinity of the enemy character. As shown in FIG. 99D, in the central portion of the upper side of the lower display device 141, it is displayed that the payout of 10 is obtained in the second round.

As shown in FIG. 100A, “10” indicating the payout is displayed in the enlarged manner as in “ROUND 2 10 CREDITS”, and as shown in FIG. 100B, the value of “WIN” is increased from 87 to 97, thereby indicating that the payout of 10 is added.

As shown in FIG. 100A and FIG. 100B, on the upper display device 131, the five video reels 3a to 3e are displayed, 20 symbols in the second round are displayed, and a player is notified that the payout which corresponds to a winning pattern by the rearranged symbols is 10.

In this example, in the first round and the second round, the battle effects of the above-described single attacks S1, S2, and S3 and single attacks S, M, and L, and the like are executed.

<Battle Effects of the Third Round to the Fifth Round>

As shown in FIG. 100C, “ROUND 3 FIGHT!” is displayed, thereby starting the third round, and subsequently, battle effects in the fourth round and the fifth round are executed (not shown).

<Battle Effects of the Sixth Round>

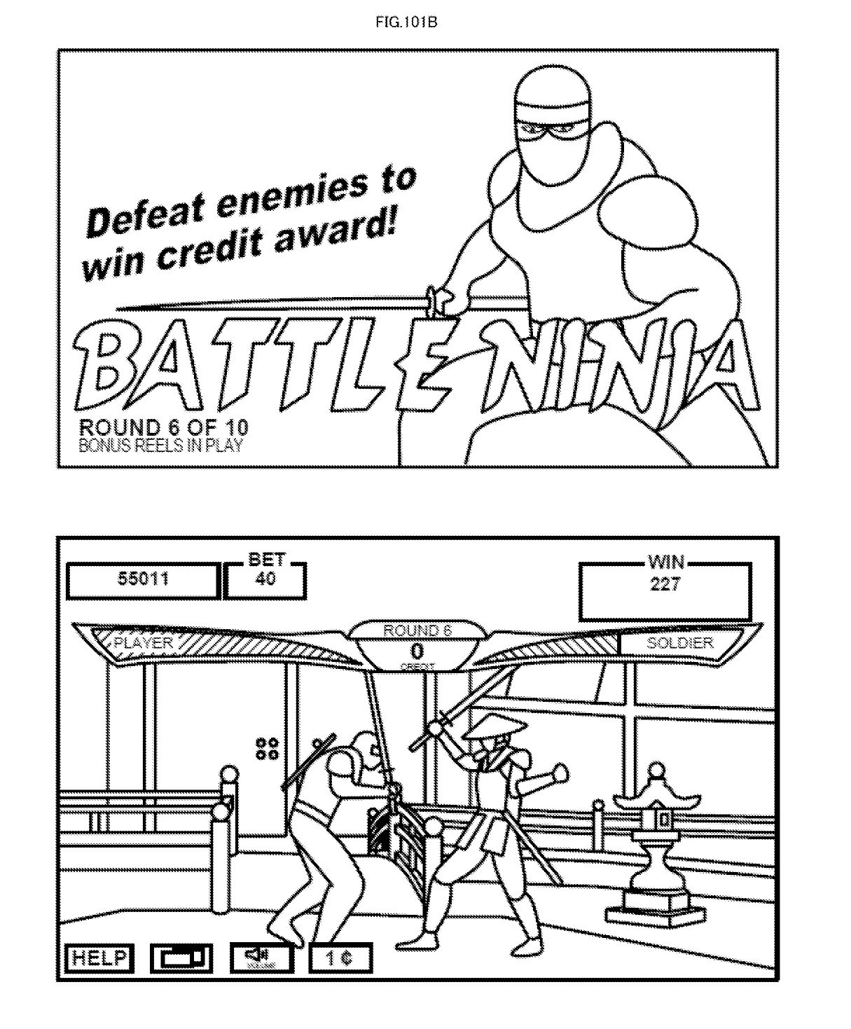

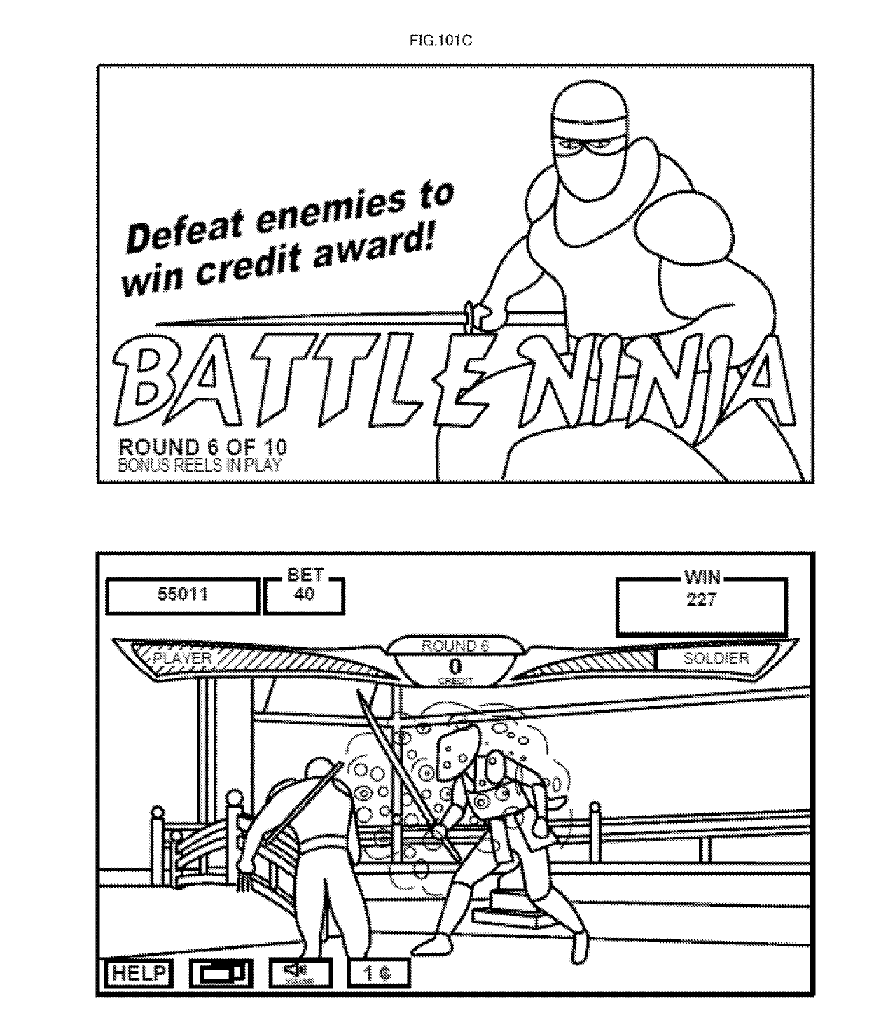

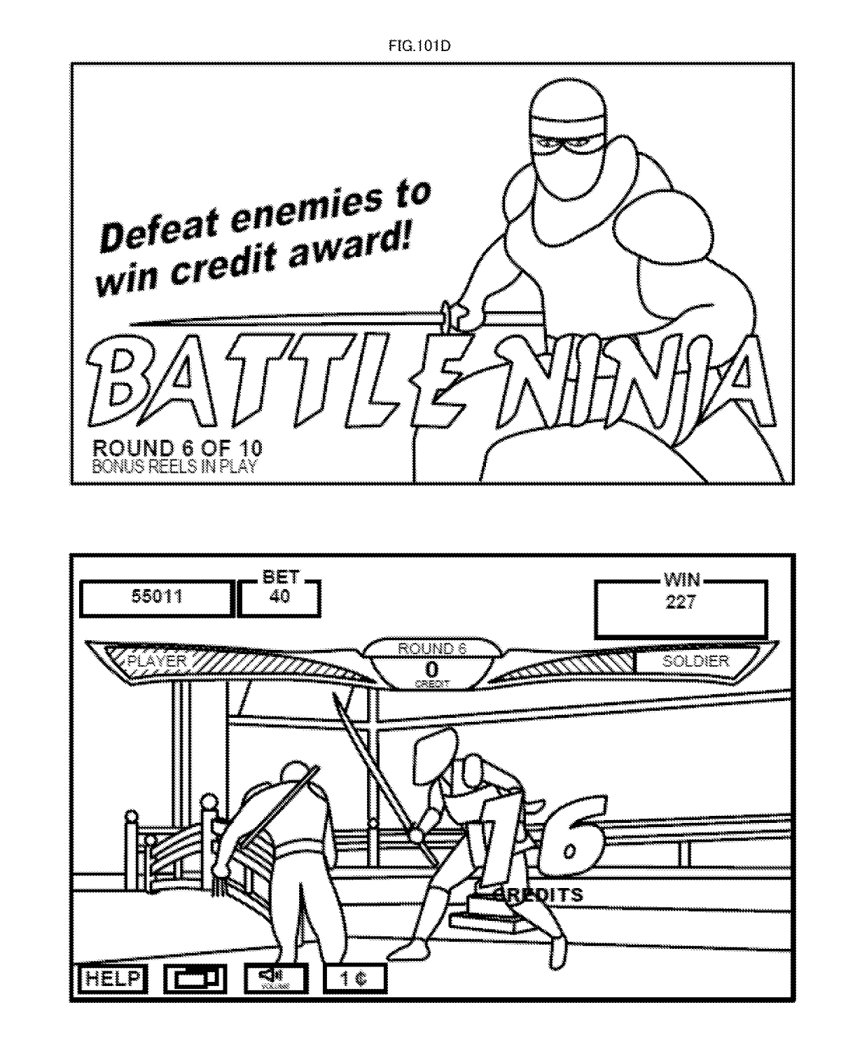

As shown in FIG. 100D, “ROUND 6 FIGHT!” is displayed, thereby starting the sixth round. As shown in FIG. 101A to FIG. 101D, an image in which the ally character attacks the enemy character is displayed. As shown in FIG. 101D, through attacking by the ally character, a numerical value of “16” indicating a payout is displayed in the vicinity of the enemy character,

Further, as shown in FIG. 100D, at the point in time when the sixth round has been started, it is displayed in the gauge (SOLDIER part) that the physical strength of the enemy character is more decreased than in the third round (FIG. 100C).

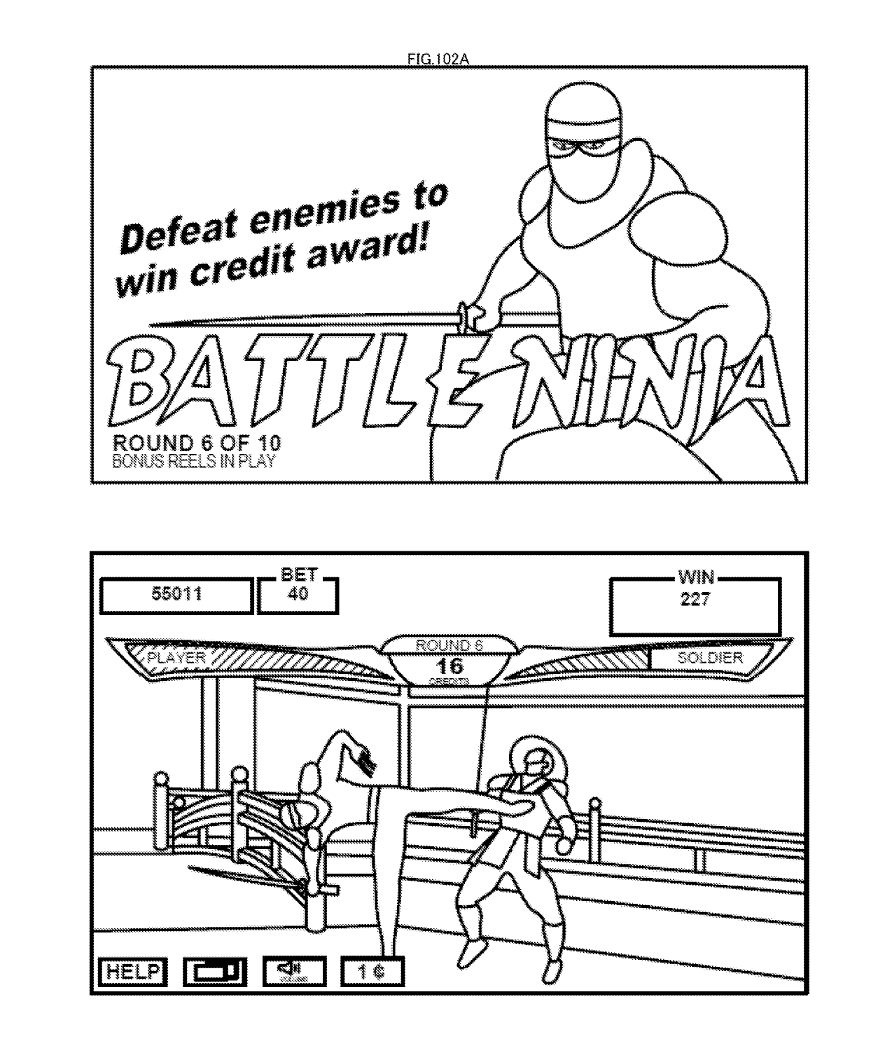

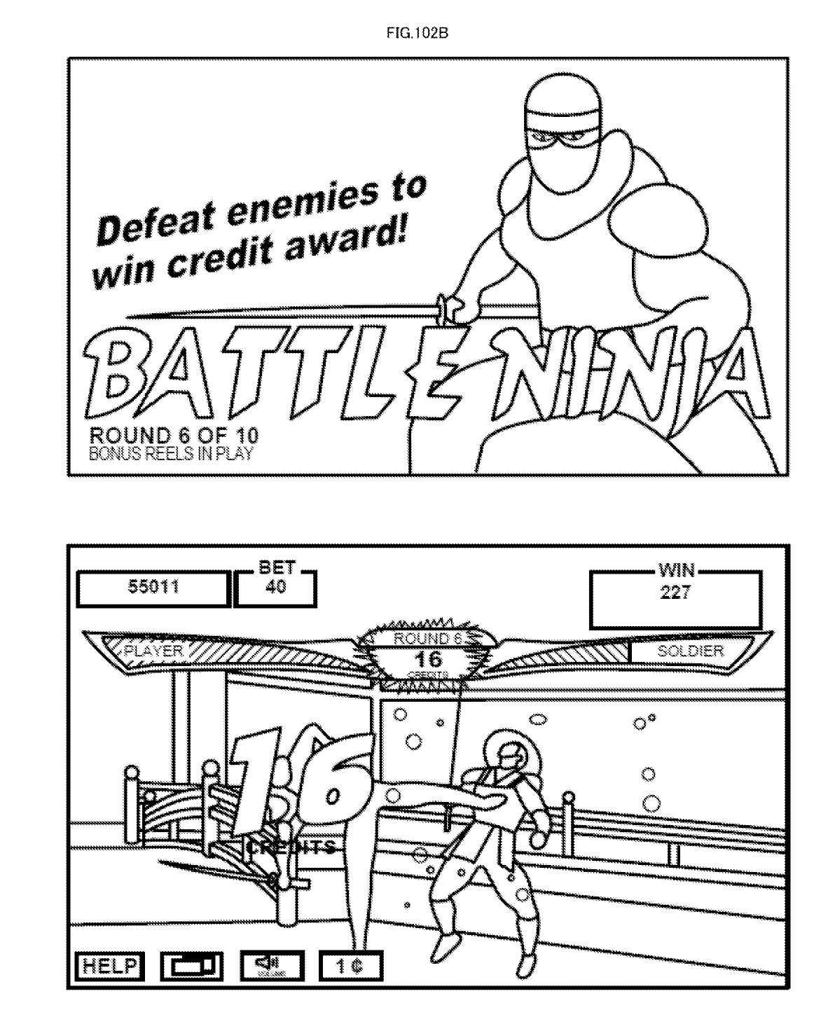

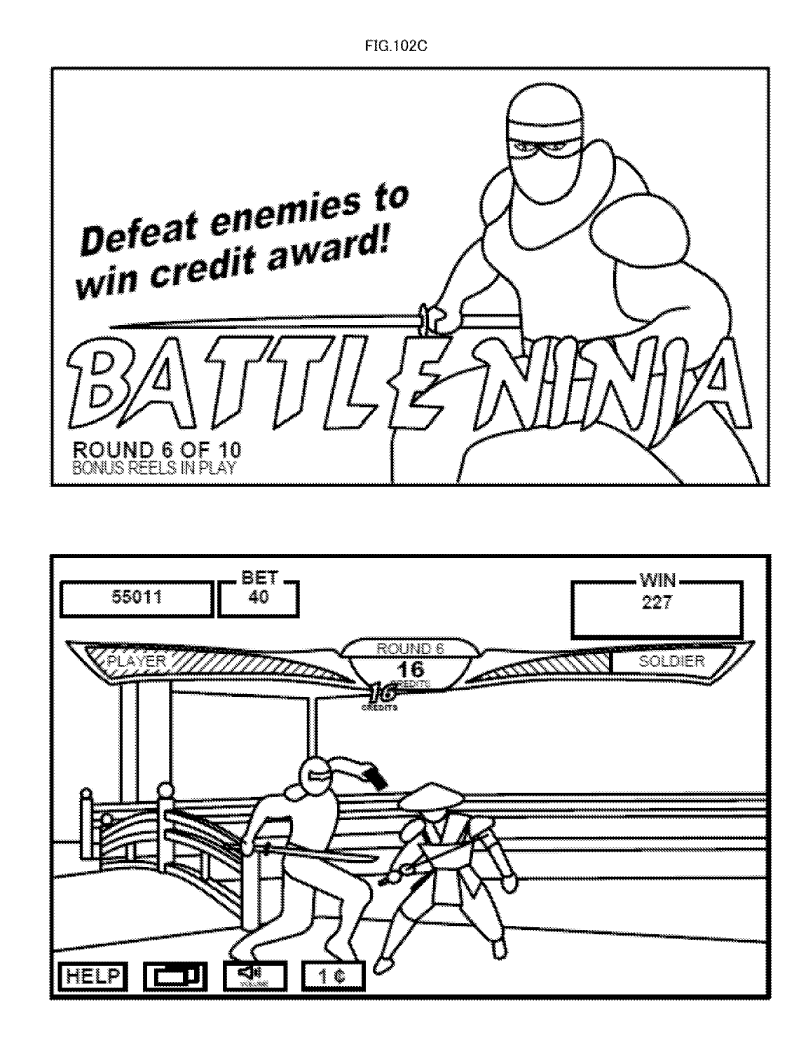

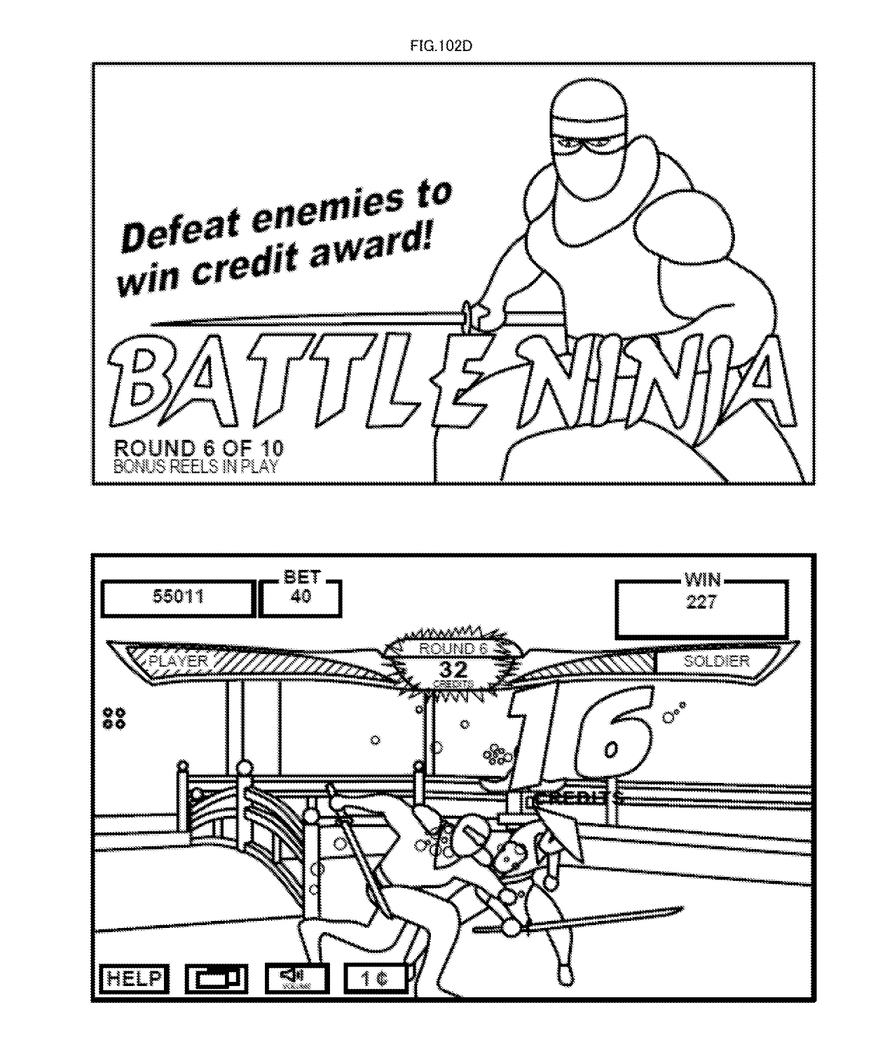

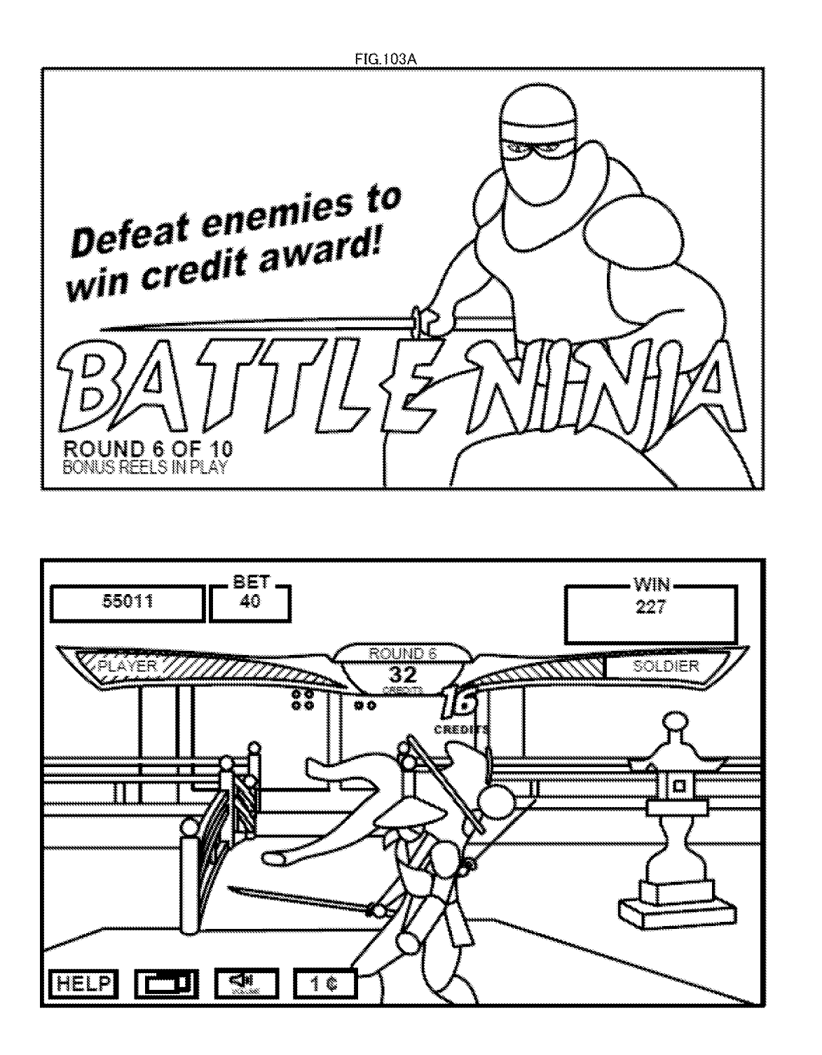

As shown in FIG. 102A, in the central portion of the upper side of the lower display device 141, it is displayed that the payout of 16 is obtained in the sixth round. As shown in FIG. 102B, an image in which the ally character further attacks the enemy character is displayed. As shown in FIG. 102B, through the further attack by the ally character, the numerical value indicating the payout of 16 is further displayed in the vicinity of the ally character. As shown in FIG. 102C, “16” indicating the payout is displayed so as to gradually move. As shown in FIG. 102D, in the central portion of the upper side of the lower display device 141, “ROUND 6 32 CREDITS” is displayed, and it is displayed that a total payout of 32 is obtained in the sixth round.

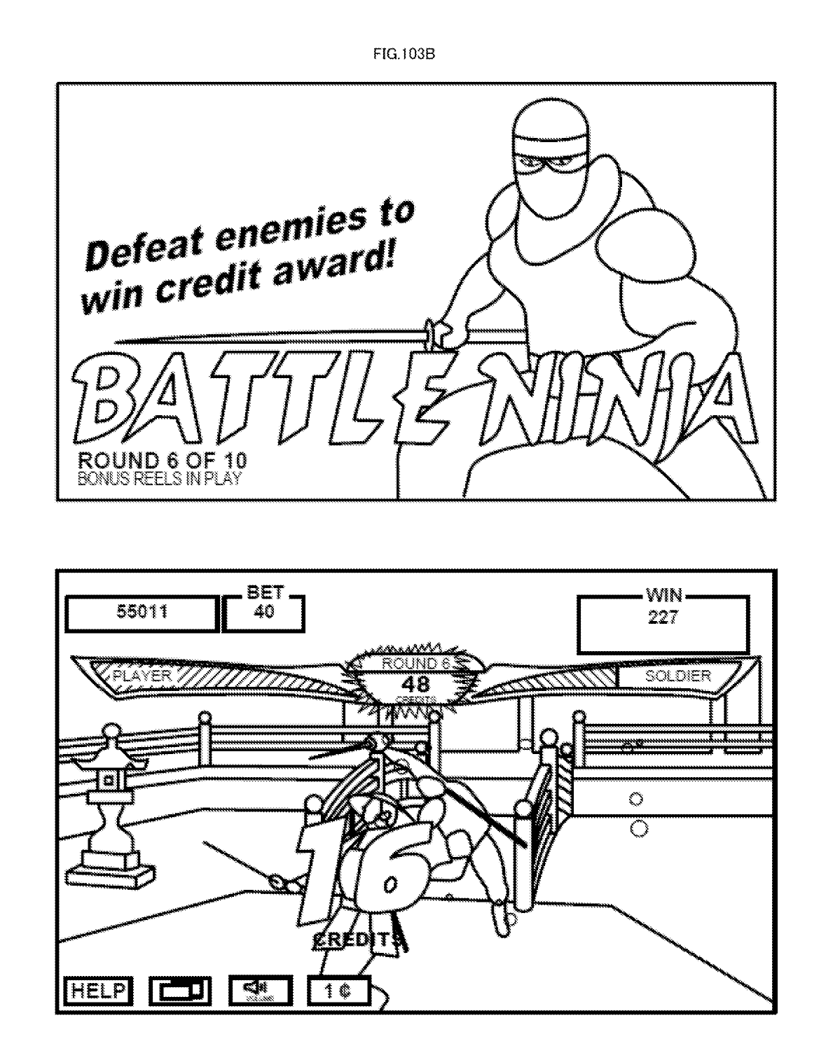

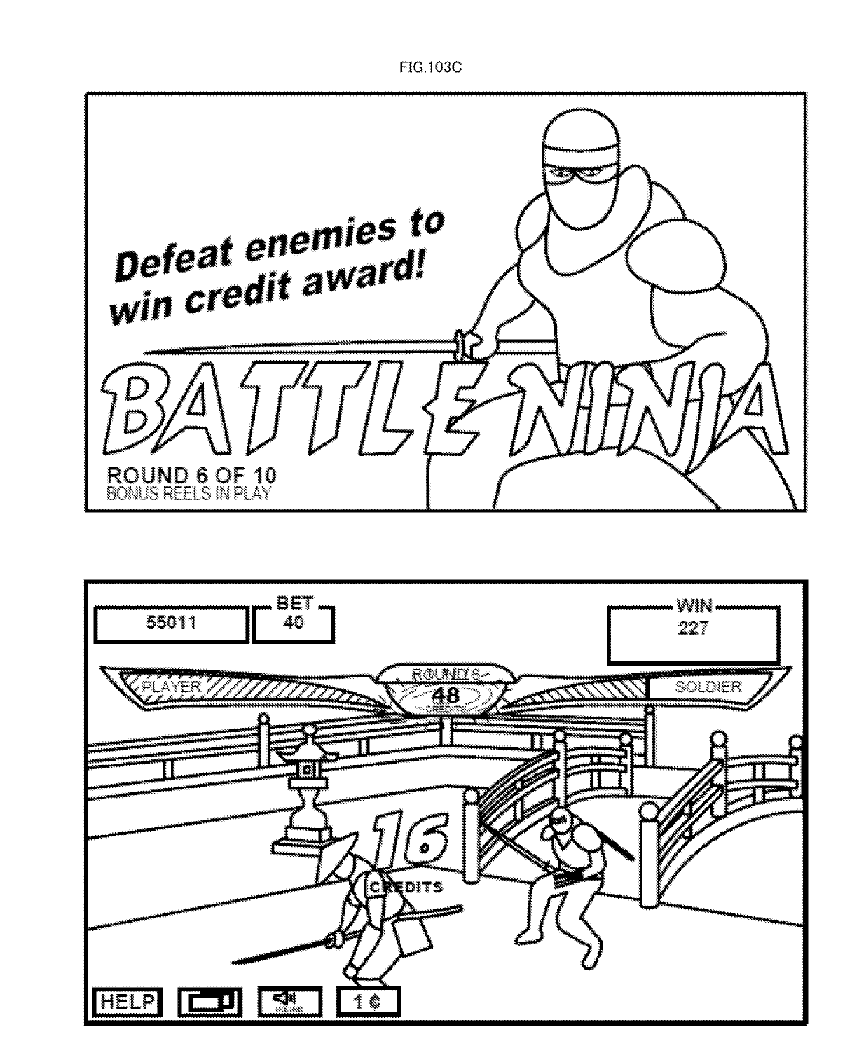

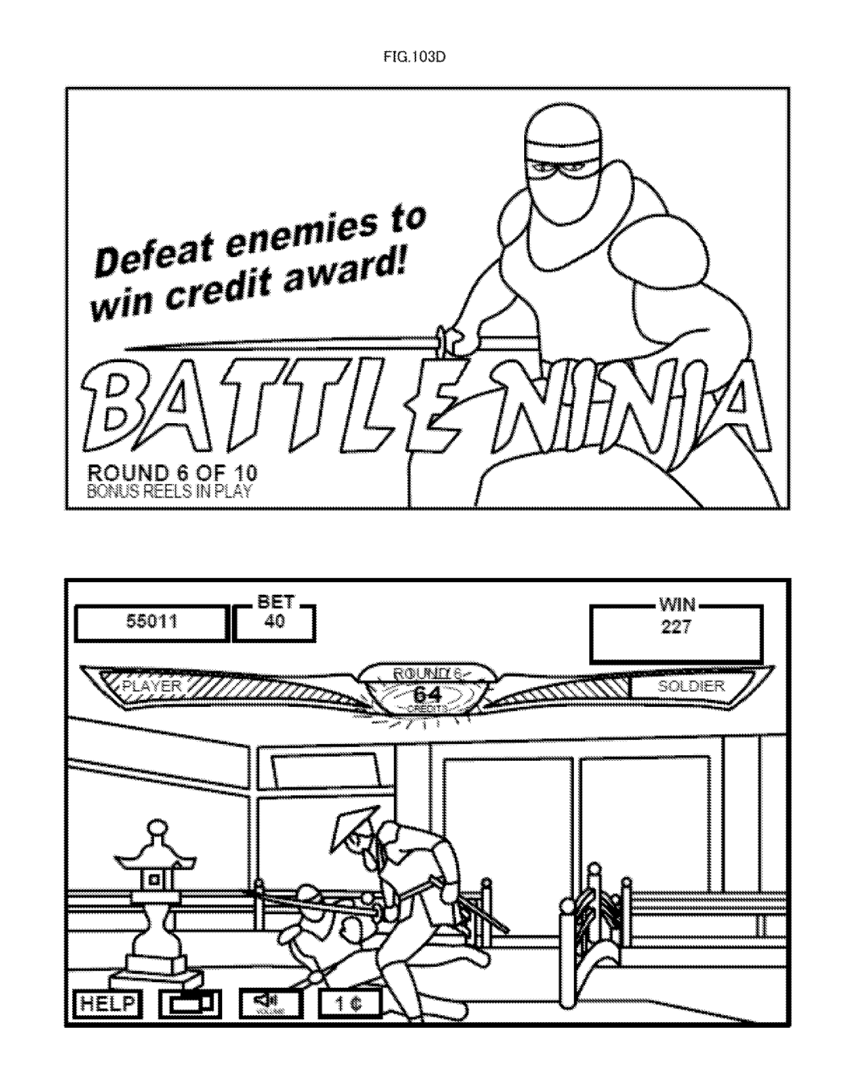

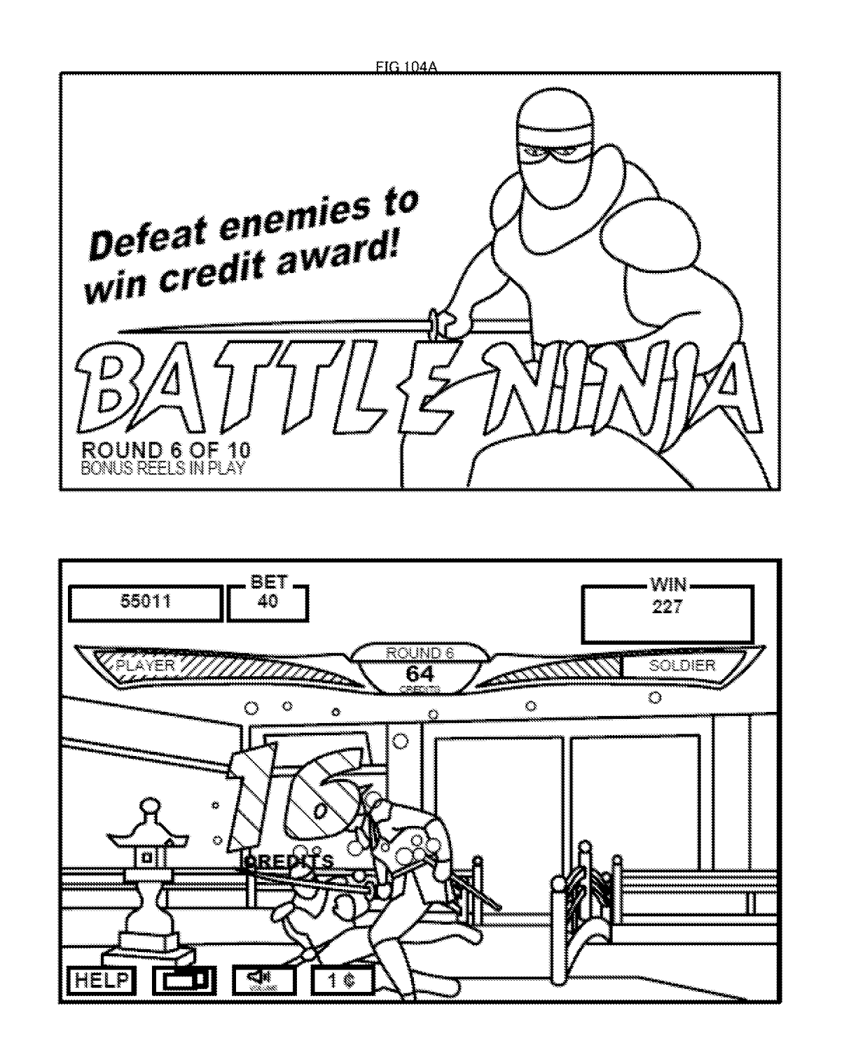

As shown in FIG. 102D, an image in which the ally character further attacks the enemy character is displayed, a numerical value indicating a payout of 16 is further displayed in the vicinity of the ally character. As shown in FIG. 103A, “16” indicating the payout is displayed so as to gradually move toward the central portion. As shown in FIG. 103B, in the central portion of the upper side of the lower display device 141, “ROUND 6 48 CREDITS” is displayed, and it is displayed that a total payout of 48 is obtained in the sixth round.

As shown in FIG. 103B, an image in which the ally character further attacks the enemy character is displayed, a numerical value of “16” indicating a payout of 16 is further displayed in the vicinity of the ally character. As shown in FIG. 103C, “16” indicating the payout is displayed so as to gradually move. As shown in FIG. 103D, in the central portion of the upper side of the lower display device 141, “ROUND 6 64 CREDITS” is displayed, and it is displayed that a total payout of 64 is obtained in the sixth round.

As shown in FIG. 104A, an image in which the ally character further attacks the enemy character is displayed, a numerical value of “16” indicating a payout of 16 is further displayed in a different color. As shown in FIG. 104B, “16” indicating the payout is displayed so as to move to the central portion. As shown in FIG. 104C, in the central portion of the upper side of the lower display device 141, “ROUND 6 80 CREDITS” is displayed, and it is displayed that a total payout of 80 is obtained in the sixth round.

As shown in FIG. 104D and FIG. 105A, on the upper display device 131, the five video reels 3a to 3e are displayed, 20 symbols in the sixth round are displayed, and a player is notified that the payout which corresponds to a winning pattern by the rearranged symbols is 80.

<Battle Effects of the 10th Round>

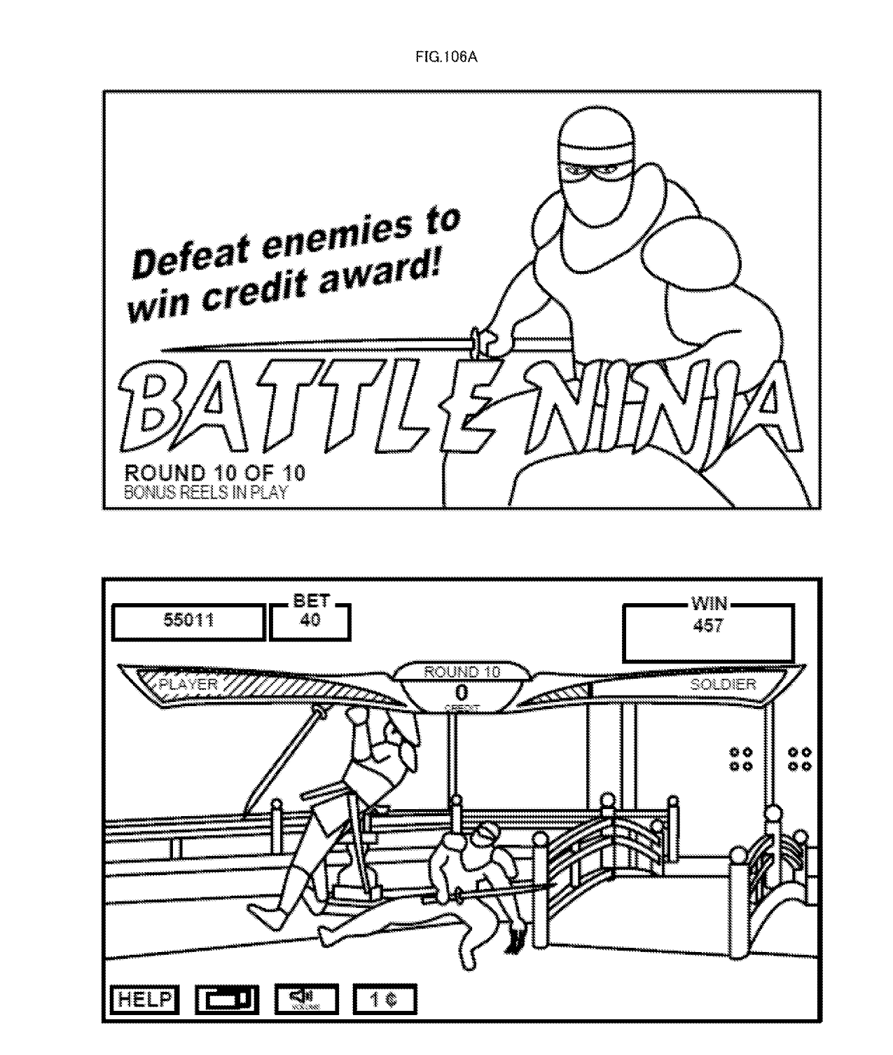

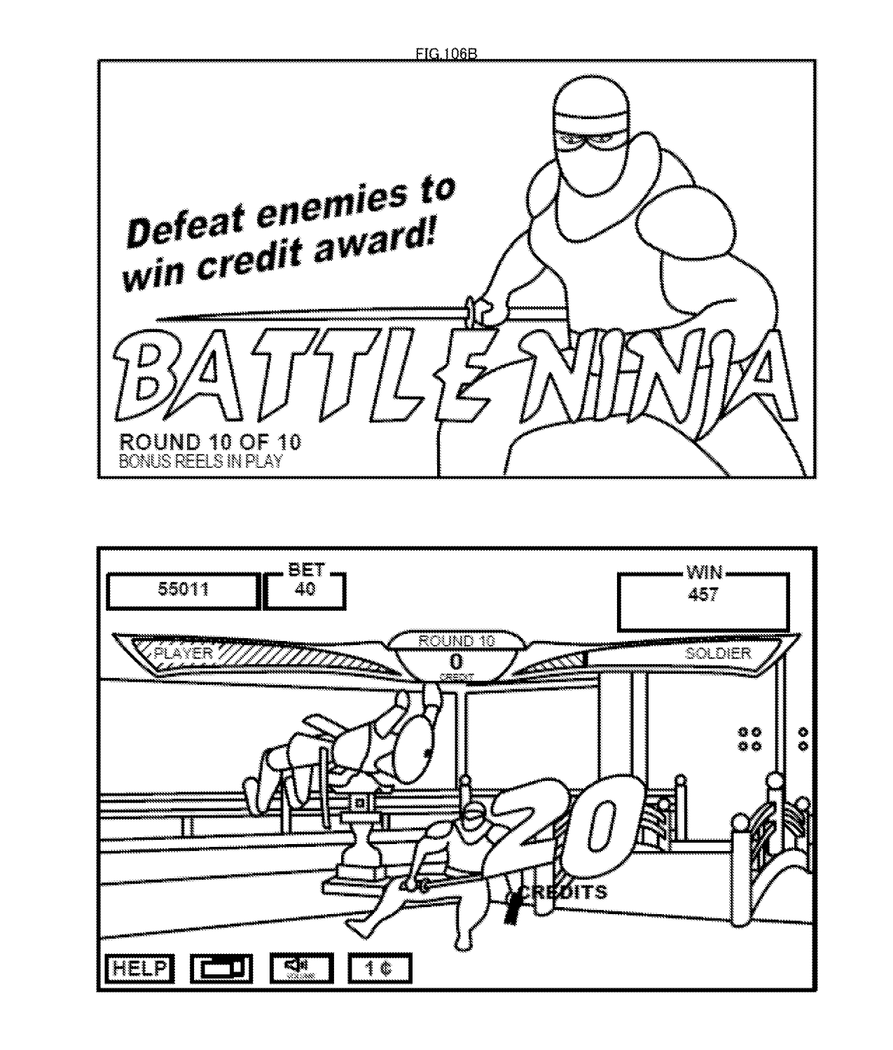

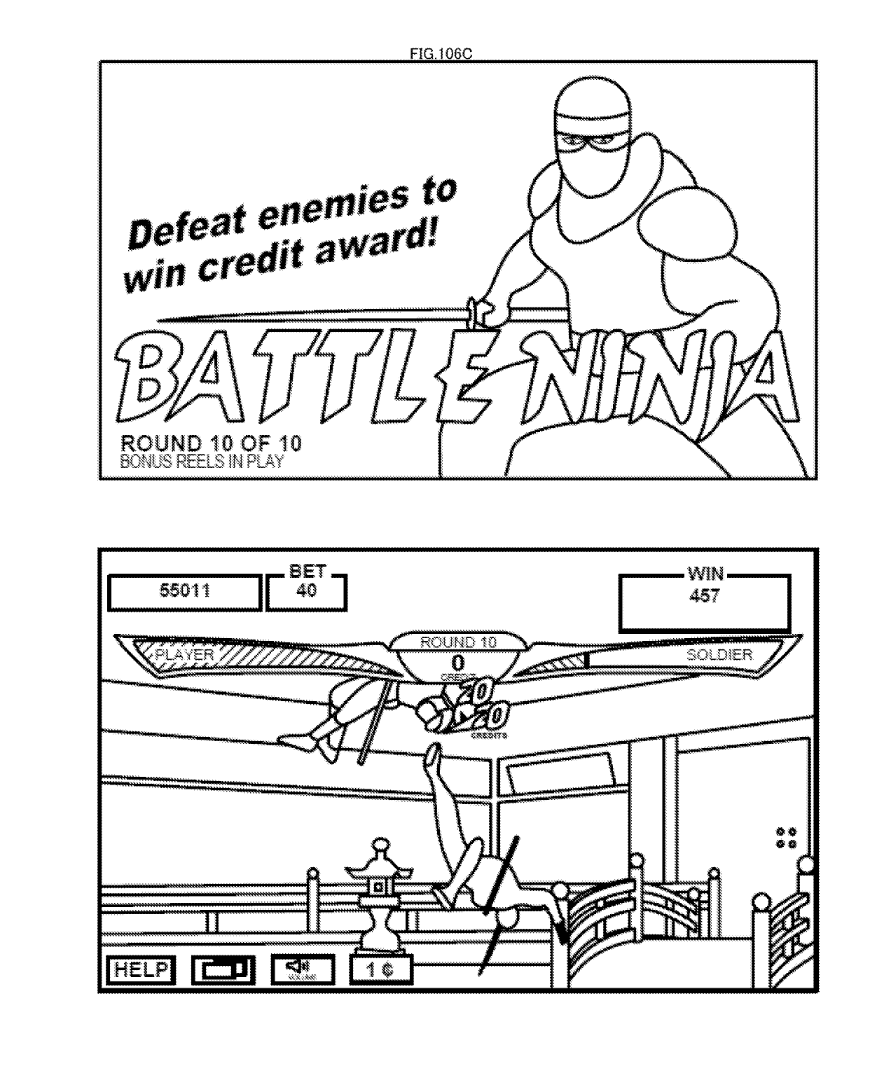

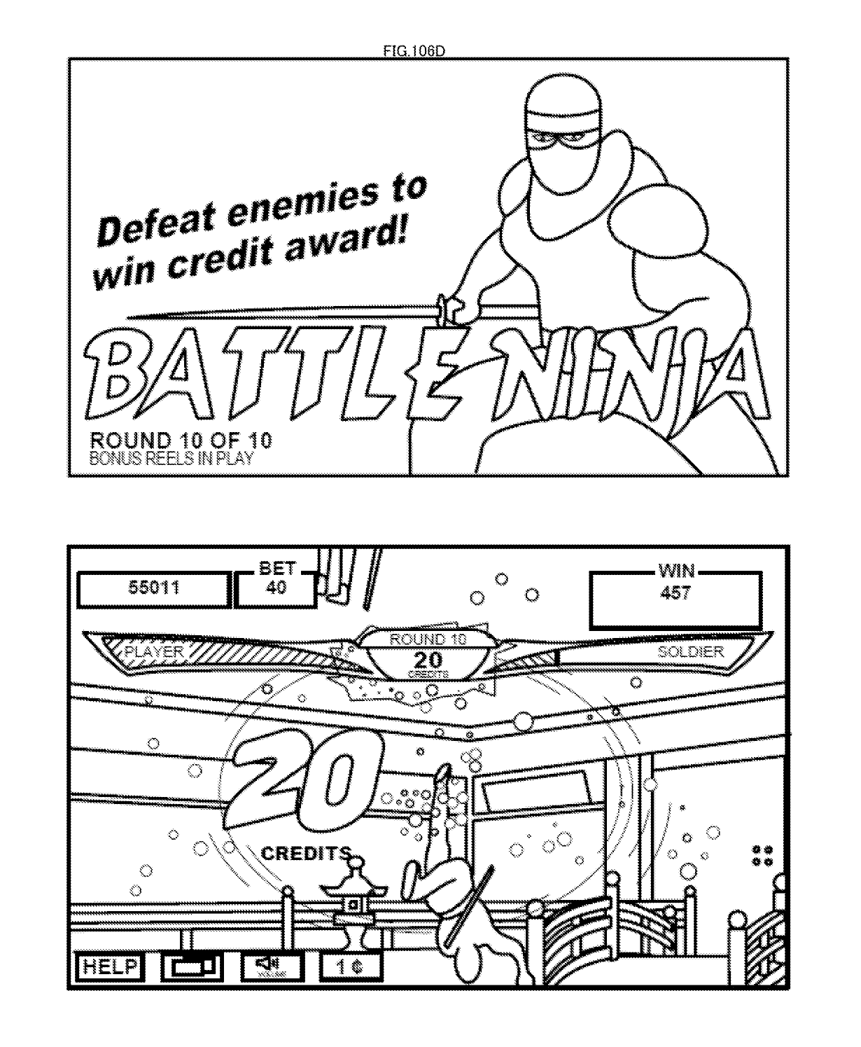

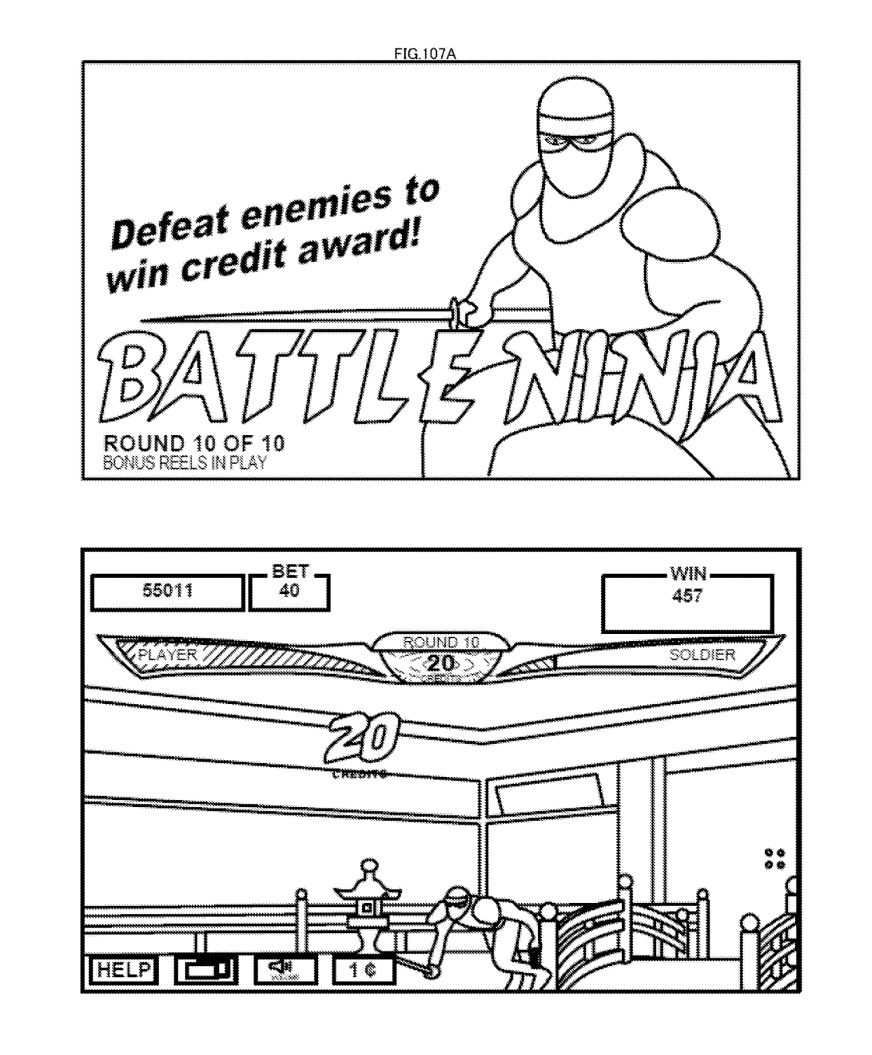

Subsequently, battle effects of the seventh round to the ninth round are executed (not shown). As shown in FIG. 105B, “ROUND 10 FIGHT!” is displayed, thereby starting the 10th round. As shown in FIG. 105C to FIG. 106B, an image in which the ally character attacks the enemy character is displayed. As shown in FIG. 106B, through the attack by the ally character, a numerical value indicating a payout of 20 is displayed in the vicinity of the ally character. As shown in FIG. 106C, “20” indicating the payout is displayed so as to gradually move to the central portion. As shown in FIG. 106D, in the central portion of the upper side of the lower display device 141, “ROUND 10 20 CREDITS” is displayed, and it is displayed that the payout of 20 is obtained in the 10th round.

Further, as shown in FIG. 105B, at the point in time when the 10th round has been started, it is displayed in the gauge (SOLDIER part) that the physical strength of the enemy character is more decreased than in the sixth round (FIG. 105A).

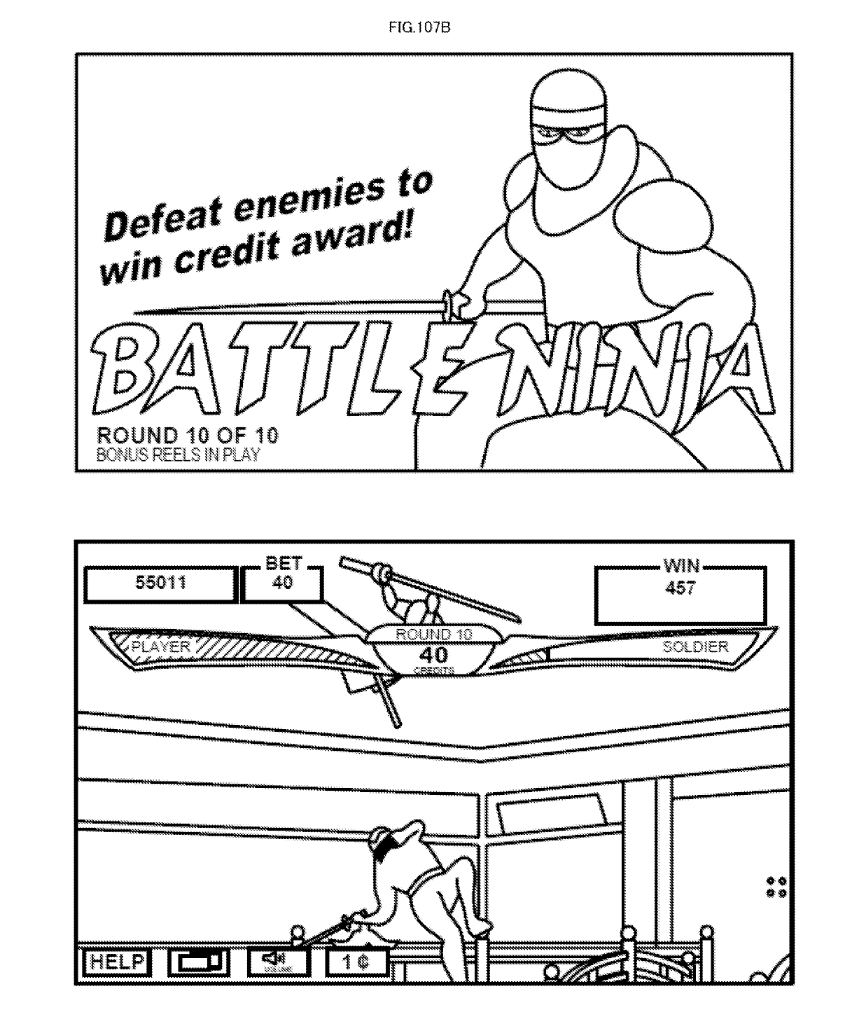

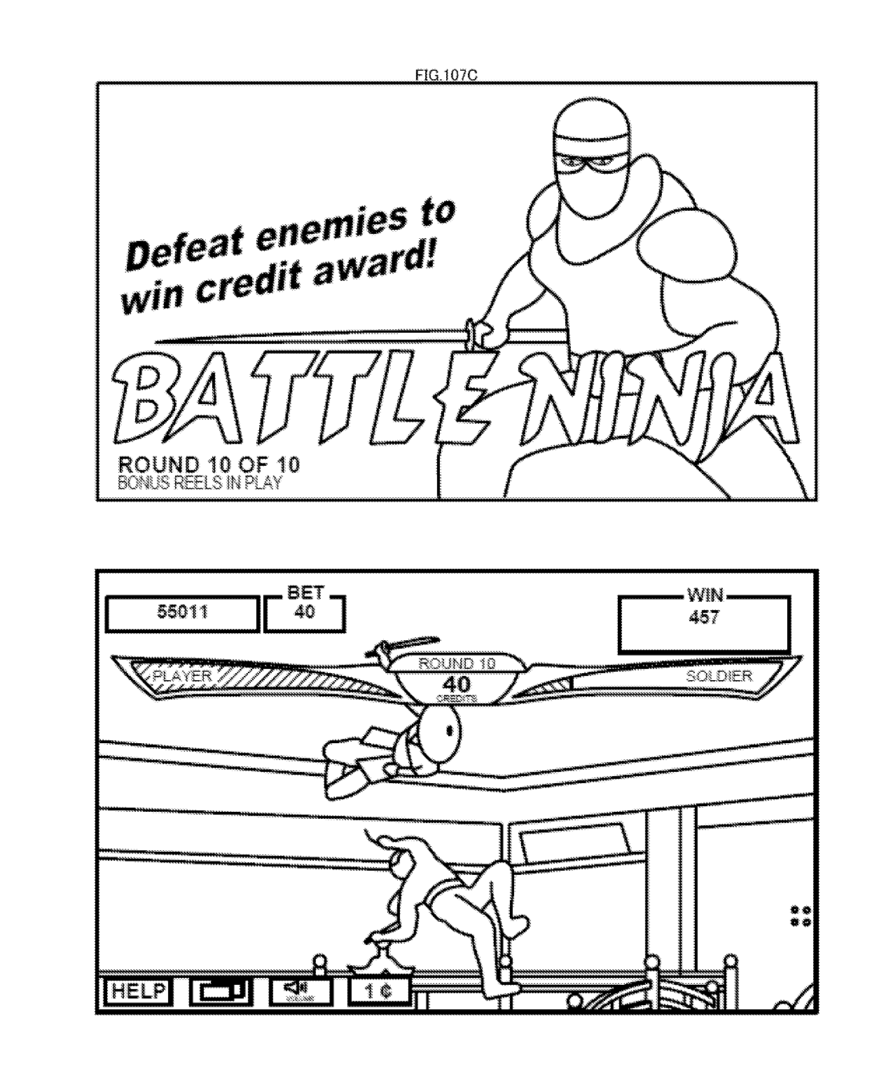

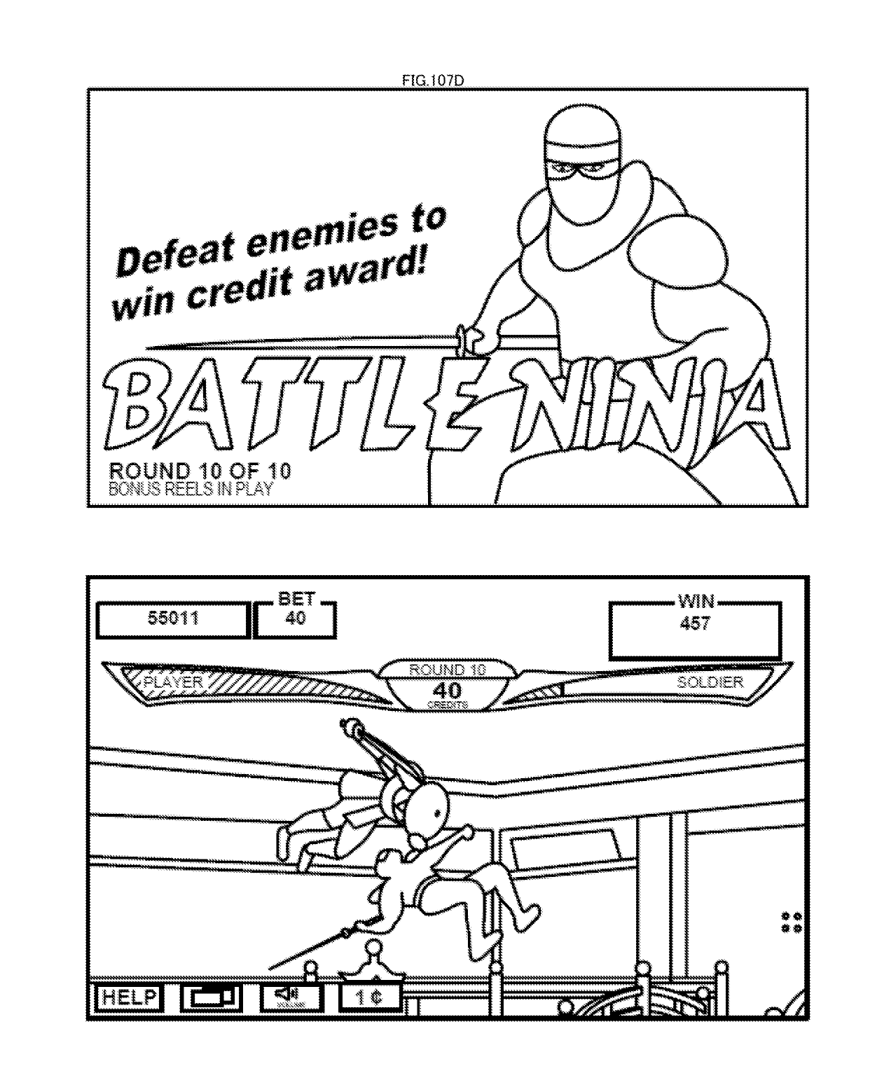

As shown in FIG. 106D, an image in which the ally character further attacks the enemy character is displayed, a numerical value indicating a payout of 20 is further displayed. As shown in FIG. 107A, “20” indicating the payout is displayed so as to gradually move to the central portion. As shown in FIG. 107B, in the central portion of the upper side of the lower display device 141 “ROUND 10 40 CREDITS” is displayed, and it is displayed that a total payout of 40 is obtained in the 10th round.

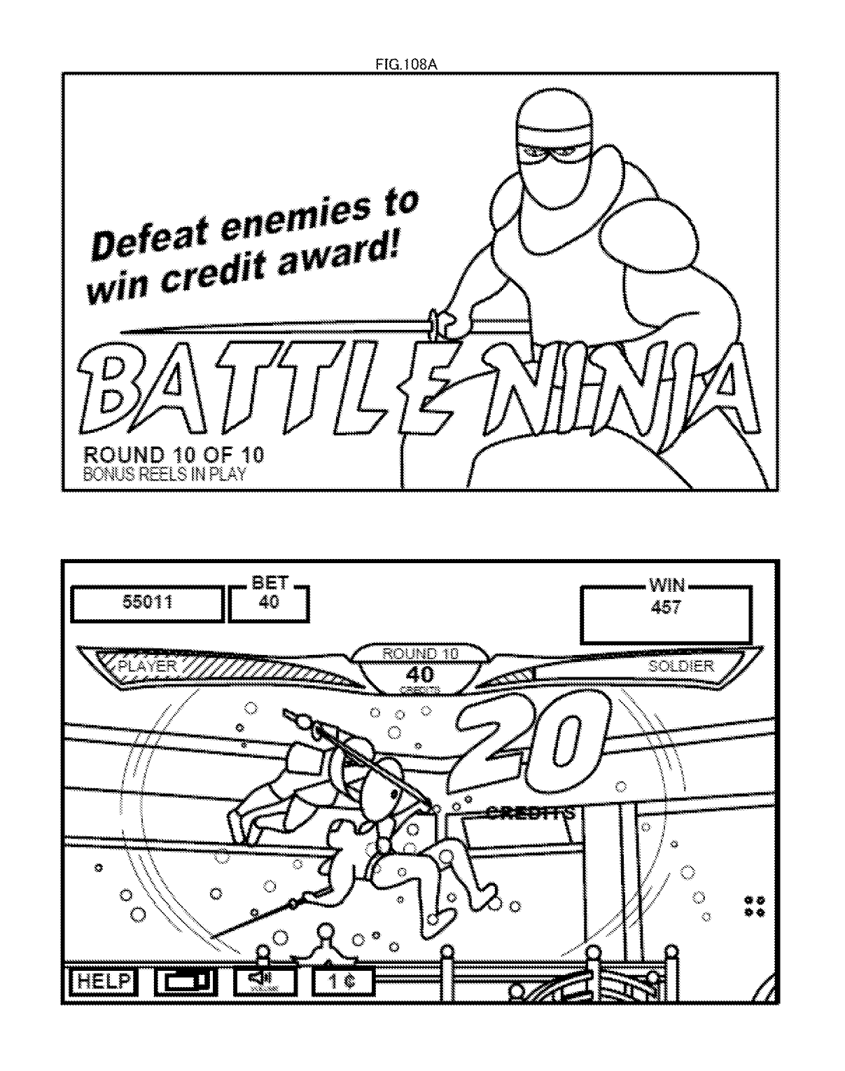

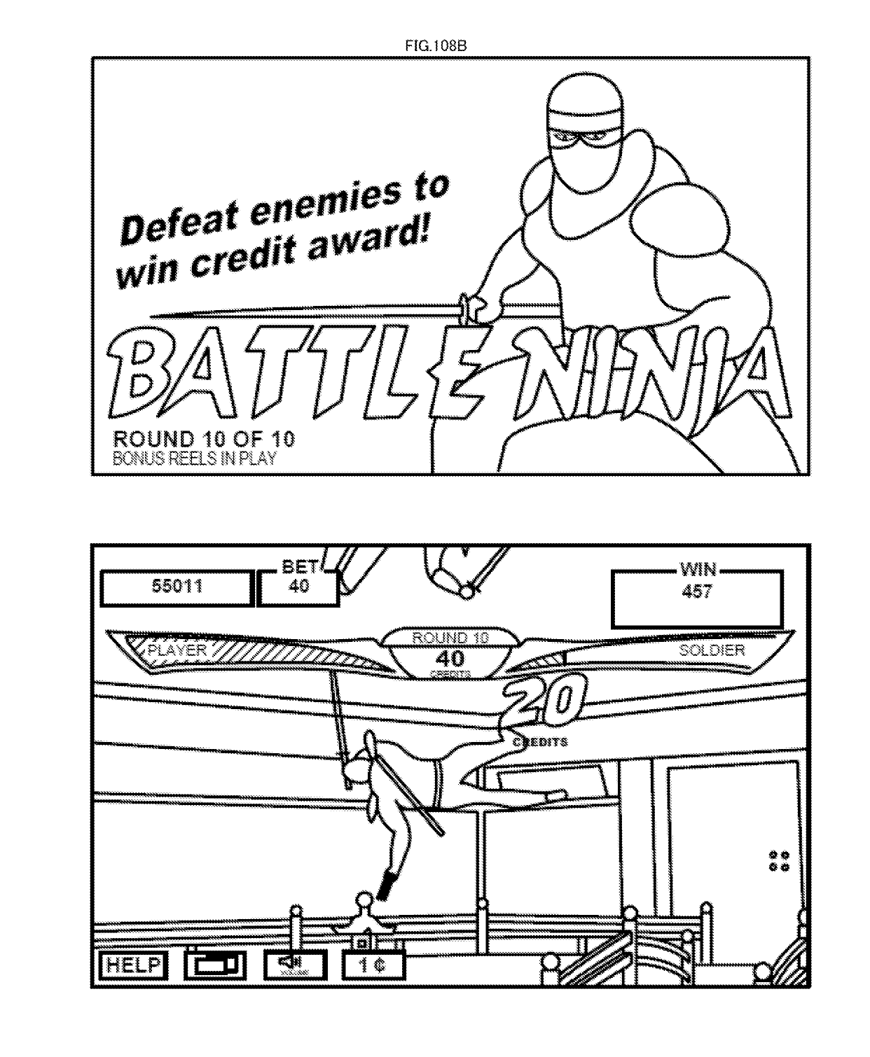

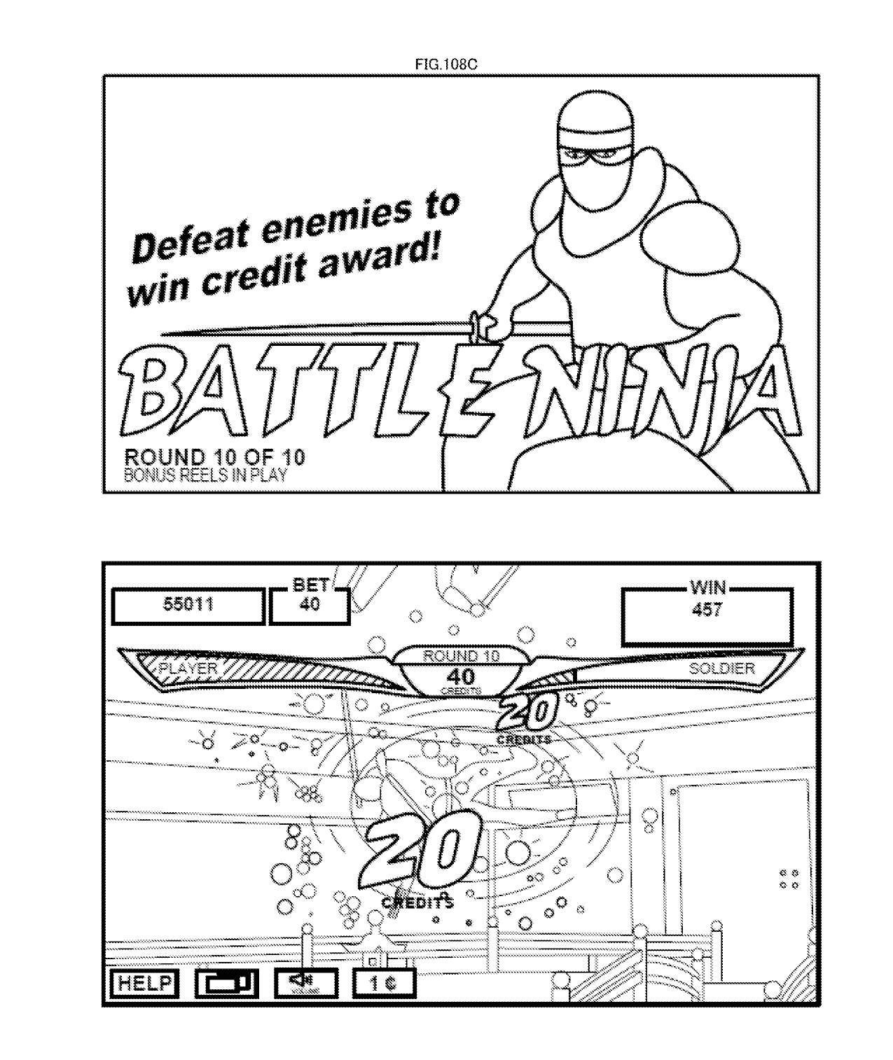

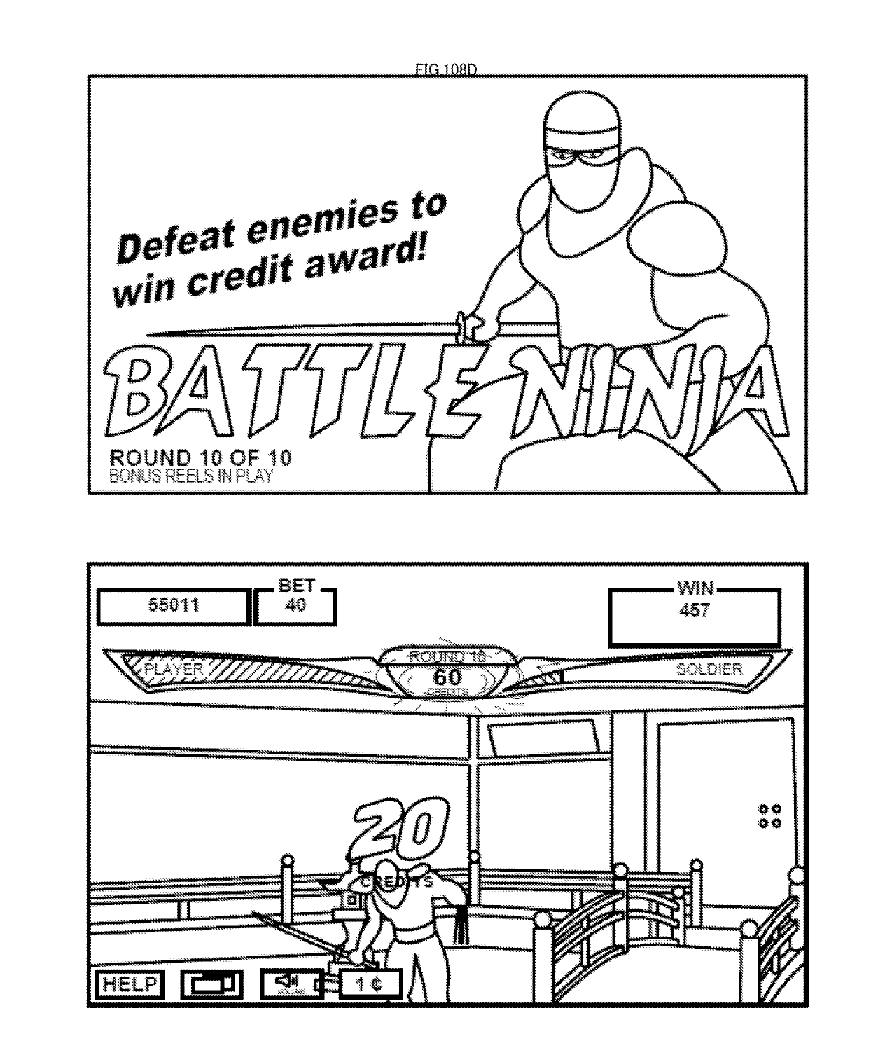

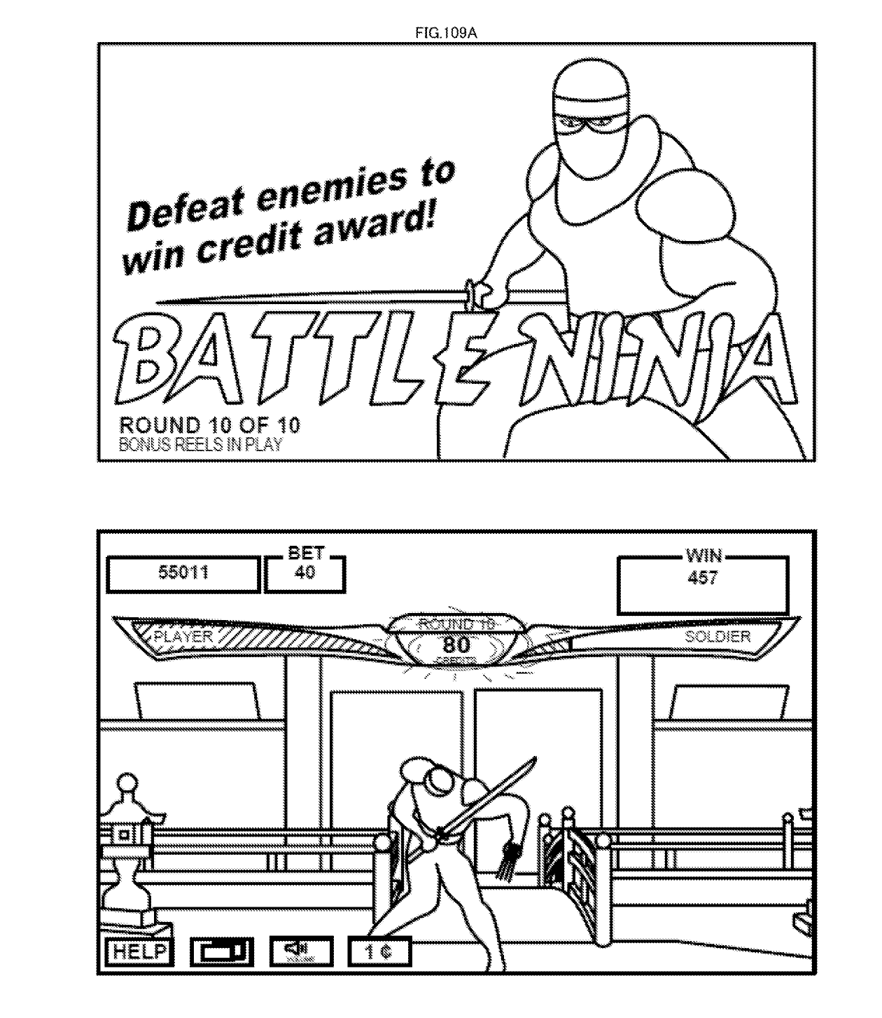

As shown in FIG. 107C to FIG. 108A, an image in which the ally character attacks the enemy character is displayed. As shown in FIG. 108A, “20” indicating a payout is displayed. As shown in FIG. 108B and FIG. 108C, “20” indicating the payout is displayed so as to gradually move to the central portion. As shown in FIG. 108D, in the central portion of the upper side of the lower display device 141, “ROUND 10 60 CREDITS” is displayed, and it is displayed that a total payout of 60 is obtained in the 10th round.

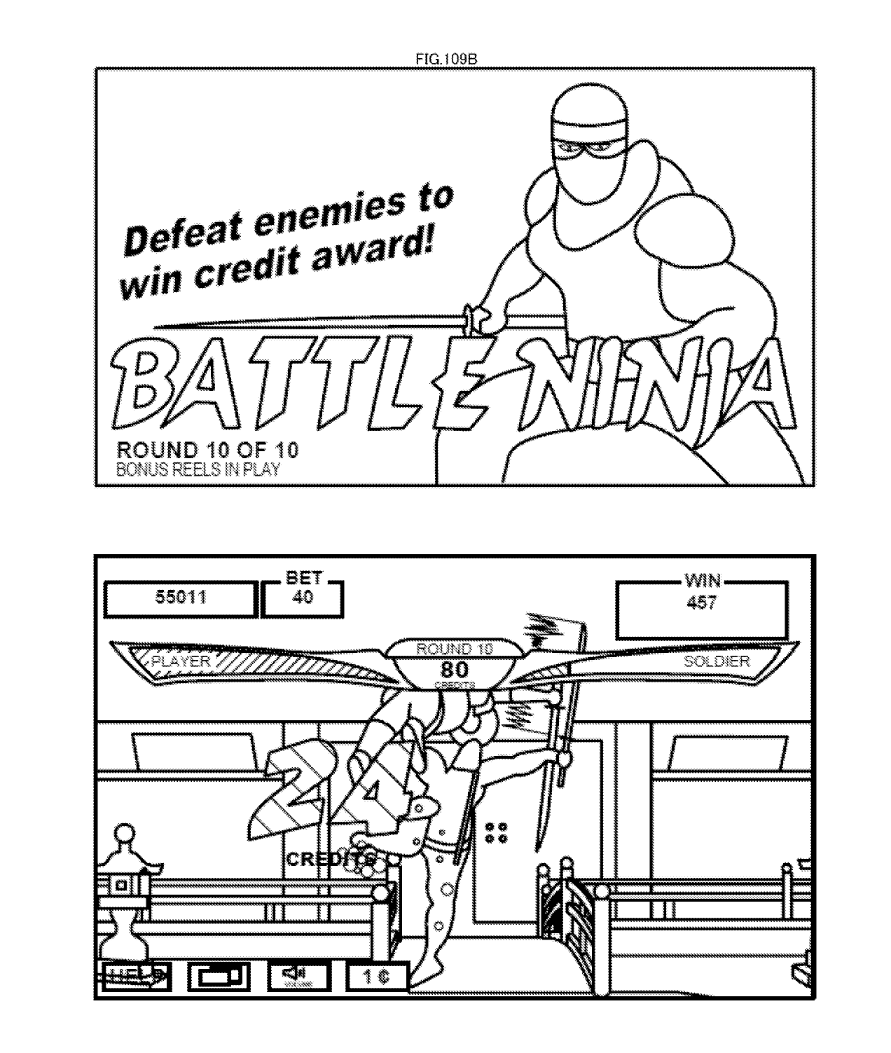

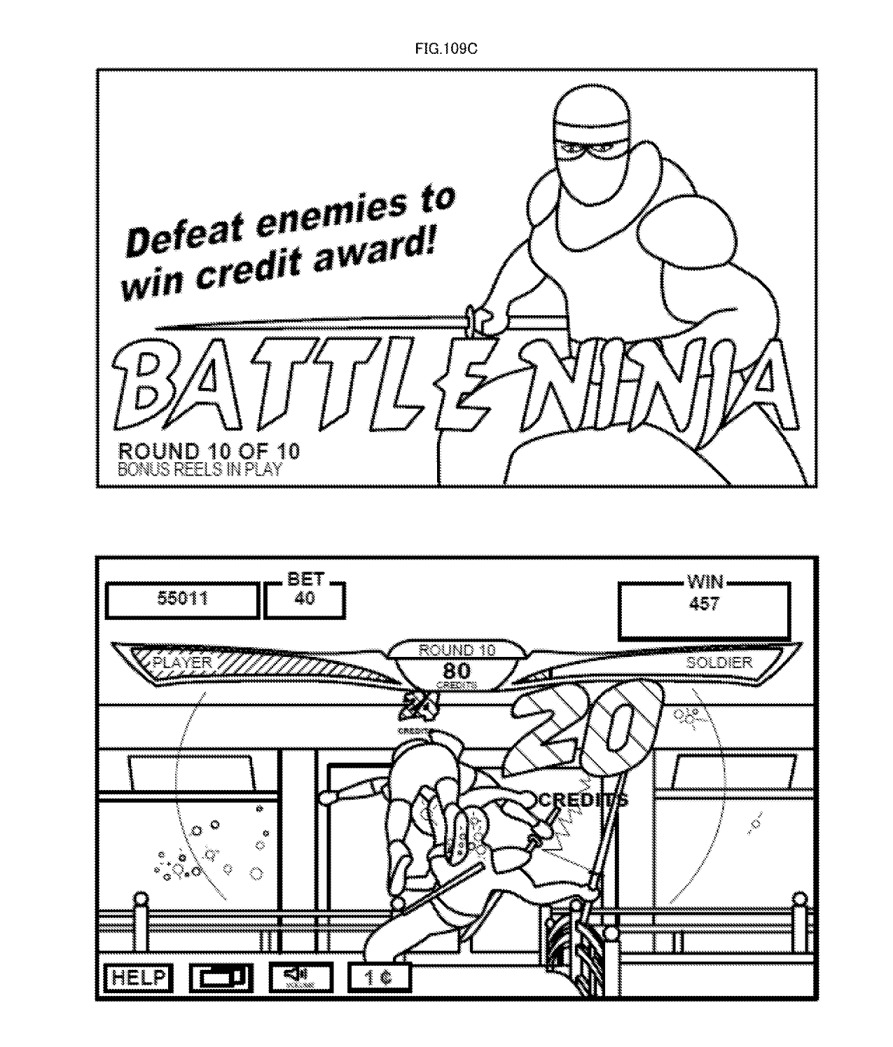

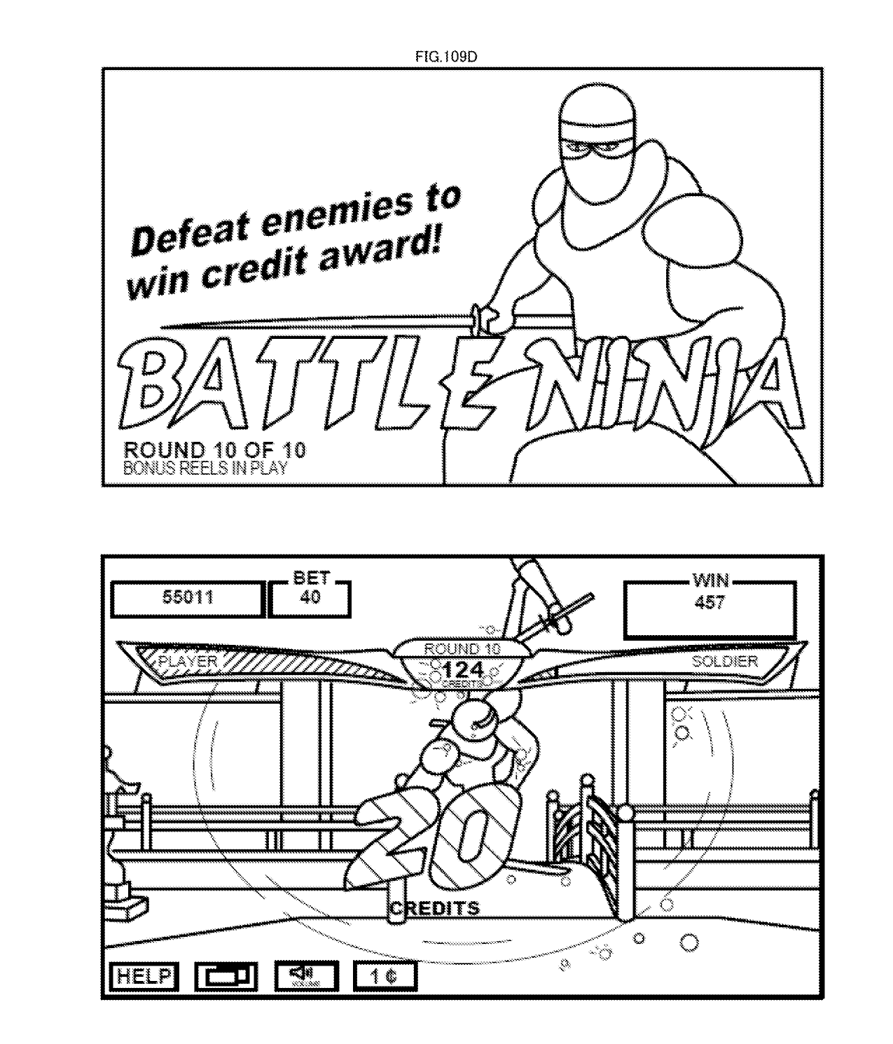

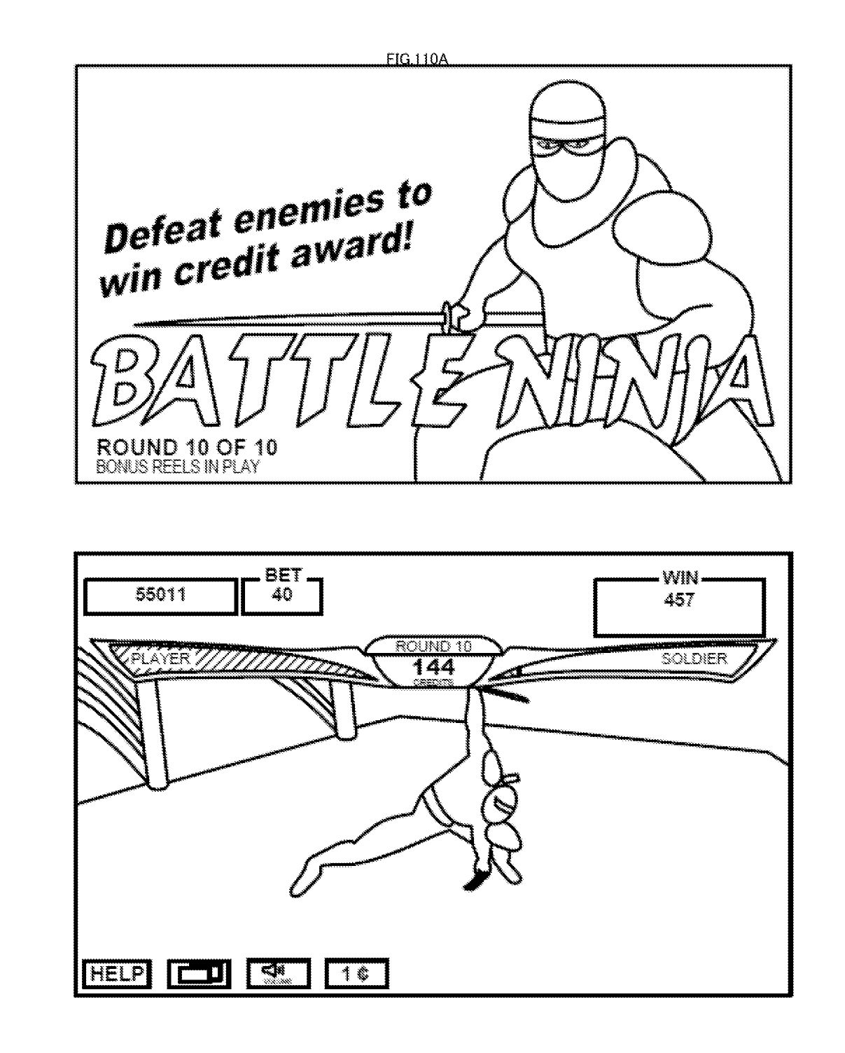

Further, as shown in FIG. 108C, an image in which the ally character attacks the enemy character is displayed, and “20” indicating a payout is displayed. As shown in FIG. 108D, “20” indicating the payout is displayed so as to gradually move to the central portion. As shown in FIG. 109A, in the central portion of the upper side of the lower display device 141, “ROUND 10 80 CREDITS” is displayed, and it is displayed that a total payout of 80 is obtained in the 10th round.

Further, as shown in FIG. 109B an image in which the ally character attacks the enemy character is displayed, and “24” indicating a payout is displayed in a different color. As shown in FIG. 109C, “24” indicating the payout is displayed so as to gradually move to the central portion.

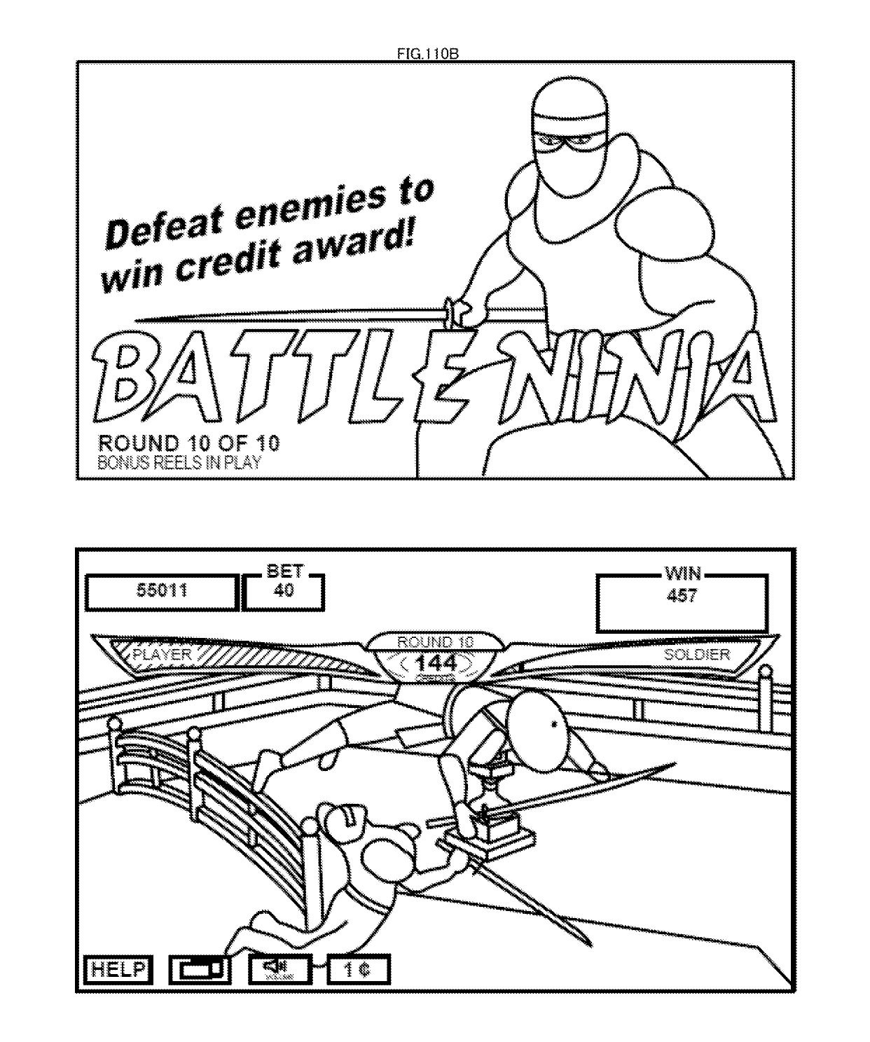

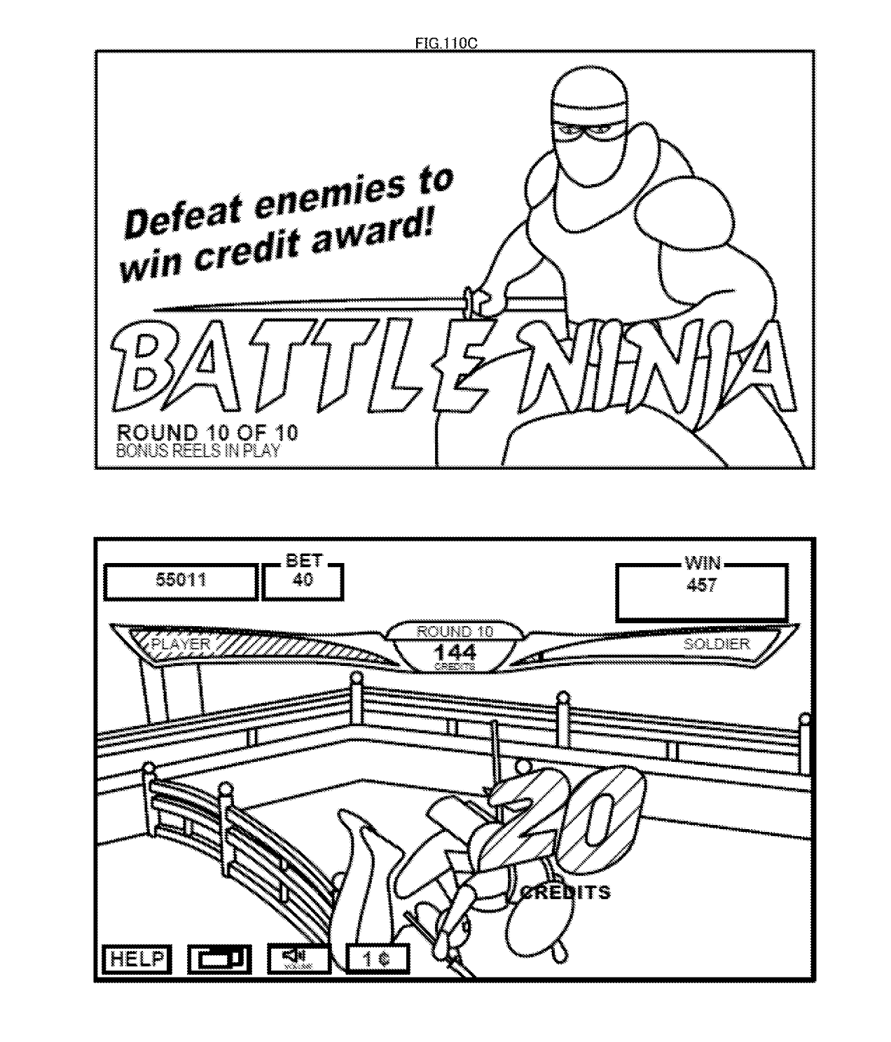

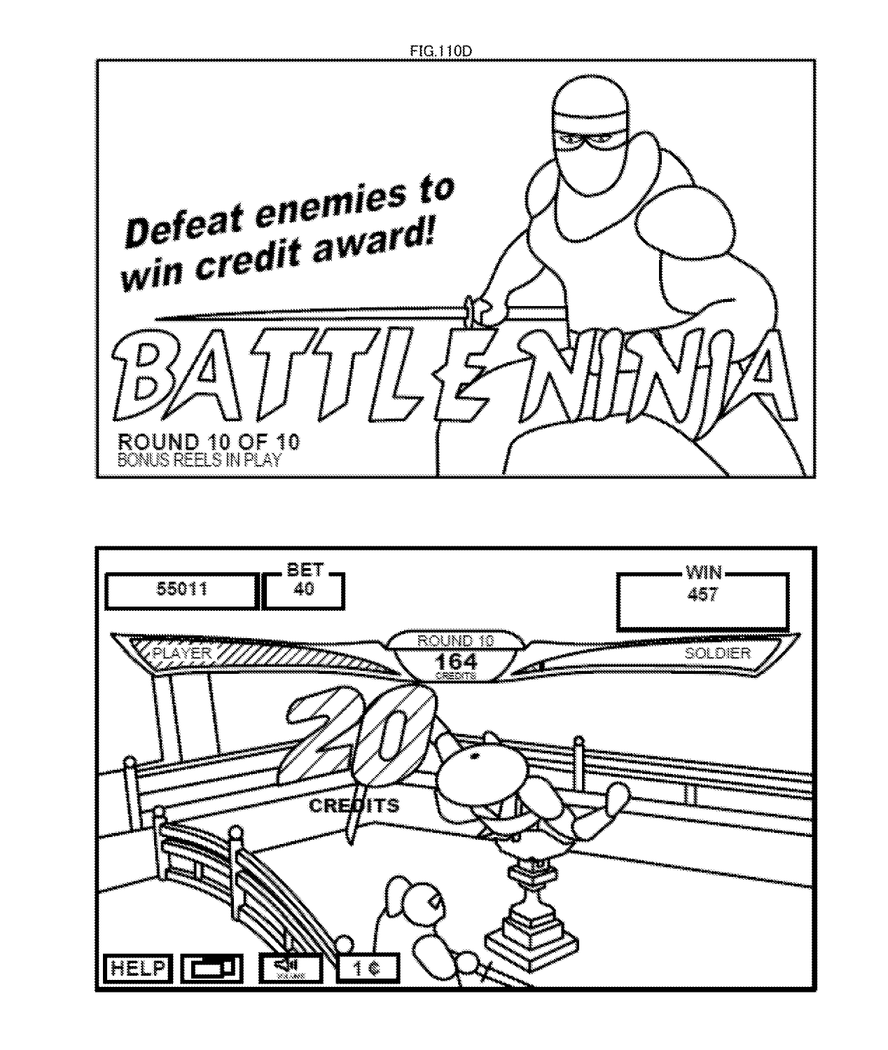

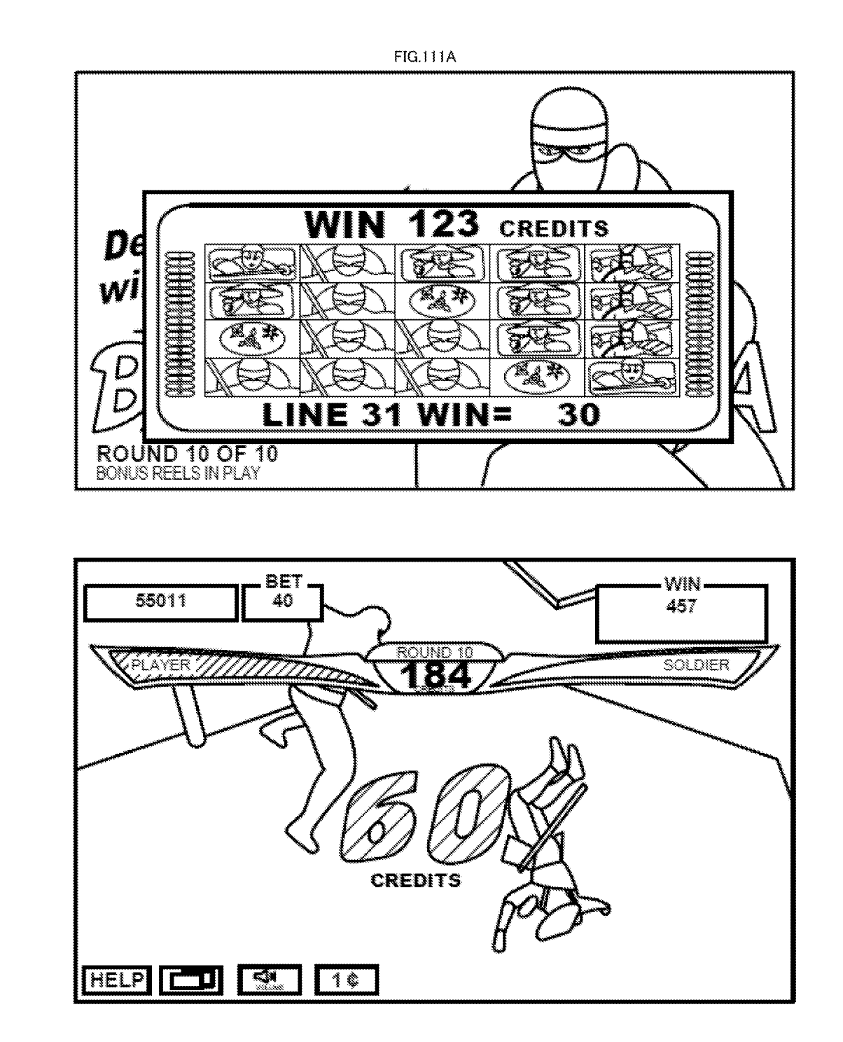

Further, as shown in FIG. 109C, an image in which the ally character attacks the enemy character is displayed, and “20” indicating a payout is displayed in a different color. As shown in FIG. 110A, in the central portion of the upper side of the lower display device 141, “ROUND 10 144 CREDITS” is displayed, and it is displayed that a total payout of 144 is obtained in the 10th round.

Further, as shown in FIG. 110B an image in which the ally character attacks the enemy character is displayed, and as shown in FIG. 110C, “20” indicating a payout is displayed in a different color. Further, an image in which the ally character attacks the enemy character is displayed, and as shown in FIG. 110D, “20” indicating a payout is displayed in a different color.

As shown in FIG. 111A and FIG. 111B, on the upper display device 131, the five video reels 3a to 3e are displayed, a player is notified that the payout which corresponds to a winning pattern by the rearranged symbols is finally 244.

As shown in FIG. 111C, in the central portion of the upper side of the lower display device 141, “ROUND 10 244 CREDITS” and “YOU WIN” are displayed, an image indicating that a player has won in the feature game mode is displayed, and as shown in FIG. 111D, an image indicating that a total payout of 701 is obtained in the feature game mode is displayed.

In this example, in the sixth round and the 10th round, the battle effects of the above-described combo A, combo B, and combo C and the like are executed. In each of the plurality of attacks in the combo in each of the rounds, the images, in each of which the ally character attacks the enemy character and the payout in each of the attacks in the combo is obtained, are displayed.

Thereafter, the game mode returns from the feature game mode to the base game mode, and a unit game in the base game mode is restarted (not shown).

Although in the above-described example, the final round is the 10th round, the final round can be up to the 50th round. The contents of battle effects are selected and executed in accordance with an outcome such as a payout, and as the kinds of battles, each of the single attacks S1, S2, and S3 and the combo

A 0-continuous-attack combo to 10-continuous-attack combo, the combo B 0-continuous-attack combo to 10-continuous-attack combo, and the combo C 0-continuous-attack combo to 10-continuous-attack combo is selected and executed.

### Other Embodiment

In the above-described example, the case when in the feature game mode, by the process in FIG. 24, the payouts of all of the unit games including the unit game in which the retrigger occurs by the revival drawing process are determined, and thereafter, the battle effects (at step S2331 in FIG. 23) in accordance with each of the payouts are executed in each of the unit games is described.

Besides, in the feature game mode, each time a payout in a unit game is provided, battle effects in accordance with the unit game and the payout may be executed. The effects can be executed in an unexpected manner by information pertinent to the payout, thereby allowing the effects surprising a player to be executed.

Further, in the feature game mode, the payouts of all of the unit games are determined, and thereafter, effects who correspond to all of the payouts may be executed in any of the unit games. Specifically, before the first (initial) unit game in the feature game mode is initiated, as predictive effects, the effects with respect to all of the payouts may be displayed. Thus, over the feature game mode, a player's feeling of expectation can be maintained.

### REFERENCE SIGNS LIST

1 gaming machine
10 slot machine
3a, 3b, 3c, 3d, and 3e video reels
71 main CPU
73 RAM
131 upper display device
141 lower display device

What is claimed is:

1. A gaming machine comprising:
a display for displaying a game in a base game mode and for displaying a unit game in a feature game mode being different from the base game mode; and
a controller for determining a payout in the unit game in the feature game mode,
the controller being programmed to execute processes described below:
a process (A-1-1) in which displaying order in which a plurality of unit games in the feature game mode are displayed is determined; and
a process (A-1-2) in which the displaying order is rearranged.

2. The gaming machine according to claim 1, wherein
the process (A-1-1) includes:
a process (A-2-1) in which a payout in each of the plurality of unit games is determined; and
a process (A-2-2) in which winning or losing in each of the plurality of unit games is determined based on the payout, and
the process (A-1-2) includes
a process (A-2-3) in which based on the winning or losing, a pattern in which the displaying order is rearranged is determined by a drawing process.

3. The gaming machine according to claim 2, wherein the feature game mode is a game mode in which by rearranging a plurality of symbols arranged in a group of reel strips, an outcome of each of the unit games is displayed on the display,
the process (A-2-1) includes:
a process (A-3-1) in which one kind of a group of reel strips is determined from a plurality of kinds of groups of reel strips for each of the unit games by a drawing process;
a process (A-3-2) in which by rearranging a plurality of symbols arranged in the one kind of the group of reel strips determined by the process (A-3-1), a payout of the unit game is determined; and
a process (A-3-3) in which in the predetermined number-th unit game among the plurality of unit games, a predetermined group of reel strips is selected from the plurality of kinds of groups of reel strips, and the process (A-3-1) is executed, and
the process (A-1-2) includes
a process (A-3-4) in which the displaying order is rearranged such that displaying order in which the predetermined number-th unit game is displayed is the same before and after the process (A-1-2) is executed.
